(19) United States
(12) Patent Application Publication
(10) Pub. No.: US 2009/0184629 A1
(43) Pub. Date: Jul. 23, 2009

(54) Novel red electroluminescent compounds and organic electroluminescent device using the same

(75) Inventors: Jin Ho Kim, Seoul (KR); Sung Jin Eum, Seoul (KR); Young Jun Cho, Seoul (KR); Hyuck Joo Kwon, Seoul (KR); Bong Ok Kim, Seoul (KR); Sung Min Kim, Seoul-city (KR); Seung Soo Yoon, Seoul (KR)

Correspondence Address: Edwin Oh;Rohm and Haas Electronic Materials LLC, 455 Forest Street, Marlborough, MA, 01752, US

(73) Assignee: Gracel Display Inc., Seoul (KR)

(21) Appl. No.: 12/288,893

(22) Filed: Oct. 24, 2008

(30) Foreign Application Priority Data
Oct. 12, 2007 (KR) 10-2007-0107557

(51) Int. Cl. H01J 1/63; C07F 15/00

(52) U.S. Cl. 313/504; 546/4

(57) ABSTRACT

The present invention relates to novel red phosphorescent compounds exhibiting high luminous efficiency, and organic electroluminescent devices comprising the same.

### FIELD OF THE INVENTION

The present invention relates to novel red phosphorescent compounds exhibiting high luminous efficiency and organic electroluminescent devices using the same.

### BACKGROUND OF THE INVENTION

The most important factor to determine luminous efficiency in an OLED (organic light-emitting diode) is the type of electroluminescent material. Though fluorescent materials has been widely used as an electroluminescent material up to the present, development of phosphorescent materials is one of the best methods to improve the luminous efficiency theoretically up to four (4) times, in view of electroluminescent mechanism.

Up to now, iridium (III) complexes are widely known as phosphorescent material, including (acac)Ir(btp)₂, Ir(ppy)₃ and Firpic, as the red, green and blue one, respectively. In particular, a lot of phosphorescent materials have been recently investigated in Japan and Europe and America.

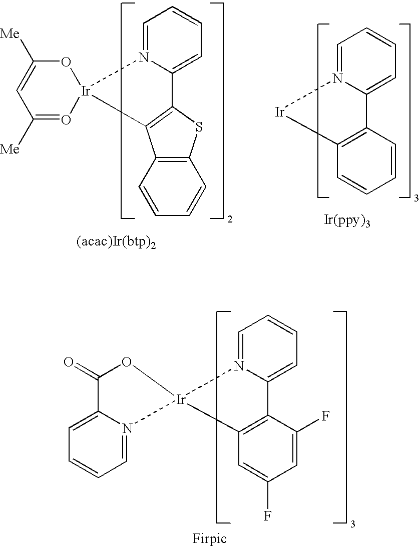

Among conventional red phosphorescent materials, several materials are reported to have good EL (electroluminescence) properties. However, very rare materials among them have reached the level of commercialization. As the best material, an iridium complex of 1-phenyl isoquinoline may be mentioned, which is known to have excellent EL property and to exhibit color purity of dark red with high luminous efficiency. [See A. Tsuboyama et al., J. Am. Chem. Soc. 2003, 125(42), 12971-12979.]

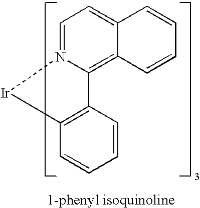

Moreover, the red materials, having no significant problem of life time, have tendency of easy commercialization if they have good color purity or luminous efficiency. Thus, the above-mentioned iridium complex is a material having very high possibility of commercialization due to its excellent color purity and luminous efficiency.

However, the iridium complex is still construed only as a material which is applicable to small displays, while higher levels of EL properties than those of known materials are practically required for an OLED panel of medium to large size.

As a result of intensive efforts of the present inventors to overcome the problems of conventional techniques as described above, they have researched for developing novel red phosphorescent compounds to realize an organic EL device having excellent luminous efficiency and surprisingly improved lifetime. Eventually, the inventors found that luminous efficiency and life property are improved when an iridium complex, which was synthesized by introducing a phenyl derivative at 6-position of quinoline to a primary ligand compound consisting of quinoline and benzene derivative, is applied as a dopant of an electroluminescent device, and completed the present invention. Thus, the object of the invention is to provide novel red phosphorescent compounds having the skeletal to give more excellent properties as compared to those of conventional red phosphorescent materials. Another object of the invention is to provide novel phosphorescent compounds which are applicable to OLED panels of medium to large size.

### SUMMARY OF THE INVENTION

Thus, the present invention relates to novel red phosphorescent compounds and organic electroluminescent devices employing the same in an electroluminescent layer. Specifically, the red phosphorescent compounds according to the invention are characterized in that they are represented by Chemical Formula (I):

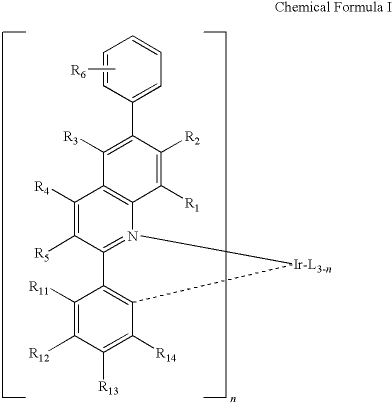

wherein, L is an organic ligand;

R₁ through R₅ independently represent hydrogen, (C₁-C₂₀) alkyl, (C₁-C₂₀) alkoxy, (C₃-C₁₂) cycloalkyl, halogen, tri(C₁-C₂₀)alkylsilyl or tri(C₆-C₂₀)arylsilyl;

R₆ represents hydrogen, (C₁-C₂₀)alkyl, halogen or (C₆-C₂₀) aryl;

R₁₁ through R₁₄ independently represent hydrogen, (C₁-C₂₀) alkyl, halogen, cyano, tri(C₁-C₂₀) alkylsilyl, tri(C₆-C₂₀) arylsilyl, (C₁-C₂₀) alkoxy, (C₁-C₂₀) alkylcarbonyl, (C₆-C₂₀)arylcarbonyl, di(C₁-C₂₀)alkylamino, di(C₆-C₂₀)arylamino, phenyl, naphthyl, anthryl, fluorenyl, spirobifluorenyl or

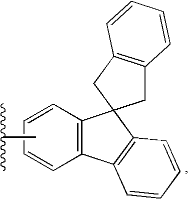

or each of R₁₁ through R₁₄ may be linked to another adjacent group from R₁₁ through R₁₄ via (C₃-C₁₂)alkylene or (C₃-C₁₂)alkenylene with or without a fused ring to form an alicyclic ring, or a monocyclic or polycyclic aromatic ring;

the alkyl, phenyl, naphthyl, anthryl, fluorenyl of R₁₁ through R₁₄, and the alicyclic ring, or the monocyclic or polycyclic aromatic ring formed therefrom by linkage via (C₃-C₁₂)alkylene or (C₃-C₁₂)alkenylene with or without a fused ring may be further substituted by one or more substituent(s) selected from (C₁-C₂₀)alkyl with or without halogen substituent(s), (C₁-C₂₀)alkoxy, halogen, tri(C₁-C₂₀)alkylsilyl, tri(C₆-C₂₀) arylsilyl, (C₁-C₂₀) alkylcarbonyl, (C₆-C₂₀) arylcarbonyl, di(C₁-C₂₀) alkylamino, di(C₆-C₂₀) arylamino and (C₆-C₂₀) aryl; and

n is an integer from 1 to 3.

### BRIEF DESCRIPTION OF THE DRAWINGS

FIG. 1 is a cross-sectional view of an OLED.

### DETAILED DESCRIPTION OF THE INVENTION

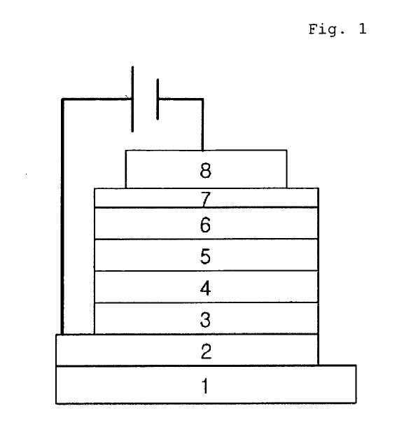

Referring now to the drawings, FIG. 1 illustrates a cross-sectional view of an OLED of the present invention comprising Glass 1, Transparent electrode 2, Hole injection layer 3, Hole transport layer 4, Electroluminescent layer 5, Electron transport layer 6, Electron injection layer 7 and Al cathode 8.

The naphthyl of Chemical Formula (I) may be 1-naphthyl and 2-naphthyl; the anthryl may be 1-anthryl, 2-anthryl and 9-anthryl; and the fluorenyl may be 1-fluorenyl, 2-fluorenyl, 3-fluorenyl, 4-fluorenyl and 9-fluorenyl.

The alicyclic ring, or the monocyclic or polycyclic aromatic ring formed from two of R₁₁ through R₁₄ in Chemical Formula (I) by linkage via (C₃-C₁₂)alkylene or (C₃-C₁₂)alkenylene with or without a fused ring is benzene, naphthalene, anthracene, fluorene, indene or phenanthrene. The compound within the square bracket ([ ]) serves as a primary ligand of iridium, and L serves as a subsidiary ligand. The organic phosphorescent compounds according to the present invention also include the complex with the ratio of primary ligand:subsidiary ligand=2:1 (n=2) and the complex with the ratio of primary ligand:subsidiary ligand=1:2 (n=1), as well as tris-chelated complexes without subsidiary ligand (L) (n=3).

R₁₁ through R₁₄ independently represent hydrogen, methyl, ethyl, n-propyl, i-propyl, n-butyl, i-bytyl, t-butyl, n-pentyl, i-pentyl, n-hexyl, n-heptyl, n-octyl, 2-ethylhexyl, n-nonyl, trifluoromethyl, fluoro, cyano, trimethylsilyl, tripropylsilyl, tri(t-butyl)silyl, t-butyldimethylsilyl, triphenylsilyl, methoxy, ethoxy, butoxy, methylcarbonyl, ethylcarbonyl, t-butylcarbonyl, phenylcarbonyl, dimethylamino, diphenylamino, phenyl, naphthyl, anthryl, fluorenyl or

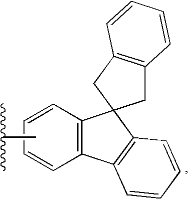

and the fluorenyl may be further substituted by methyl, ethyl, n-propyl, i-propyl, n-butyl, i-butyl, t-butyl, n-pentyl, i-pentyl, n-hexyl, n-heptyl, n-octyl, 2-ethylhexyl, n-nonyl, phenyl, naphthyl, anthryl, trimethylsilyl, tripropylsilyl, tri(t-butyl)silyl, t-butyldimethylsilyl or triphenylsilyl.

The organic phosphorescent compound according to the invention may be exemplified by the compounds represented by one of Chemical Formulas (II) to (VI):

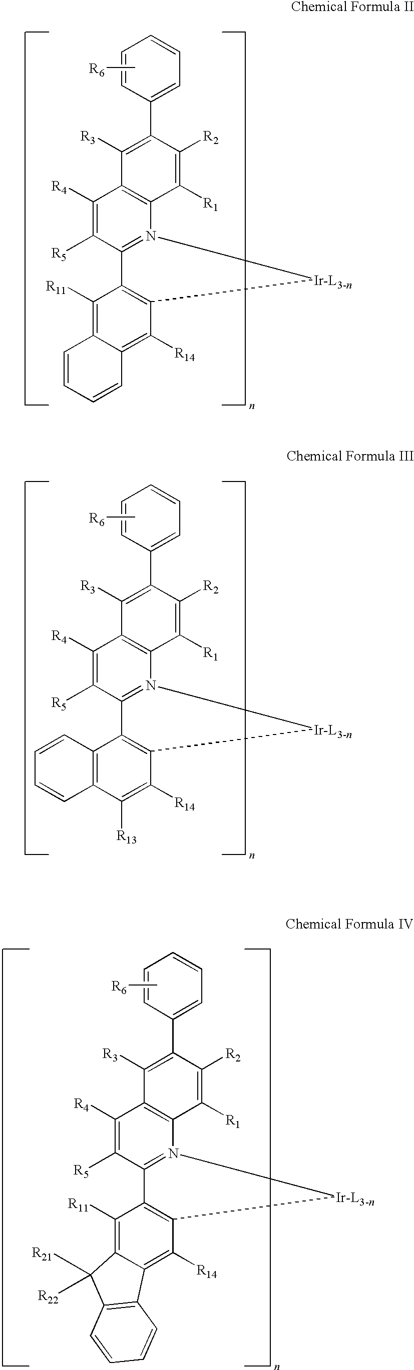

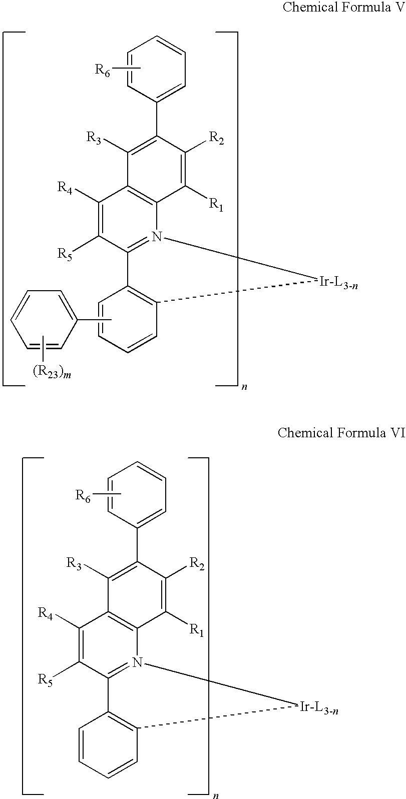

wherein, L, R₁, R₂, R₃, R₄, R₅, R₆, R₁₁, R₁₃, R₁₄ and n are defined as in Chemical Formula (I);

R₂₁ and R₂₂ independently represent hydrogen, (C₁-C₂₀)alkyl, (C₆-C₂₀)aryl, or R₂₁ and R₂₂ may be linked each other via (C₃-C₁₂)alkylene or (C₃-C₁₂)alkenylene with or without a fused ring to form an alicyclic ring, or a monocyclic or polycyclic aromatic ring;

R₂₃ represents (C₁-C₂₀) alkyl, halogen, cyano, tri(C₁-C₂₀) alkylsilyl, tri(C₆-C₂₀) arylsilyl, (C₁-C₂₀) alkoxy, (C₁-C₂₀) alkylcarbonyl, (C₆-C₂₀) arylcarbonyl, phenyl, di(C₁-C₂₀) alkylamino, di(C₆-C₂₀) arylamino, naphthyl, 9,9-di(C₁-C₂₀) alkylfluorenyl or 9,9-di(C₆-C₂₀)arylfluorenyl; and

m is an integer from 1 to 5.

R₁ through R₅ of Chemical Formula (I) independently represent hydrogen, methyl, ethyl, n-propyl, i-propyl, n-butyl, i-butyl, t-butyl, n-pentyl, i-pentyl, n-hexyl, n-heptyl, n-octyl, ethylhexyl, methoxy, ethoxy, butoxy, cyclopropyl, cyclohexyl, cycloheptyl, fluoro, trimethylsilyl, tripropylsilyl, tri(t-butyl)silyl, t-butyldimethylsilyl or triphenylsilyl; and R₆ represents hydrogen, methyl, ethyl, n-propyl, i-propyl, n-butyl, i-butyl, t-butyl, n-pentyl, n-hexyl, n-heptyl, n-octyl, ethylhexyl, fluoro, phenyl, naphthyl, anthryl, fluorenyl or spirobifluorenyl.

The organic phosphorescent compounds according to the present invention can be specifically exemplified by the following compounds, but they are not restricted thereto:

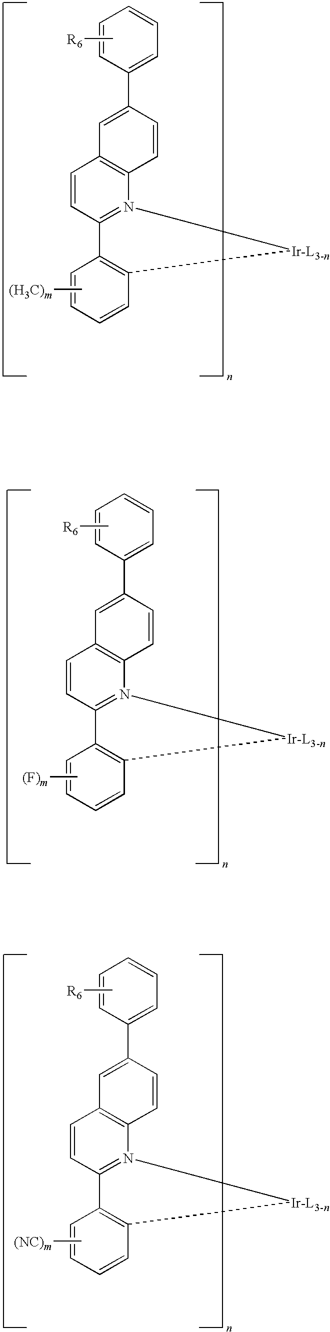

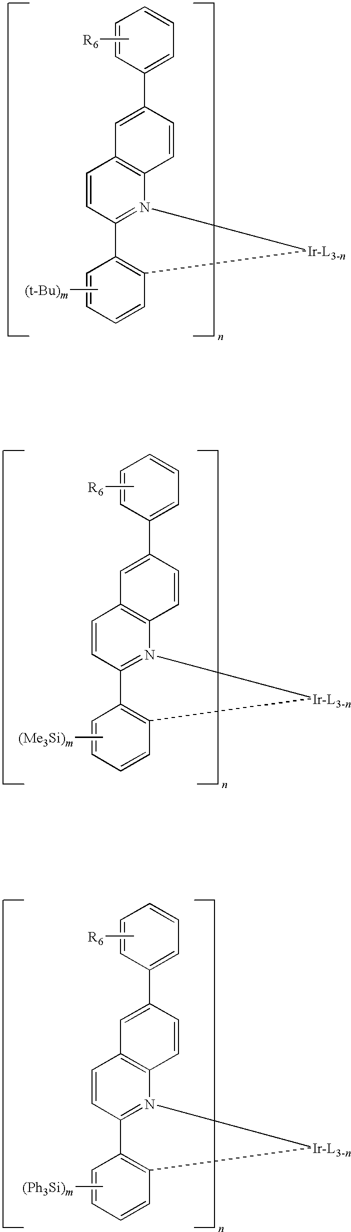

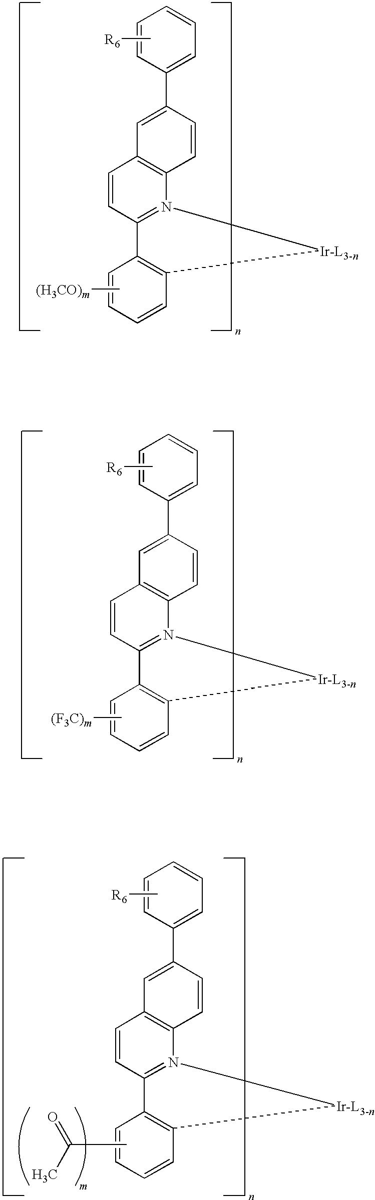

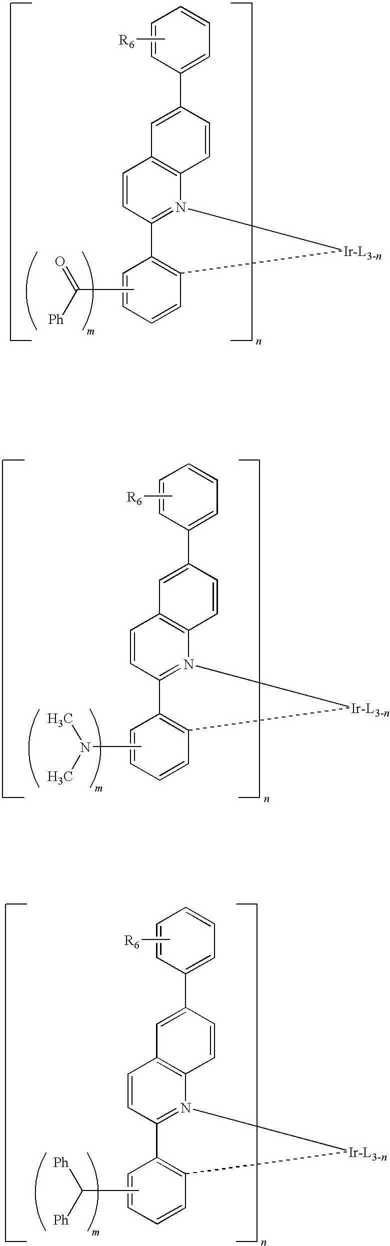

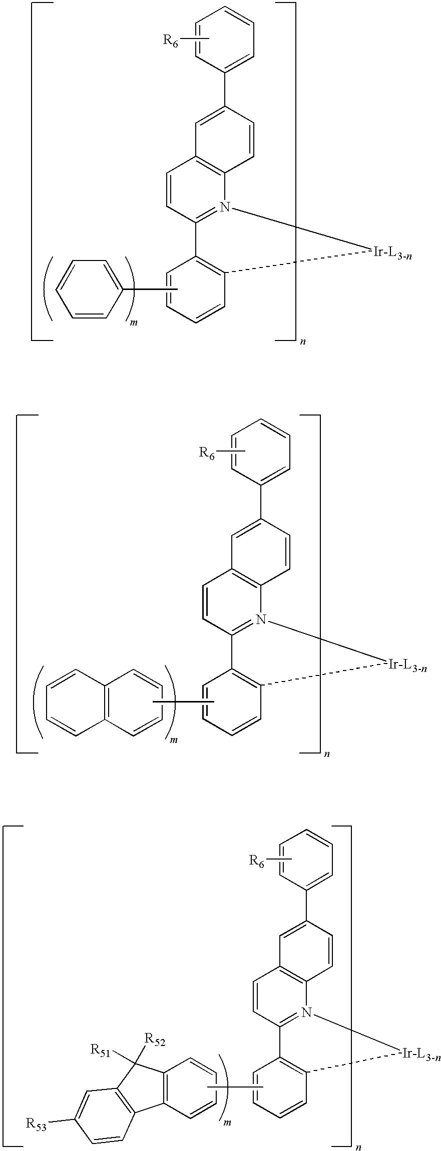

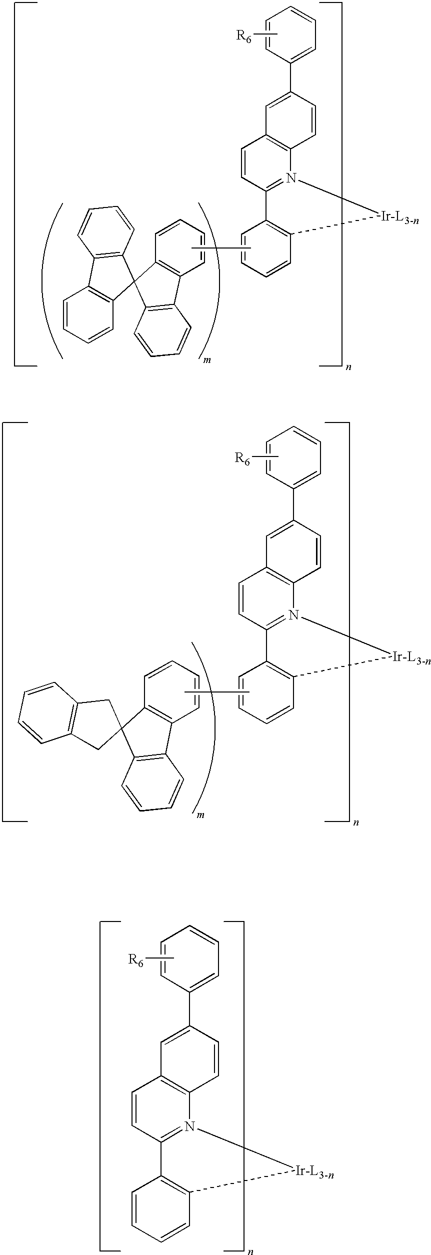

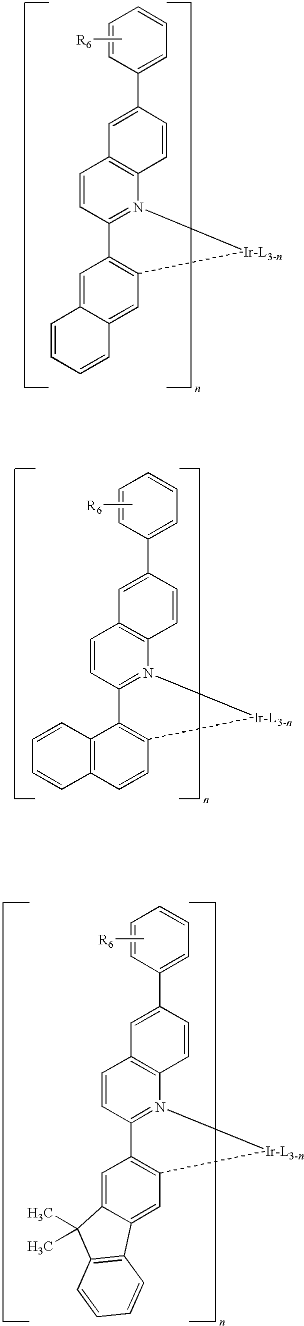

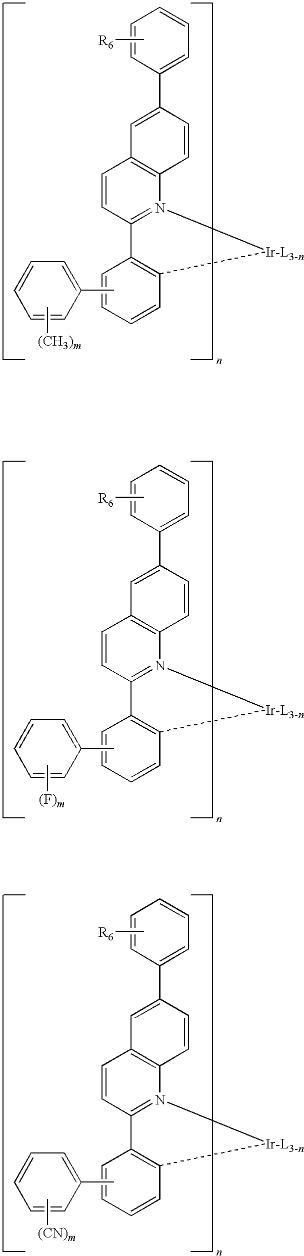

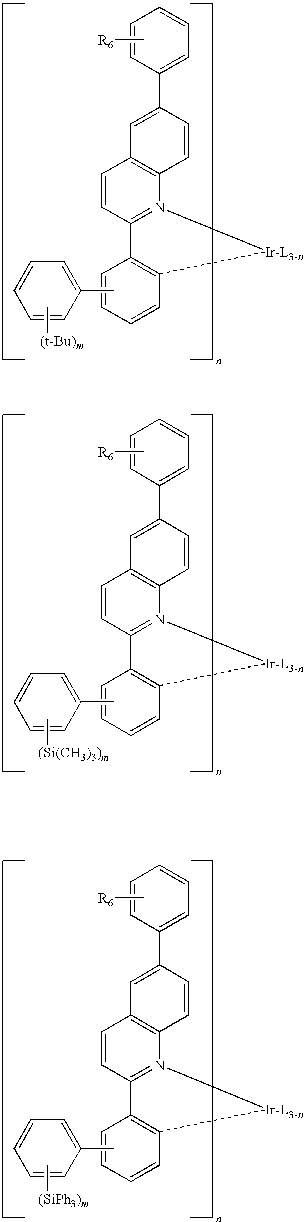

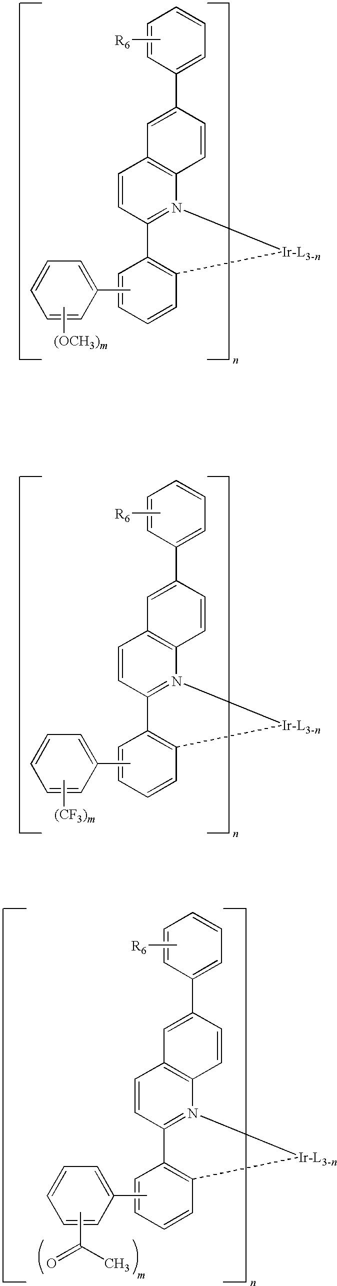

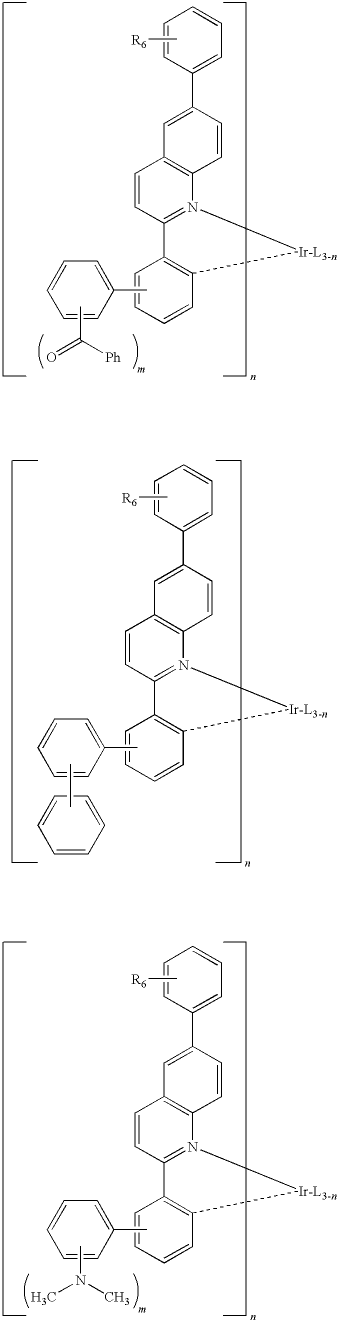

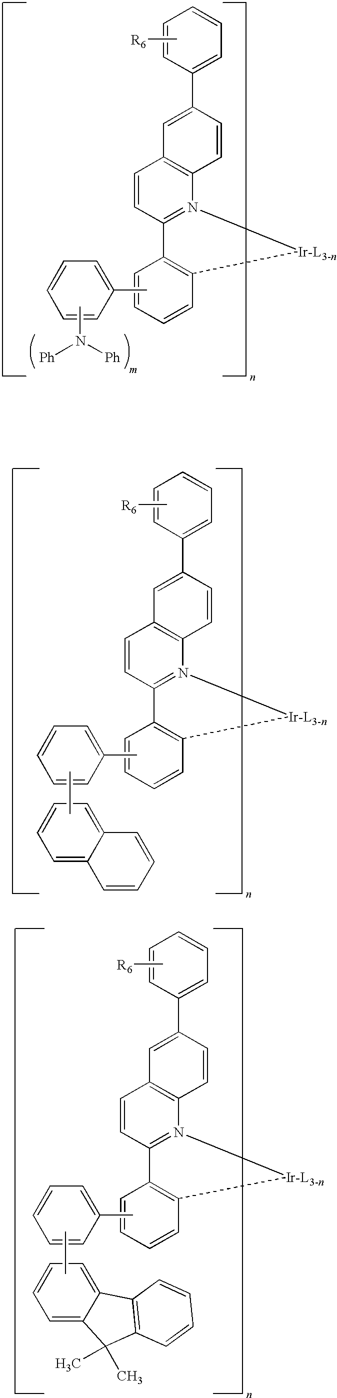

wherein, L represents an organic ligand;

R₆ represents hydrogen, methyl, ethyl, n-propyl, i-propyl, n-butyl, i-butyl, t-butyl, n-pentyl, i-pentyl, n-hexyl, n-heptyl, n-octyl, ethylhexyl, fluoro, phenyl or naphthyl;

R₅₁ and R₅₂ independently represent methyl, ethyl, n-propyl, i-propyl, n-butyl, i-butyl, t-butyl, n-pentyl, i-pentyl, n-hexyl, n-heptyl, n-octyl, ethylhexyl, phenyl or naphthyl, or R₅₁ and R₅₂ may be linked each other via (C₃-C₁₂)alkylene or (C₃-C₁₂)alkenylene with or without a fused ring to form an alicyclic ring, or a monocyclic or polycyclic aromatic ring;

R₅₃ represents hydrogen, methyl, ethyl, n-propyl, i-propyl, n-butyl, i-butyl, t-butyl, n-pentyl, i-pentyl, n-hexyl, n-heptyl, n-octyl, 2-ethylhexyl, trimethylsilyl, tripropylsilyl, tri(t-butyl)silyl, t-butyldimethylsilyl, triphenylsilyl, phenyl or naphthyl;

m is an integer from 1 to 3; and

n is an integer from 1 to 3.

The subsidiary ligands (L) of the organic phosphorescent compounds according to the present invention include the following structures:

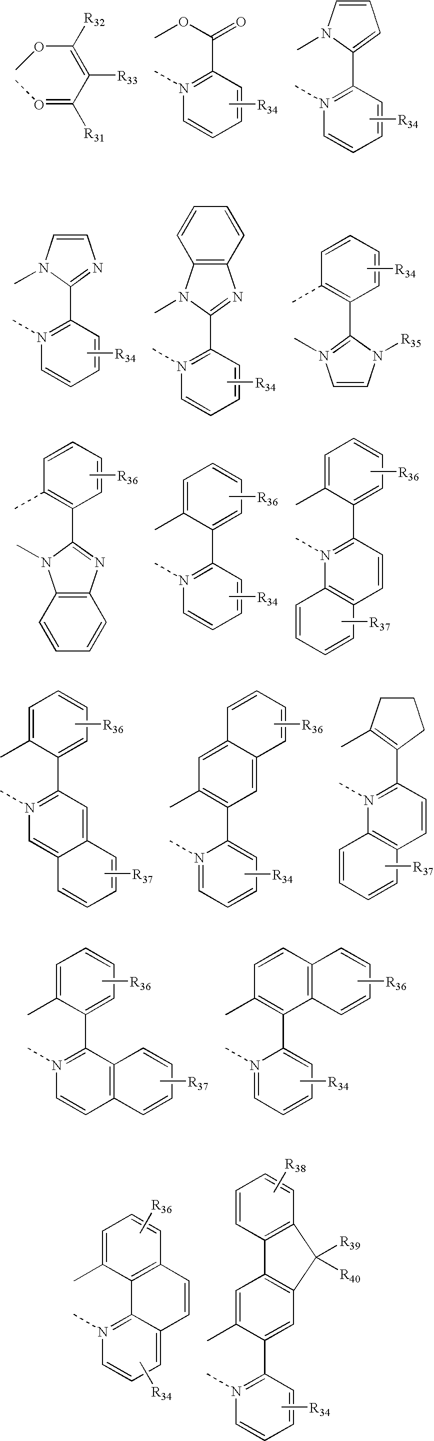

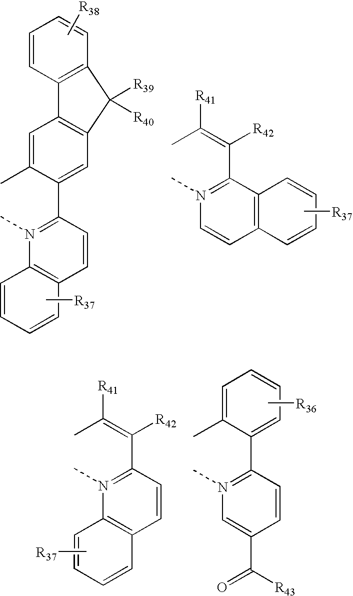

wherein, R₃₁ and R₃₂ independently represent hydrogen, (C₁-C₂₀)alkyl with or without halogen substituent(s), phenyl with or without (C₁-C₂₀)alkyl substituent(s) or halogen;

R₃₃ through R₃₈ independently represent hydrogen, (C₁-C₂₀)alkyl, phenyl with or without (C₁-C₂₀)alkyl substituent(s), tri(C₁-C₂₀)alkylsilyl or halogen;

R₃₉ through R₄₂ independently represent hydrogen, (C₁-C₂₀)alkyl, phenyl with or without (C₁-C₂₀)alkyl substituent(s); and

R₄₃ represents (C₁-C₂₀)alkyl, phenyl with or without (C₁-C₂₀)alkyl substituent(s), or halogen.

The subsidiary ligands (L) of the organic phosphorescent compounds according to the present invention can be exemplified by the following structures, but they are not restricted thereto:

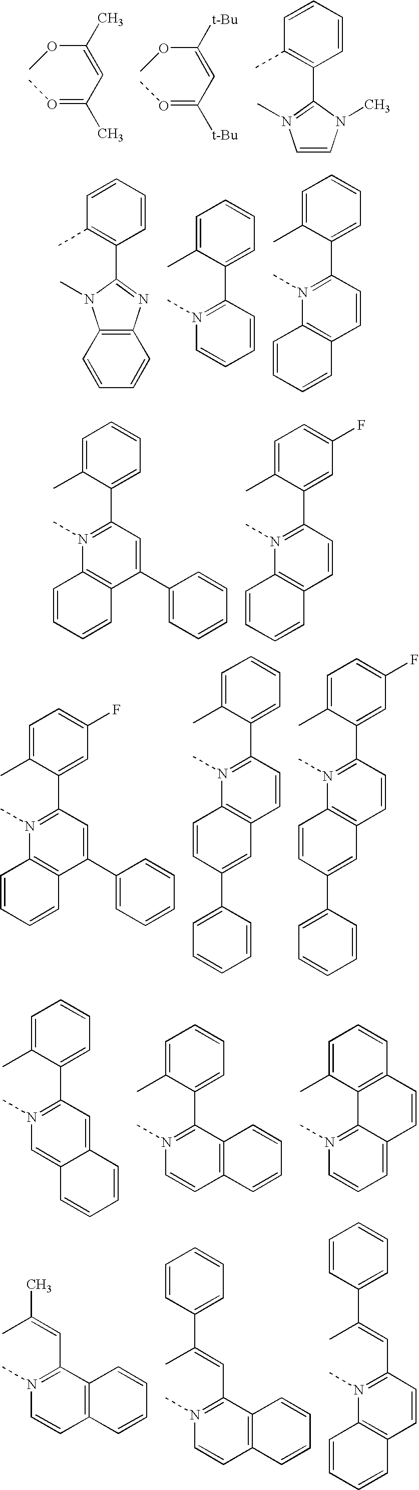

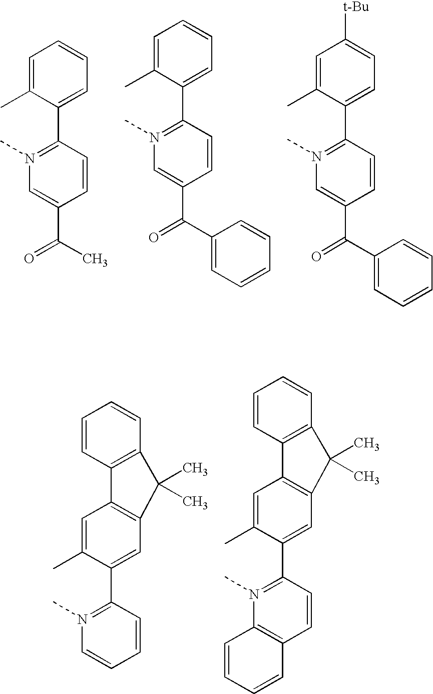

The process for preparing the organic phosphorescent compounds according to the present invention is described by referring to Reaction Schemes (1) to (3) shown below:

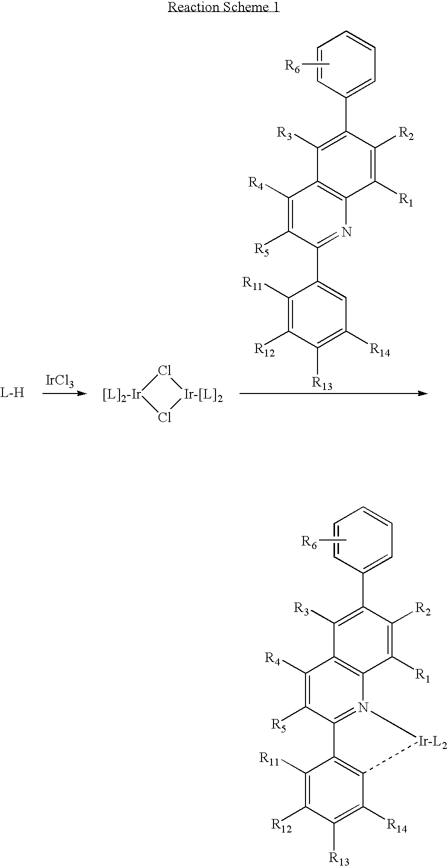

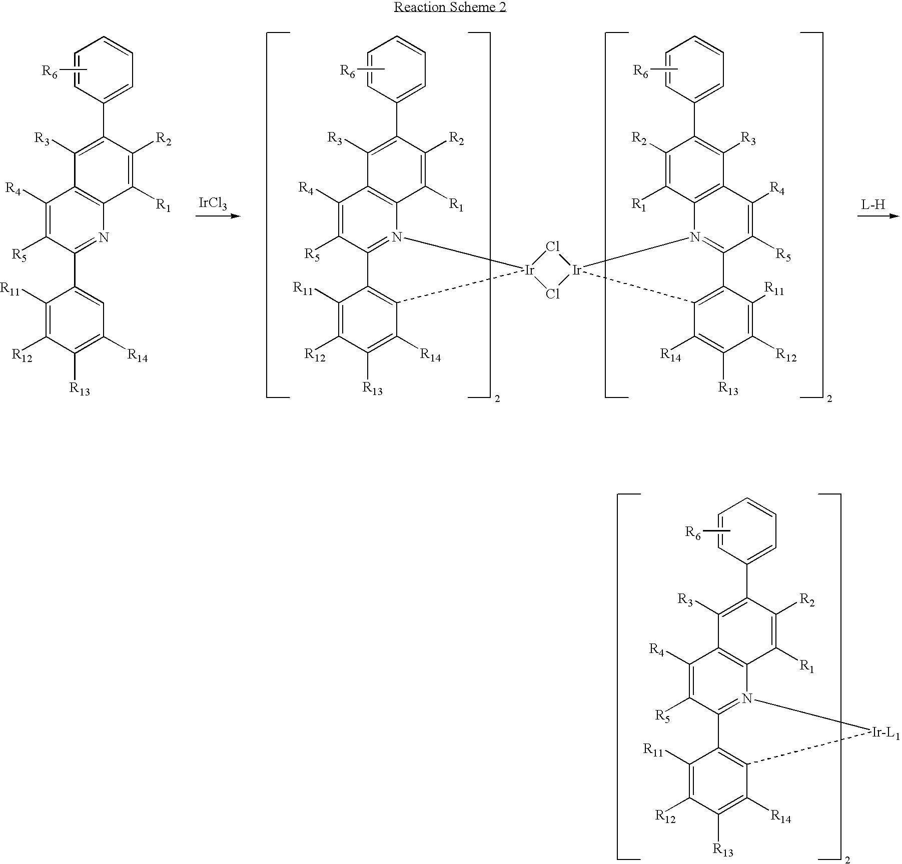

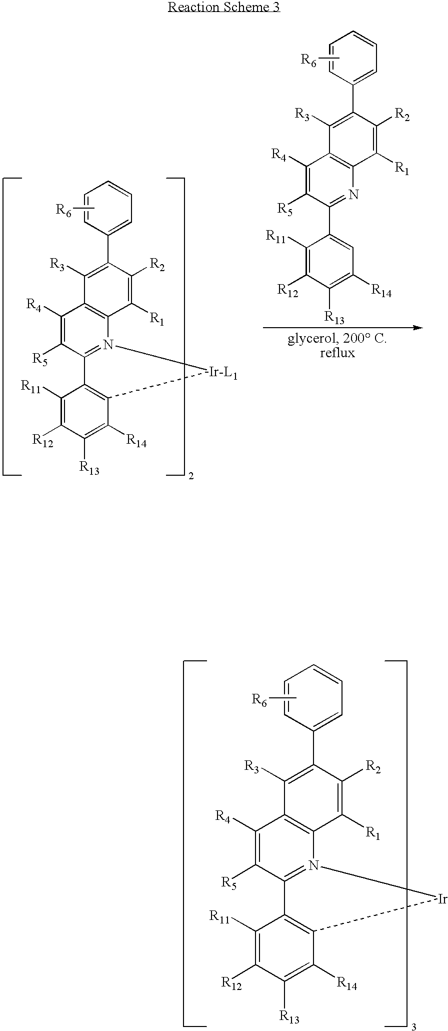

wherein, R₁, R₂, R₃, R₄, R₅, R₆, R₁₁, R₁₂, R₁₃, R₁₄ and L are defined as in Chemical Formula (I).

Reaction Scheme (1) provides a compound of Chemical Formula (I) with n=1, in which iridium trichloride (IrCl₃) and a subsidiary ligand compound (L-H) are mixed in a solvent at a molar ratio of 1:2˜3, and the mixture is heated under reflux to isolate diiridium dimer. In the reaction stage, preferable solvent is alcohol or a mixed solvent of alcohol/water, such as 2-ethoxyethanol, and 2-ethoxyethanol/water mixtures. The isolated diiridium dimer is then heated with a primary ligand compound as a in organic solvent to provide an organic phosphorescent iridium compound having the ratio of primary ligand:subsidiary ligand of 1:2 as the final product. The reaction is carried out with AgCF₃SO₃, Na₂CO₃ or NaOH being admixed with organic solvent such as 2-ethoxyethanol and 2-methoxyethylether.

Reaction Scheme (2) provides a compound of Chemical Formula (I) with n=2, in which iridium trichloride (IrCl₃) and a primary ligand compound are mixed in a solvent at a molar ratio of 1:2-3, and the mixture is heated under reflux to isolate diiridium dimer. In the reaction stage, preferable solvent is alcohol or a mixed solvent of alcohol/water, such as 2-ethoxyethanol, and 2-ethoxyethanol/water mixture. The isolated diiridium dimer is then heated with the subsidiary ligand compound (L-H) in organic solvent to provide an organic phosphorescent iridium compound having the ratio of primary ligand:subsidiary ligand of 2:1 as the final product.

The molar ratio of the primary ligand of Chemical Formula (I) and the subsidiary ligand (L) in the final product is determined by appropriate molar ratio of the reactant depending on the composition. The reaction may be carried out with AgCF₃SO₃, Na₂CO₃ or NaOH being admixed with organic solvent such as 2-ethoxyethanol, 2-methoxyethylether and 1,2-dichloromethane.

Reaction Scheme (3) provides a compound of Chemical Formula (I) with n=3, in which iridium complex prepared according to Reaction Scheme (2) and a compound of Chemical Formula (I) as primary ligand are mixed in glycerol at a molar ratio of 1:2˜3, and the mixture is heated under reflux to obtain organic phosphorescent iridium complex coordinated with three primary ligands.

The compounds employed as a primary ligand in the present invention can be prepared according to Reaction Scheme (4), on the basis of conventional processes.

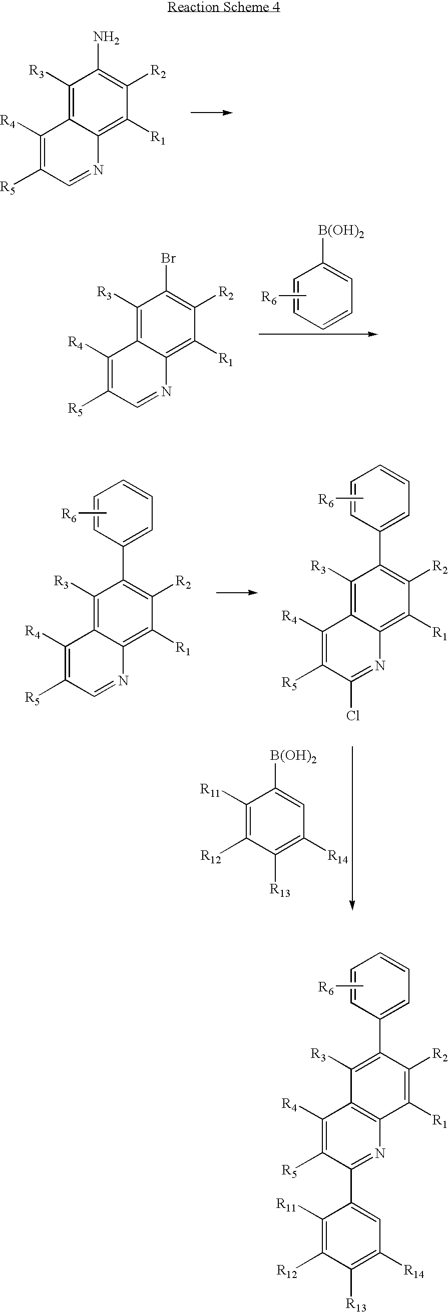

wherein, R₁ through R₆ and R₁₁ through R₁₄ are defined as in Chemical Formula (I).

The present invention also provides an organic electroluminescent device which is comprised of a first electrode; a second electrode; and at least one organic layer(s) interposed between the first electrode and the second electrode; wherein the organic layer comprises one or more compound(s) represented by Chemical Formula (I):

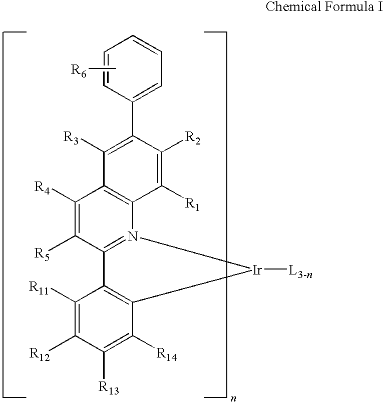

wherein, L is an organic ligand;

R₁ through R₅ independently represent hydrogen, (C₁-C₂₀) alkyl, (C₁-C₂₀) alkoxy, (C₃-C₁₂) cycloalkyl, halogen, tri(C₁-C₂₀)alkylsilyl or tri(C₆-C₂₀)arylsilyl;

R₆ represents hydrogen, (C₁-C₂₀)alkyl, halogen or (C₆-C₂₀) aryl;

R₁₁ through R₁₄ independently represent hydrogen, (C₁-C₂₀)alkyl, halogen, cyano, tri(C₁-C₂₀)alkylsilyl, tri(C₆-C₂₀) arylsilyl, (C₁-C₂₀) alkoxy, (C₁-C₂₀) alkylcarbonyl, (C₆-C₂₀) arylcarbonyl, di(C₁-C₂₀) alkylamino, di(C₆-C₂₀) arylamino, phenyl, naphthyl, anthryl, fluorenyl, spirobifluorenyl or

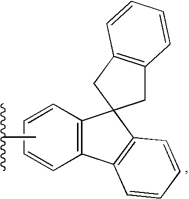

or each of R₁₁ through R₁₄ may be linked to another adjacent group from R₁₁ through R₁₄ via (C₃-C₁₂)alkylene or (C₃-C₁₂)alkenylene with or without a fused ring to form an alicyclic ring, or a monocyclic or polycyclic aromatic ring;

the alkyl, phenyl, naphthyl, anthryl, fluorenyl of R₁₁ through R₁₄, and the alicyclic ring, or the monocyclic or polycyclic aromatic ring formed therefrom by linkage via (C₃-C₁₂)alkylene or (C₃-C₁₂)alkenylene with or without a fused ring may be further substituted by one or more substituent(s) selected from (C₁-C₂₀)alkyl with or without halogen substituent(s), (C₁-C₂₀)alkoxy, halogen, tri(C₁-C₂₀)alkylsilyl, tri(C₆-C₂₀) arylsilyl, (C₁-C₂₀) alkylcarbonyl, (C₆-C₂₀) arylcarbonyl, di(C₁-C₂₀) alkylamino, di(C₆-C₂₀) arylamino and (C₆-C₂₀) aryl; and

n is an integer from 1 to 3.

The organic electroluminescent device according to the present invention is characterized in that the organic layer comprises an electroluminescent region, which comprises one or more compound(s) represented by Chemical Formula (I) as electroluminescent dopant, and one or more host(s). The host applied to the organic electroluminescent device according to the invention is not particularly restricted, but can be exemplified by the compounds represented by one of Chemical Formulas (VII) to (IX):

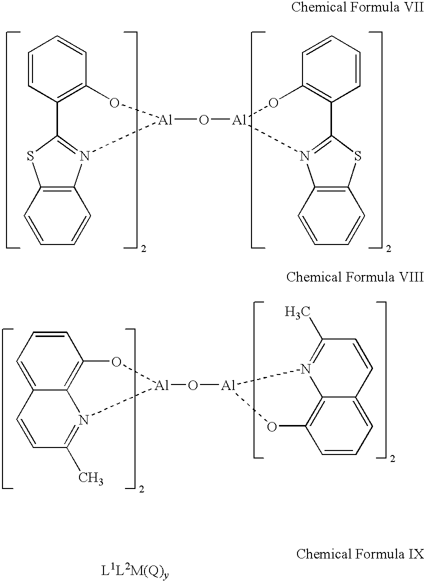

wherein, the ligands, L¹ and L² independently represent one of the following structures:

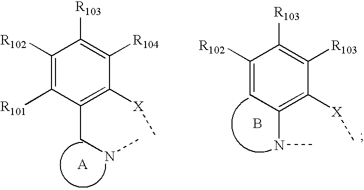

M is a bivalent or trivalent metal;

y is 0 when M is a bivalent metal, while y is 1 when M is a trivalent metal;

Q represents (C₆-C₂₀)aryloxy or tri(C₆-C₂₀)arylsilyl, and the aryloxy and triarylsilyl of Q may be further substituted by (C₁-C₅)alkyl or (C₆-C₂₀)aryl;

X represents O, S or Se;

ring A represents oxazole, thiazole, imidazole, oxadiazole, thiadiazole, benzoxazole, benzothiazole, benzimidazole, pyridine or quinoline;

ring B represents pyridine or quinoline, and ring B may be further substituted by (C₁-C₅)alkyl, or substituted or unsubstituted phenyl or naphthyl;

R₁₀₁ through R₁₀₄ independently represent hydrogen, (C₁-C₅)alkyl, halogen, tri(C₁-C₅)alkylsilyl, tri(C₆-C₂₀)arylsilyl or (C₆-C₂₀)aryl, or each of them may be linked to an adjacent substituent via alkylene or alkenylene to form a fused ring, and the pyridine or quinoline may form a chemical bond together with R₁₀₁ to form a fused ring; and

the ring A or aryl group of R₁₀₁ through R₁₀₄ may be further substituted by (C₁-C₅)alkyl, halogen, (C₁-C₅)alkyl with halogen substituent (s), phenyl, naphthyl, tri(C₁-C₅)alkylsilyl, tri(C₆-C₂₀)arylsilyl or amino group.

The ligands, L¹ and L² are independently selected from the following structures:

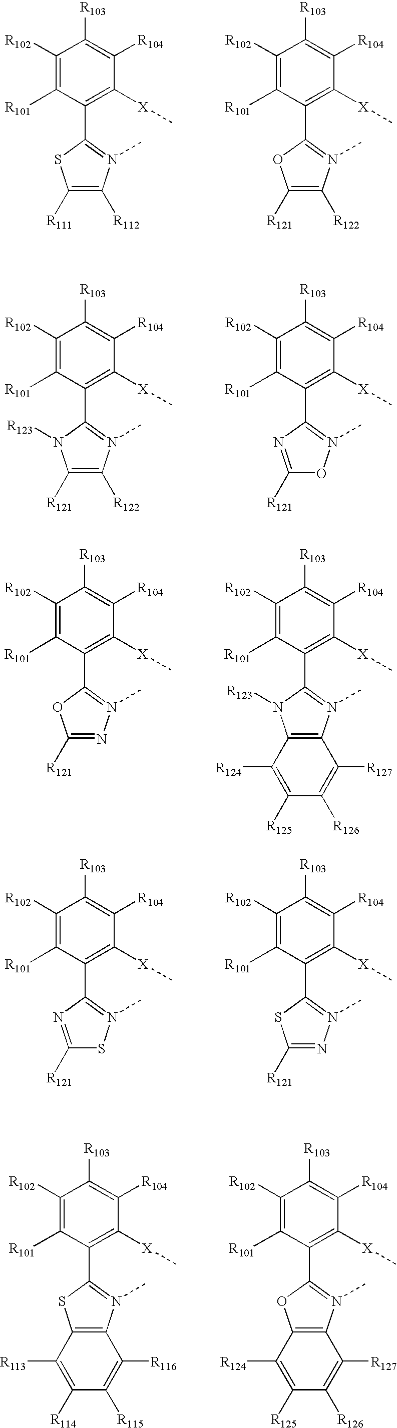

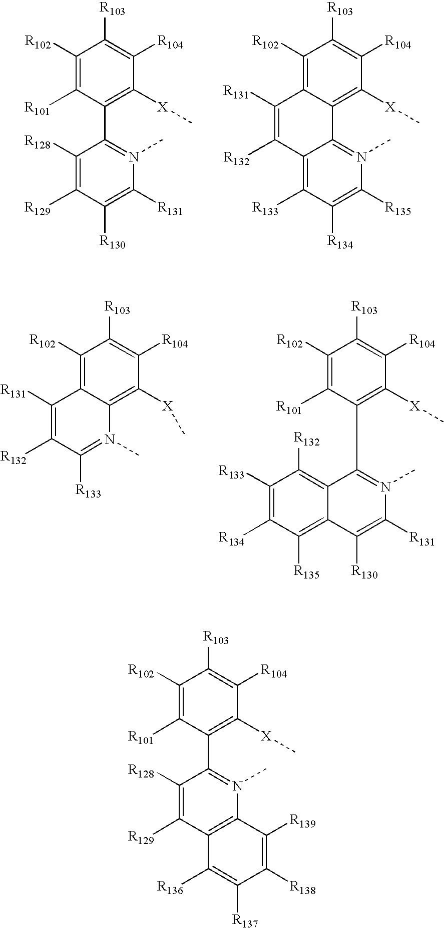

wherein, X represents O, S or Se; R₁₀₁ through R₁₀₄ independently represent hydrogen, (C₁-C₅)alkyl with or without halogen substituent(s), halogen, (C₆-C₂₀)aryl, (C₄-C₂₀)heteroaryl, tri(C₁-C₅)alkylsilyl, tri(C₆-C₂₀)arylsilyl, di(C₁-C₅)alkylamino, di(C₆-C₂₀)arylamino, thiophenyl or furanyl, or each of them may be linked to an adjacent substituent via alkylene or alkenylene to form a fused ring;

R₁₁₁ through R₁₁₆, R₁₂₁ and R₁₂₂ independently represent hydrogen, (C₁-C₅)alkyl, halogen, (C₁-C₅)alkyl with halogen substituent(s), phenyl, naphthyl, biphenyl, fluorenyl, tri(C₁-C₅) alkylsilyl, tri(C₆-C₂₀)arylsilyl, di(C₁-C₅)alkylamino, di(C₆-C₂₀)arylamino, thiophenyl or furanyl;

R₁₂₃ represents (C₁-C₂₀)alkyl, phenyl or naphthyl;

R₁₂₄ through R₁₃₉ independently represent hydrogen, (C₁-C₅) alkyl, halogen, (C₁-C₅)alkyl with halogen substituent(s), phenyl, naphthyl, biphenyl, fluorenyl, tri(C₁-C₅)alkylsilyl, tri(C₆-C₂₀) arylsilyl, di(C₁-C₅) alkylamino, di(C₆-C₂₀) arylamino, thiophenyl or furanyl; and

the phenyl, naphthyl, biphenyl, fluorenyl, thiophenyl or furanyl of R₁₁₁ through R₁₁₆ and R₁₂₁ through R₁₃₉ may be further substituted by one or more substituent(s) selected from (C₁-C₅)alkyl, halogen, naphthyl, fluorenyl, tri(C₁-C₅)alkylsilyl, tri(C₆-C₂₀)arylsilyl, di(C₁-C₅)alkylamino and di(C₆-C₂₀)arylamino.

In Chemical Formula (IX), M is a bivalent metal selected from Be, Zn, Mg, Cu and Ni, or a trivalent metal selected from Al, Ga, In and B, and Q is selected from the following structures.

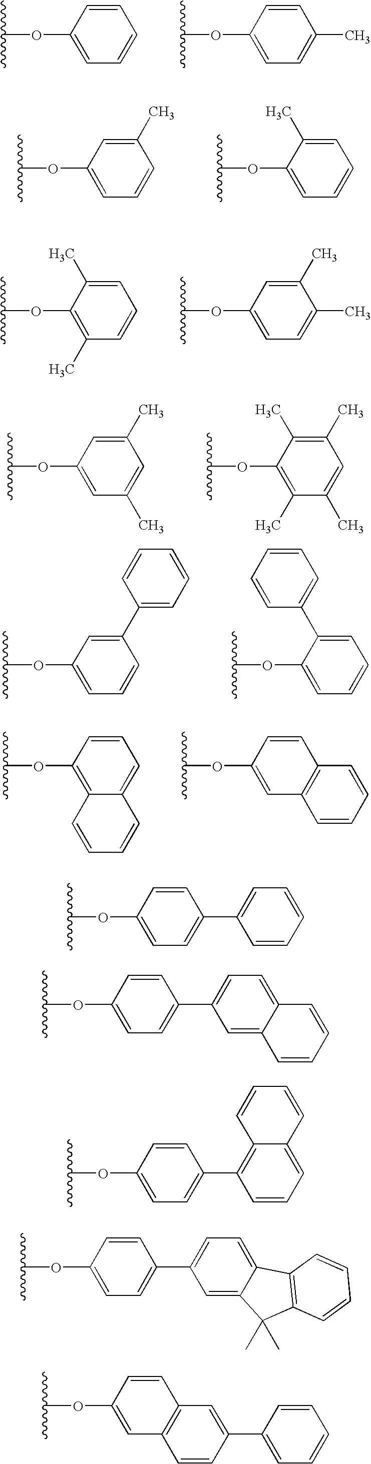

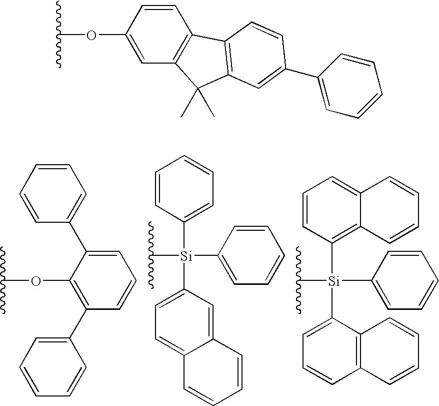

The compound of Chemical Formula (IX) is selected from the compounds represented by the following structures.

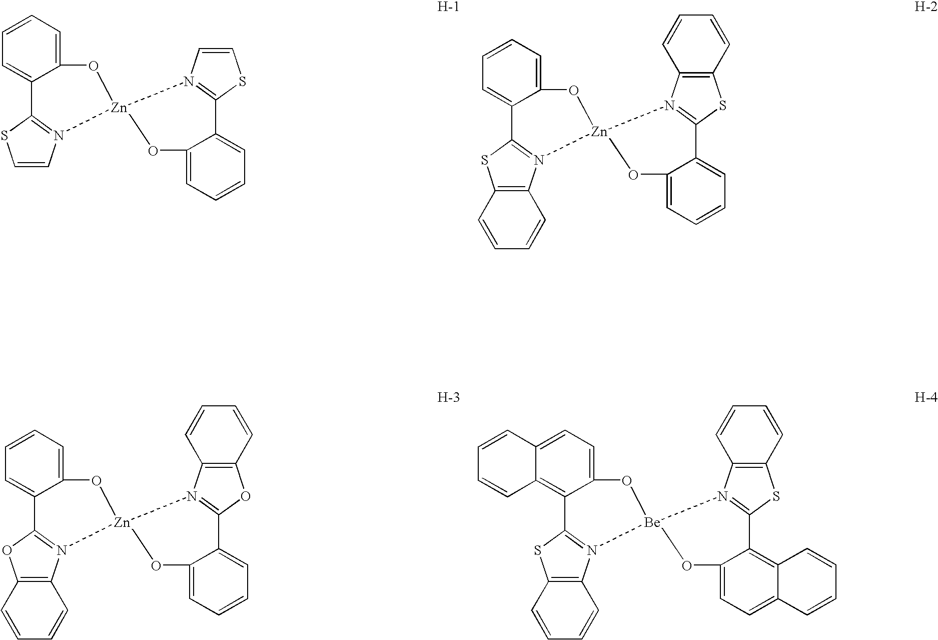

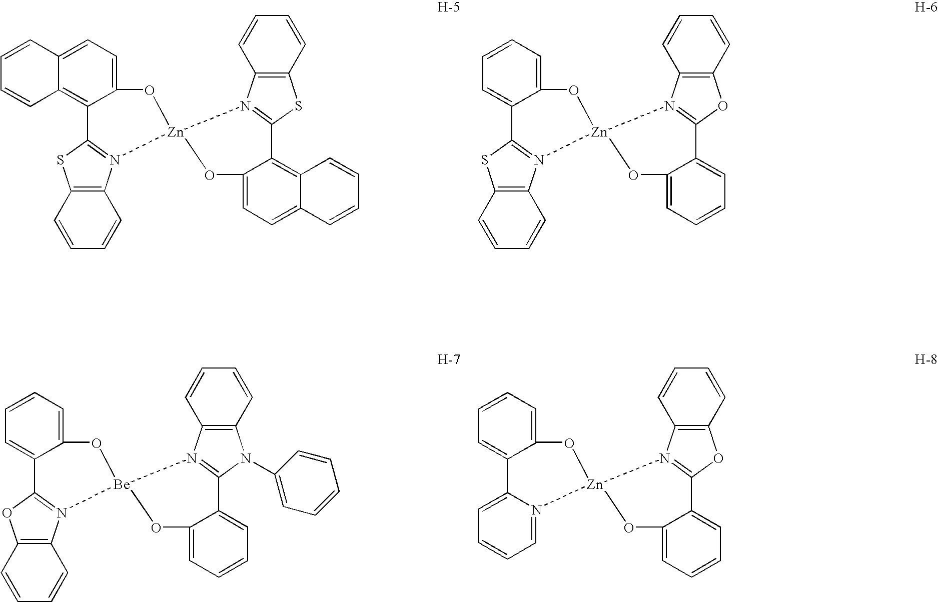

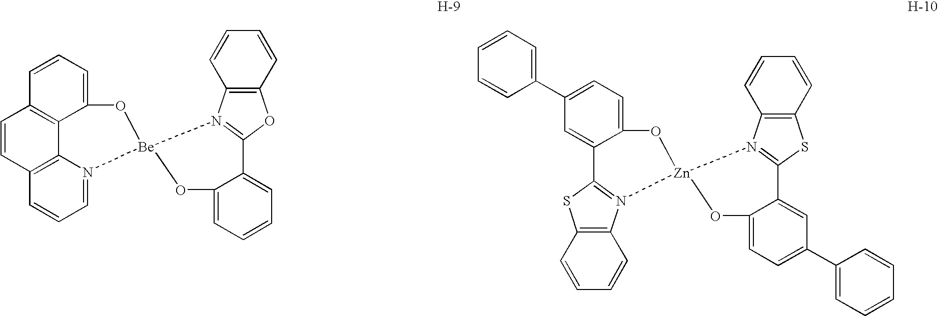

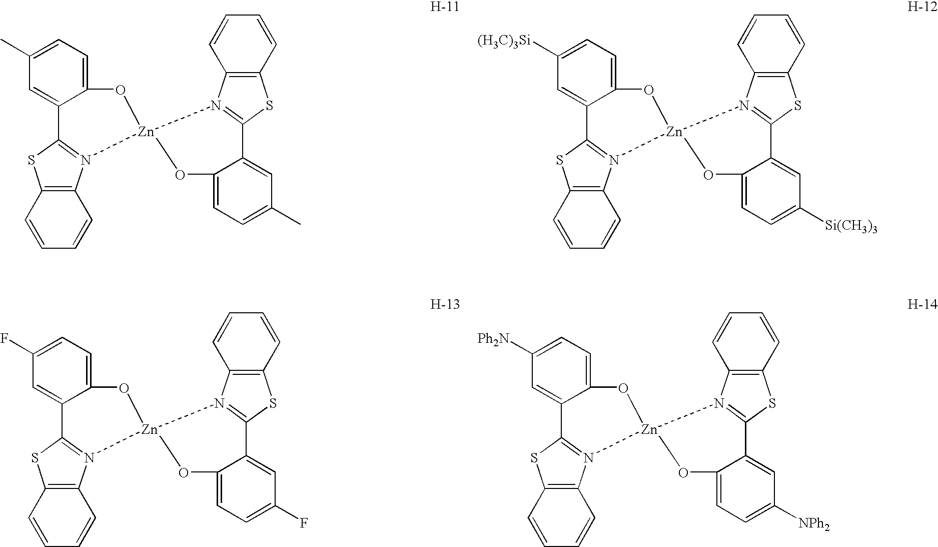

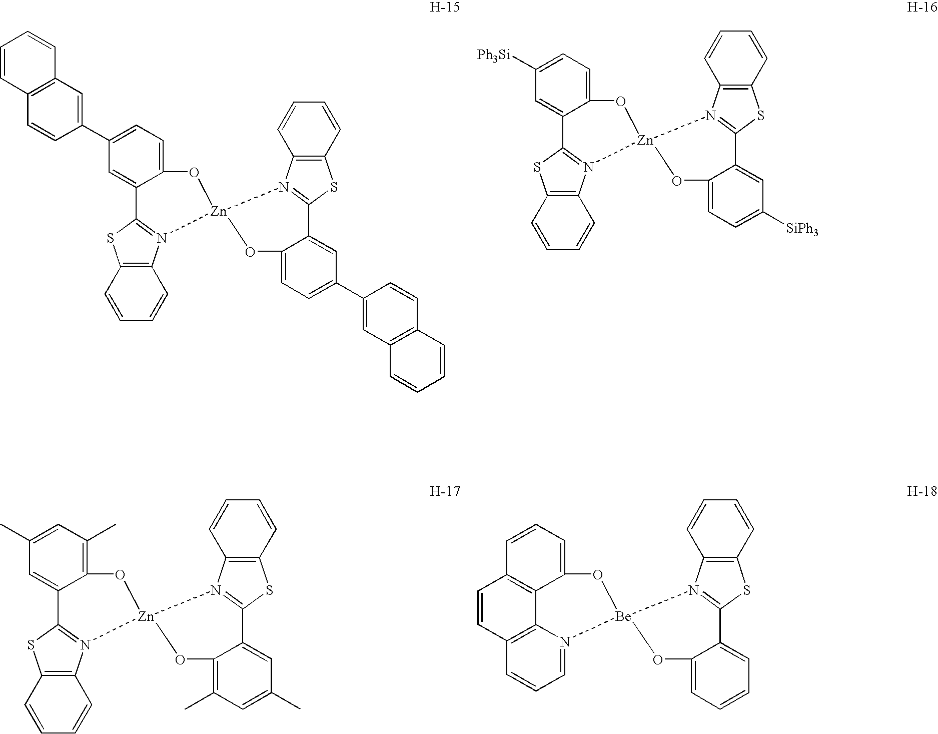

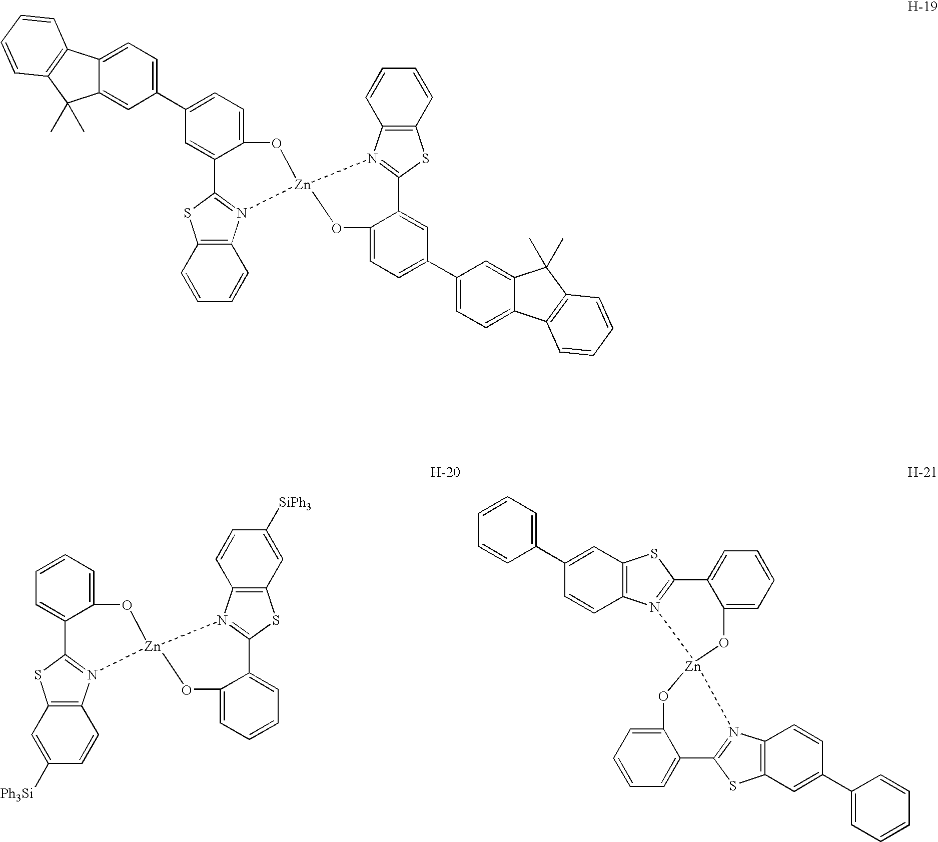

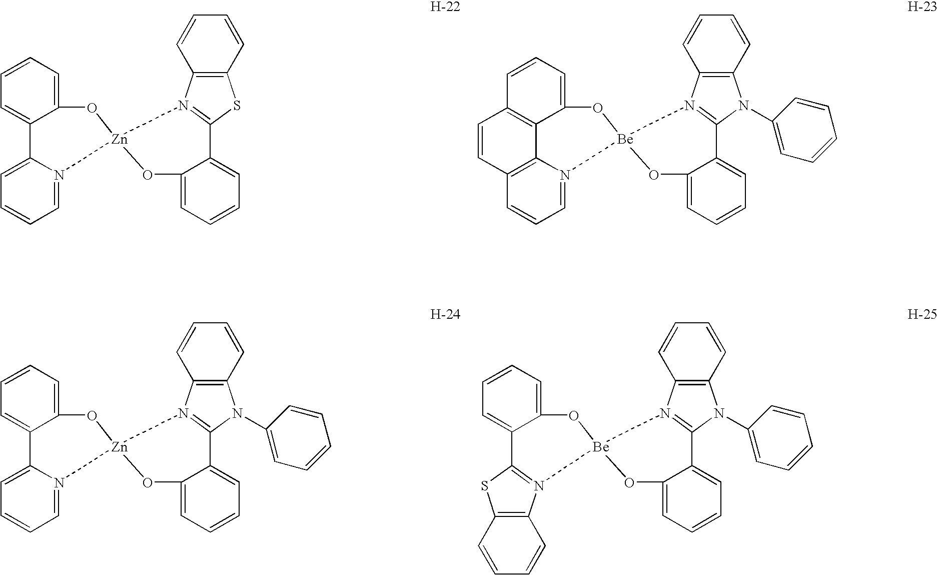

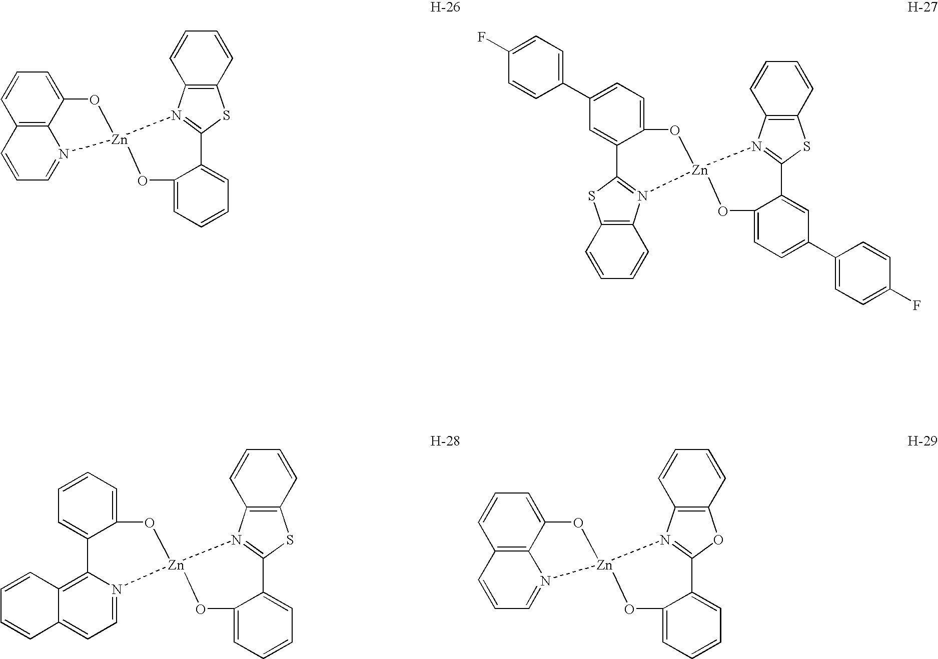

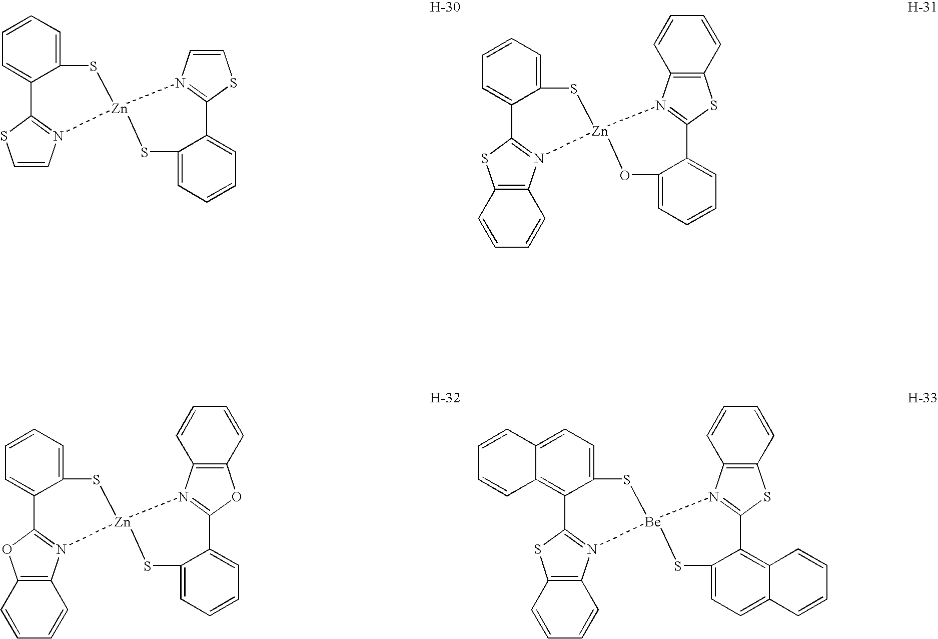

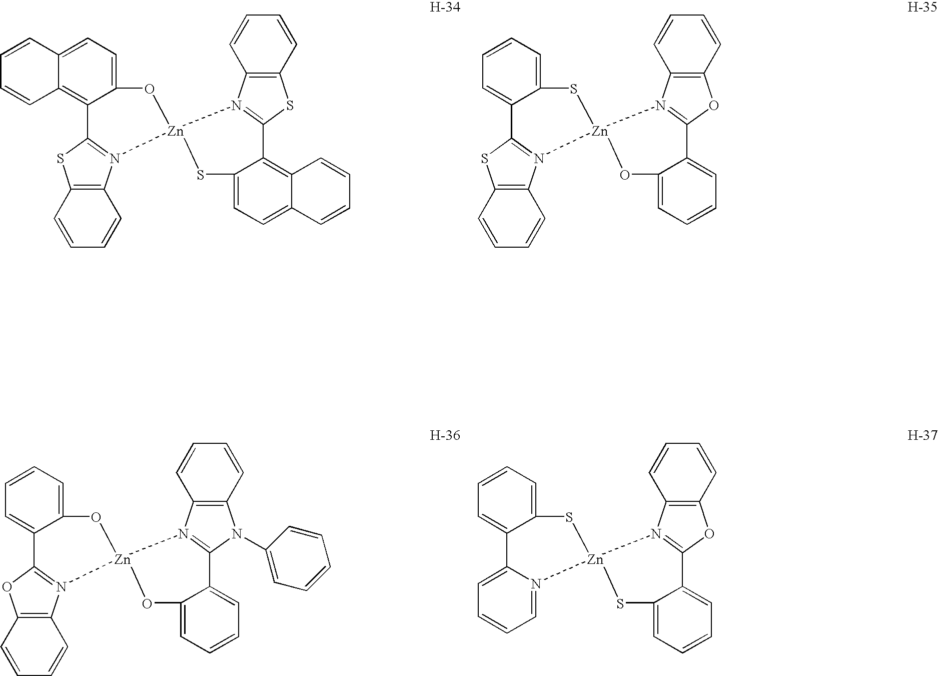

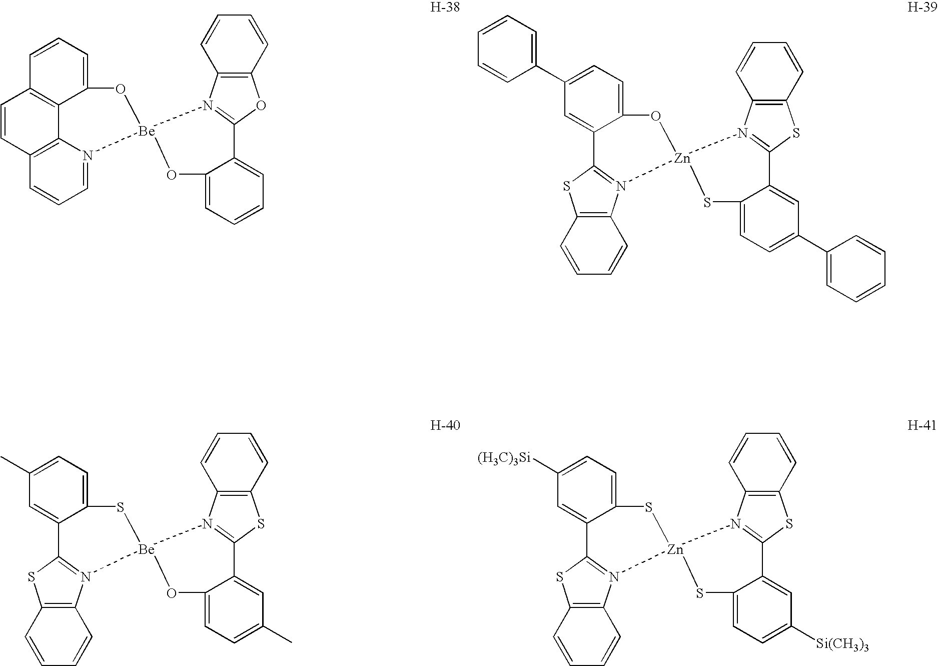

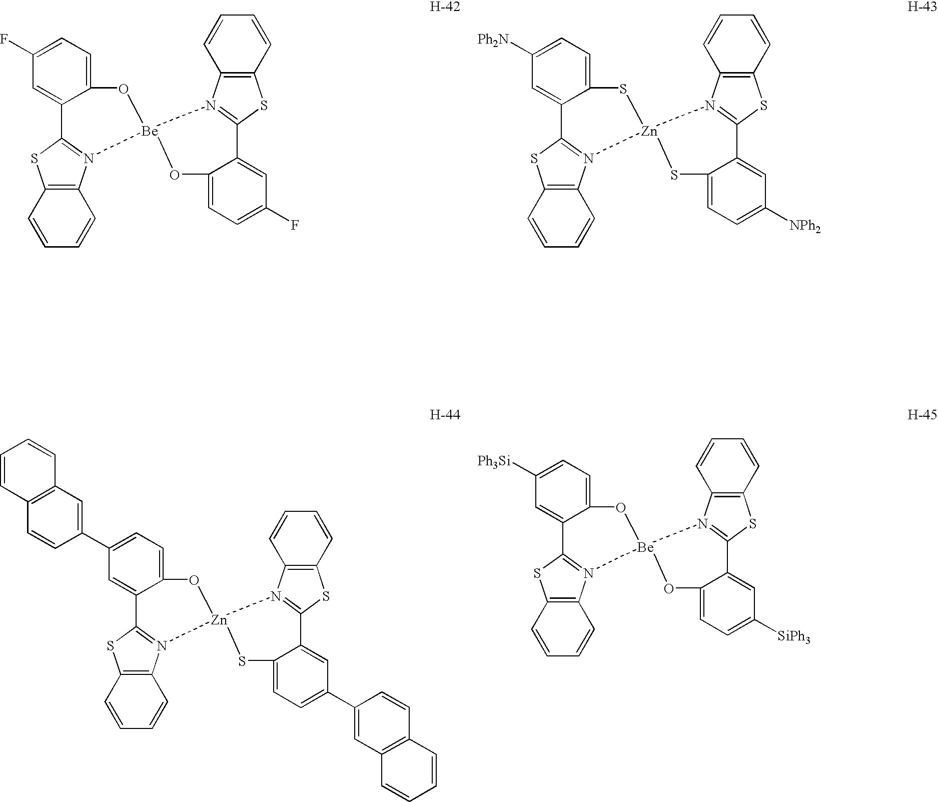

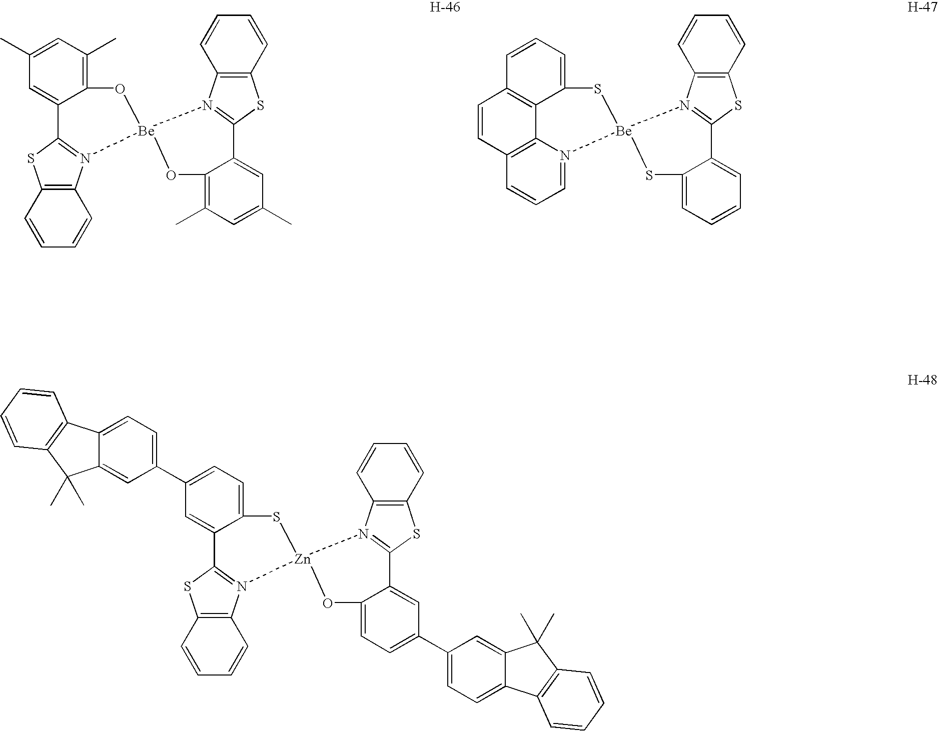

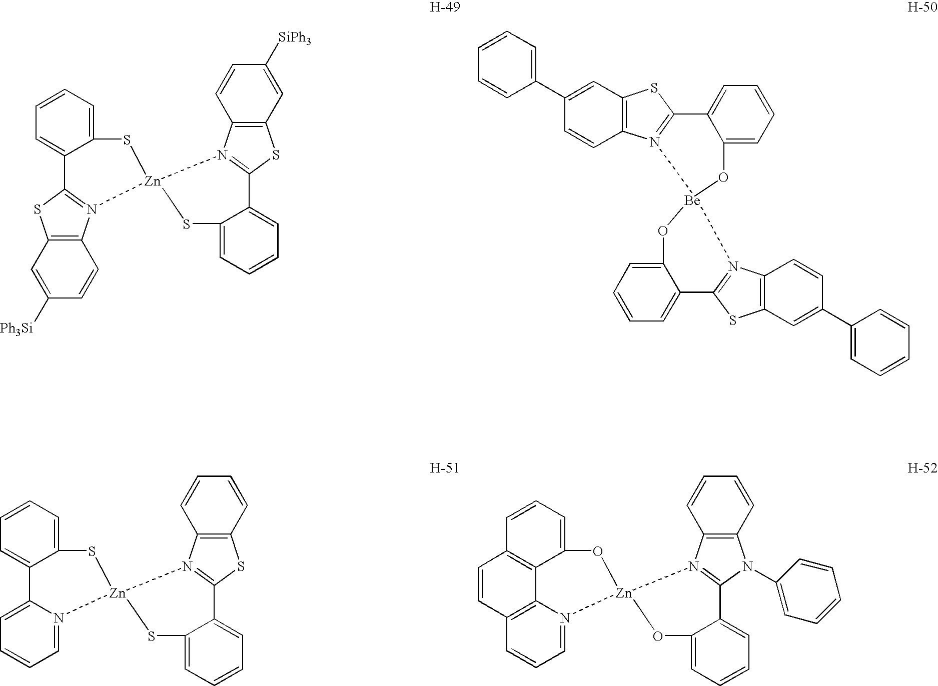

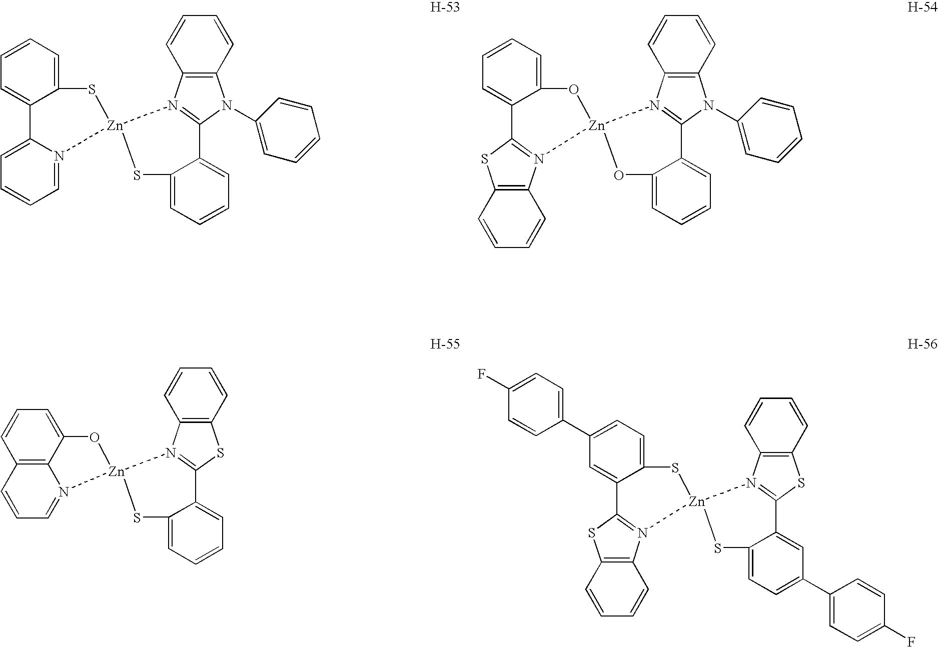

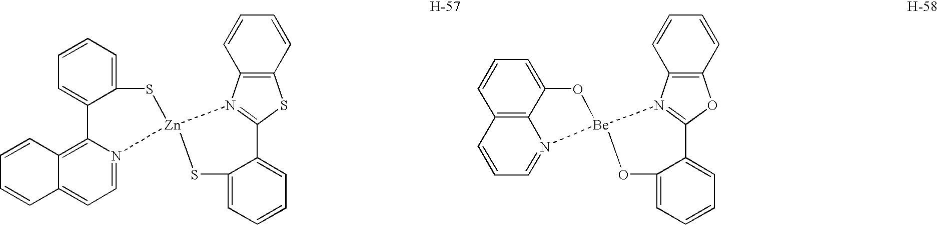

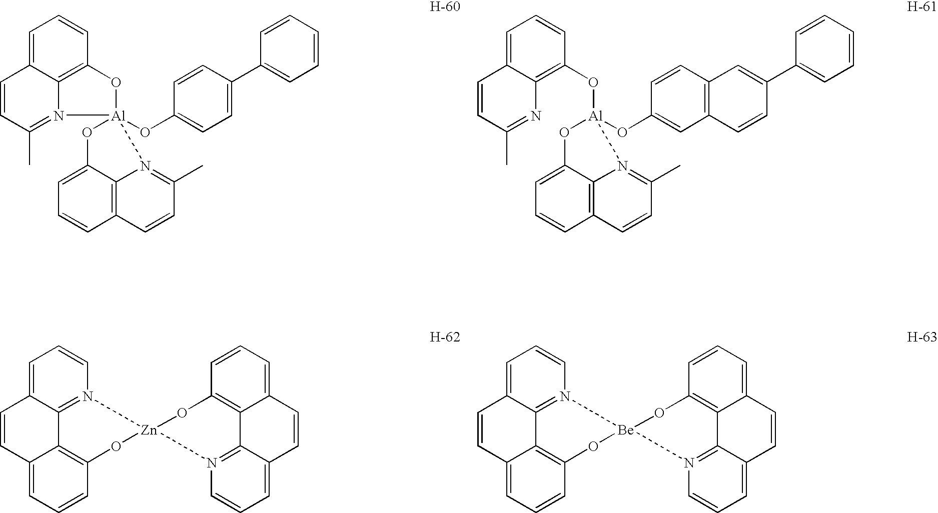

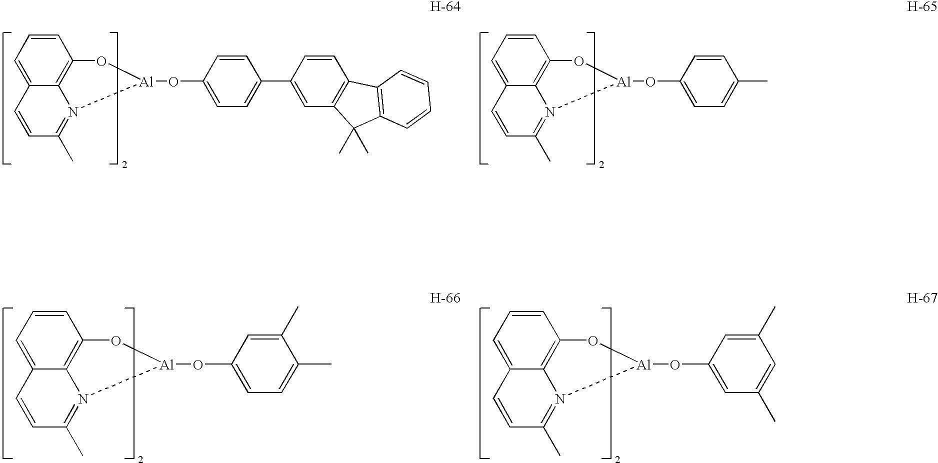

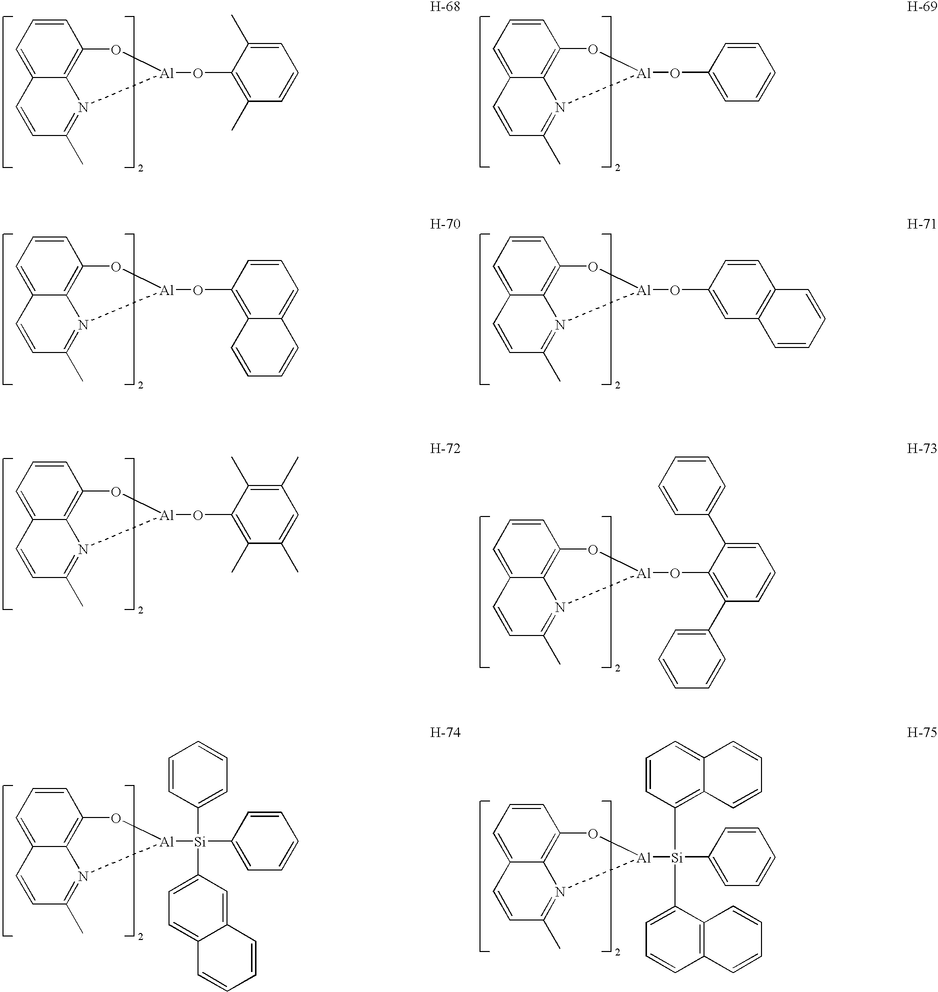

The red electroluminescent compounds according to the present invention, being a compound of more beneficial skeletal in terms of better properties and thermal stability than conventional red phosphorescent materials, exhibit excellent luminous efficiency and color purity, and thus an OLED with lowered operation voltage can be manufactured therefrom.

The present invention is further described with respect to the processes for preparing novel organic phosphorescent compounds according to the invention by referring to Examples, which are provided for illustration only but are not intended to limit the scope of the invention by any means.

### PREPARATION EXAMPLES

### Preparation Example 1

### Preparation of Compound (11)

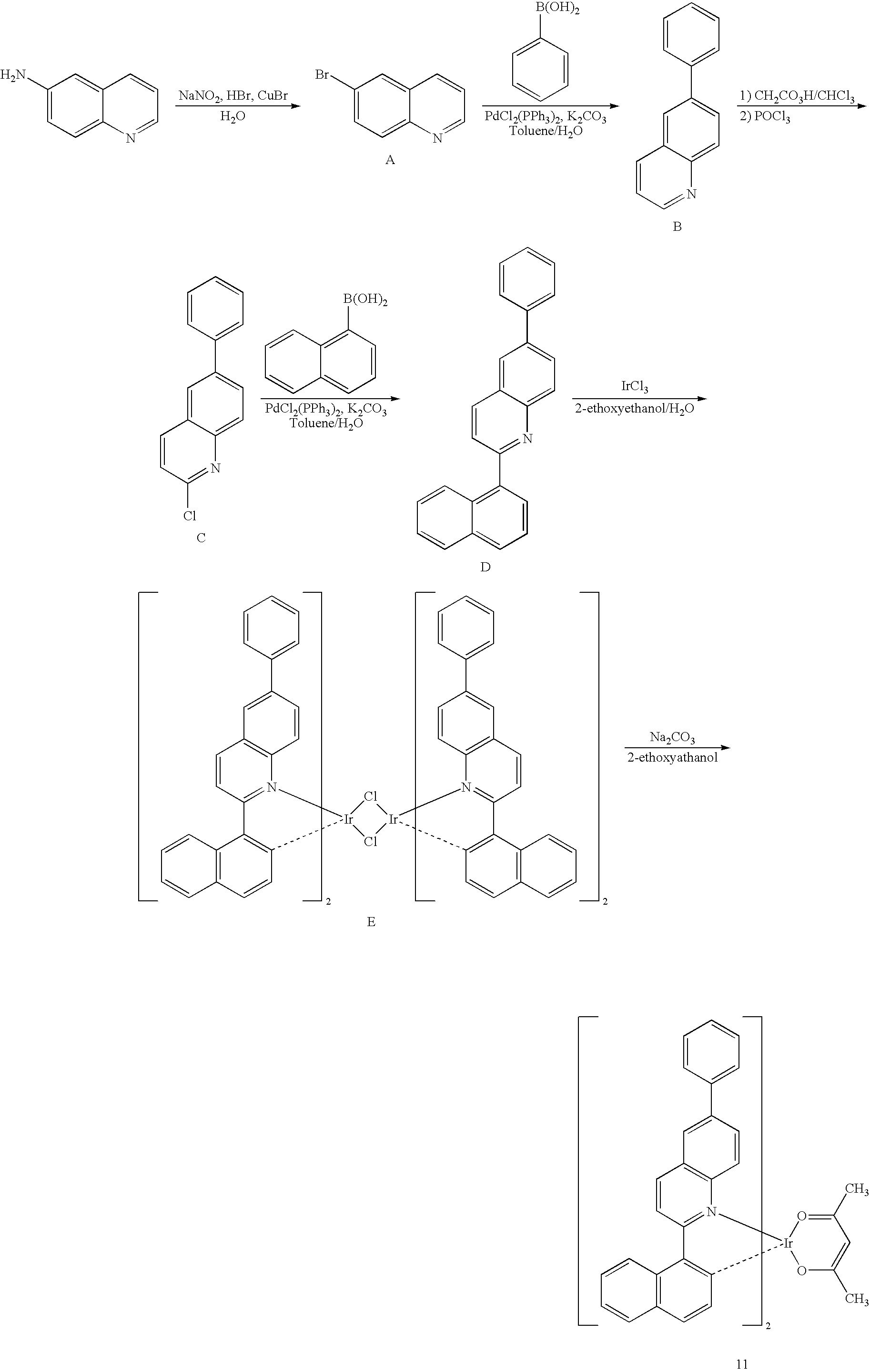

Preparation of Compound (A)

In aqueous hydrobromide solution (48% aq. HBr) (60 mL), dissolved was 6-aminoquinoline (20.0 g, 138.7 mmol), and the solution was chilled to −10° C. After adding aqueous sodium nitrate solution (10.9 g in 100 mL of H₂O) (158.1 mmol) thereto, the reaction mixture was stirred at 0° C. for 10 minutes. To the mixture, added was solution of copper bromide (23.1 g, 160.9 mmol) in 240 mL of water and 65 mL of aqueous HBr. The resultant mixture was heated with stirring at 60° C. for 30 minutes. When the reaction was completed, the mixture was cooled to room temperature, and ice water was added thereto. After adjusting the pH to about 10 by using aqueous NaOH (4M) solution, the mixture was extracted with ethyl acetate, and the extract was filtered under reduced pressure. Purification via silicagel column chromatography gave Compound (A) (18.2 g, 87.4 mmol).

Preparation of Compound (B)

In toluene (150 mL) and ethanol (45 mL), dissolved were Compound (A) (18.0 g, 86.5 mmol), phenylboronic acid (12.7 g, 103.8 mmol), tetrakispalladium(0) triphenylphosphine (Pd(PPh₃)₄) (3.6 g, 5.2 mmol). To the solution, aqueous 2M sodium carbonate solution (70 mL) was added, and the mixture was stirred under reflux at 120° C. for 4 hours. After cooling the mixture to 25° C., distilled water (200 mL) was added to quench the reaction. The mixture was extracted with ethyl acetate (300 mL), and the extract was dried under reduced pressure. Purification via silicagel column chromatography gave Compound (B) (14.6 g, 70.9 mmol).

Preparation of Compound (C)

Compound (B) (14.0 g, 68.2 mmol) was dissolved in chloroform (200 mL), and peroxyacetic acid (150 mL) was added thereto. The reaction mixture was stirred under reflux for 4 hours. When the reaction was completed, the reaction mixture was cooled to room temperature, and ice water was added thereto. After adjusting the pH to about 10 by using aqueous sodium hydroxide solution (10M), the solid produced was obtained under reduced pressure. The solid was cooled to 5° C., and POCl₃ 150 mL was added thereto, and the resultant mixture was stirred under reflux at 100° C. for 1 hour. After cooling the solution to room temperature, ice water was added thereto. By using aqueous sodium hydroxide solution (10M), the pH of the solution was adjusted to about 8, and the solution was then extracted with dichloromethane. The extract was filtered under reduced pressure. Purification via silicagel column chromatography gave Compound (C) (6.2 g, 25.9 mmol).

Preparation of Compound (D)

In toluene (100 mL) and ethanol (30 mL), dissolved were Compound (C) (6.0 g, 25.0 mmol), 1-naphthalene boronic acid (6.0 g, 30.0 mmol), tetrakispalladium (0) triphenylphosphine (Pd(PPh₃)₄) (1.1 g, 1.5 mmol). To the solution, aqueous 2M sodium carbonate solution (30 mL) was added, and the mixture was stirred under reflux at 120° C. for 4 hours. After cooling the mixture to 25° C., distilled water (200 mL) was added thereto to quench the reaction. The mixture was extracted with ethyl acetate (300 mL), and the extract was dried under reduced pressure. Purification via silicagel column chromatography gave Compound (D) (7.2 g, 20.0 mmol).

Preparation of Compound (E)

In 2-ethoxyethanol (80 mL) and distilled water (35 mL), dissolved were Compound (D) (7.0 g, 19.6 mmol) and iridium chloride (IrCl₃) (2.63 g, 8.82 mmol), and the solution was stirred under reflux for 24 hours. When the reaction was completed, the reaction mixture was cooled to room temperature. The solid thus produced was filtered and dried to obtain Compound (E) (9.1 g, 7.79 mmol).

Preparation of Compound (11)

In 2-ethoxyethanol (240 mL), dissolved were Compound (E) (9.1 g, 7.8 mmol), 2,4-pentanedione (0.9 g, 9.3 mmol), and Na₂CO₃ (3.0 g, 28.0 mmol), and the solution was heated for 4 hours. When the reaction was completed, the reaction mixture was cooled to room temperature, and the solid precipitate produced was filtered. Purification via silicagel column chromatography and recrystallization gave Compound (II) (0.8 g, 1.3 mmol, overall yield: 16%) as red crystal.

According to the same procedure as Preparation Example 1, organic phosphorescent compounds (Compound 1 through Compound 1023) in Table 1 were prepared, of which the ¹H NMR and MS/FAB data are listed in Table 2.

TABLE 1

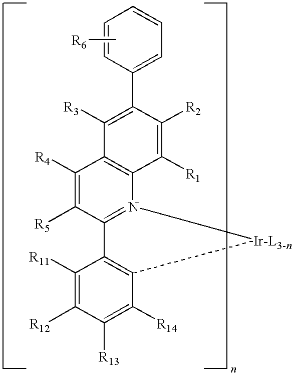

| com- pound No. | R₁ | R₂ | R₃ | R₄ | R₅ | R₆ | 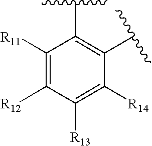 | L | n |
|---|---|---|---|---|---|---|---|---|---|
| 1 | H | H | H | H | H | H | 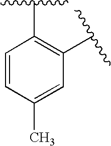 | 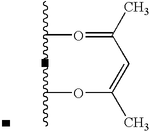 | 2 |
| 2 | H | H | H | H | H | H | 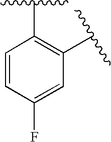 | 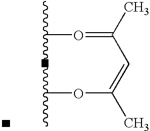 | 2 |
| 3 | H | H | H | H | H | H | 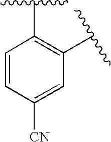 | 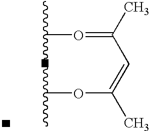 | 2 |
| 4 | H | H | H | H | H | H | 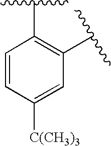 | 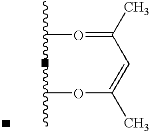 | 2 |
| 5 | H | H | H | H | H | H | 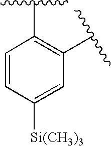 | 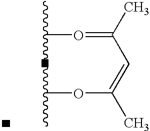 | 2 |
| 6 | H | H | H | H | H | H | 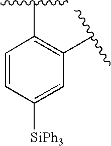 | 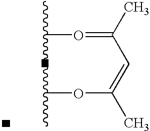 | 2 |
| 7 | H | H | H | H | H | H | 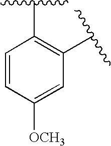 | 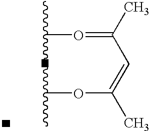 | 2 |
| 8 | H | H | H | H | H | H | 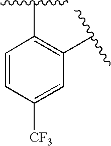 | 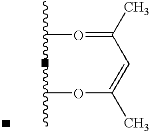 | 2 |
| 9 | H | H | H | H | H | H | 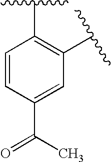 | 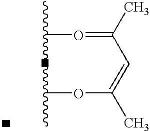 | 2 |
| 10 | H | H | H | H | H | H | 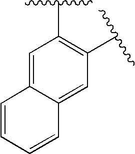 | 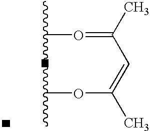 | 2 |
| 11 | H | H | H | H | H | H | 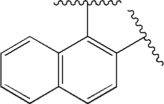 | 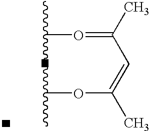 | 2 |
| 12 | H | H | H | H | H | H | 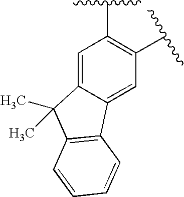 | 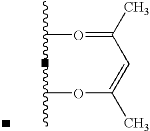 | 2 |
| 13 | H | H | H | H | H | H | 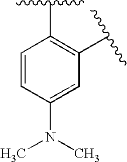 | 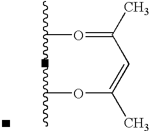 | 2 |
| 14 | H | H | H | H | H | H | 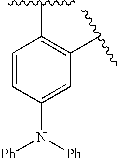 | 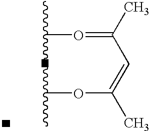 | 2 |
| 15 | H | H | H | H | H | H | 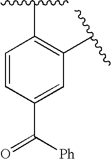 | 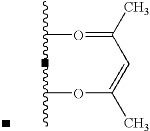 | 2 |
| 16 | H | H | H | H | H | H | 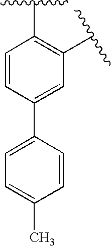 | 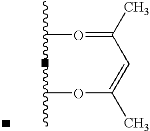 | 2 |
| 17 | H | H | H | H | H | H | 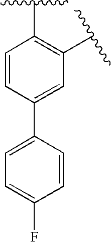 | 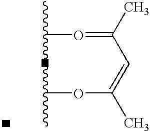 | 2 |
| 18 | H | H | H | H | H | H | 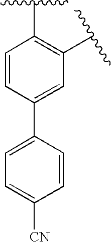 | 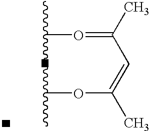 | 2 |
| 19 | H | H | H | H | H | H | 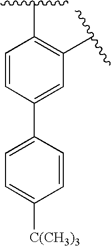 | 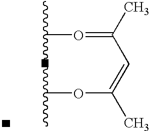 | 2 |
| 20 | H | H | H | H | H | H | 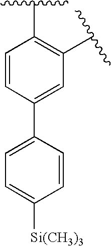 | 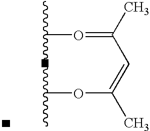 | 2 |
| 21 | H | H | H | H | H | H | 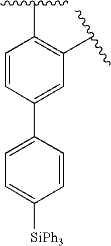 | 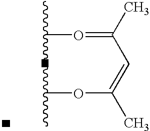 | 2 |
| 22 | H | H | H | H | H | H | 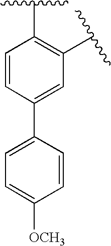 | 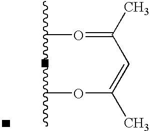 | 2 |
| 23 | H | H | H | H | H | H | 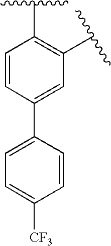 | 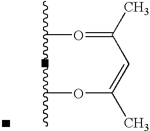 | 2 |
| 24 | H | H | H | H | H | H | 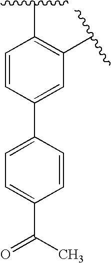 | 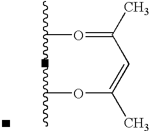 | 2 |
| 25 | H | H | H | H | H | H | 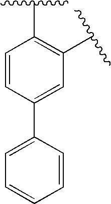 | 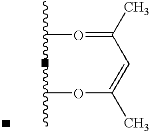 | 2 |
| 26 | H | H | H | H | H | H | 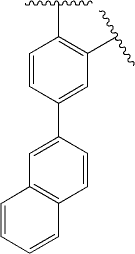 | 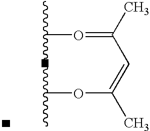 | 2 |
| 27 | H | H | H | H | H | H | 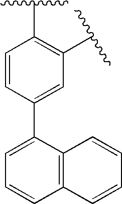 | 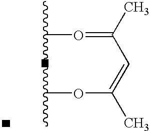 | 2 |
| 28 | H | H | H | H | H | H | 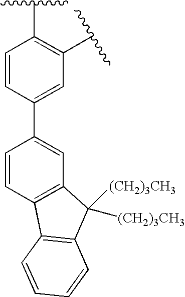 | 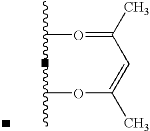 | 2 |
| 29 | H | H | H | H | H | H | 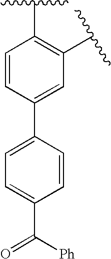 | 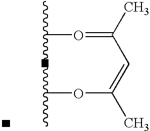 | 2 |
| 30 | H | H | H | H | H | H | 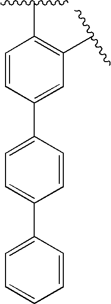 | 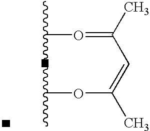 | 2 |
| 31 | H | H | H | H | H | H | 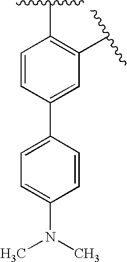 | 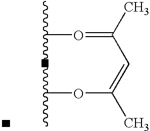 | 2 |
| 32 | H | H | H | H | H | H | 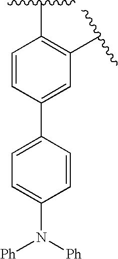 | 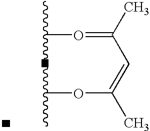 | 2 |
| 33 | H | H | H | H | H | H | 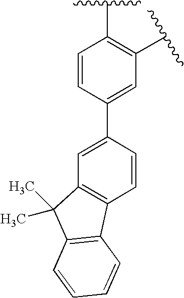 | 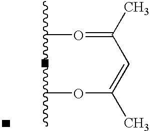 | 2 |
| 34 | H | H | H | H | H | H | 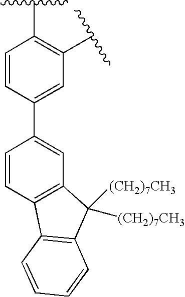 | 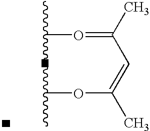 | 2 |
| 35 | H | H | H | H | H | H | 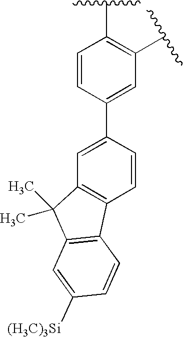 | 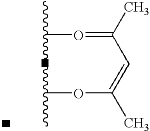 | 2 |
| 36 | H | H | H | H | H | H | 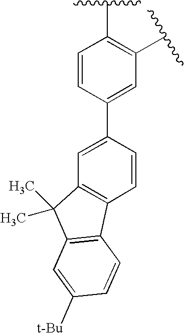 | 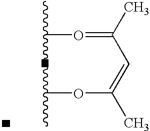 | 2 |
| 37 | H | H | H | H | H | H | 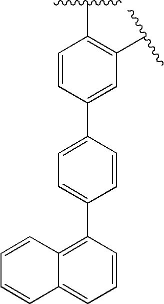 | 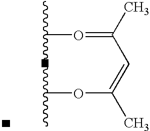 | 2 |
| 38 | H | H | H | H | H | H | 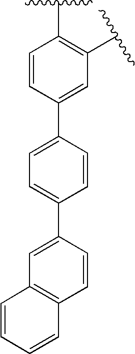 | 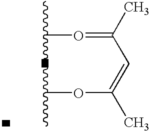 | 2 |
| 39 | H | H | H | H | H | H | 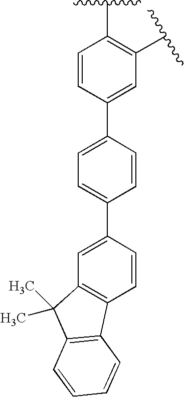 | 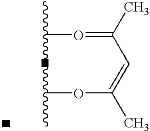 | 2 |
| 40 | H | H | H | H | H | H | 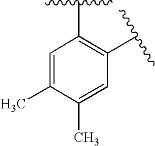 | 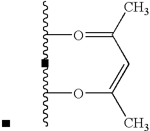 | 2 |
| 41 | H | H | H | H | H | H | 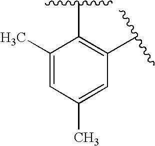 | 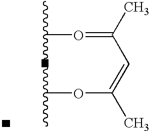 | 2 |
| 42 | H | H | H | H | H | H | 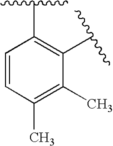 | 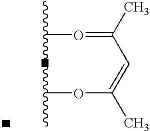 | 2 |
| 43 | H | H | H | H | H | H | 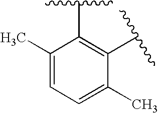 | 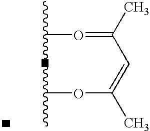 | 2 |
| 44 | H | H | H | H | H | H | 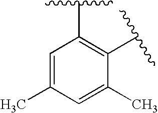 | 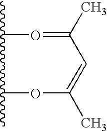 | 2 |
| 45 | H | H | H | H | H | H | 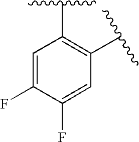 | 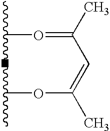 | 2 |
| 46 | H | H | H | H | H | H | 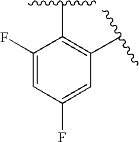 | 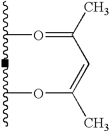 | 2 |
| 47 | H | H | H | H | H | H | 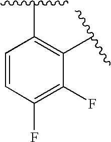 | 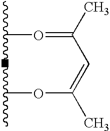 | 2 |
| 48 | H | H | H | H | H | H | 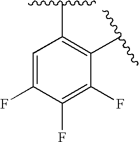 | 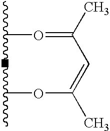 | 2 |
| 49 | H | H | H | H | H | H | 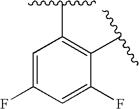 | 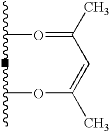 | 2 |
| 50 | H | H | H | H | H | H | 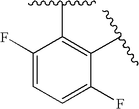 | 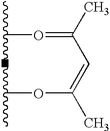 | 2 |
| 51 | H | H | H | H | H | H | 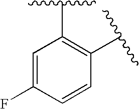 | 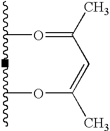 | 2 |
| 52 | H | H | H | H | H | H | 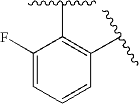 | 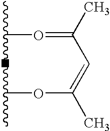 | 2 |
| 53 | H | H | H | H | H | H | 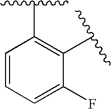 | 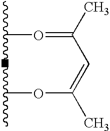 | 2 |
| 54 | H | H | H | H | H | H | 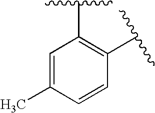 | 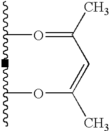 | 2 |
| 55 | H | H | H | H | H | H | 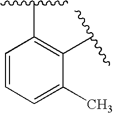 | 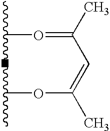 | 2 |
| 56 | H | H | H | H | H | H | 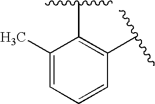 | 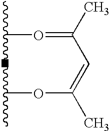 | 2 |
| 57 | H | H | H | H | H | H | 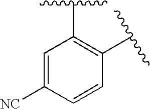 | 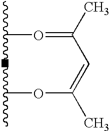 | 2 |
| 58 | H | H | H | H | H | H | 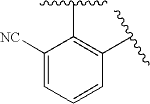 | 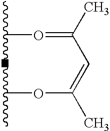 | 2 |
| 59 | H | H | H | H | H | H | 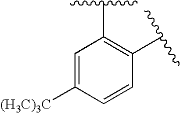 | 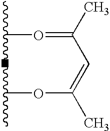 | 2 |
| 60 | H | H | H | H | H | H | 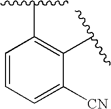 | 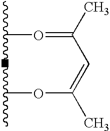 | 2 |
| 61 | H | H | H | H | H | H | 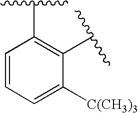 | 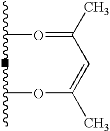 | 2 |
| 62 | H | H | H | H | H | H | 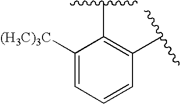 | 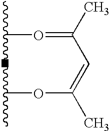 | 2 |
| 63 | H | H | H | H | H | H | 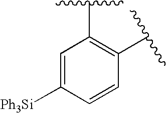 | 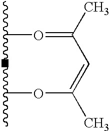 | 2 |
| 64 | H | H | H | H | H | H | 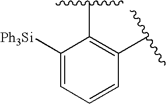 | 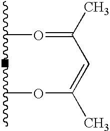 | 2 |
| 65 | H | H | H | H | H | H | 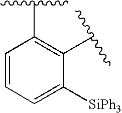 | 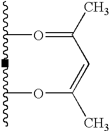 | 2 |
| 66 | H | H | H | H | H | H | 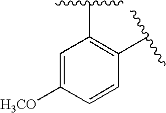 | 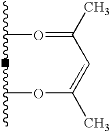 | 2 |
| 67 | H | H | H | H | H | H | 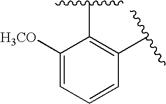 | 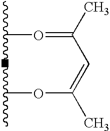 | 2 |
| 68 | H | H | H | H | H | H | 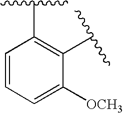 | 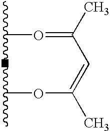 | 2 |
| 69 | H | H | H | H | H | H | 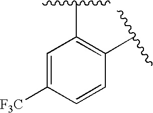 | 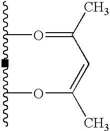 | 2 |
| 70 | H | H | H | H | H | H | 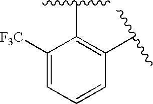 | 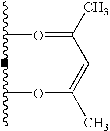 | 2 |
| 71 | H | H | H | H | H | H | 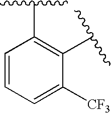 | 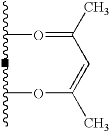 | 2 |
| 72 | H | H | H | H | H | H | 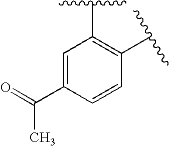 | 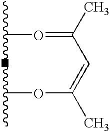 | 2 |
| 73 | H | H | H | H | H | H | 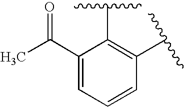 | 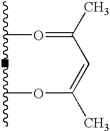 | 2 |
| 74 | H | H | H | H | H | H | 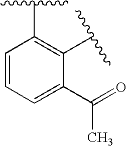 | 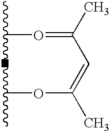 | 2 |
| 75 | H | H | H | H | H | H | 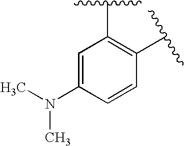 | 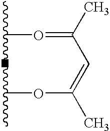 | 2 |
| 76 | H | H | H | H | H | H | 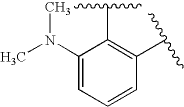 | 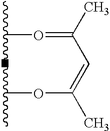 | 2 |
| 77 | H | H | H | H | H | H | 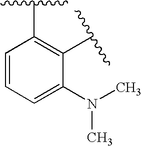 | 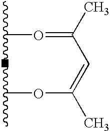 | 2 |
| 78 | H | H | H | H | H | H | 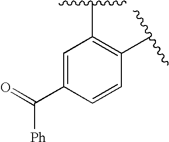 | 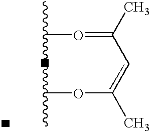 | 2 |
| 79 | H | H | H | H | H | H | 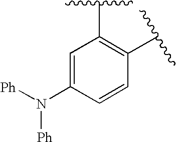 | 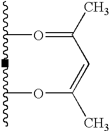 | 2 |
| 80 | H | H | H | H | H | H | 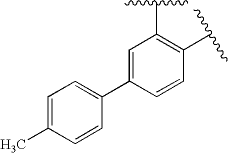 | 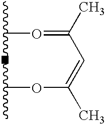 | 2 |
| 81 | H | H | H | H | H | H | 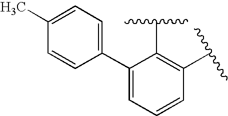 | 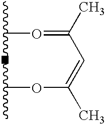 | 2 |
| 82 | H | H | H | H | H | H | 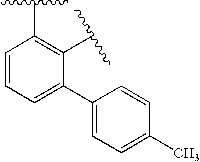 | 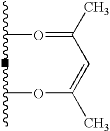 | 2 |
| 83 | H | H | H | H | H | H | 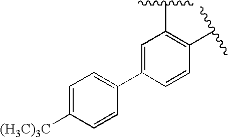 | 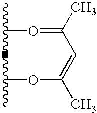 | 2 |
| 84 | H | H | H | H | H | H | 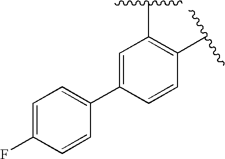 | 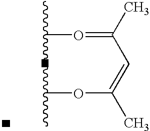 | 2 |
| 85 | H | H | H | H | H | H | 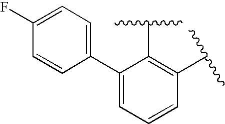 | 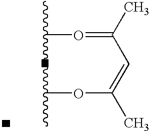 | 2 |
| 86 | H | H | H | H | H | H | 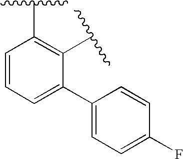 | 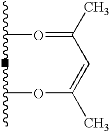 | 2 |
| 87 | H | H | H | H | H | H | 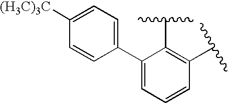 | 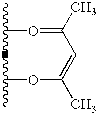 | 2 |
| 88 | H | H | H | H | H | H | 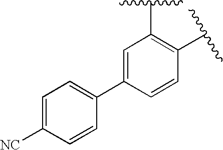 | 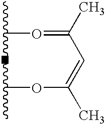 | 2 |
| 89 | H | H | H | H | H | H | 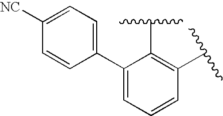 | 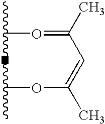 | 2 |
| 90 | H | H | H | H | H | H | 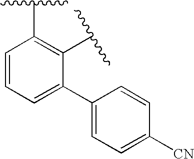 | 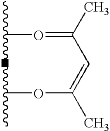 | 2 |
| 91 | H | H | H | H | H | H | 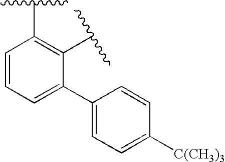 | 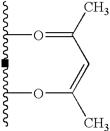 | 2 |
| 92 | H | H | H | H | H | H | 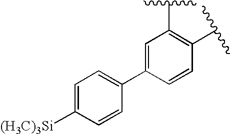 | 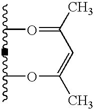 | 2 |
| 93 | H | H | H | H | H | H | 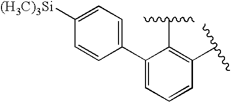 | 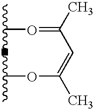 | 2 |
| 94 | H | H | H | H | H | H | 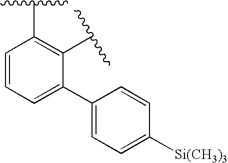 | 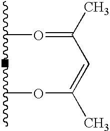 | 2 |
| 95 | H | H | H | H | H | H | 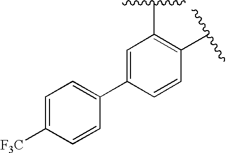 | 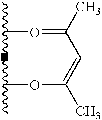 | 2 |
| 96 | H | H | H | H | H | H | 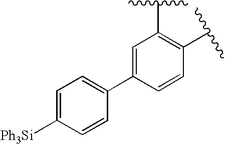 | 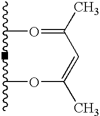 | 2 |
| 97 | H | H | H | H | H | H | 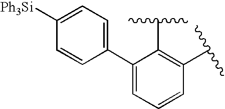 | 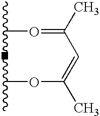 | 2 |
| 98 | H | H | H | H | H | H | 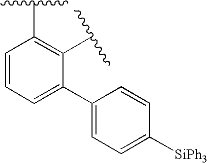 | 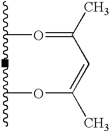 | 2 |
| 99 | H | H | H | H | H | H | 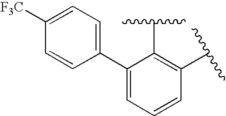 | 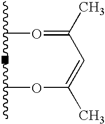 | 2 |
| 100 | H | H | H | H | H | H | 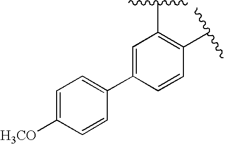 | 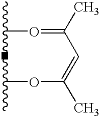 | 2 |
| 101 | H | H | H | H | H | H | 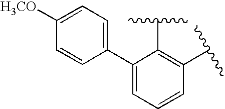 | 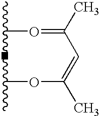 | 2 |
| 102 | H | H | H | H | H | H | 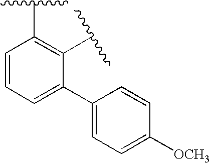 | 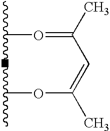 | 2 |
| 103 | H | H | H | H | H | H | 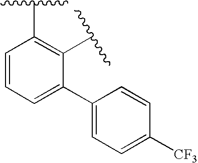 | 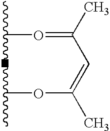 | 2 |
| 104 | H | H | H | H | H | H | 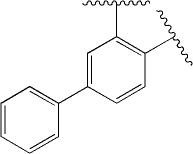 | 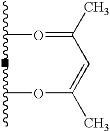 | 2 |
| 105 | H | H | H | H | H | H | 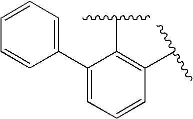 | 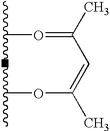 | 2 |
| 106 | H | H | H | H | H | H | 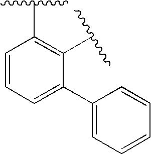 | 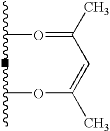 | 2 |
| 107 | H | H | H | H | H | H | 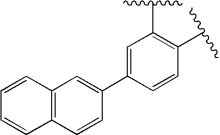 | 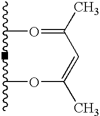 | 2 |
| 108 | H | H | H | H | H | H | 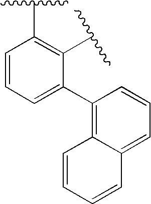 | 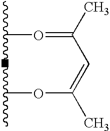 | 2 |
| 109 | H | H | H | H | H | H | 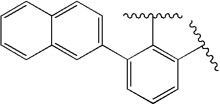 | 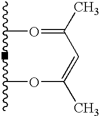 | 2 |
| 110 | H | H | H | H | H | H | 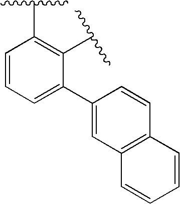 | 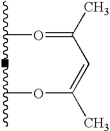 | 2 |
| 111 | H | H | H | H | H | H | 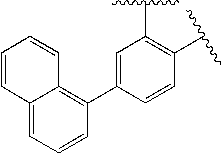 | 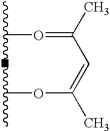 | 2 |
| 112 | H | H | H | H | H | H | 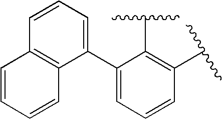 | 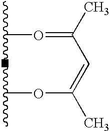 | 2 |
| 113 | H | H | H | H | H | H | 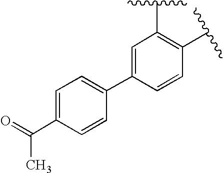 | 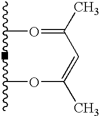 | 2 |
| 114 | H | H | H | H | H | H | 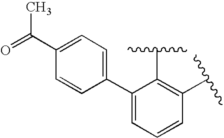 | 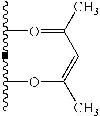 | 2 |
| 115 | H | H | H | H | H | H | 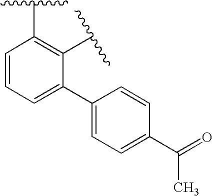 | 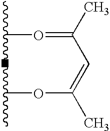 | 2 |
| 116 | H | H | H | H | H | H | 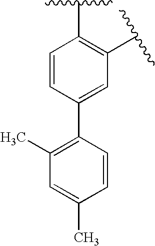 | 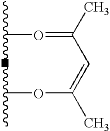 | 2 |
| 117 | H | H | H | H | H | H | 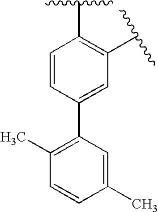 | 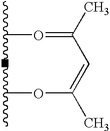 | 2 |
| 118 | H | H | H | H | H | H | 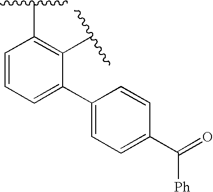 | 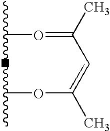 | 2 |
| 119 | H | H | H | H | H | H | 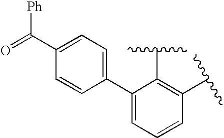 | 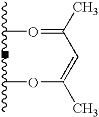 | 2 |
| 120 | H | H | H | H | H | H | 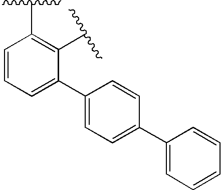 | 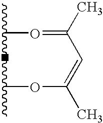 | 2 |
| 121 | H | H | H | H | H | H | 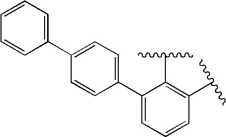 | 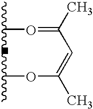 | 2 |
| 122 | H | H | H | H | H | H | 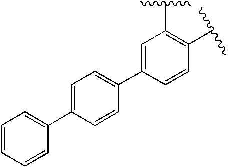 | 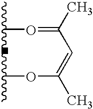 | 2 |
| 123 | H | H | H | H | H | H | 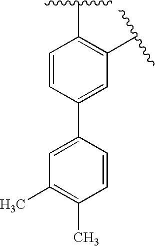 | 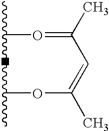 | 2 |
| 124 | H | H | H | H | H | H | 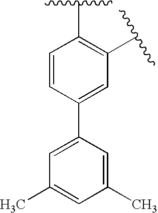 | 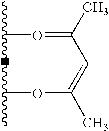 | 2 |
| 125 | H | H | H | H | H | H | 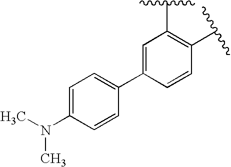 | 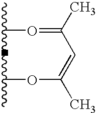 | 2 |
| 126 | H | H | H | H | H | H | 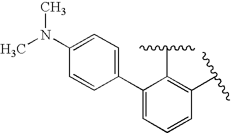 | 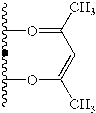 | 2 |
| 127 | H | H | H | H | H | H | 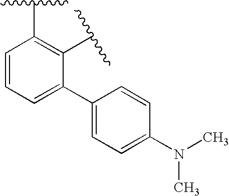 | 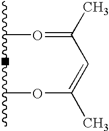 | 2 |
| 128 | H | H | H | H | H | H | 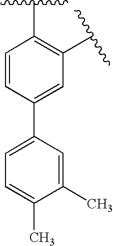 | 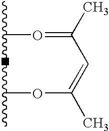 | 2 |
| 129 | H | H | H | H | H | H | 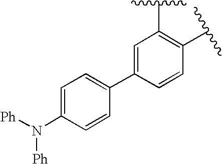 | 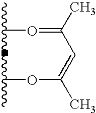 | 2 |
| 130 | H | H | H | H | H | H | 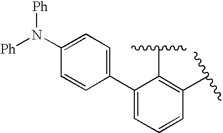 | 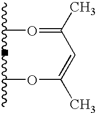 | 2 |
| 131 | H | H | H | H | H | H | 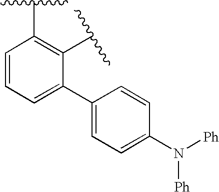 | 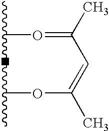 | 2 |
| 132 | H | H | H | H | H | H | 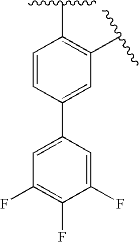 | 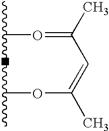 | 2 |
| 133 | H | H | H | H | H | H | 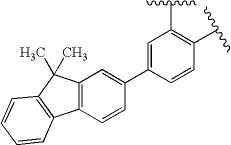 | 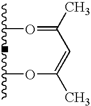 | 2 |
| 134 | H | H | H | H | H | H | 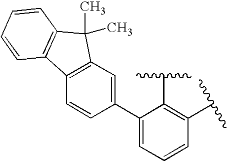 | 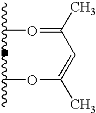 | 2 |
| 135 | H | H | H | H | H | H | 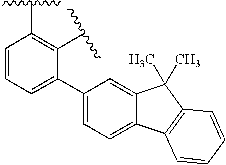 | 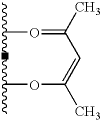 | 2 |
| 136 | H | H | H | H | H | H | 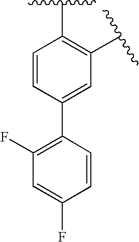 | 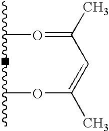 | 2 |
| 137 | H | H | H | H | H | H | 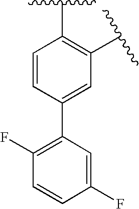 | 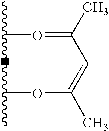 | 2 |
| 138 | H | H | H | H | H | H | 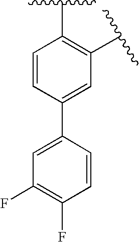 | 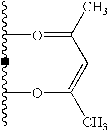 | 2 |
| 139 | H | H | H | H | H | H | 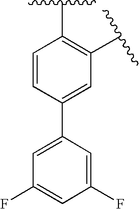 | 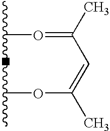 | 2 |
| 140 | H | H | H | H | H | H | 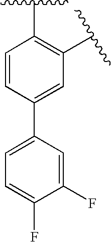 | 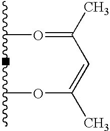 | 2 |
| 141 | H | H | H | H | H | H | 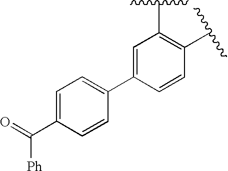 | 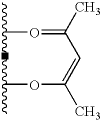 | 2 |
| 142 | H | H | H | H | H | H | 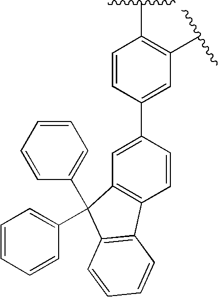 | 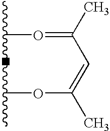 | 2 |
| 143 | H | H | H | H | H | H | 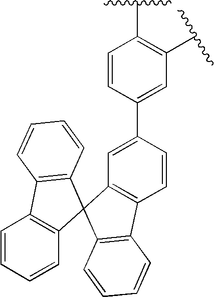 | 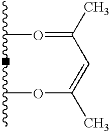 | 2 |
| 144 | H | H | H | H | H | H | 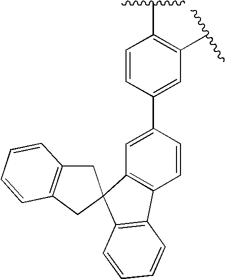 | 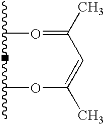 | 2 |
| 145 | H | H | H | H | H | H | 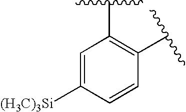 | 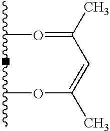 | 2 |
| 146 | H | H | H | H | H | H | 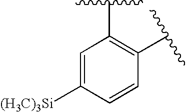 | 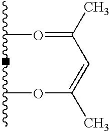 | 2 |
| 147 | H | H | H | H | H | H | 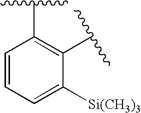 | 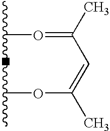 | 2 |
| 148 | H | H | H | H | H | H | 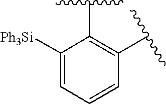 | 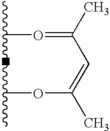 | 2 |
| 149 | H | H | H | H | H | H | 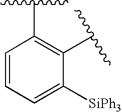 | 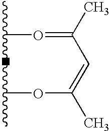 | 2 |
| 150 | H | H | H | H | H | H | 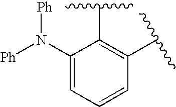 | 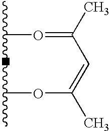 | 2 |
| 151 | H | H | H | H | H | H | 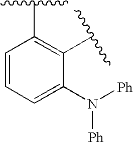 | 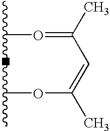 | 2 |
| 152 | H | H | H | H | H | H | 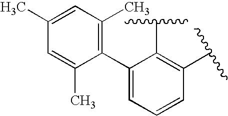 | 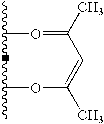 | 2 |
| 153 | H | H | H | H | H | H | 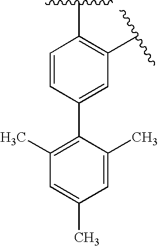 | 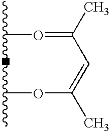 | 2 |
| 154 | H | H | H | H | H | H | 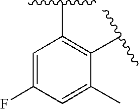 | 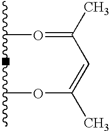 | 2 |
| 155 | H | H | H | H | H | H | 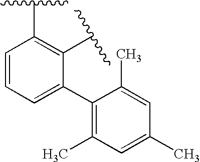 | 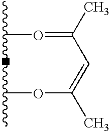 | 2 |
| 156 | H | H | H | H | H | H | 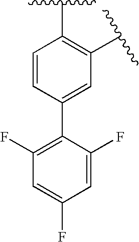 | 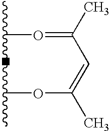 | 2 |
| 157 | H | H | H | H | H | H | 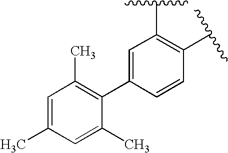 | 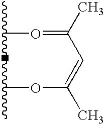 | 2 |
| 158 | H | H | H | H | H | H | 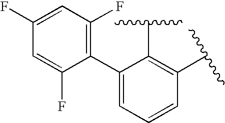 | 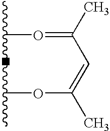 | 2 |
| 159 | H | H | H | H | H | H | 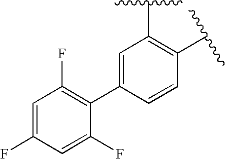 | 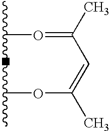 | 2 |
| 160 | H | H | H | H | H | H | 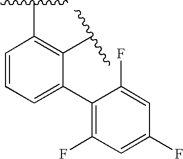 | 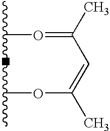 | 2 |
| 161 | H | H | H | H | H | H | 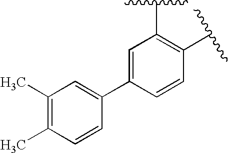 | 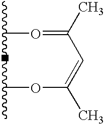 | 2 |
| 162 | H | H | H | H | H | H | 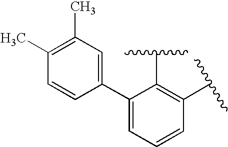 | 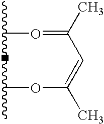 | 2 |
| 163 | H | H | H | H | H | H | 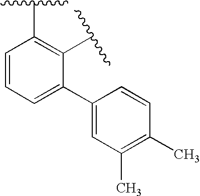 | 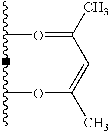 | 2 |
| 164 | H | H | H | H | H | H | 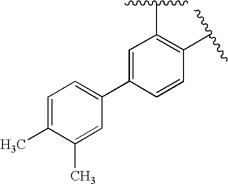 | 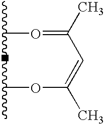 | 2 |
| 165 | H | H | H | H | H | H | 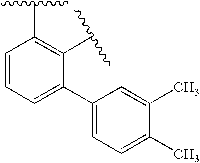 | 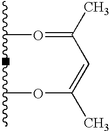 | 2 |
| 166 | H | H | H | H | H | H | 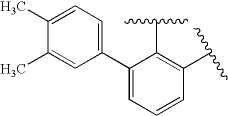 | 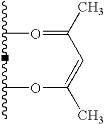 | 2 |
| 167 | H | H | H | H | H | H | 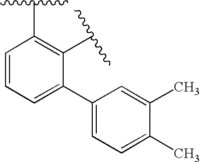 | 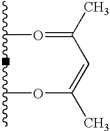 | 2 |
| 168 | H | H | H | H | H | H | 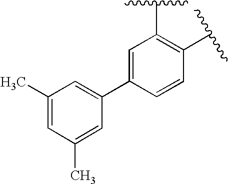 | 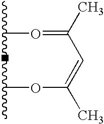 | 2 |
| 169 | H | H | H | H | H | H | 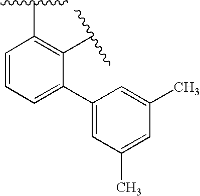 | 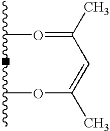 | 2 |
| 170 | H | H | H | H | H | H | 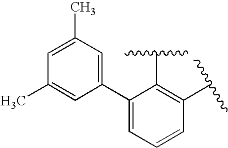 | 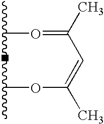 | 2 |
| 171 | H | H | H | H | H | H | 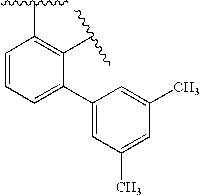 | 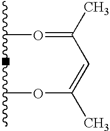 | 2 |
| 172 | H | H | H | H | H | H | 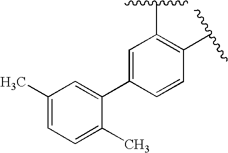 | 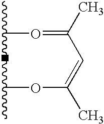 | 2 |
| 173 | H | H | H | H | H | H | 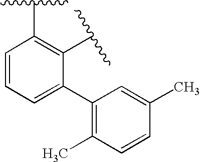 | 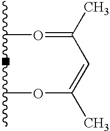 | 2 |
| 174 | H | H | H | H | H | H | 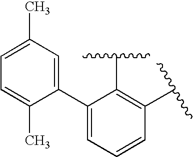 | 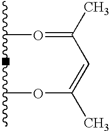 | 2 |
| 175 | H | H | H | H | H | H | 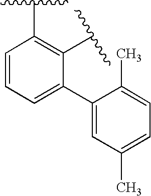 | 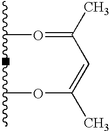 | 2 |
| 176 | H | H | H | H | H | H | 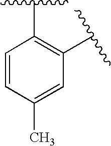 | 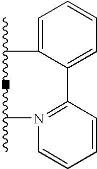 | 2 |
| 177 | H | H | H | H | H | H | 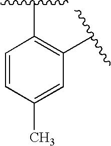 | 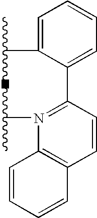 | 2 |
| 178 | H | H | H | H | H | H | 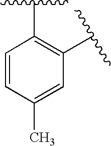 | 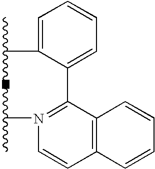 | 2 |
| 179 | H | H | H | H | H | H | 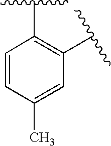 | 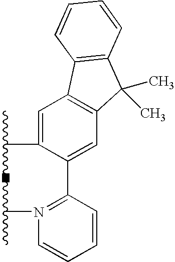 | 2 |
| 180 | H | H | H | H | H | H | 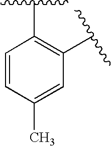 | 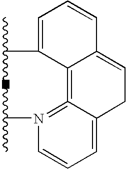 | 2 |
| 181 | H | H | H | H | H | H | 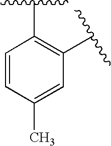 | 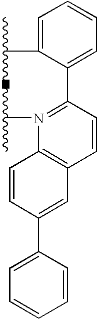 | 2 |
| 182 | H | H | H | H | H | H | 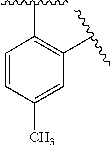 | 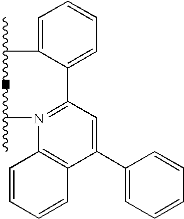 | 2 |
| 183 | H | H | H | H | H | H | 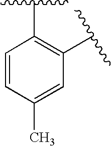 | 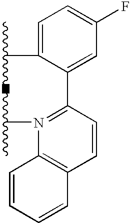 | 2 |
| 184 | H | H | H | H | H | H | 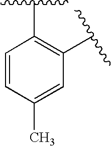 | 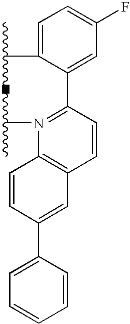 | 2 |
| 185 | H | H | H | H | H | H | 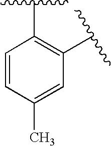 | 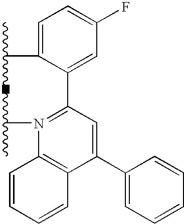 | 2 |
| 186 | H | H | H | H | H | H | 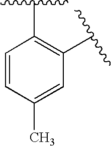 | 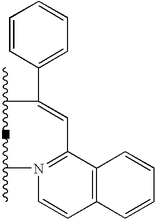 | 2 |
| 187 | H | H | H | H | H | H | 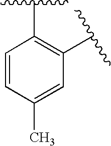 | 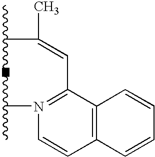 | 2 |
| 188 | H | H | H | H | H | H | 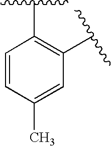 | 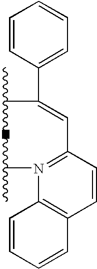 | 2 |
| 189 | H | H | H | H | H | H | 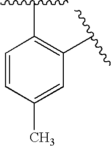 | 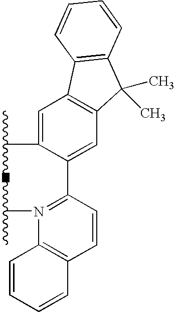 | 2 |
| 190 | H | H | H | H | H | H | 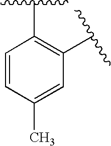 | 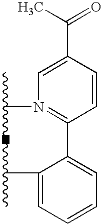 | 2 |
| 191 | H | H | H | H | H | H | 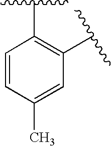 | 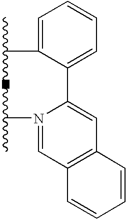 | 2 |
| 192 | H | H | H | H | H | H | 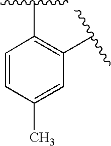 | 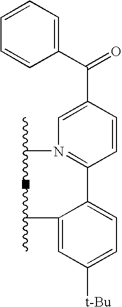 | 2 |
| 193 | H | H | H | H | H | H | 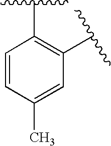 | 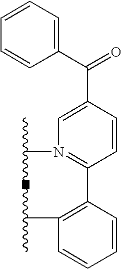 | 2 |
| 194 | H | H | H | H | H | H | 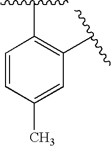 | 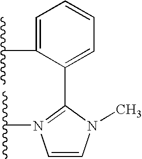 | 2 |
| 195 | H | H | H | H | H | H | 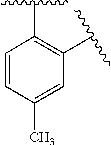 | 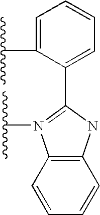 | 2 |
| 196 | H | H | H | H | H | H | 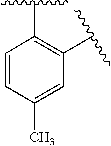 | 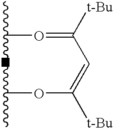 | 2 |
| 197 | H | H | H | H | H | H | 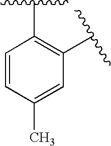 | 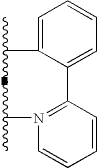 | 1 |
| 198 | H | H | H | H | H | H | 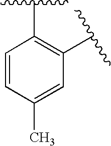 | — | 3 |
| 199 | H | H | H | H | H | F | 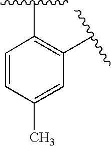 | 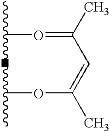 | 2 |
| 200 | H | H | H | H | H | F | 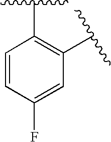 | 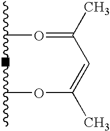 | 2 |
| 201 | H | H | H | H | H | F | 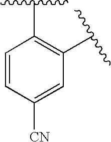 | 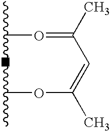 | 2 |
| 202 | H | H | H | H | H | F | 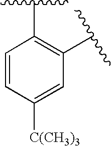 | 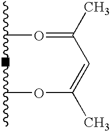 | 2 |
| 203 | H | H | H | H | H | F | 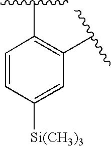 | 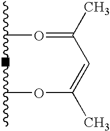 | 2 |
| 204 | H | H | H | H | H | F | 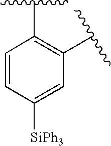 | 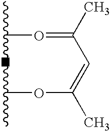 | 2 |
| 205 | H | H | H | H | H | F | 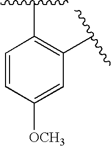 | 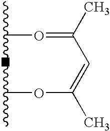 | 2 |
| 206 | H | H | H | H | H | F | 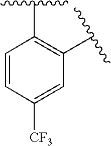 | 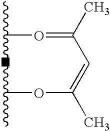 | 2 |
| 207 | H | H | H | H | H | F | 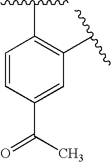 | 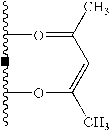 | 2 |
| 208 | H | H | H | H | H | F | 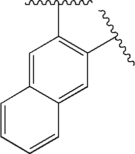 | 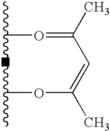 | 2 |
| 209 | H | H | H | H | H | F | 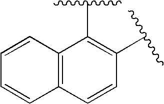 | 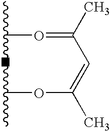 | 2 |
| 210 | H | H | H | H | H | F | 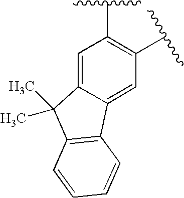 | 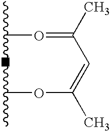 | 2 |
| 211 | H | H | H | H | H | F | 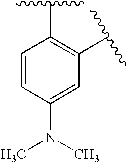 | 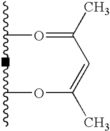 | 2 |
| 212 | H | H | H | H | H | F | 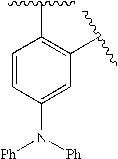 | 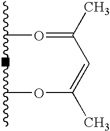 | 2 |
| 213 | H | H | H | H | H | F | 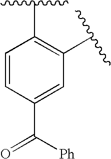 | 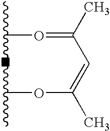 | 2 |
| 214 | H | H | H | H | H | F | 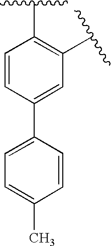 | 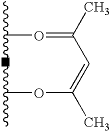 | 2 |
| 215 | H | H | H | H | H | F | 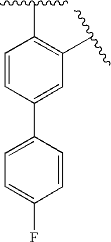 | 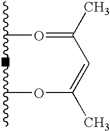 | 2 |
| 216 | H | H | H | H | H | F | 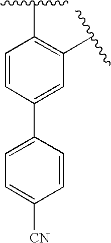 | 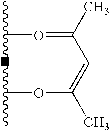 | 2 |
| 217 | H | H | H | H | H | F | 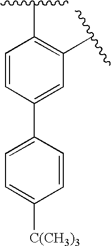 | 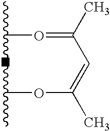 | 2 |
| 218 | H | H | H | H | H | F | 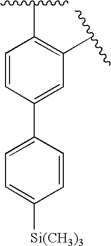 | 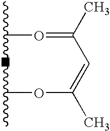 | 2 |
| 219 | H | H | H | H | H | F | 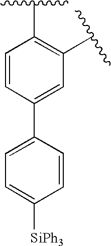 | 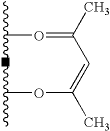 | 2 |
| 220 | H | H | H | H | H | F | 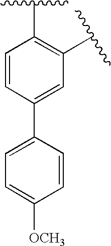 | 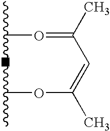 | 2 |
| 221 | H | H | H | H | H | F | 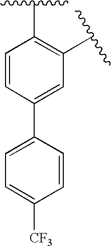 | 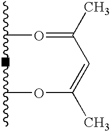 | 2 |
| 222 | H | H | H | H | H | F | 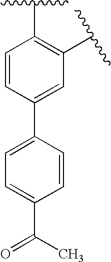 | 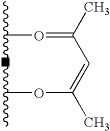 | 2 |
| 223 | H | H | H | H | H | F | 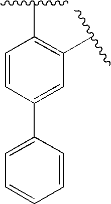 | 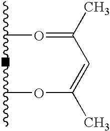 | 2 |
| 224 | H | H | H | H | H | F | 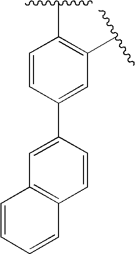 | 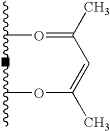 | 2 |
| 225 | H | H | H | H | H | F | 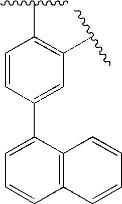 | 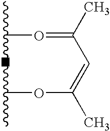 | 2 |
| 226 | H | H | H | H | H | F | 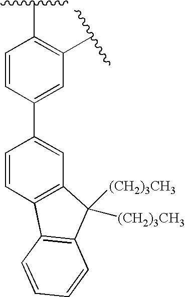 | 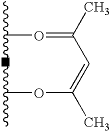 | 2 |
| 227 | H | H | H | H | H | F | 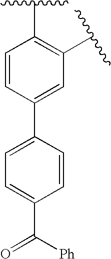 | 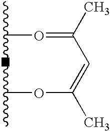 | 2 |
| 228 | H | H | H | H | H | F | 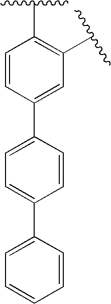 | 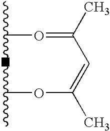 | 2 |
| 229 | H | H | H | H | H | F | 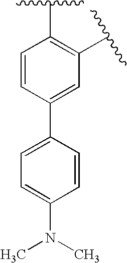 | 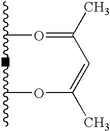 | 2 |
| 230 | H | H | H | H | H | F | 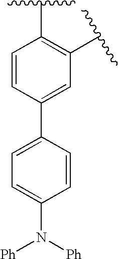 | 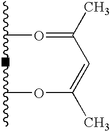 | 2 |
| 231 | H | H | H | H | H | F | 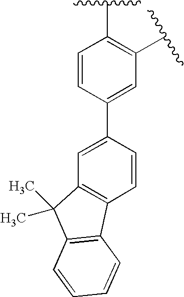 | 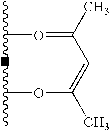 | 2 |
| 232 | H | H | H | H | H | F | 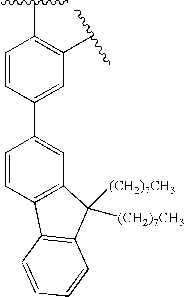 | 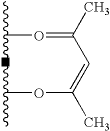 | 2 |
| 233 | H | H | H | H | H | F | 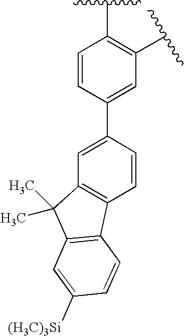 | 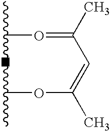 | 2 |
| 234 | H | H | H | H | H | F | 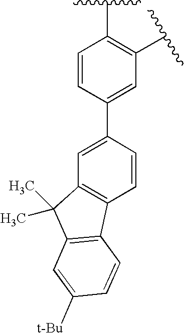 | 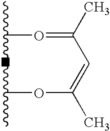 | 2 |
| 235 | H | H | H | H | H | F | 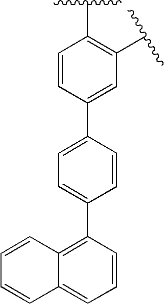 | 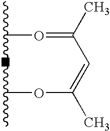 | 2 |
| 236 | H | H | H | H | H | F | 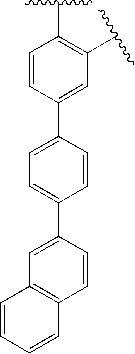 | 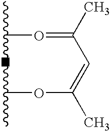 | 2 |
| 237 | H | H | H | H | H | F | 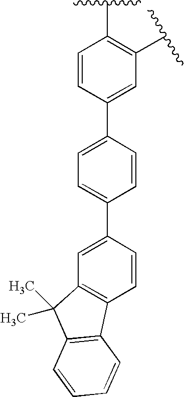 | 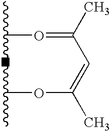 | 2 |
| 238 | H | H | H | H | H | F | 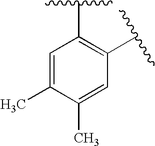 | 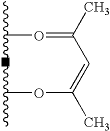 | 2 |
| 239 | H | H | H | H | H | F | 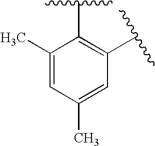 | 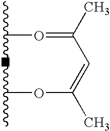 | 2 |
| 240 | H | H | H | H | H | F | 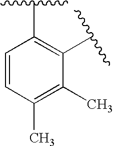 | 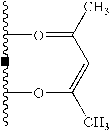 | 2 |
| 241 | H | H | H | H | H | F | 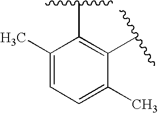 | 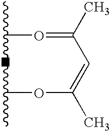 | 2 |
| 242 | H | H | H | H | H | F | 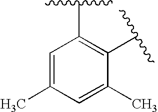 | 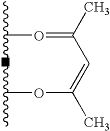 | 2 |
| 243 | H | H | H | H | H | F | 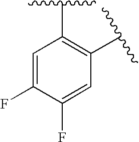 | 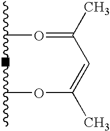 | 2 |
| 244 | H | H | H | H | H | F | 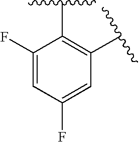 | 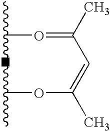 | 2 |
| 245 | H | H | H | H | H | F | 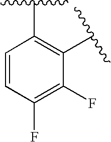 | 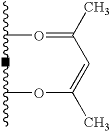 | 2 |
| 246 | H | H | H | H | H | F | 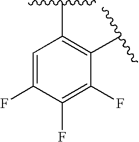 | 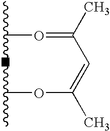 | 2 |
| 247 | H | H | H | H | H | F | 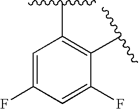 | 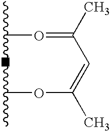 | 2 |
| 248 | H | H | H | H | H | F | 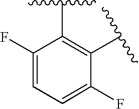 | 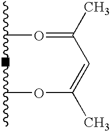 | 2 |
| 249 | H | H | H | H | H | F | 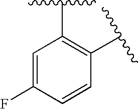 | 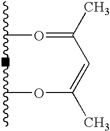 | 2 |
| 250 | H | H | H | H | H | F | 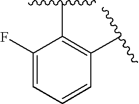 | 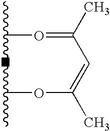 | 2 |
| 251 | H | H | H | H | H | F | 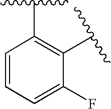 | 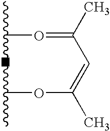 | 2 |
| 252 | H | H | H | H | H | F | 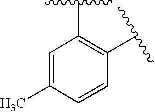 | 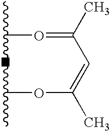 | 2 |
| 253 | H | H | H | H | H | F | 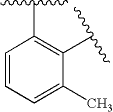 | 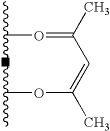 | 2 |
| 254 | H | H | H | H | H | F | 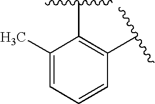 | 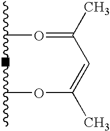 | 2 |
| 255 | H | H | H | H | H | F | 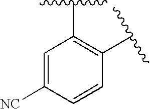 | 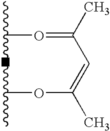 | 2 |
| 256 | H | H | H | H | H | F | 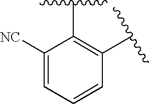 | 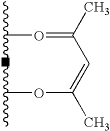 | 2 |
| 257 | H | H | H | H | H | F | 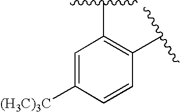 | 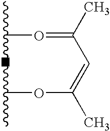 | 2 |
| 258 | H | H | H | H | H | F | 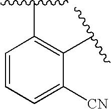 | 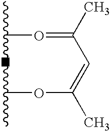 | 2 |
| 259 | H | H | H | H | H | F | 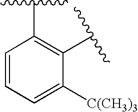 | 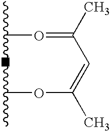 | 2 |
| 260 | H | H | H | H | H | F | 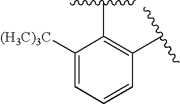 | 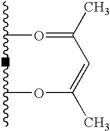 | 2 |
| 261 | H | H | H | H | H | F | 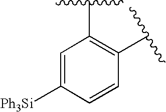 | 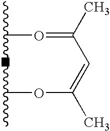 | 2 |
| 262 | H | H | H | H | H | F | 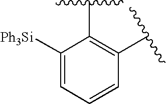 | 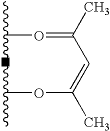 | 2 |
| 263 | H | H | H | H | H | F | 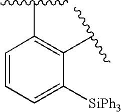 | 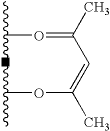 | 2 |
| 264 | H | H | H | H | H | F | 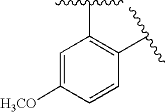 | 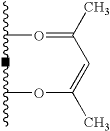 | 2 |
| 265 | H | H | H | H | H | F | 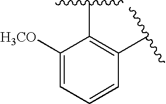 | 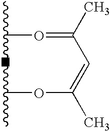 | 2 |
| 266 | H | H | H | H | H | F | 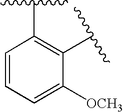 | 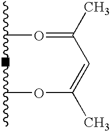 | 2 |
| 267 | H | H | H | H | H | F | 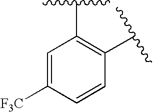 | 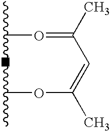 | 2 |
| 268 | H | H | H | H | H | F | 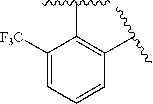 | 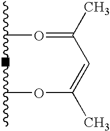 | 2 |
| 269 | H | H | H | H | H | F | 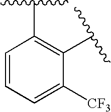 | 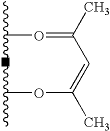 | 2 |
| 270 | H | H | H | H | H | F | 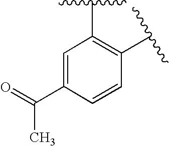 | 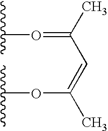 | 2 |
| 271 | H | H | H | H | H | F | 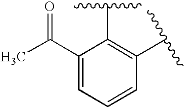 | 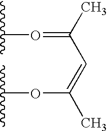 | 2 |
| 272 | H | H | H | H | H | F | 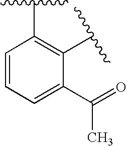 | 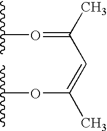 | 2 |
| 273 | H | H | H | H | H | F | 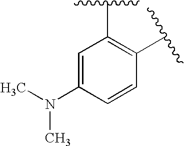 | 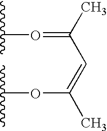 | 2 |
| 274 | H | H | H | H | H | F | 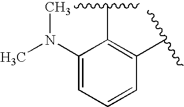 | 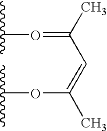 | 2 |
| 275 | H | H | H | H | H | F | 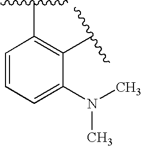 | 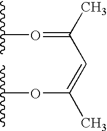 | 2 |
| 276 | H | H | H | H | H | F | 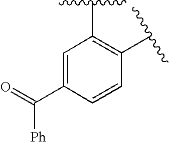 | 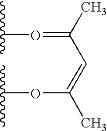 | 2 |
| 277 | H | H | H | H | H | F | 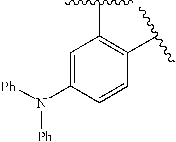 | 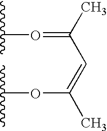 | 2 |
| 278 | H | H | H | H | H | F | 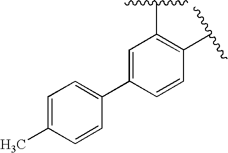 | 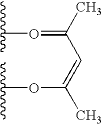 | 2 |
| 279 | H | H | H | H | H | F | 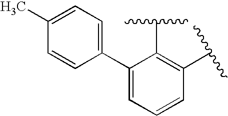 | 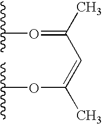 | 2 |
| 280 | H | H | H | H | H | F | 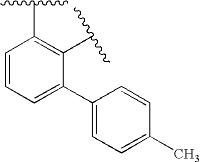 | 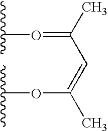 | 2 |
| 281 | H | H | H | H | H | F | 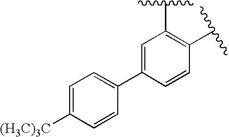 | 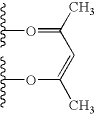 | 2 |
| 282 | H | H | H | H | H | F | 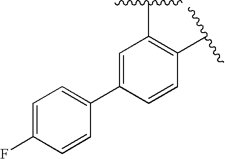 | 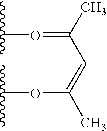 | 2 |
| 283 | H | H | H | H | H | F | 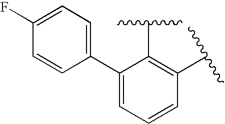 | 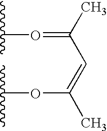 | 2 |
| 284 | H | H | H | H | H | F | 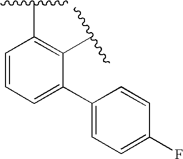 | 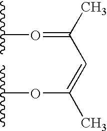 | 2 |
| 285 | H | H | H | H | H | F | 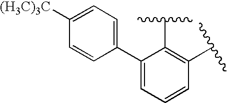 | 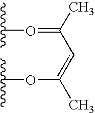 | 2 |
| 286 | H | H | H | H | H | F | 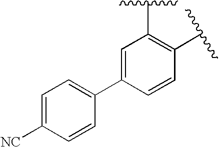 | 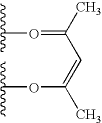 | 2 |
| 287 | H | H | H | H | H | F | 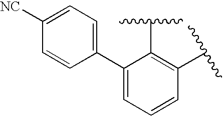 | 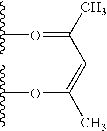 | 2 |
| 288 | H | H | H | H | H | F | 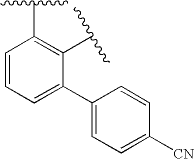 | 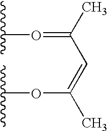 | 2 |
| 289 | H | H | H | H | H | F | 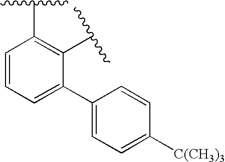 | 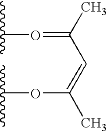 | 2 |
| 290 | H | H | H | H | H | F | 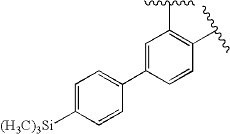 | 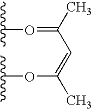 | 2 |
| 291 | H | H | H | H | H | F | 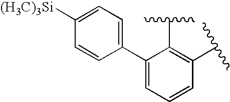 | 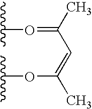 | 2 |
| 292 | H | H | H | H | H | F | 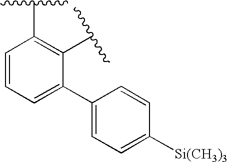 | 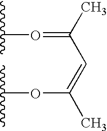 | 2 |
| 293 | H | H | H | H | H | F | 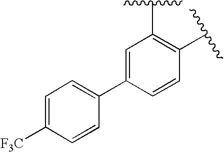 | 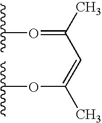 | 2 |
| 294 | H | H | H | H | H | F | 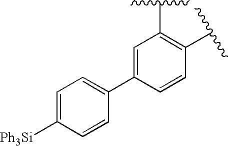 | 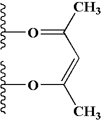 | 2 |
| 295 | H | H | H | H | H | F | 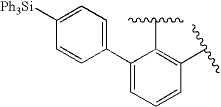 | 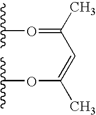 | 2 |
| 296 | H | H | H | H | H | F | 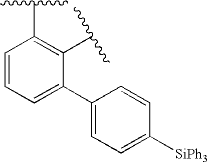 | 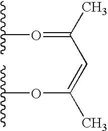 | 2 |
| 297 | H | H | H | H | H | F | 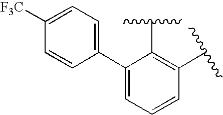 | 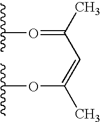 | 2 |
| 298 | H | H | H | H | H | F | 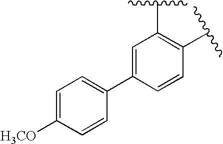 | 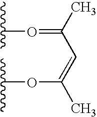 | 2 |
| 299 | H | H | H | H | H | F | 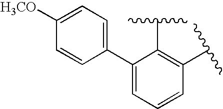 | 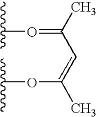 | 2 |
| 300 | H | H | H | H | H | F | 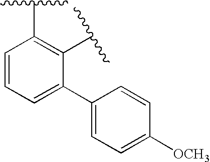 | 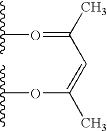 | 2 |
| 301 | H | H | H | H | H | F | 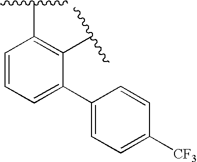 | 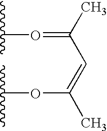 | 2 |
| 302 | H | H | H | H | H | F | 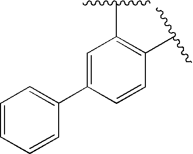 | 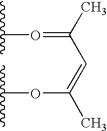 | 2 |
| 303 | H | H | H | H | H | F | 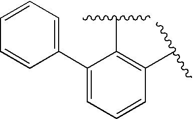 | 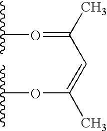 | 2 |
| 304 | H | H | H | H | H | F | 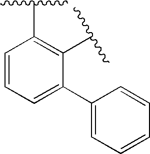 | 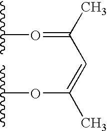 | 2 |
| 305 | H | H | H | H | H | F | 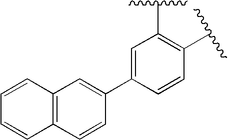 | 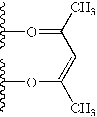 | 2 |
| 306 | H | H | H | H | H | F | 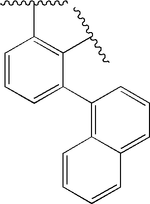 | 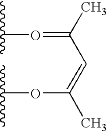 | 2 |
| 307 | H | H | H | H | H | F | 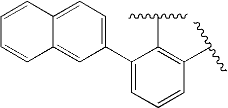 | 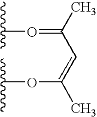 | 2 |
| 308 | H | H | H | H | H | F | 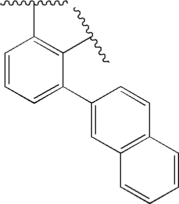 | 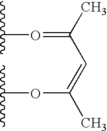 | 2 |
| 309 | H | H | H | H | H | F | 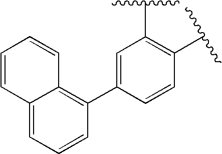 | 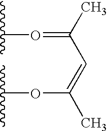 | 2 |
| 310 | H | H | H | H | H | F | 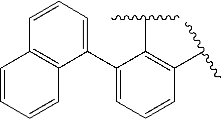 | 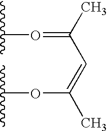 | 2 |
| 311 | H | H | H | H | H | F | 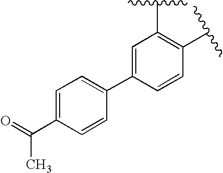 | 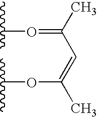 | 2 |
| 312 | H | H | H | H | H | F | 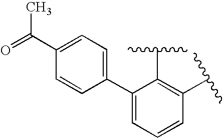 | 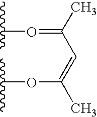 | 2 |
| 313 | H | H | H | H | H | F | 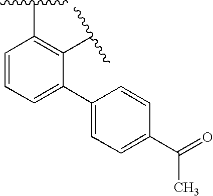 | 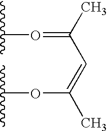 | 2 |
| 314 | H | H | H | H | H | F | 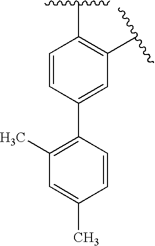 | 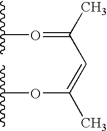 | 2 |
| 315 | H | H | H | H | H | F | 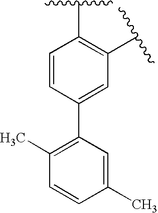 | 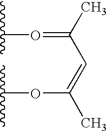 | 2 |
| 316 | H | H | H | H | H | F | 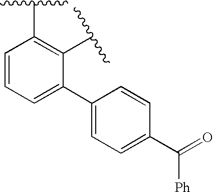 | 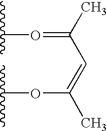 | 2 |
| 317 | H | H | H | H | H | F | 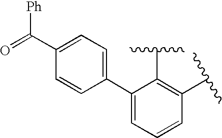 | 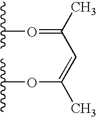 | 2 |
| 318 | H | H | H | H | H | F | 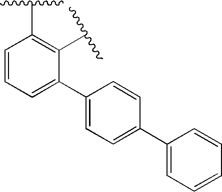 | 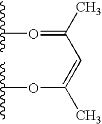 | 2 |
| 319 | H | H | H | H | H | F | 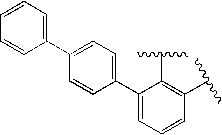 | 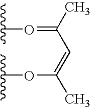 | 2 |
| 320 | H | H | H | H | H | F | 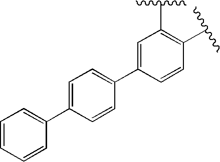 | 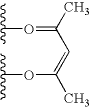 | 2 |
| 321 | H | H | H | H | H | F | 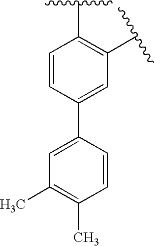 | 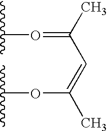 | 2 |
| 322 | H | H | H | H | H | F | 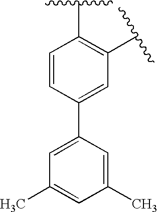 | 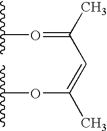 | 2 |
| 323 | H | H | H | H | H | F | 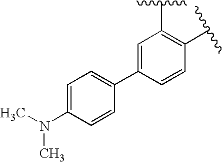 | 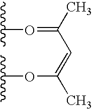 | 2 |
| 324 | H | H | H | H | H | F | 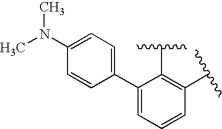 | 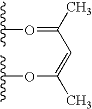 | 2 |
| 325 | H | H | H | H | H | F | 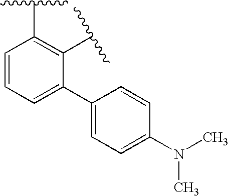 | 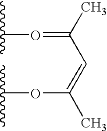 | 2 |
| 326 | H | H | H | H | H | F | 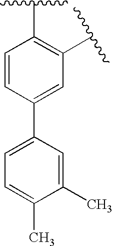 | 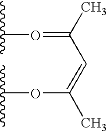 | 2 |
| 327 | H | H | H | H | H | F | 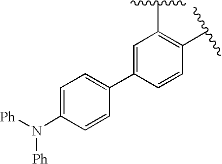 | 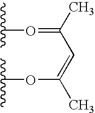 | 2 |
| 328 | H | H | H | H | H | F | 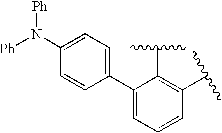 | 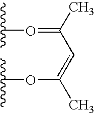 | 2 |
| 329 | H | H | H | H | H | F | 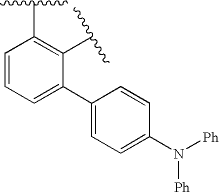 | 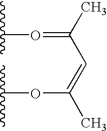 | 2 |
| 330 | H | H | H | H | H | F | 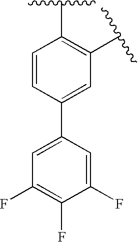 | 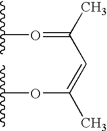 | 2 |
| 331 | H | H | H | H | H | F | 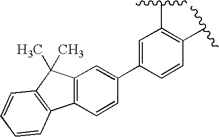 | 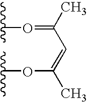 | 2 |
| 332 | H | H | H | H | H | F | 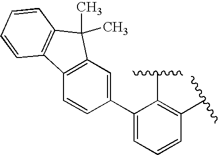 | 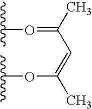 | 2 |
| 333 | H | H | H | H | H | F | 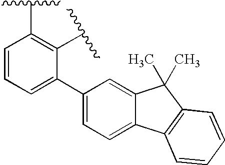 | 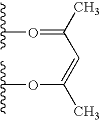 | 2 |
| 334 | H | H | H | H | H | F | 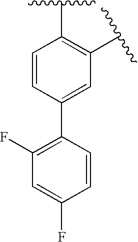 | 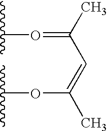 | 2 |
| 335 | H | H | H | H | H | F | 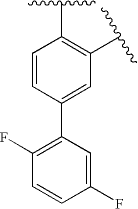 | 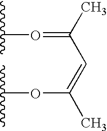 | 2 |
| 336 | H | H | H | H | H | F | 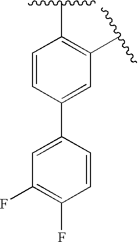 | 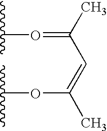 | 2 |
| 337 | H | H | H | H | H | F | 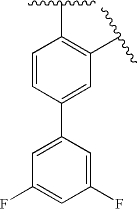 | 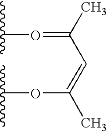 | 2 |
| 338 | H | H | H | H | H | F | 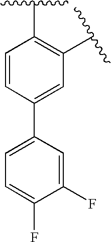 | 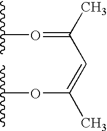 | 2 |
| 339 | H | H | H | H | H | F | 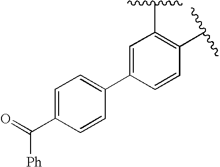 | 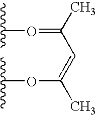 | 2 |
| 340 | H | H | H | H | H | F | 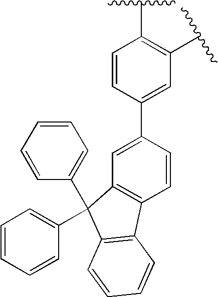 | 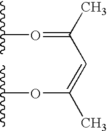 | 2 |
| 341 | H | H | H | H | H | F | 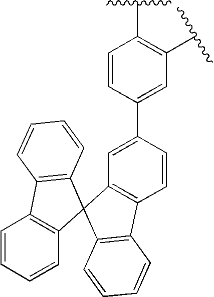 | 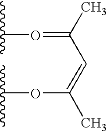 | 2 |
| 342 | H | H | H | H | H | F | 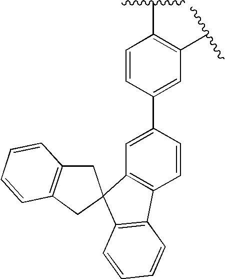 | 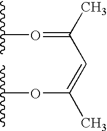 | 2 |
| 343 | H | H | H | H | H | F | 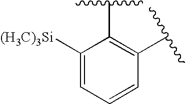 | 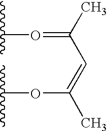 | 2 |
| 344 | H | H | H | H | H | F | 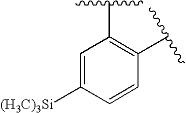 | 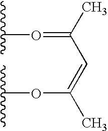 | 2 |
| 345 | H | H | H | H | H | F | 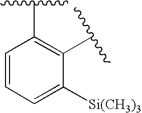 | 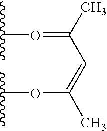 | 2 |
| 346 | H | H | H | H | H | F | 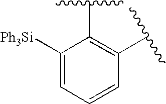 | 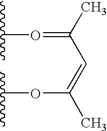 | 2 |
| 347 | H | H | H | H | H | F | 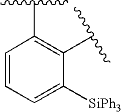 | 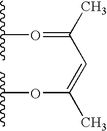 | 2 |
| 348 | H | H | H | H | H | F | 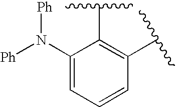 | 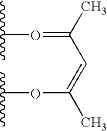 | 2 |
| 349 | H | H | H | H | H | F | 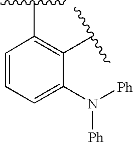 | 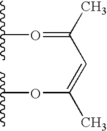 | 2 |
| 350 | H | H | H | H | H | F | 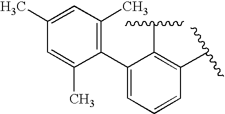 | 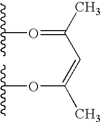 | 2 |
| 351 | H | H | H | H | H | F | 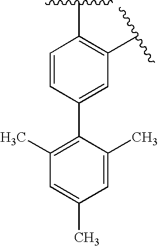 | 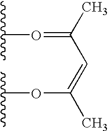 | 2 |
| 352 | H | H | H | H | H | F | 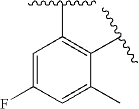 | 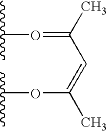 | 2 |
| 353 | H | H | H | H | H | F | 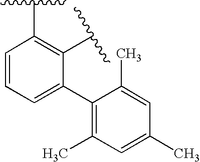 | 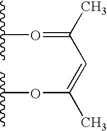 | 2 |
| 354 | H | H | H | H | H | F | 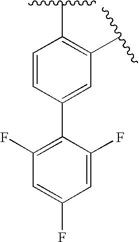 | 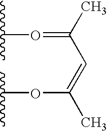 | 2 |
| 355 | H | H | H | H | H | F | 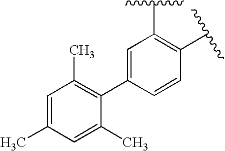 | 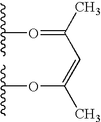 | 2 |
| 356 | H | H | H | H | H | F | 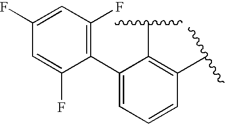 | 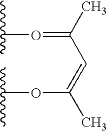 | 2 |
| 357 | H | H | H | H | H | F | 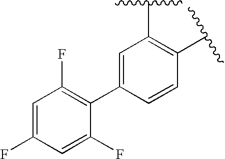 | 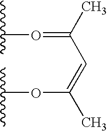 | 2 |
| 358 | H | H | H | H | H | F | 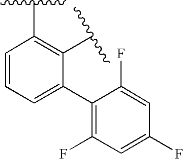 | 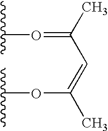 | 2 |
| 359 | H | H | H | H | H | F | 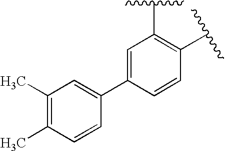 | 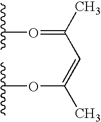 | 2 |
| 360 | H | H | H | H | H | F | 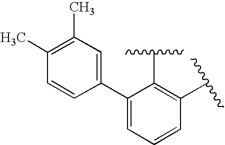 | 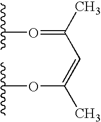 | 2 |
| 361 | H | H | H | H | H | F | 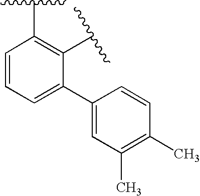 | 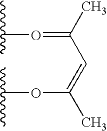 | 2 |
| 362 | H | H | H | H | H | F | 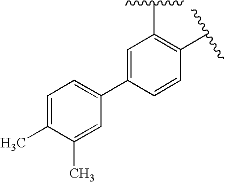 | 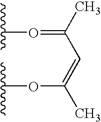 | 2 |
| 363 | H | H | H | H | H | F | 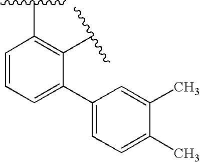 | 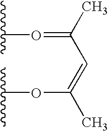 | 2 |
| 364 | H | H | H | H | H | F | 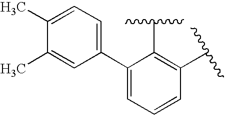 | 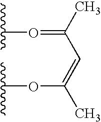 | 2 |
| 365 | H | H | H | H | H | F | 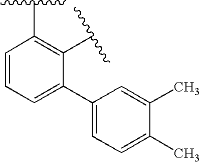 | 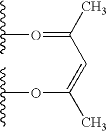 | 2 |
| 366 | H | H | H | H | H | F | 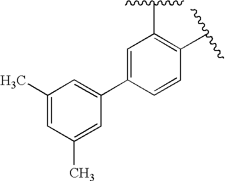 | 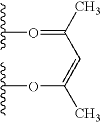 | 2 |
| 367 | H | H | H | H | H | F | 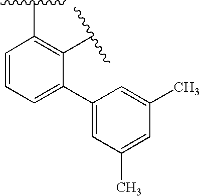 | 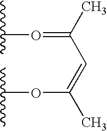 | 2 |
| 368 | H | H | H | H | H | F | 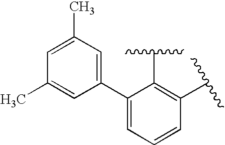 | 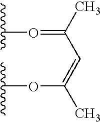 | 2 |
| 369 | H | H | H | H | H | F | 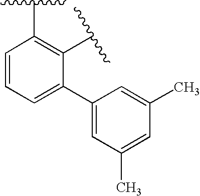 | 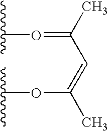 | 2 |
| 370 | H | H | H | H | H | F | 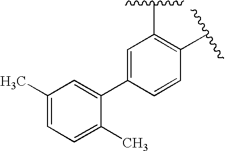 | 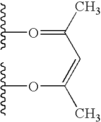 | 2 |
| 371 | H | H | H | H | H | F | 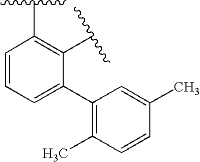 | 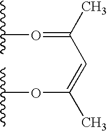 | 2 |
| 372 | H | H | H | H | H | F | 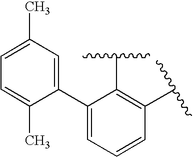 | 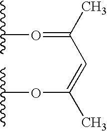 | 2 |
| 373 | H | H | H | H | H | F | 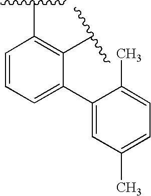 | 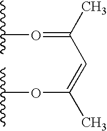 | 2 |
| 374 | H | H | H | H | H | F | 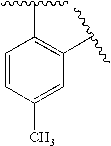 | 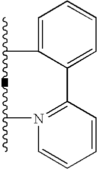 | 2 |
| 375 | H | H | H | H | H | F | 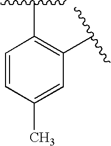 | 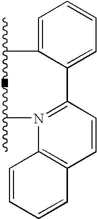 | 2 |
| 376 | H | H | H | H | H | F | 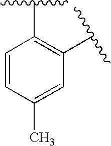 | 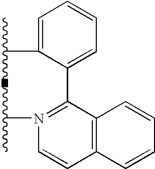 | 2 |
| 377 | H | H | H | H | H | F | 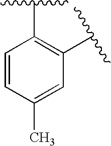 | 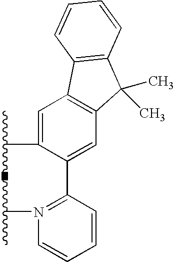 | 2 |
| 378 | H | H | H | H | H | F | 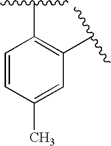 | 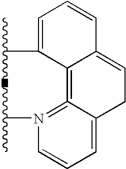 | 2 |
| 379 | H | H | H | H | H | F | 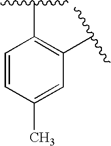 | 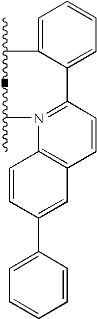 | 2 |
| 380 | H | H | H | H | H | F | 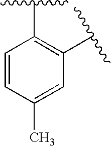 | 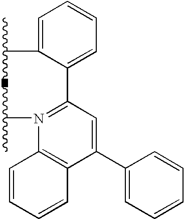 | 2 |
| 381 | H | H | H | H | H | F | 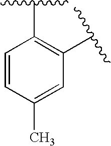 | 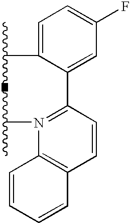 | 2 |
| 382 | H | H | H | H | H | F | 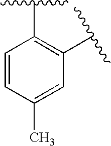 | 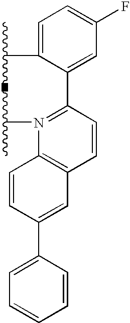 | 2 |
| 383 | H | H | H | H | H | F | 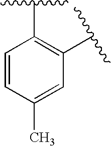 | 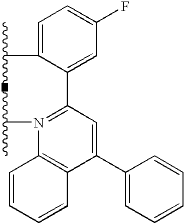 | 2 |
| 384 | H | H | H | H | H | F | 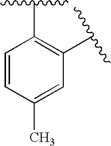 | 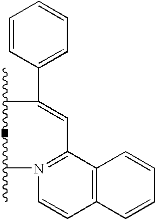 | 2 |
| 385 | H | H | H | H | H | F | 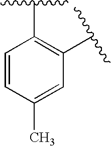 | 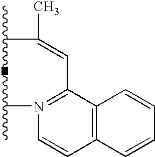 | 2 |
| 386 | H | H | H | H | H | F | 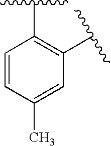 | 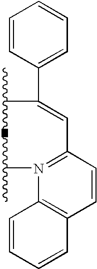 | 2 |
| 387 | H | H | H | H | H | F | 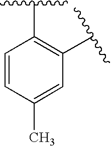 | 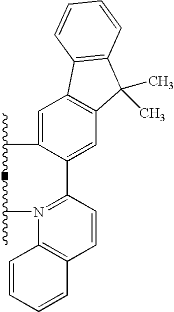 | 2 |
| 388 | H | H | H | H | H | F | 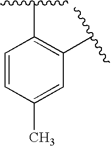 | 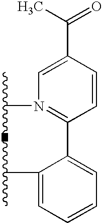 | 2 |
| 389 | H | H | H | H | H | F | 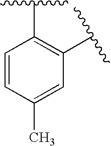 | 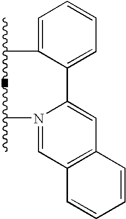 | 2 |
| 390 | H | H | H | H | H | F | 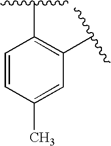 | 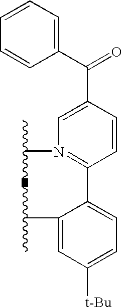 | 2 |
| 391 | H | H | H | H | H | F | 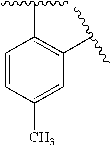 | 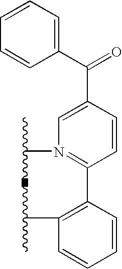 | 2 |
| 392 | H | H | H | H | H | F | 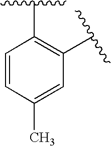 | 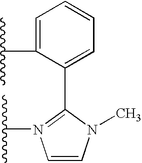 | 2 |
| 393 | H | H | H | H | H | F | 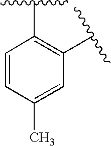 | 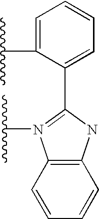 | 2 |
| 394 | H | H | H | H | H | F | 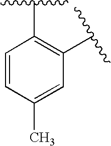 | 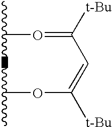 | 2 |
| 395 | H | H | H | H | H | F | 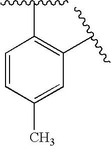 | 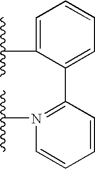 | 1 |
| 396 | H | H | H | H | H | F | 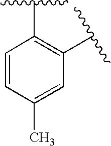 | — | 3 |
| 397 | H | H | H | H | H | —CH₃ | 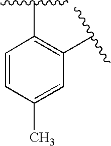 | 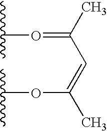 | 2 |
| 398 | H | H | H | H | H | —CH₃ | 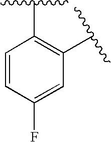 | 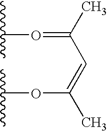 | 2 |
| 399 | H | H | H | H | H | —CH₃ | 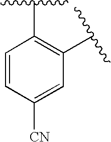 | 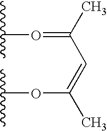 | 2 |
| 400 | H | H | H | H | H | —CH₃ | 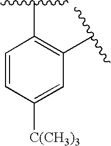 | 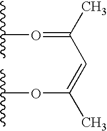 | 2 |
| 401 | H | H | H | H | H | —CH₃ | 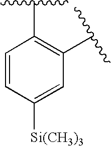 | 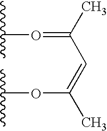 | 2 |
| 402 | H | H | H | H | H | —CH₃ | 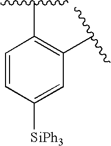 | 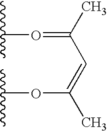 | 2 |
| 403 | H | H | H | H | H | —CH₃ | 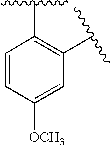 | 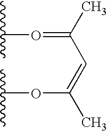 | 2 |
| 404 | H | H | H | H | H | —CH₃ | 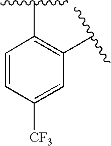 | 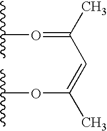 | 2 |
| 405 | H | H | H | H | H | —CH₃ | 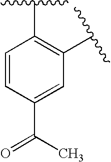 | 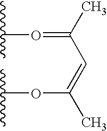 | 2 |
| 406 | H | H | H | H | H | —CH₃ | 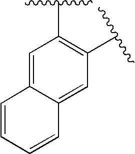 | 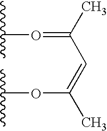 | 2 |
| 407 | H | H | H | H | H | —CH₃ | 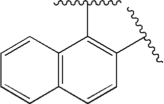 | 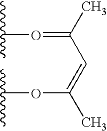 | 2 |
| 408 | H | H | H | H | H | —CH₃ | 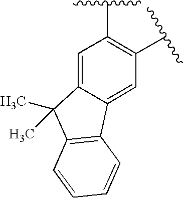 | 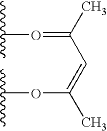 | 2 |
| 409 | H | H | H | H | H | —CH₃ | 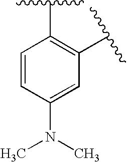 | 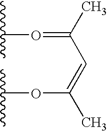 | 2 |
| 410 | H | H | H | H | H | —CH₃ | 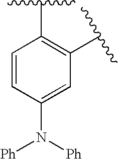 | 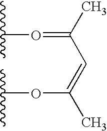 | 2 |
| 411 | H | H | H | H | H | —CH₃ | 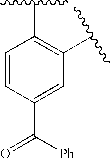 | 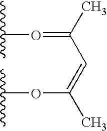 | 2 |
| 412 | H | H | H | H | H | —CH₃ | 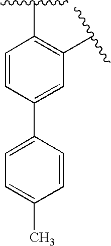 | 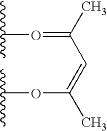 | 2 |
| 413 | H | H | H | H | H | —CH₃ | 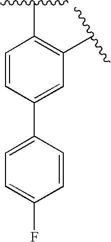 | 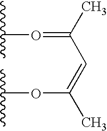 | 2 |
| 414 | H | H | H | H | H | —CH₃ | 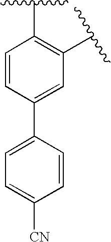 | 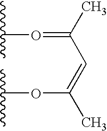 | 2 |
| 415 | H | H | H | H | H | —CH₃ | 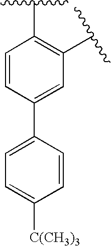 | 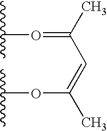 | 2 |
| 416 | H | H | H | H | H | —CH₃ | 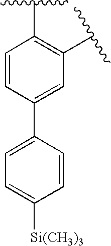 | 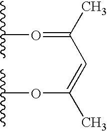 | 2 |
| 417 | H | H | H | H | H | —CH₃ | 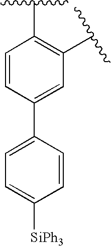 | 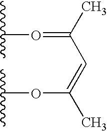 | 2 |
| 418 | H | H | H | H | H | —CH₃ | 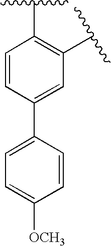 | 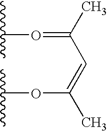 | 2 |
| 419 | H | H | H | H | H | —CH₃ | 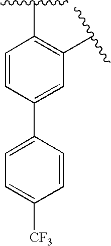 | 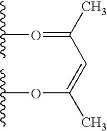 | 2 |
| 420 | H | H | H | H | H | —CH₃ | 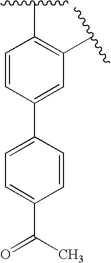 | 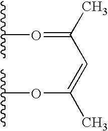 | 2 |
| 421 | H | H | H | H | H | —CH₃ | 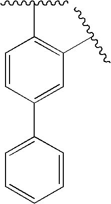 | 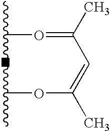 | 2 |
| 422 | H | H | H | H | H | —CH₃ | 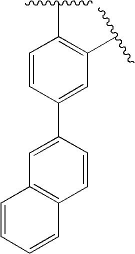 | 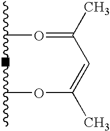 | 2 |
| 423 | H | H | H | H | H | —CH₃ | 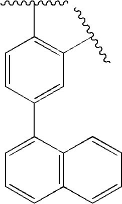 | 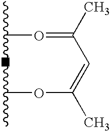 | 2 |
| 424 | H | H | H | H | H | —CH₃ | 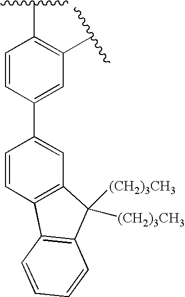 | 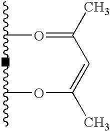 | 2 |
| 425 | H | H | H | H | H | —CH₃ | 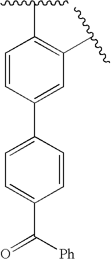 | 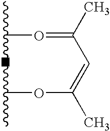 | 2 |
| 426 | H | H | H | H | H | —CH₃ | 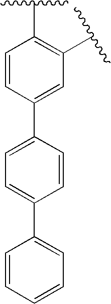 | 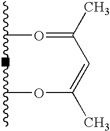 | 2 |
| 427 | H | H | H | H | H | —CH₃ | 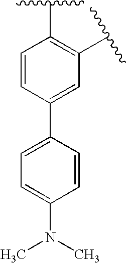 | 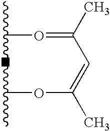 | 2 |
| 428 | H | H | H | H | H | —CH₃ | 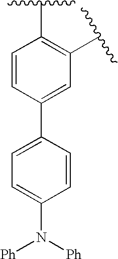 | 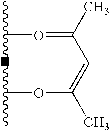 | 2 |
| 429 | H | H | H | H | H | —CH₃ | 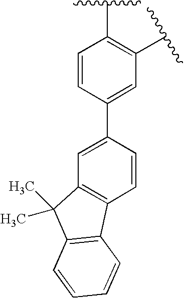 | 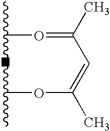 | 2 |
| 430 | H | H | H | H | H | —CH₃ | 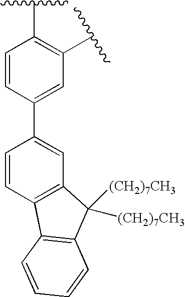 | 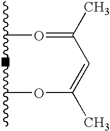 | 2 |
| 431 | H | H | H | H | H | —CH₃ | 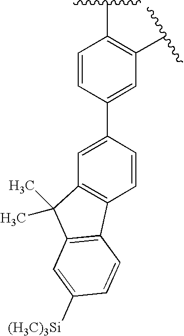 | 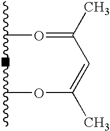 | 2 |
| 432 | H | H | H | H | H | —CH₃ | 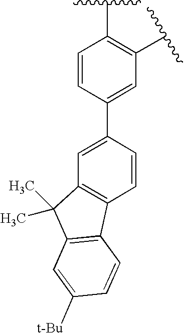 | 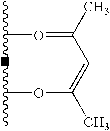 | 2 |
| 433 | H | H | H | H | H | —CH₃ | 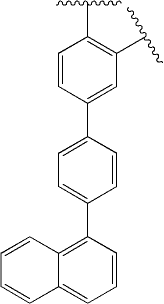 | 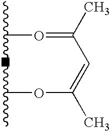 | 2 |
| 434 | H | H | H | H | H | —CH₃ | 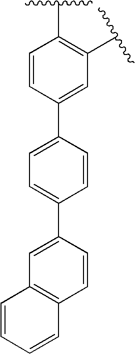 | 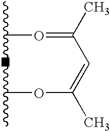 | 2 |
| 435 | H | H | H | H | H | —CH₃ | 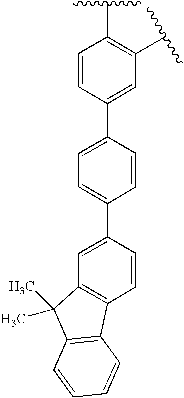 | 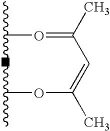 | 2 |
| 436 | H | H | H | H | H | —CH₃ | 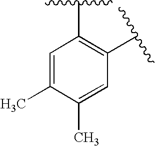 | 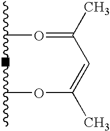 | 2 |
| 437 | H | H | H | H | H | —CH₃ | 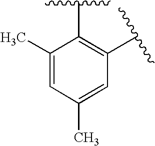 | 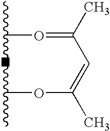 | 2 |
| 438 | H | H | H | H | H | —CH₃ | 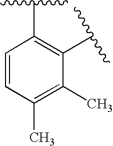 | 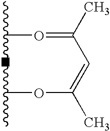 | 2 |
| 439 | H | H | H | H | H | —CH₃ | 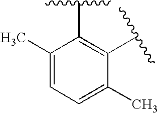 | 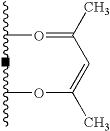 | 2 |
| 440 | H | H | H | H | H | —CH₃ | 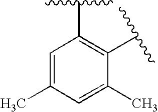 | 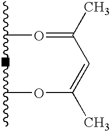 | 2 |
| 441 | H | H | H | H | H | —CH₃ | 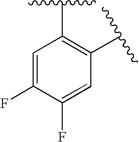 | 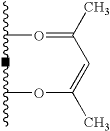 | 2 |
| 442 | H | H | H | H | H | —CH₃ | 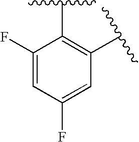 | 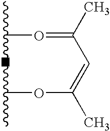 | 2 |
| 443 | H | H | H | H | H | —CH₃ | 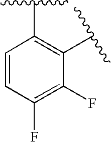 | 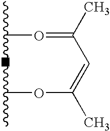 | 2 |
| 444 | H | H | H | H | H | —CH₃ | 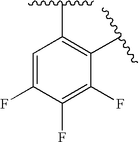 | 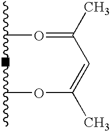 | 2 |
| 445 | H | H | H | H | H | —CH₃ | 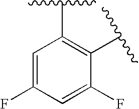 | 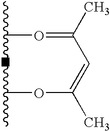 | 2 |
| 446 | H | H | H | H | H | —CH₃ | 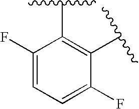 | 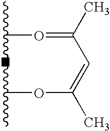 | 2 |
| 447 | H | H | H | H | H | —CH₃ | 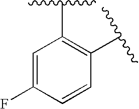 | 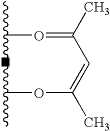 | 2 |
| 448 | H | H | H | H | H | —CH₃ | 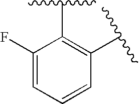 | 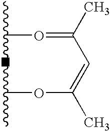 | 2 |
| 449 | H | H | H | H | H | —CH₃ | 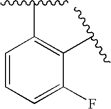 | 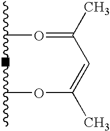 | 2 |
| 450 | H | H | H | H | H | —CH₃ | 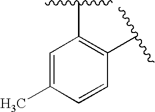 | 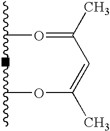 | 2 |
| 451 | H | H | H | H | H | —CH₃ | 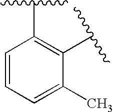 | 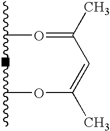 | 2 |
| 452 | H | H | H | H | H | —CH₃ | 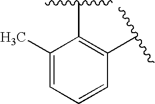 | 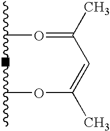 | 2 |
| 453 | H | H | H | H | H | —CH₃ | 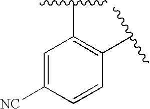 | 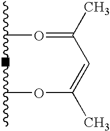 | 2 |
| 454 | H | H | H | H | H | —CH₃ | 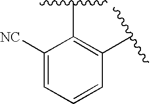 | 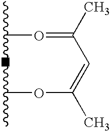 | 2 |
| 455 | H | H | H | H | H | —CH₃ | 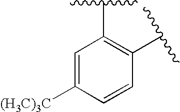 | 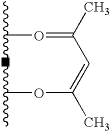 | 2 |
| 456 | H | H | H | H | H | —CH₃ | 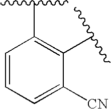 | 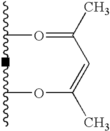 | 2 |
| 457 | H | H | H | H | H | —CH₃ | 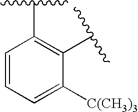 | 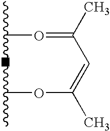 | 2 |
| 458 | H | H | H | H | H | —CH₃ | 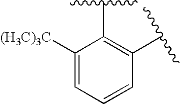 | 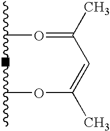 | 2 |
| 459 | H | H | H | H | H | —CH₃ | 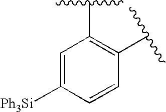 | 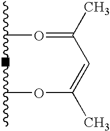 | 2 |
| 460 | H | H | H | H | H | —CH₃ | 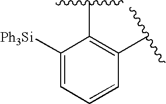 | 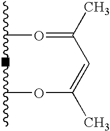 | 2 |
| 461 | H | H | H | H | H | —CH₃ | 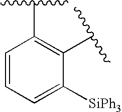 | 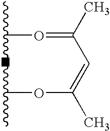 | 2 |
| 462 | H | H | H | H | H | —CH₃ | 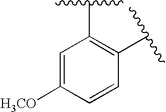 | 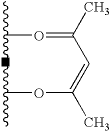 | 2 |
| 463 | H | H | H | H | H | —CH₃ | 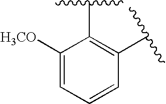 | 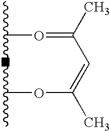 | 2 |
| 464 | H | H | H | H | H | —CH₃ | 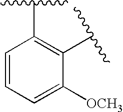 | 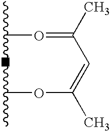 | 2 |
| 465 | H | H | H | H | H | —CH₃ | 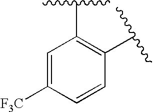 | 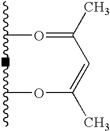 | 2 |
| 466 | H | H | H | H | H | —CH₃ | 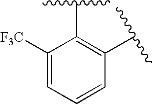 | 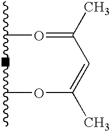 | 2 |
| 467 | H | H | H | H | H | —CH₃ | 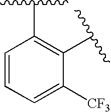 | 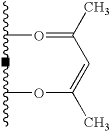 | 2 |
| 468 | H | H | H | H | H | —CH₃ | 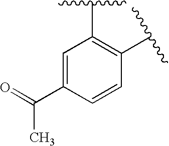 | 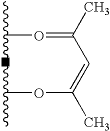 | 2 |
| 469 | H | H | H | H | H | —CH₃ | 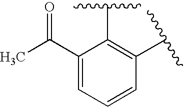 | 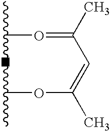 | 2 |
| 470 | H | H | H | H | H | —CH₃ | 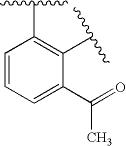 | 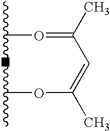 | 2 |
| 471 | H | H | H | H | H | —CH₃ | 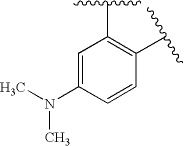 | 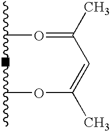 | 2 |
| 472 | H | H | H | H | H | —CH₃ | 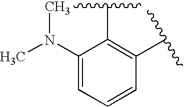 | 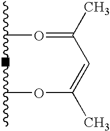 | 2 |
| 473 | H | H | H | H | H | —CH₃ | 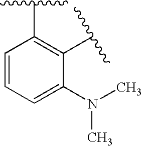 | 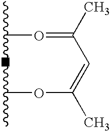 | 2 |
| 474 | H | H | H | H | H | —CH₃ | 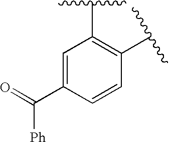 | 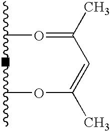 | 2 |
| 475 | H | H | H | H | H | —CH₃ | 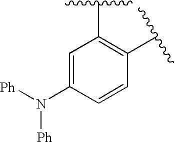 | 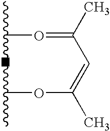 | 2 |
| 476 | H | H | H | H | H | —CH₃ | 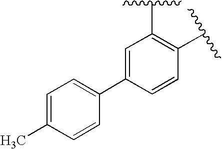 | 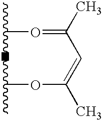 | 2 |
| 477 | H | H | H | H | H | —CH₃ | 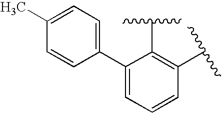 | 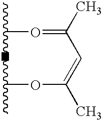 | 2 |
| 478 | H | H | H | H | H | —CH₃ | 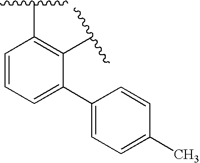 | 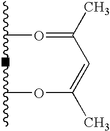 | 2 |
| 479 | H | H | H | H | H | —CH₃ | 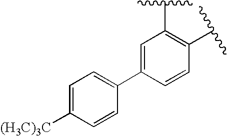 | 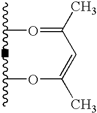 | 2 |
| 480 | H | H | H | H | H | —CH₃ | 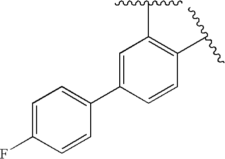 | 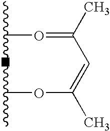 | 2 |
| 481 | H | H | H | H | H | —CH₃ | 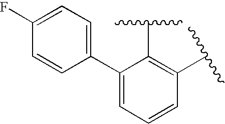 | 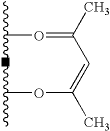 | 2 |
| 482 | H | H | H | H | H | —CH₃ | 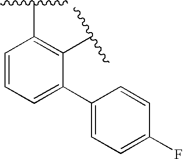 | 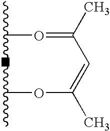 | 2 |
| 483 | H | H | H | H | H | —CH₃ | 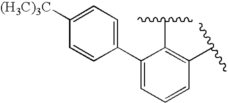 | 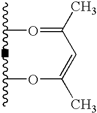 | 2 |
| 484 | H | H | H | H | H | —CH₃ | 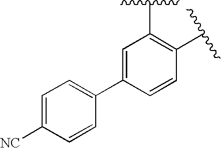 | 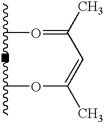 | 2 |
| 485 | H | H | H | H | H | —CH₃ | 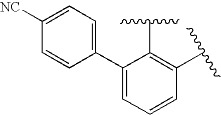 | 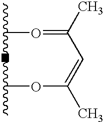 | 2 |
| 486 | H | H | H | H | H | —CH₃ | 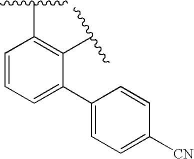 | 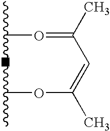 | 2 |
| 487 | H | H | H | H | H | —CH₃ | 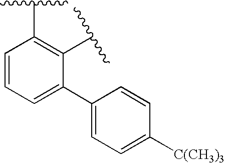 | 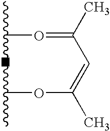 | 2 |
| 488 | H | H | H | H | H | —CH₃ | 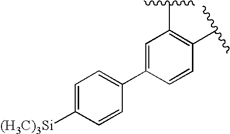 | 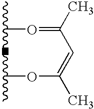 | 2 |
| 489 | H | H | H | H | H | —CH₃ | 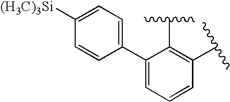 | 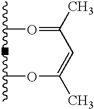 | 2 |

| | | | | | | | | | |
|---|---|---|---|---|---|---|---|---|---|
| 490 | H | H | H | H | H | —CH₃ | 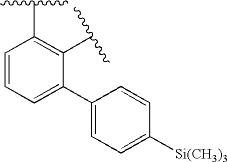 | 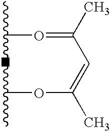 | 2 |
| 491 | H | H | H | H | H | —CH₃ | 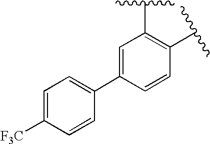 | 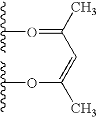 | 2 |
| 492 | H | H | H | H | H | —CH₃ | 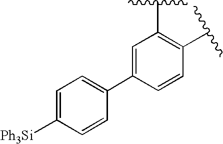 | 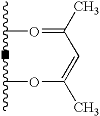 | 2 |
| 493 | H | H | H | H | H | —CH₃ | 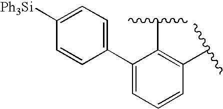 | 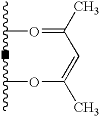 | 2 |
| 494 | H | H | H | H | H | —CH₃ | 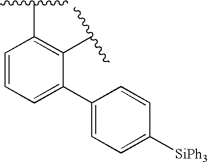 | 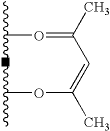 | 2 |
| 495 | H | H | H | H | H | —CH₃ | 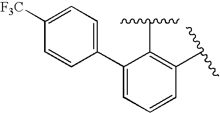 | 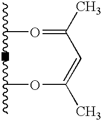 | 2 |
| 496 | H | H | H | H | H | —CH₃ | 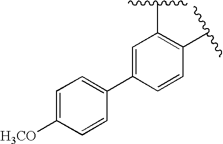 | 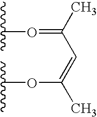 | 2 |
| 497 | H | H | H | H | H | —CH₃ | 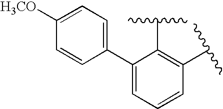 | 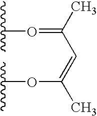 | 2 |
| 498 | H | H | H | H | H | —CH₃ | 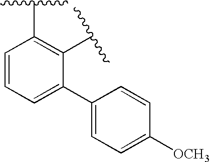 | 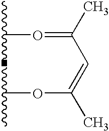 | 2 |
| 499 | H | H | H | H | H | —CH₃ | 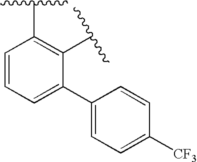 | 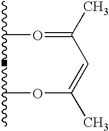 | 2 |
| 500 | H | H | H | H | H | —CH₃ | 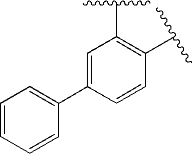 | 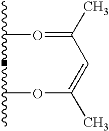 | 2 |
| 501 | H | H | H | H | H | —CH₃ | 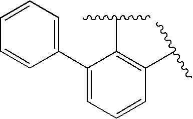 | 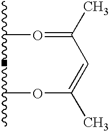 | 2 |
| 502 | H | H | H | H | H | —CH₃ | 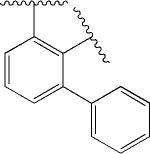 | 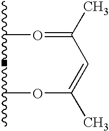 | 2 |
| 503 | H | H | H | H | H | —CH₃ | 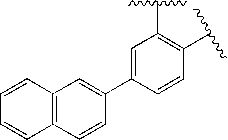 | 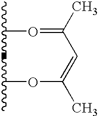 | 2 |
| 504 | H | H | H | H | H | —CH₃ | 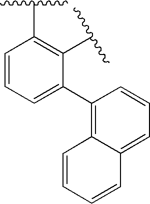 | 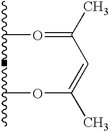 | 2 |
| 505 | H | H | H | H | H | —CH₃ | 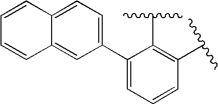 | 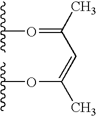 | 2 |
| 506 | H | H | H | H | H | —CH₃ | 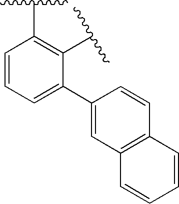 | 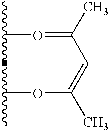 | 2 |
| 507 | H | H | H | H | H | —CH₃ | 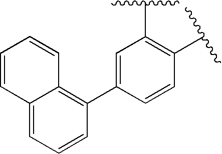 | 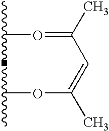 | 2 |
| 508 | H | H | H | H | H | —CH₃ | 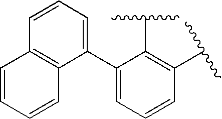 | 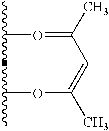 | 2 |
| 509 | H | H | H | H | H | —CH₃ | 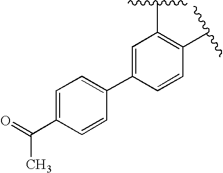 | 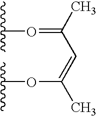 | 2 |
| 510 | H | H | H | H | H | —CH₃ | 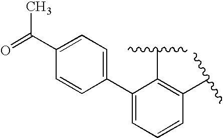 | 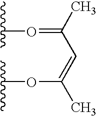 | 2 |
| 511 | H | H | H | H | H | —CH₃ | 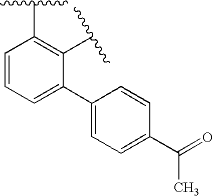 | 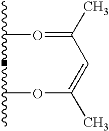 | 2 |
| 512 | H | H | H | H | H | —CH₃ | 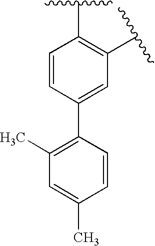 | 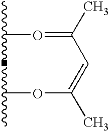 | 2 |
| 513 | H | H | H | H | H | —CH₃ | 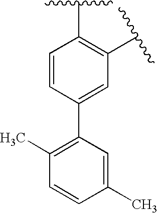 | 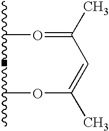 | 2 |
| 514 | H | H | H | H | H | —CH₃ | 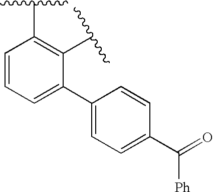 | 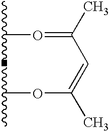 | 2 |
| 515 | H | H | H | H | H | —CH₃ | 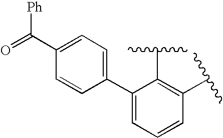 | 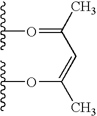 | 2 |
| 516 | H | H | H | H | H | —CH₃ | 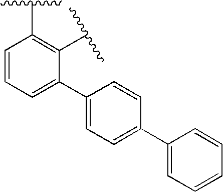 | 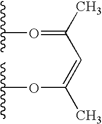 | 2 |
| 517 | H | H | H | H | H | —CH₃ | 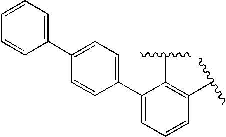 | 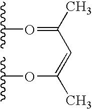 | 2 |
| 518 | H | H | H | H | H | —CH₃ | 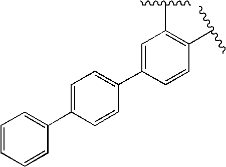 | 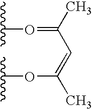 | 2 |
| 519 | H | H | H | H | H | —CH₃ | 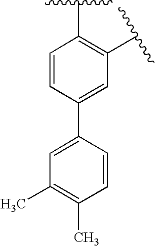 | 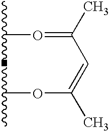 | 2 |
| 520 | H | H | H | H | H | —CH₃ | 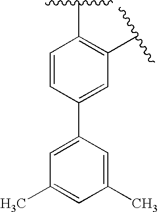 | 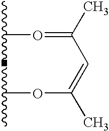 | 2 |
| 521 | H | H | H | H | H | —CH₃ | 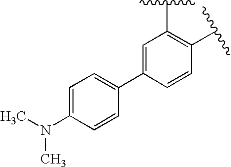 | 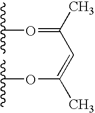 | 2 |
| 522 | H | H | H | H | H | —CH₃ | 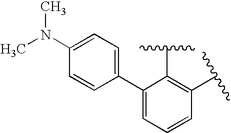 | 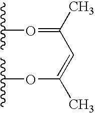 | 2 |
| 523 | H | H | H | H | H | —CH₃ | 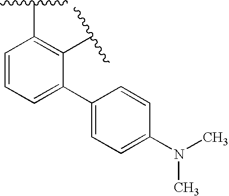 | 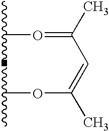 | 2 |
| 524 | H | H | H | H | H | —CH₃ | 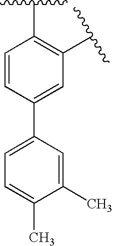 | 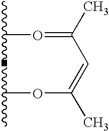 | 2 |
| 525 | H | H | H | H | H | —CH₃ | 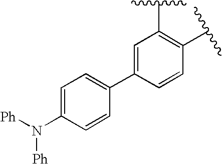 | 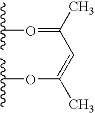 | 2 |
| 526 | H | H | H | H | H | —CH₃ | 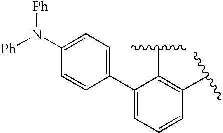 | 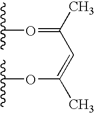 | 2 |
| 527 | H | H | H | H | H | —CH₃ | 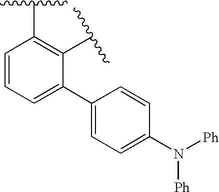 | 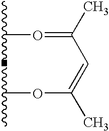 | 2 |
| 528 | H | H | H | H | H | —CH₃ | 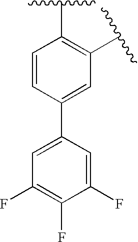 | 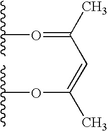 | 2 |
| 529 | H | H | H | H | H | —CH₃ | 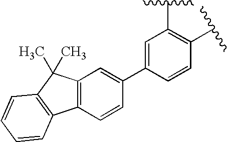 | 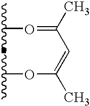 | 2 |
| 530 | H | H | H | H | H | —CH₃ | 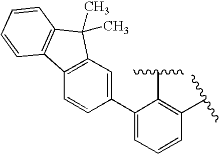 | 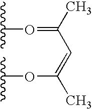 | 2 |
| 531 | H | H | H | H | H | —CH₃ | 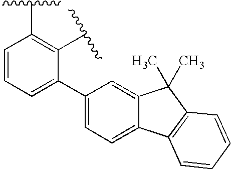 | 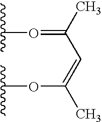 | 2 |
| 532 | H | H | H | H | H | —CH₃ | 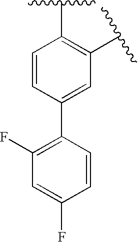 | 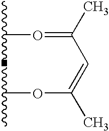 | 2 |
| 533 | H | H | H | H | H | —CH₃ | 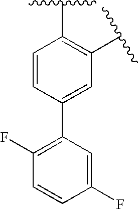 | 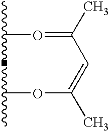 | 2 |
| 534 | H | H | H | H | H | —CH₃ | 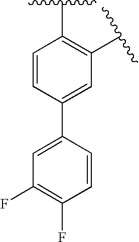 | 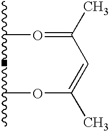 | 2 |
| 535 | H | H | H | H | H | —CH₃ | 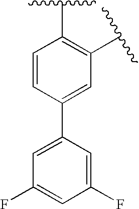 | 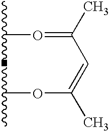 | 2 |
| 536 | H | H | H | H | H | —CH₃ | 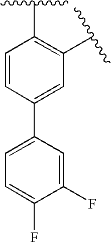 | 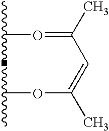 | 2 |
| 537 | H | H | H | H | H | —CH₃ | 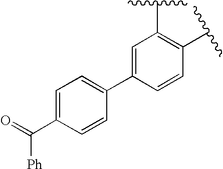 | 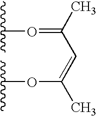 | 2 |
| 538 | H | H | H | H | H | —CH₃ | 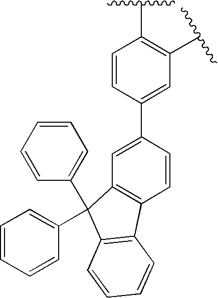 | 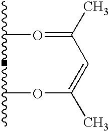 | 2 |
| 539 | H | H | H | H | H | —CH₃ | 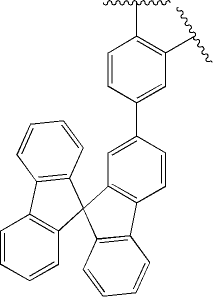 | 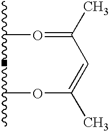 | 2 |
| 540 | H | H | H | H | H | —CH₃ | 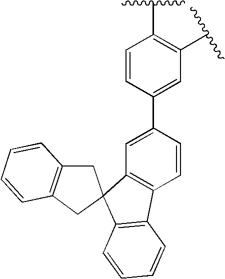 | 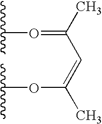 | 2 |
| 541 | H | H | H | H | H | —CH₃ | 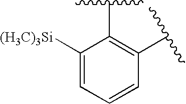 | 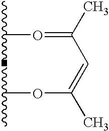 | 2 |
| 542 | H | H | H | H | H | —CH₃ | 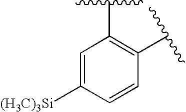 | 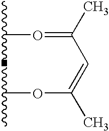 | 2 |
| 543 | H | H | H | H | H | —CH₃ | 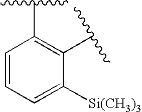 | 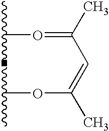 | 2 |
| 544 | H | H | H | H | H | —CH₃ | 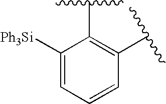 | 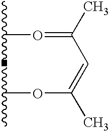 | 2 |
| 545 | H | H | H | H | H | —CH₃ | 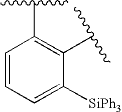 | 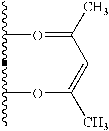 | 2 |
| 546 | H | H | H | H | H | —CH₃ | 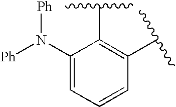 | 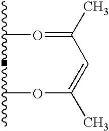 | 2 |
| 547 | H | H | H | H | —CH₃ | —CH₃ | 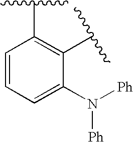 | 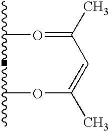 | 2 |
| 548 | H | H | H | H | H | —CH₃ | 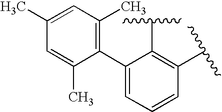 | 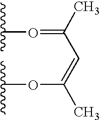 | 2 |
| 549 | H | H | H | H | H | —CH₃ | 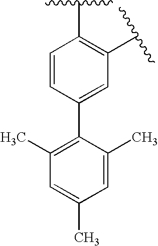 | 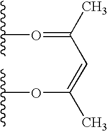 | 2 |
| 550 | H | H | H | H | H | —CH₃ | 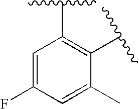 | 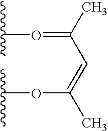 | 2 |
| 551 | H | H | H | H | H | —CH₃ | 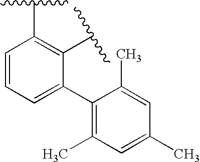 | 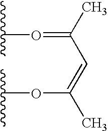 | 2 |
| 552 | H | H | H | H | H | —CH₃ | 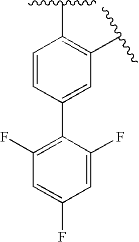 | 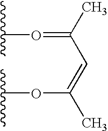 | 2 |
| 553 | H | H | H | H | H | —CH₃ | 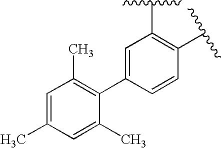 | 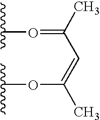 | 2 |
| 554 | H | H | H | H | H | —CH₃ | 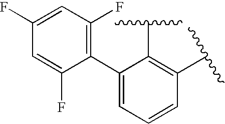 | 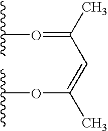 | 2 |
| 555 | H | H | H | H | H | —CH₃ | 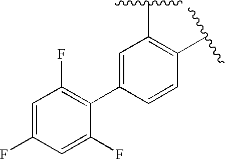 | 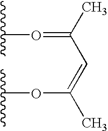 | 2 |
| 556 | H | H | H | H | H | —CH₃ | 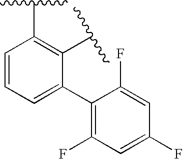 | 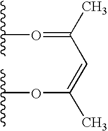 | 2 |
| 557 | H | H | H | H | H | —CH₃ | 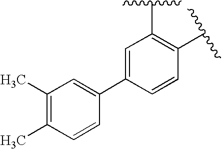 | 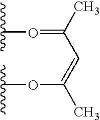 | 2 |
| 558 | H | H | H | H | H | —CH₃ | 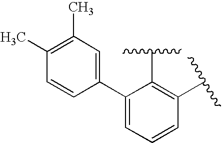 | 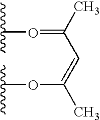 | 2 |
| 559 | H | H | H | H | H | —CH₃ | 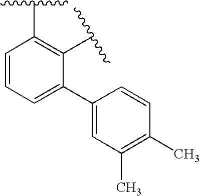 | 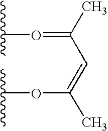 | 2 |
| 560 | H | H | H | H | H | —CH₃ | 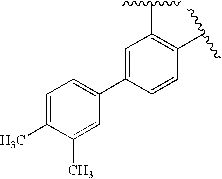 | 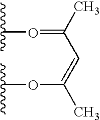 | 2 |
| 561 | H | H | H | H | H | —CH₃ | 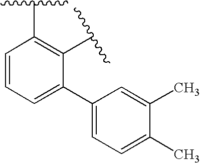 | 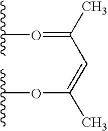 | 2 |
| 562 | H | H | H | H | H | —CH₃ | 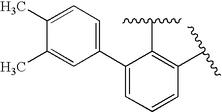 | 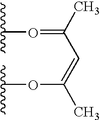 | 2 |
| 563 | H | H | H | H | H | —CH₃ | 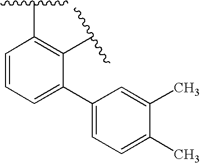 | 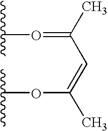 | 2 |
| 564 | H | H | H | H | H | —CH₃ | 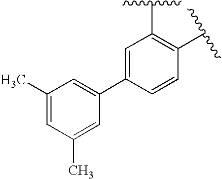 | 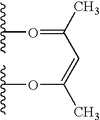 | 2 |
| 565 | H | H | H | H | H | —CH₃ | 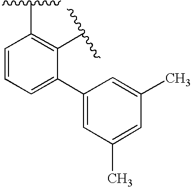 | 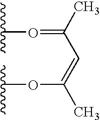 | 2 |
| 566 | H | H | H | H | H | —CH₃ | 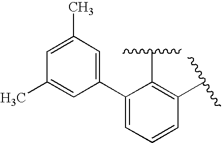 | 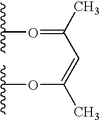 | 2 |
| 567 | H | H | H | H | H | —CH₃ | 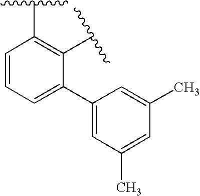 | 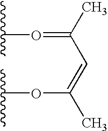 | 2 |
| 568 | H | H | H | H | H | —CH₃ | 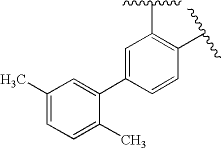 | 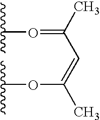 | 2 |
| 569 | H | H | H | H | H | —CH₃ | 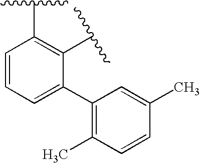 | 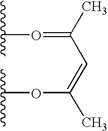 | 2 |
| 570 | H | H | H | H | H | —CH₃ | 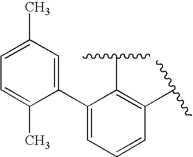 | 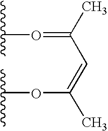 | 2 |
| 571 | H | H | H | H | H | —CH₃ | 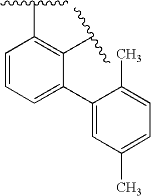 | 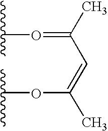 | 2 |
| 572 | H | H | H | H | H | —CH₃ | 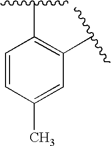 | 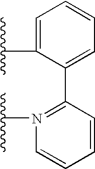 | 2 |
| 573 | H | H | H | H | H | —CH₃ | 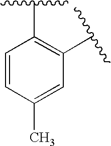 | 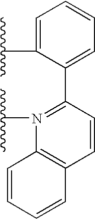 | 2 |
| 574 | H | H | H | H | H | —CH₃ | 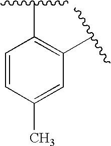 | 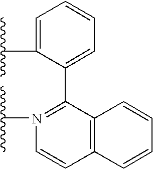 | 2 |
| 575 | H | H | H | H | H | —CH₃ | 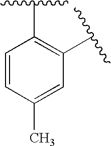 | 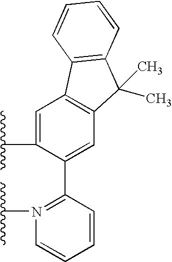 | 2 |
| 576 | H | H | H | H | H | —CH₃ | 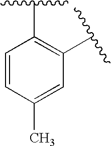 | 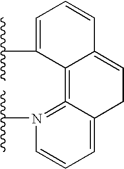 | 2 |
| 577 | H | H | H | H | H | —CH₃ | 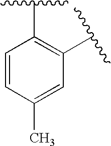 | 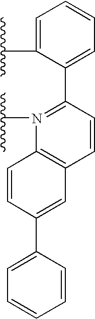 | 2 |
| 578 | H | H | H | H | H | —CH₃ | 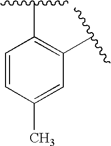 | 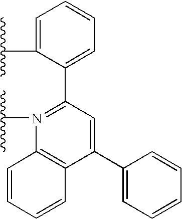 | 2 |
| 579 | H | H | H | H | H | —CH₃ | 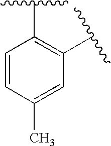 | 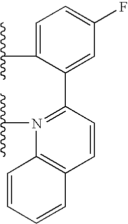 | 2 |
| 580 | H | H | H | H | H | —CH₃ | 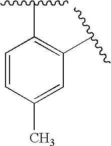 | 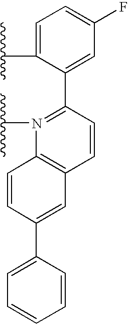 | 2 |
| 581 | H | H | H | H | H | —CH₃ | 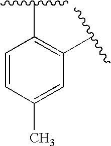 | 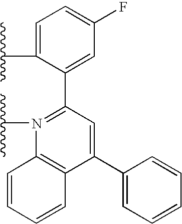 | 2 |
| 582 | H | H | H | H | H | —CH₃ | 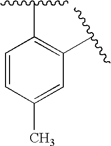 | 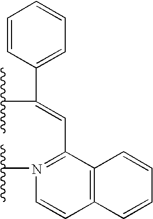 | 2 |
| 583 | H | H | H | H | H | —CH₃ | 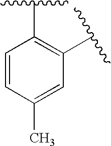 | 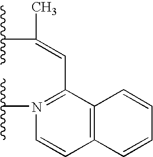 | 2 |
| 584 | H | H | H | H | H | —CH₃ | 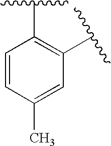 | 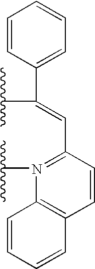 | 2 |
| 585 | H | H | H | H | H | —CH₃ | 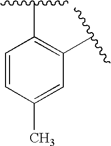 | 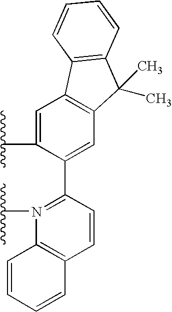 | 2 |
| 586 | H | H | H | H | H | —CH₃ | 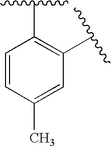 | 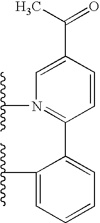 | 2 |
| 587 | H | H | H | H | H | —CH₃ | 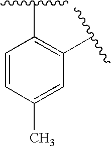 | 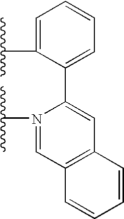 | 2 |
| 588 | H | H | H | H | H | —CH₃ | 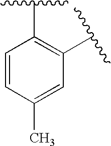 | 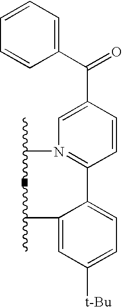 | 2 |
| 589 | H | H | H | H | H | —CH₃ | 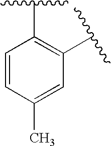 | 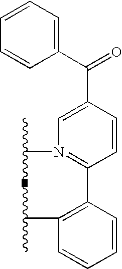 | 2 |
| 590 | H | H | H | H | H | —CH₃ | 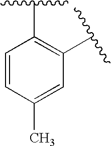 | 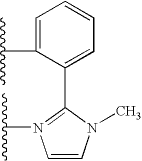 | 2 |
| 591 | H | H | H | H | H | —CH₃ | 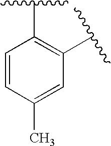 | 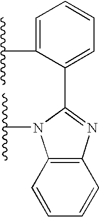 | 2 |
| 592 | H | H | H | H | H | —CH₃ | 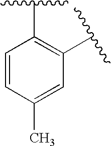 | 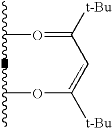 | 2 |
| 593 | H | H | H | H | H | —CH₃ | 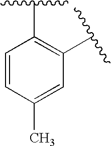 | 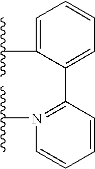 | 1 |
| 594 | H | H | H | H | H | —CH₃ | 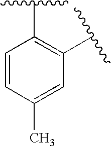 | — | 3 |
| 595 | H | H | H | H | H | —C(CH₃)₃ | 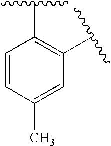 | 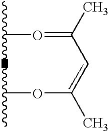 | 2 |
| 596 | H | H | H | H | H | —C(CH₃)₃ | 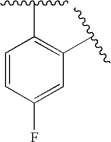 | 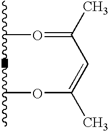 | 2 |
| 597 | H | H | H | H | H | —C(CH₃)₃ | 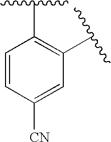 | 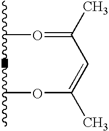 | 2 |
| 598 | H | H | H | H | H | —C(CH₃)₃ | 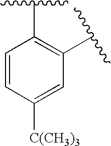 | 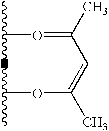 | 2 |
| 599 | H | H | H | H | H | —C(CH₃)₃ | 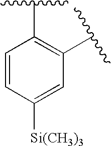 | 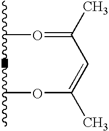 | 2 |
| 600 | H | H | H | H | H | —C(CH₃)₃ | 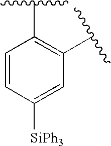 | 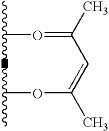 | 2 |
| 601 | H | H | H | H | H | —C(CH₃)₃ | 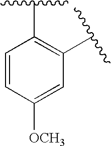 | 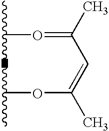 | 2 |
| 602 | H | H | H | H | H | —C(CH₃)₃ | 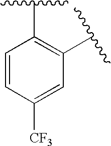 | 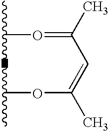 | 2 |
| 603 | H | H | H | H | H | —C(CH₃)₃ | 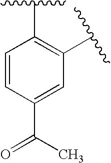 | 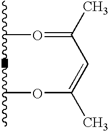 | 2 |
| 604 | H | H | H | H | H | —C(CH₃)₃ | 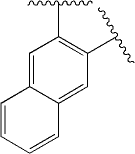 | 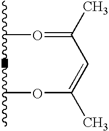 | 2 |
| 605 | H | H | H | H | H | —C(CH₃)₃ | 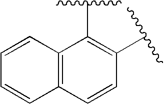 | 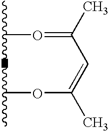 | 2 |
| 606 | H | H | H | H | H | —C(CH₃)₃ | 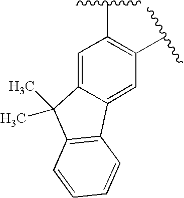 | 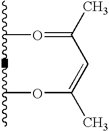 | 2 |
| 607 | H | H | H | H | H | —C(CH₃)₃ | 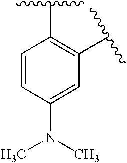 | 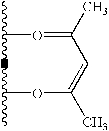 | 2 |
| 608 | H | H | H | H | H | —C(CH₃)₃ | 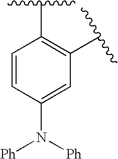 | 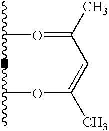 | 2 |
| 609 | H | H | H | H | H | —C(CH₃)₃ | 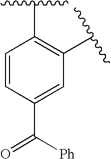 | 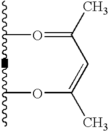 | 2 |
| 610 | H | H | H | H | H | —C(CH₃)₃ | 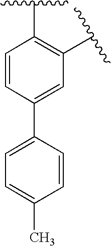 | 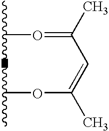 | 2 |
| 611 | H | H | H | H | H | —C(CH₃)₃ | 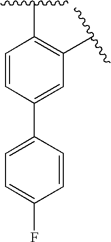 | 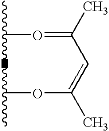 | 2 |
| 612 | H | H | H | H | H | —C(CH₃)₃ | 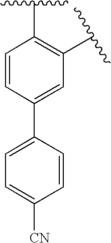 | 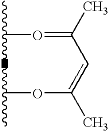 | 2 |
| 613 | H | H | H | H | H | —C(CH₃)₃ | 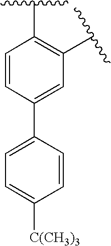 | 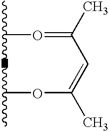 | 2 |
| 614 | H | H | H | H | H | —C(CH₃)₃ | 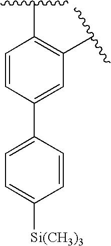 | 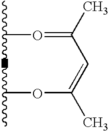 | 2 |
| 615 | H | H | H | H | H | —C(CH₃)₃ | 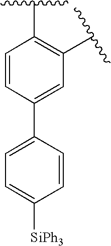 | 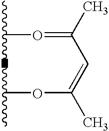 | 2 |
| 616 | H | H | H | H | H | —C(CH₃)₃ | 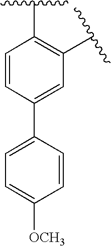 | 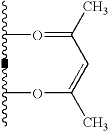 | 2 |
| 617 | H | H | H | H | H | —C(CH₃)₃ | 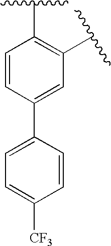 | 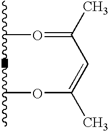 | 2 |
| 618 | H | H | H | H | H | —C(CH₃)₃ | 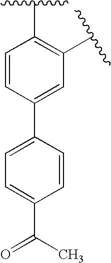 | 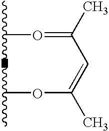 | 2 |
| 619 | H | H | H | H | H | —C(CH₃)₃ | 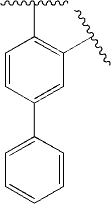 | 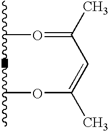 | 2 |
| 620 | H | H | H | H | H | —C(CH₃)₃ | 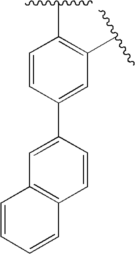 | 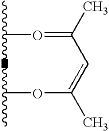 | 2 |
| 621 | H | H | H | H | H | —C(CH₃)₃ | 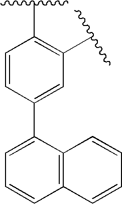 | 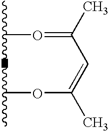 | 2 |
| 622 | H | H | H | H | H | —C(CH₃)₃ | 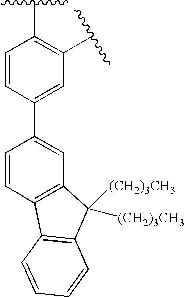 | 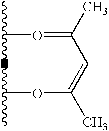 | 2 |
| 623 | H | H | H | H | H | —C(CH₃)₃ | 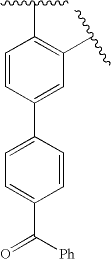 | 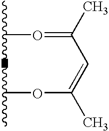 | 2 |
| 624 | H | H | H | H | H | —C(CH₃)₃ | 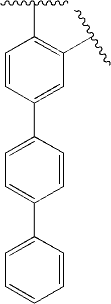 | 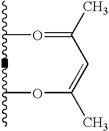 | 2 |
| 625 | H | H | H | H | H | —C(CH₃)₃ | 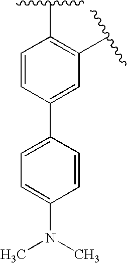 | 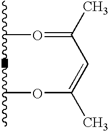 | 2 |
| 626 | H | H | H | H | H | —C(CH₃)₃ | 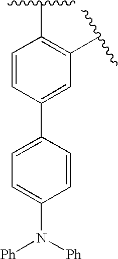 | 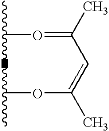 | 2 |
| 627 | H | H | H | H | H | —C(CH₃)₃ | 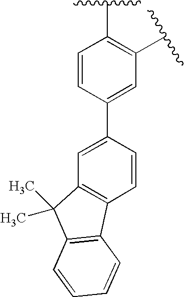 | 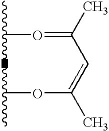 | 2 |
| 628 | H | H | H | H | H | —C(CH₃)₃ | 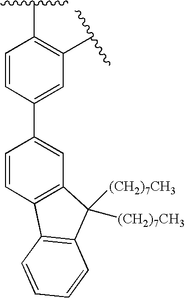 | 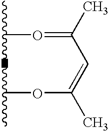 | 2 |
| 629 | H | H | H | H | H | —C(CH₃)₃ | 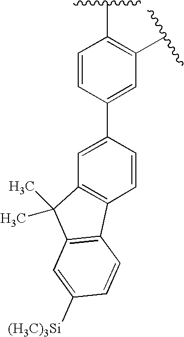 | 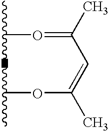 | 2 |
| 630 | H | H | H | H | H | —C(CH₃)₃ | 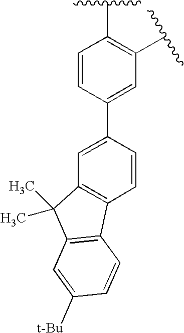 | 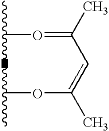 | 2 |
| 631 | H | H | H | H | H | —C(CH₃)₃ | 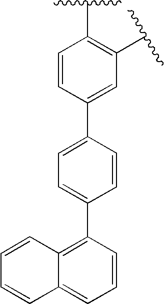 | 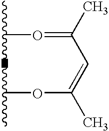 | 2 |
| 632 | H | H | H | H | H | —C(CH₃)₃ | 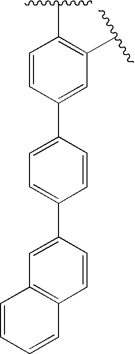 | 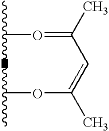 | 2 |
| 633 | H | H | H | H | H | —C(CH₃)₃ | 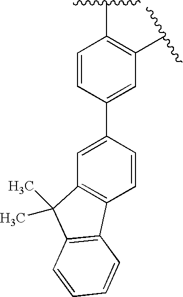 | 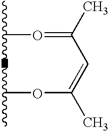 | 2 |
| 634 | H | H | H | H | H | —C(CH₃)₃ | 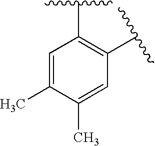 | 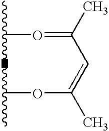 | 2 |
| 635 | H | H | H | H | H | —C(CH₃)₃ | 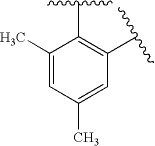 | 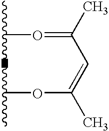 | 2 |
| 636 | H | H | H | H | H | —C(CH₃)₃ | 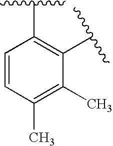 | 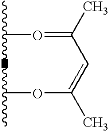 | 2 |
| 637 | H | H | H | H | H | —C(CH₃)₃ | 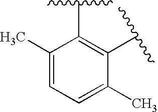 | 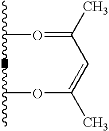 | 2 |
| 638 | H | H | H | H | H | —C(CH₃)₃ | 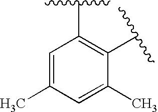 | 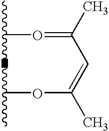 | 2 |
| 639 | H | H | H | H | H | —C(CH₃)₃ | 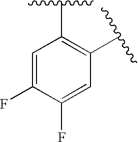 | 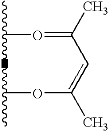 | 2 |
| 640 | H | H | H | H | H | —C(CH₃)₃ | 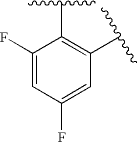 | 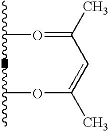 | 2 |
| 641 | H | H | H | H | H | —C(CH₃)₃ | 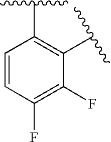 | 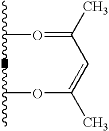 | 2 |
| 642 | H | H | H | H | H | —C(CH₃)₃ | 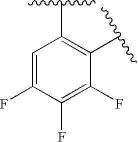 | 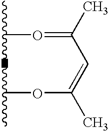 | 2 |
| 643 | H | H | H | H | H | —C(CH₃)₃ | 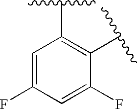 | 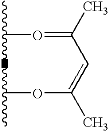 | 2 |
| 644 | H | H | H | H | H | —C(CH₃)₃ | 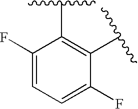 | 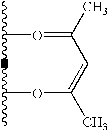 | 2 |
| 645 | H | H | H | H | H | —C(CH₃)₃ | 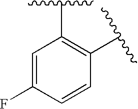 | 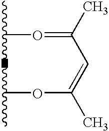 | 2 |
| 646 | H | H | H | H | H | —C(CH₃)₃ | 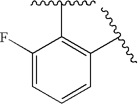 | 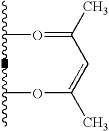 | 2 |
| 647 | H | H | H | H | H | —C(CH₃)₃ | 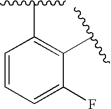 | 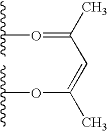 | 2 |
| 648 | H | H | H | H | H | —C(CH₃)₃ | 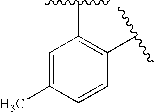 | 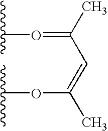 | 2 |
| 649 | H | H | H | H | H | —C(CH₃)₃ | 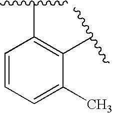 | 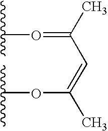 | 2 |
| 650 | H | H | H | H | H | —C(CH₃)₃ | 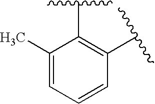 | 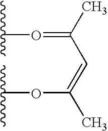 | 2 |
| 651 | H | H | H | H | H | —C(CH₃)₃ | 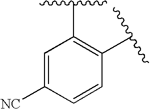 | 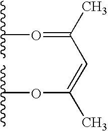 | 2 |
| 652 | H | H | H | H | H | —C(CH₃)₃ | 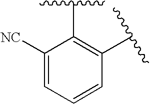 | 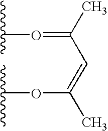 | 2 |
| 653 | H | H | H | H | H | —C(CH₃)₃ | 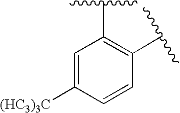 | 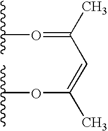 | 2 |
| 654 | H | H | H | H | H | —C(CH₃)₃ | 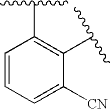 | 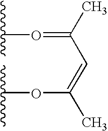 | 2 |
| 655 | H | H | H | H | H | —C(CH₃)₃ | 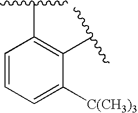 | 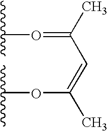 | 2 |
| 656 | H | H | H | H | H | —C(CH₃)₃ | 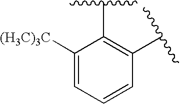 | 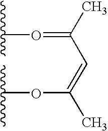 | 2 |
| 657 | H | H | H | H | H | —C(CH₃)₃ | 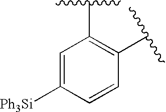 | 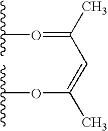 | 2 |
| 658 | H | H | H | H | H | —C(CH₃)₃ | 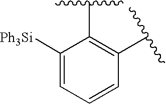 | 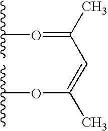 | 2 |
| 659 | H | H | H | H | H | —C(CH₃)₃ | 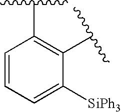 | 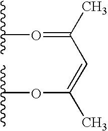 | 2 |
| 660 | H | H | H | H | H | —C(CH₃)₃ | 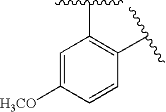 | 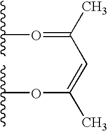 | 2 |
| 661 | H | H | H | H | H | —C(CH₃)₃ | 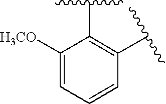 | 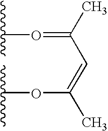 | 2 |
| 662 | H | H | H | H | H | —C(CH₃)₃ | 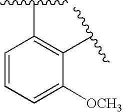 | 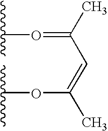 | 2 |
| 663 | H | H | H | H | H | —C(CH₃)₃ | 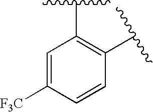 | 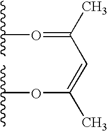 | 2 |
| 664 | H | H | H | H | H | —C(CH₃)₃ | 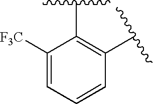 | 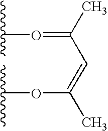 | 2 |
| 665 | H | H | H | H | H | —C(CH₃)₃ | 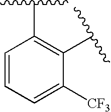 | 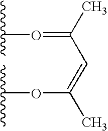 | 2 |
| 666 | H | H | H | H | H | —C(CH₃)₃ | 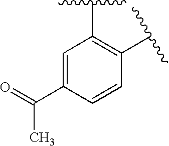 | 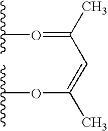 | 2 |
| 667 | H | H | H | H | H | —C(CH₃)₃ | 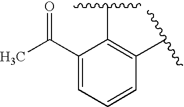 | 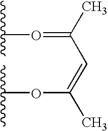 | 2 |
| 668 | H | H | H | H | H | —C(CH₃)₃ | 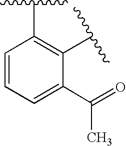 | 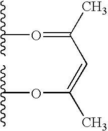 | 2 |
| 669 | H | H | H | H | H | —C(CH₃)₃ | 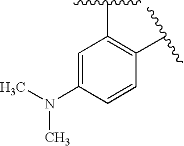 | 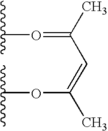 | 2 |
| 670 | H | H | H | H | H | —C(CH₃)₃ | 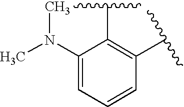 | 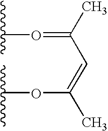 | 2 |
| 671 | H | H | H | H | H | —C(CH₃)₃ | 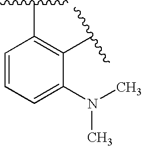 | 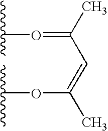 | 2 |
| 672 | H | H | H | H | H | —C(CH₃)₃ | 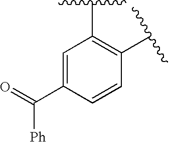 | 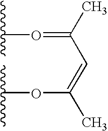 | 2 |
| 673 | H | H | H | H | H | —C(CH₃)₃ | 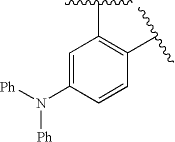 | 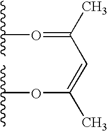 | 2 |
| 674 | H | H | H | H | H | —C(CH₃)₃ | 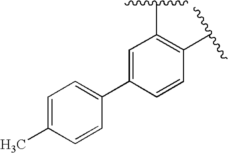 | 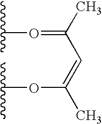 | 2 |
| 675 | H | H | H | H | H | —C(CH₃)₃ | 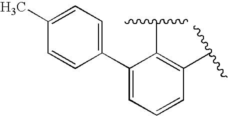 | 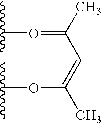 | 2 |
| 676 | H | H | H | H | H | —C(CH₃)₃ | 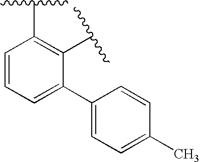 | 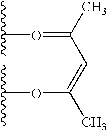 | 2 |
| 677 | H | H | H | H | H | —C(CH₃)₃ | 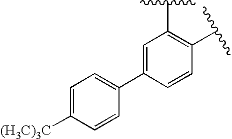 | 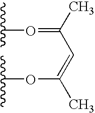 | 2 |
| 678 | H | H | H | H | H | —C(CH₃)₃ | 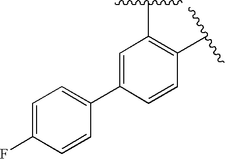 | 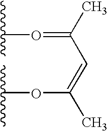 | 2 |
| 679 | H | H | H | H | H | —C(CH₃)₃ | 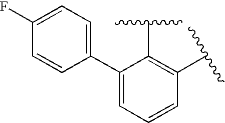 | 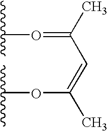 | 2 |
| 680 | H | H | H | H | H | —C(CH₃)₃ | 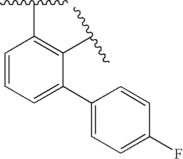 | 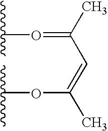 | 2 |
| 681 | H | H | H | H | H | —C(CH₃)₃ | 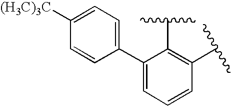 | 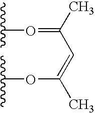 | 2 |
| 682 | H | H | H | H | H | —C(CH₃)₃ | 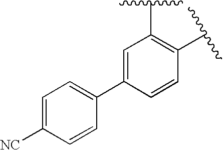 | 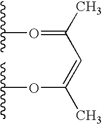 | 2 |
| 683 | H | H | H | H | H | —C(CH₃)₃ | 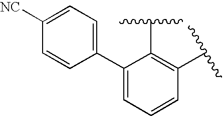 | 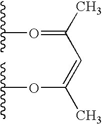 | 2 |
| 684 | H | H | H | H | H | —C(CH₃)₃ | 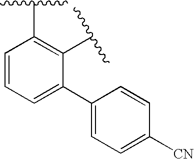 | 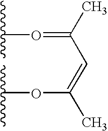 | 2 |
| 685 | H | H | H | H | H | —C(CH₃)₃ | 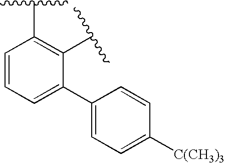 | 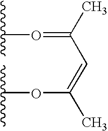 | 2 |
| 686 | H | H | H | H | H | —C(CH₃)₃ | 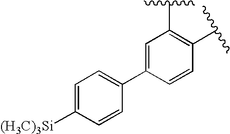 | 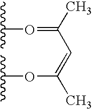 | 2 |
| 687 | H | H | H | H | H | —C(CH₃)₃ | 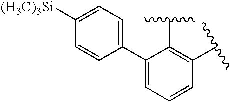 | 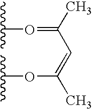 | 2 |
| 688 | H | H | H | H | H | —C(CH₃)₃ | 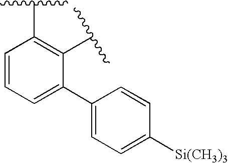 | 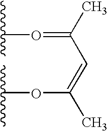 | 2 |
| 689 | H | H | H | H | H | —C(CH₃)₃ | 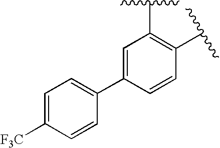 | 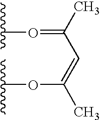 | 2 |
| 690 | H | H | H | H | H | —C(CH₃)₃ | 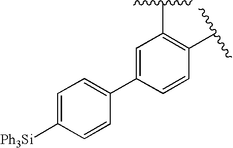 | 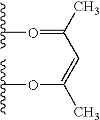 | 2 |
| 691 | H | H | H | H | H | —C(CH₃)₃ | 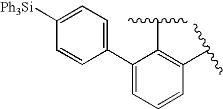 | 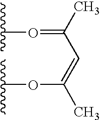 | 2 |
| 692 | H | H | H | H | H | —C(CH₃)₃ | 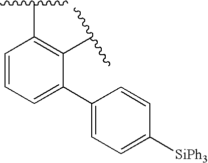 | 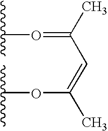 | 2 |
| 693 | H | H | H | H | H | —C(CH₃)₃ | 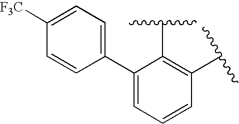 | 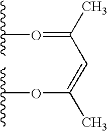 | 2 |
| 694 | H | H | H | H | H | —C(CH₃)₃ | 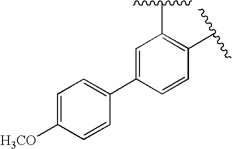 | 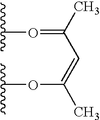 | 2 |
| 695 | H | H | H | H | H | —C(CH₃)₃ | 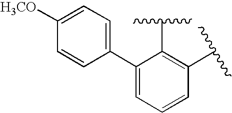 | 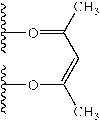 | 2 |
| 696 | H | H | H | H | H | —C(CH₃)₃ | 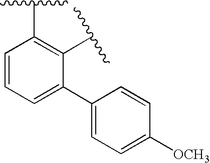 | 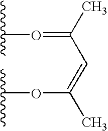 | 2 |
| 697 | H | H | H | H | H | —C(CH₃)₃ | 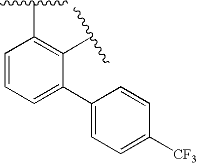 | 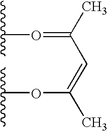 | 2 |
| 698 | H | H | H | H | H | —C(CH₃)₃ | 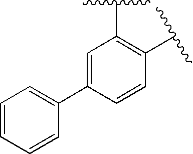 | 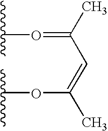 | 2 |
| 699 | H | H | H | H | H | —C(CH₃)₃ | 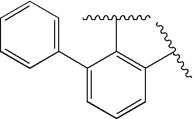 | 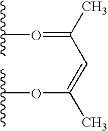 | 2 |
| 700 | H | H | H | H | H | —C(CH₃)₃ | 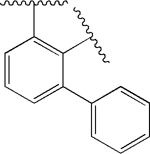 | 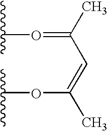 | 2 |
| 701 | H | H | H | H | H | —C(CH₃)₃ | 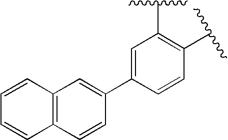 | 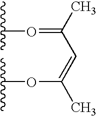 | 2 |
| 702 | H | H | H | H | H | —C(CH₃)₃ | 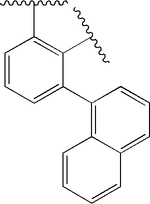 | 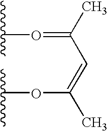 | 2 |
| 703 | H | H | H | H | H | —C(CH₃)₃ | 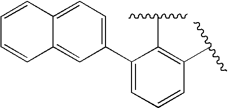 | 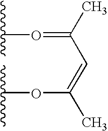 | 2 |
| 704 | H | H | H | H | H | —C(CH₃)₃ | 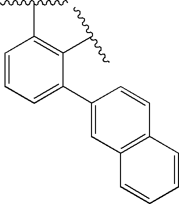 | 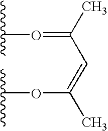 | 2 |
| 705 | H | H | H | H | H | —C(CH₃)₃ | 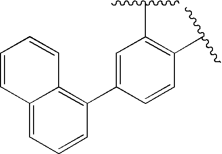 | 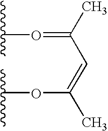 | 2 |
| 706 | H | H | H | H | H | —C(CH₃)₃ | 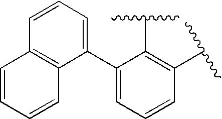 | 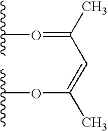 | 2 |
| 707 | H | H | H | H | H | —C(CH₃)₃ | 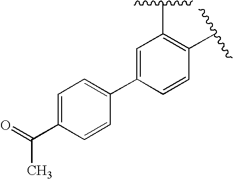 | 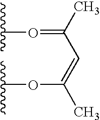 | 2 |
| 708 | H | H | H | H | H | —C(CH₃)₃ | 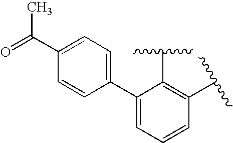 | 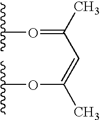 | 2 |
| 709 | H | H | H | H | H | —C(CH₃)₃ | 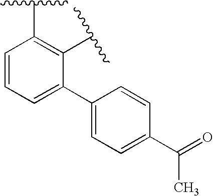 | 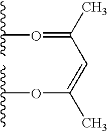 | 2 |
| 710 | H | H | H | H | H | —C(CH₃)₃ | 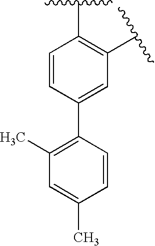 | 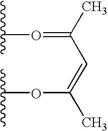 | 2 |
| 711 | H | H | H | H | H | —C(CH₃)₃ | 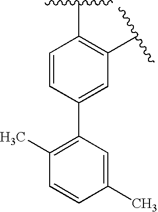 | 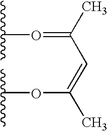 | 2 |
| 712 | H | H | H | H | H | —C(CH₃)₃ | 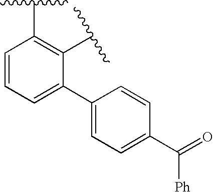 | 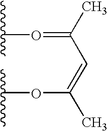 | 2 |
| 713 | H | H | H | H | H | —C(CH₃)₃ | 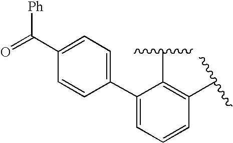 | 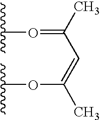 | 2 |
| 714 | H | H | H | H | H | —C(CH₃)₃ | 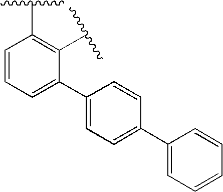 | 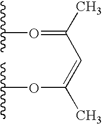 | 2 |
| 715 | H | H | H | H | H | —C(CH₃)₃ | 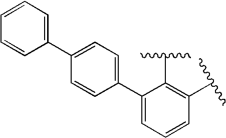 | 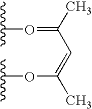 | 2 |
| 716 | H | H | H | H | H | —C(CH₃)₃ | 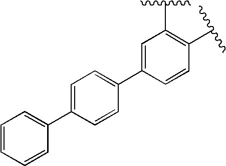 | 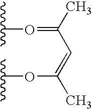 | 2 |
| 717 | H | H | H | H | H | —C(CH₃)₃ | 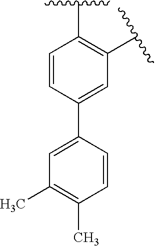 | 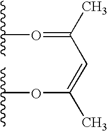 | 2 |
| 718 | H | H | H | H | H | —C(CH₃)₃ | 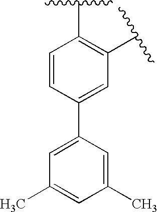 | 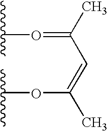 | 2 |
| 719 | H | H | H | H | H | —C(CH₃)₃ | 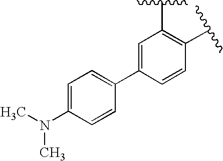 | 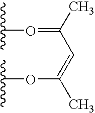 | 2 |
| 720 | H | H | H | H | H | —C(CH₃)₃ | 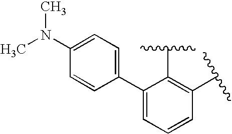 | 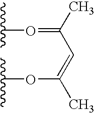 | 2 |
| 721 | H | H | H | H | H | —C(CH₃)₃ | 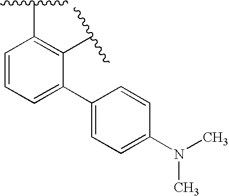 | 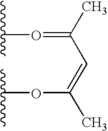 | 2 |
| 722 | H | H | H | H | H | —C(CH₃)₃ | 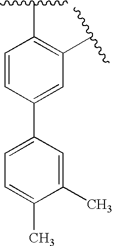 | 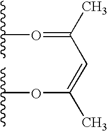 | 2 |
| 723 | H | H | H | H | H | —C(CH₃)₃ | 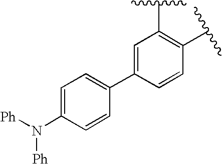 | 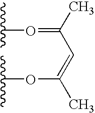 | 2 |
| 724 | H | H | H | H | H | —C(CH₃)₃ | 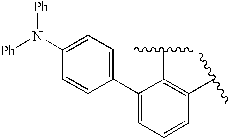 | 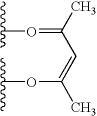 | 2 |
| 725 | H | H | H | H | H | —C(CH₃)₃ | 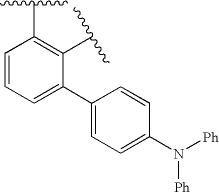 | 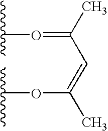 | 2 |
| 726 | H | H | H | H | H | —C(CH₃)₃ | 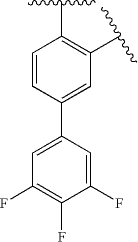 | 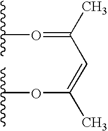 | 2 |
| 727 | H | H | H | H | H | —C(CH₃)₃ | 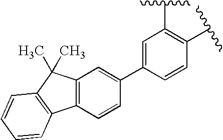 | 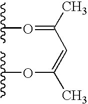 | 2 |
| 728 | H | H | H | H | H | —C(CH₃)₃ | 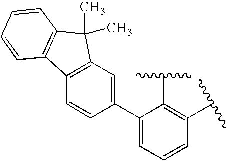 | 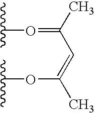 | 2 |
| 729 | H | H | H | H | H | —C(CH₃)₃ | 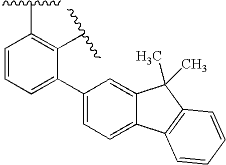 | 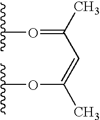 | 2 |
| 730 | H | H | H | H | H | —C(CH₃)₃ | 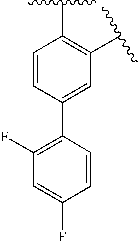 | 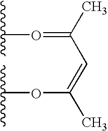 | 2 |
| 731 | H | H | H | H | H | —C(CH₃)₃ | 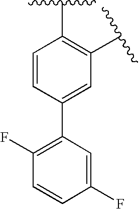 | 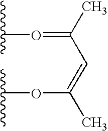 | 2 |
| 732 | H | H | H | H | H | —C(CH₃)₃ | 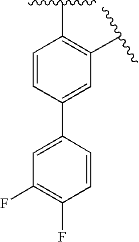 | 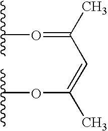 | 2 |
| 733 | H | H | H | H | H | —C(CH₃)₃ | 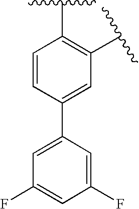 | 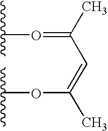 | 2 |
| 734 | H | H | H | H | H | —C(CH₃)₃ | 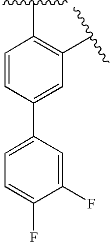 | 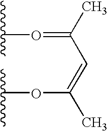 | 2 |
| 735 | H | H | H | H | H | —C(CH₃)₃ | 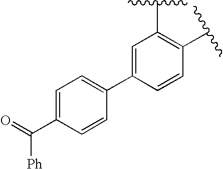 | 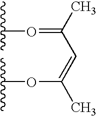 | 2 |
| 736 | H | H | H | H | H | —C(CH₃)₃ | 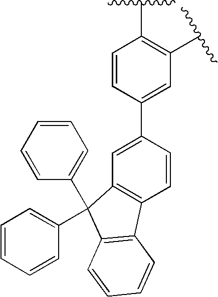 | 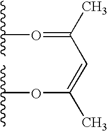 | 2 |
| 737 | H | H | H | H | H | —C(CH₃)₃ | 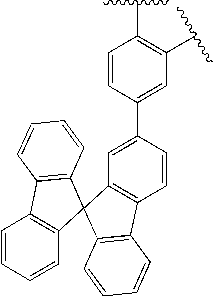 | 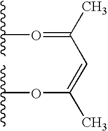 | 2 |
| 738 | H | H | H | H | H | —C(CH₃)₃ | 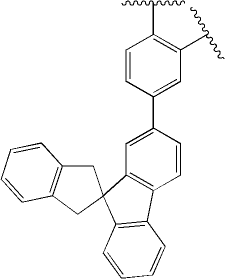 | 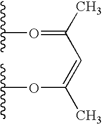 | 2 |
| 739 | H | H | H | H | H | —C(CH₃)₃ | 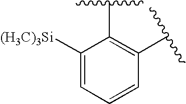 | 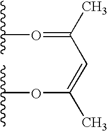 | 2 |
| 740 | H | H | H | H | H | —C(CH₃)₃ | 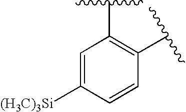 | 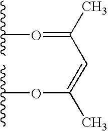 | 2 |
| 741 | H | H | H | H | H | —C(CH₃)₃ | 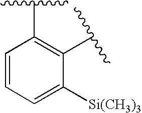 | 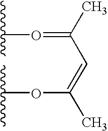 | 2 |
| 742 | H | H | H | H | H | —C(CH₃)₃ | 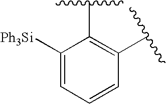 | 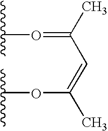 | 2 |
| 743 | H | H | H | H | H | —C(CH₃)₃ | 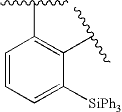 | 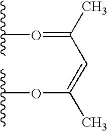 | 2 |
| 744 | H | H | H | H | H | —C(CH₃)₃ | 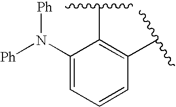 | 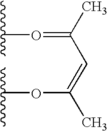 | 2 |
| 745 | H | H | H | H | H | —C(CH₃)₃ | 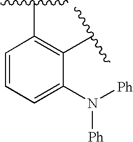 | 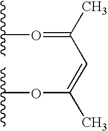 | 2 |
| 746 | H | H | H | H | H | —C(CH₃)₃ | 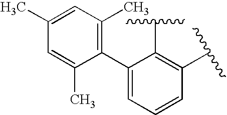 | 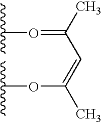 | 2 |
| 747 | H | H | H | H | H | —C(CH₃)₃ | 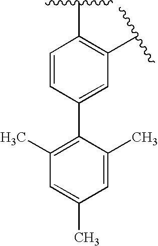 | 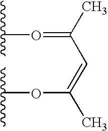 | 2 |
| 748 | H | H | H | H | H | —C(CH₃)₃ | 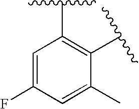 | 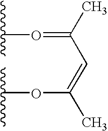 | 2 |
| 749 | H | H | H | H | H | —C(CH₃)₃ | 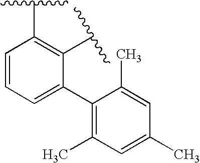 | 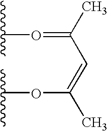 | 2 |
| 750 | H | H | H | H | H | —C(CH₃)₃ | 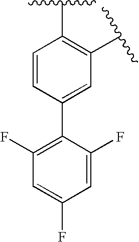 | 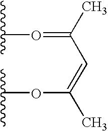 | 2 |
| 751 | H | H | H | H | H | —C(CH₃)₃ | 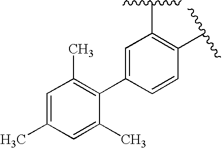 | 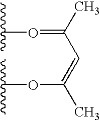 | 2 |
| 752 | H | H | H | H | H | —C(CH₃)₃ | 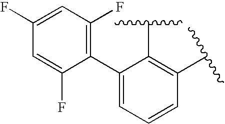 | 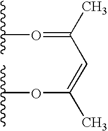 | 2 |
| 753 | H | H | H | H | H | —C(CH₃)₃ | 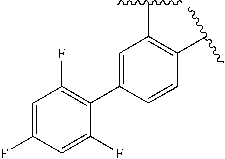 | 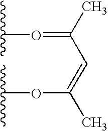 | 2 |
| 754 | H | H | H | H | H | —C(CH₃)₃ | 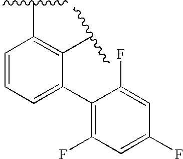 | 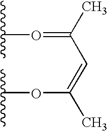 | 2 |
| 755 | H | H | H | H | H | —C(CH₃)₃ | 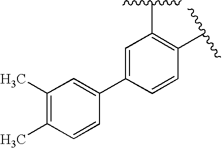 | 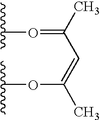 | 2 |
| 756 | H | H | H | H | H | —C(CH₃)₃ | 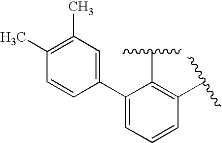 | 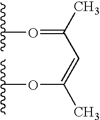 | 2 |
| 757 | H | H | H | H | H | —C(CH₃)₃ | 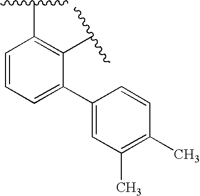 | 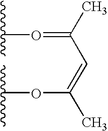 | 2 |
| 758 | H | H | H | H | H | —C(CH₃)₃ | 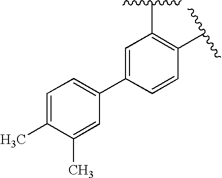 | 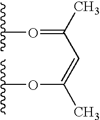 | 2 |
| 759 | H | H | H | H | H | —C(CH₃)₃ | 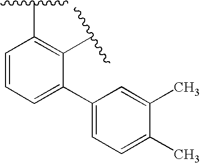 | 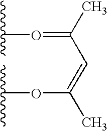 | 2 |
| 760 | H | H | H | H | H | —C(CH₃)₃ | 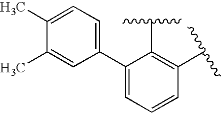 | 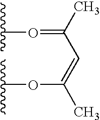 | 2 |
| 761 | H | H | H | H | H | —C(CH₃)₃ | 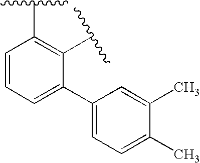 | 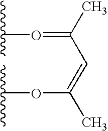 | 2 |
| 762 | H | H | H | H | H | —C(CH₃)₃ | 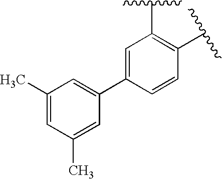 | 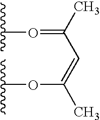 | 2 |
| 763 | H | H | H | H | H | —C(CH₃)₃ | 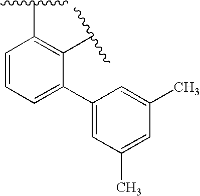 | 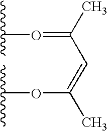 | 2 |
| 764 | H | H | H | H | H | —C(CH₃)₃ | 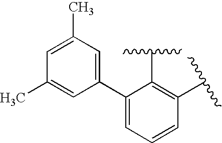 | 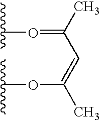 | 2 |
| 765 | H | H | H | H | H | —C(CH₃)₃ | 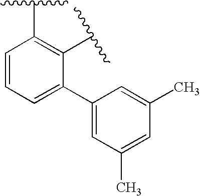 | 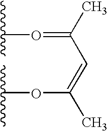 | 2 |
| 766 | H | H | H | H | H | —C(CH₃)₃ | 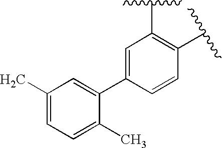 | 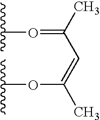 | 2 |
| 767 | H | H | H | H | H | —C(CH₃)₃ | 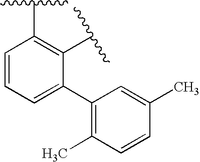 | 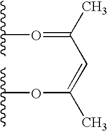 | 2 |
| 768 | H | H | H | H | H | —C(CH₃)₃ | 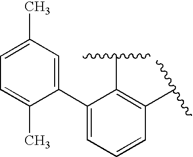 | 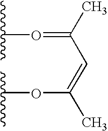 | 2 |
| 769 | H | H | H | H | H | —C(CH₃)₃ | 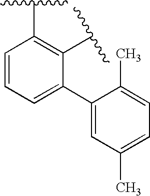 | 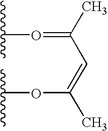 | 2 |
| 770 | H | H | H | H | H | —C(CH₃)₃ | 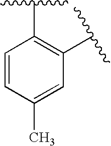 | 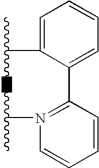 | 2 |
| 771 | H | H | H | H | H | —C(CH₃)₃ | 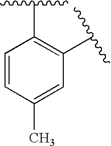 | 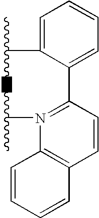 | 2 |
| 772 | H | H | H | H | H | —C(CH₃)₃ | 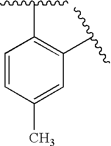 | 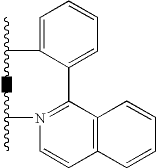 | 2 |
| 773 | H | H | H | H | H | —C(CH₃)₃ | 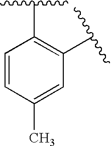 | 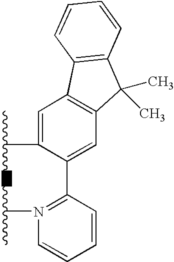 | 2 |
| 774 | H | H | H | H | H | —C(CH₃)₃ | 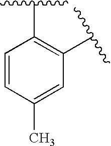 | 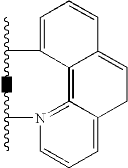 | 2 |
| 775 | H | H | H | H | H | —C(CH₃)₃ | 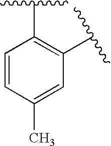 | 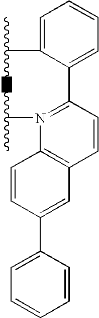 | 2 |
| 776 | H | H | H | H | H | —C(CH₃)₃ | 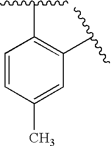 | 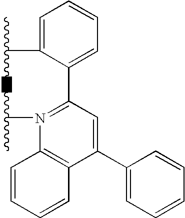 | 2 |
| 777 | H | H | H | H | H | —C(CH₃)₃ | 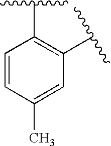 | 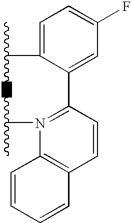 | 2 |
| 778 | H | H | H | H | H | —C(CH₃)₃ | 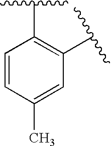 | 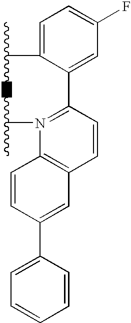 | 2 |
| 779 | H | H | H | H | H | —C(CH₃)₃ | 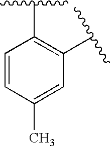 | 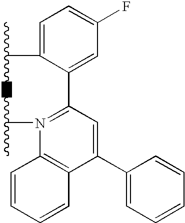 | 2 |
| 780 | H | H | H | H | H | —C(CH₃)₃ | 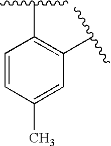 | 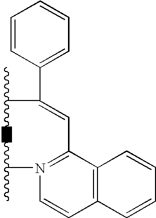 | 2 |
| 781 | H | H | H | H | H | —C(CH₃)₃ | 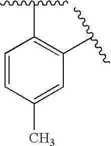 | 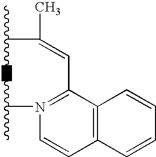 | 2 |
| 782 | H | H | H | H | H | —C(CH₃)₃ | 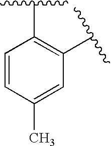 | 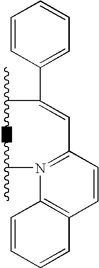 | 2 |
| 783 | H | H | H | H | H | —C(CH₃)₃ | 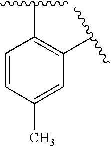 | 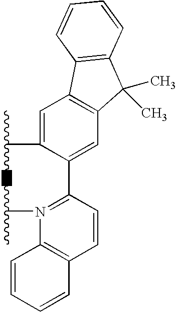 | 2 |
| 784 | H | H | H | H | H | —C(CH₃)₃ | 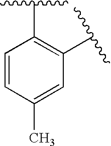 | 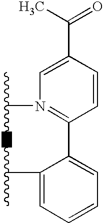 | 2 |
| 785 | H | H | H | H | H | —C(CH₃)₃ | 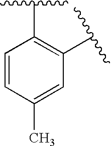 | 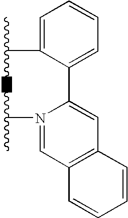 | 2 |
| 786 | H | H | H | H | H | —C(CH₃)₃ | 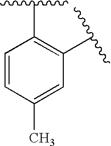 | 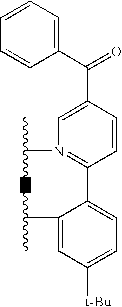 | 2 |
| 787 | H | H | H | H | H | —C(CH₃)₃ | 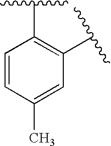 | 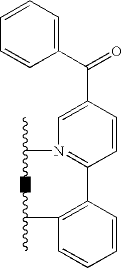 | 2 |
| 788 | H | H | H | H | H | —C(CH₃)₃ | 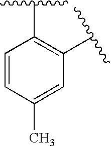 | 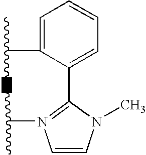 | 2 |
| 789 | H | H | H | H | H | —C(CH₃)₃ | 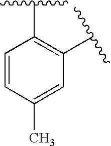 | 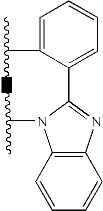 | 2 |
| 790 | H | H | H | H | H | —C(CH₃)₃ | 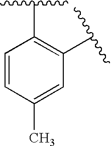 | 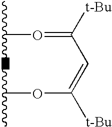 | 2 |
| 791 | H | H | H | H | H | —C(CH₃)₃ | 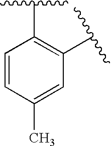 | 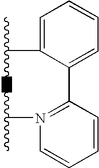 | 1 |
| 792 | H | H | H | H | H | —C(CH₃)₃ | 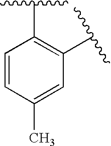 | — | 3 |
| 793 | H | H | H | H | H | 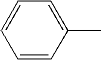 | 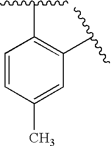 | 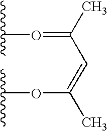 | 2 |
| 794 | H | H | H | H | H | 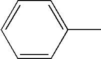 | 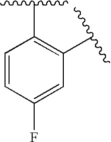 | 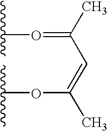 | 2 |
| 795 | H | H | H | H | H | 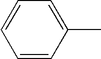 | 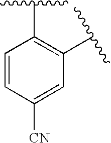 | 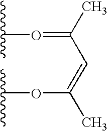 | 2 |
| 796 | H | H | H | H | H | 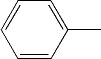 | 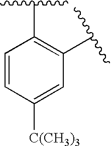 | 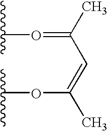 | 2 |
| 797 | H | H | H | H | H | 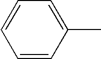 | 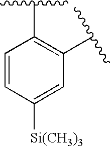 | 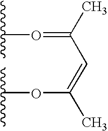 | 2 |
| 798 | H | H | H | H | H | 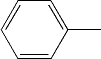 | 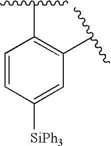 | 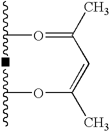 | 2 |
| 799 | H | H | H | H | H | 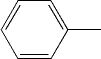 | 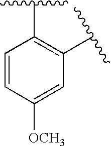 | 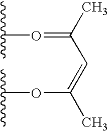 | 2 |
| 800 | H | H | H | H | H | 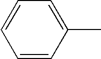 | 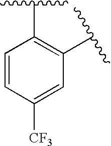 | 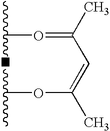 | 2 |
| 801 | H | H | H | H | H | 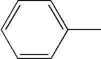 | 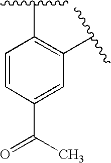 | 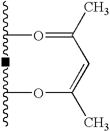 | 2 |
| 802 | H | H | H | H | H | 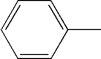 | 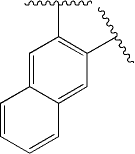 | 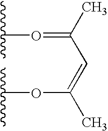 | 2 |

| | | | | | | | | | |
|---|---|---|---|---|---|---|---|---|---|
| 803 | H | H | H | H | H | 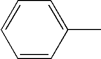 | 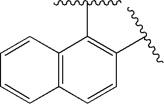 | 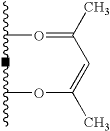 | 2 |
| 804 | H | H | H | H | H | 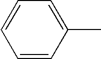 | 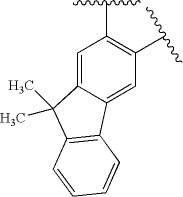 | 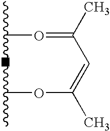 | 2 |
| 805 | H | H | H | H | H | 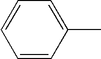 | 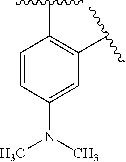 | 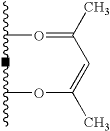 | 2 |
| 806 | H | H | H | H | H | 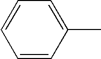 | 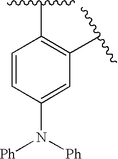 | 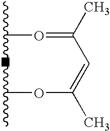 | 2 |
| 807 | H | H | H | H | H | 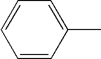 | 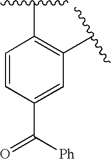 | 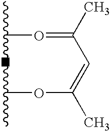 | 2 |
| 808 | H | H | H | H | H | 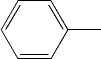 | 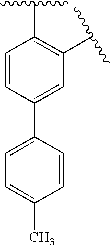 | 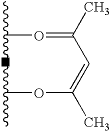 | 2 |
| 809 | H | H | H | H | H | 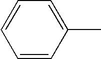 | 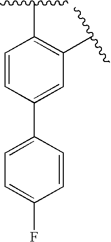 | 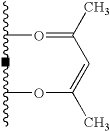 | 2 |
| 810 | H | H | H | H | H | 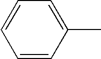 | 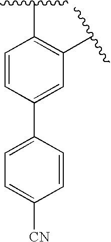 | 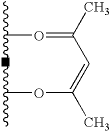 | 2 |
| 811 | H | H | H | H | H | 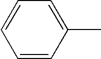 | 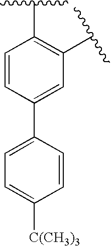 | 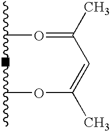 | 2 |
| 812 | H | H | H | H | H | 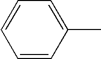 | 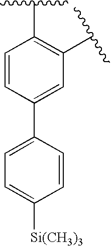 | 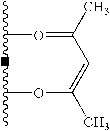 | 2 |
| 813 | H | H | H | H | H | 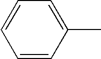 | 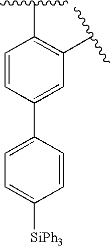 | 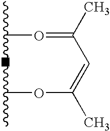 | 2 |
| 814 | H | H | H | H | H | 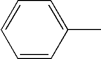 | 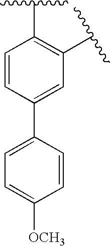 | 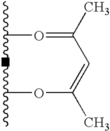 | 2 |
| 815 | H | H | H | H | H | 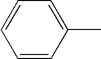 | 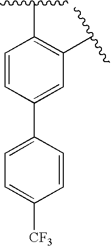 | 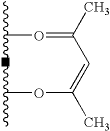 | 2 |
| 816 | H | H | H | H | H | 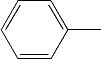 | 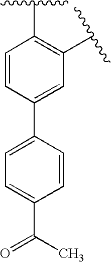 | 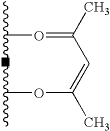 | 2 |
| 817 | H | H | H | H | H | 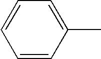 | 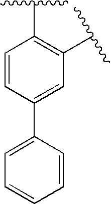 | 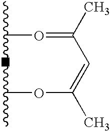 | 2 |
| 818 | H | H | H | H | H | 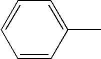 | 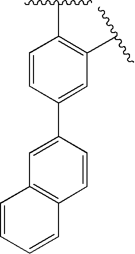 | 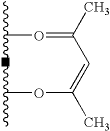 | 2 |
| 819 | H | H | H | H | H | 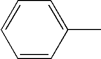 | 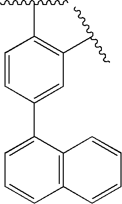 | 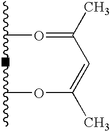 | 2 |
| 820 | H | H | H | H | H | 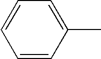 | 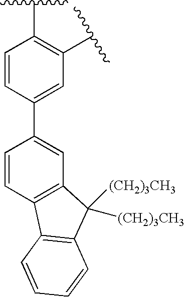 | 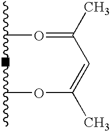 | 2 |
| 821 | H | H | H | H | H | 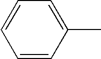 | 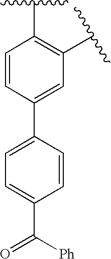 | 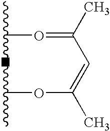 | 2 |
| 822 | H | H | H | H | H | 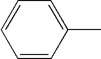 | 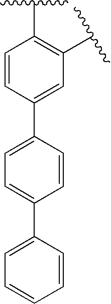 | 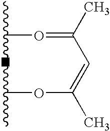 | 2 |
| 823 | H | H | H | H | H | 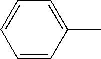 | 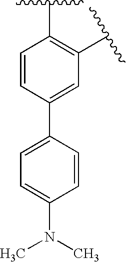 | 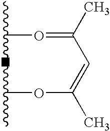 | 2 |
| 824 | H | H | H | H | H | 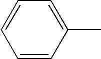 | 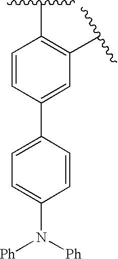 | 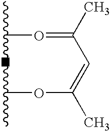 | 2 |
| 825 | H | H | H | H | H | 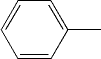 | 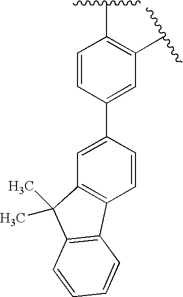 | 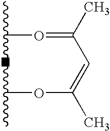 | 2 |
| 826 | H | H | H | H | H | 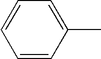 | 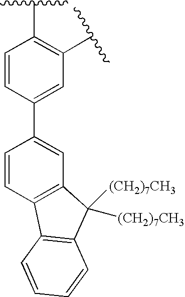 | 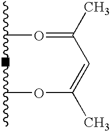 | 2 |
| 827 | H | H | H | H | H | 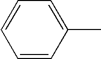 | 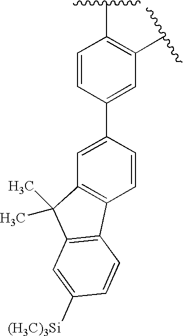 | 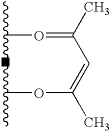 | 2 |
| 828 | H | H | H | H | H | 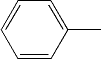 | 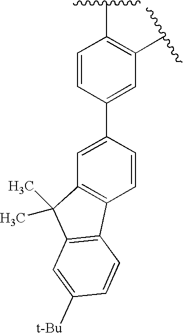 | 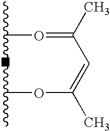 | 2 |
| 829 | H | H | H | H | H | 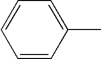 | 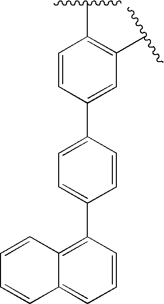 | 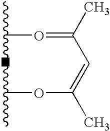 | 2 |
| 830 | H | H | H | H | H | 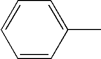 | 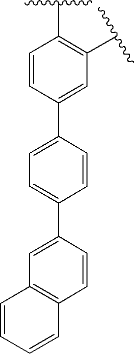 | 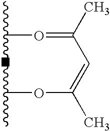 | 2 |
| 831 | H | H | H | H | H | 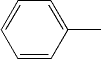 | 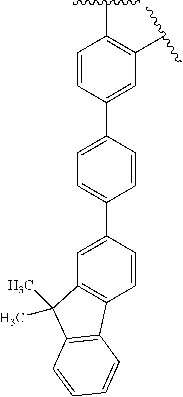 | 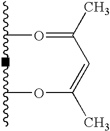 | 2 |
| 832 | H | H | H | H | H | 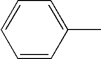 | 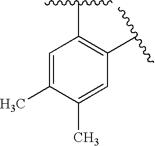 | 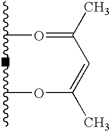 | 2 |
| 833 | H | H | H | H | H | 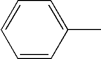 | 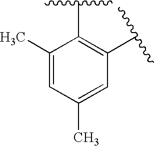 | 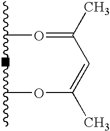 | 2 |
| 834 | H | H | H | H | H | 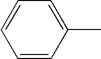 | 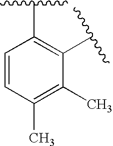 | 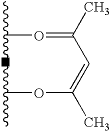 | 2 |
| 835 | H | H | H | H | H | 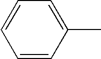 | 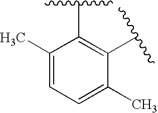 | 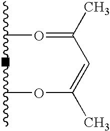 | 2 |
| 836 | H | H | H | H | H | 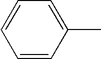 | 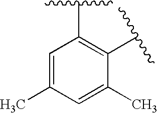 | 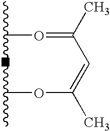 | 2 |
| 837 | H | H | H | H | H | 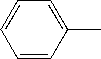 | 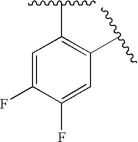 | 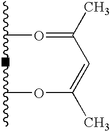 | 2 |
| 838 | H | H | H | H | H | 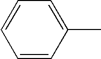 | 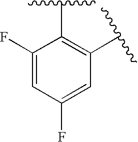 | 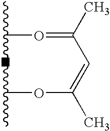 | 2 |
| 839 | H | H | H | H | H | 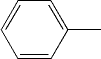 | 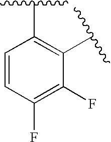 | 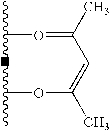 | 2 |
| 840 | H | H | H | H | H | 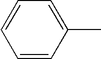 | 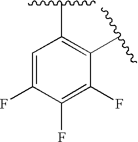 | 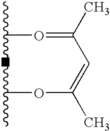 | 2 |
| 841 | H | H | H | H | H | 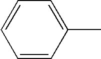 | 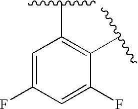 | 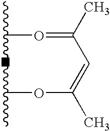 | 2 |
| 842 | H | H | H | H | H | 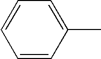 | 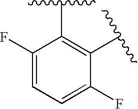 | 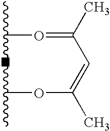 | 2 |
| 843 | H | H | H | H | H | 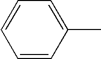 | 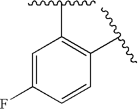 | 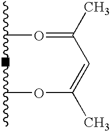 | 2 |
| 844 | H | H | H | H | H | 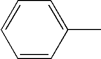 | 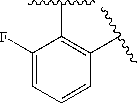 | 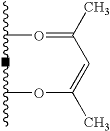 | 2 |
| 845 | H | H | H | H | H | 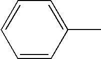 | 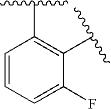 | 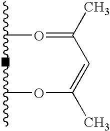 | 2 |
| 846 | H | H | H | H | H | 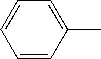 | 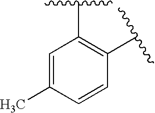 | 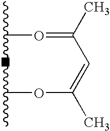 | 2 |
| 847 | H | H | H | H | H | 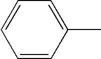 | 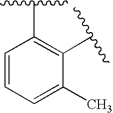 | 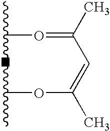 | 2 |
| 848 | H | H | H | H | H | 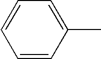 | 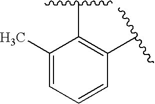 | 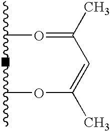 | 2 |
| 849 | H | H | H | H | H | 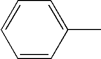 | 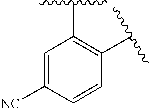 | 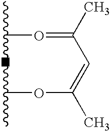 | 2 |
| 850 | H | H | H | H | H | 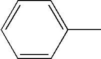 | 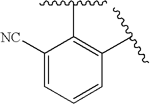 | 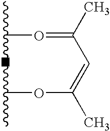 | 2 |
| 851 | H | H | H | H | H | 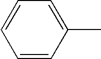 | 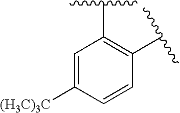 | 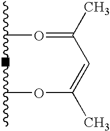 | 2 |
| 852 | H | H | H | H | H | 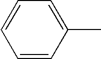 | 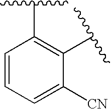 | 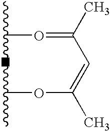 | 2 |
| 853 | H | H | H | H | H | 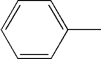 | 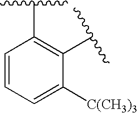 | 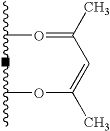 | 2 |
| 854 | H | H | H | H | H | 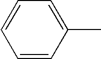 | 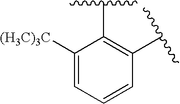 | 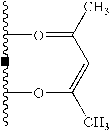 | 2 |
| 855 | H | H | H | H | H | 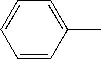 | 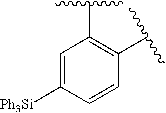 | 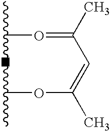 | 2 |
| 856 | H | H | H | H | H | 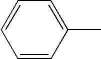 | 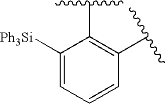 | 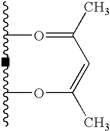 | 2 |
| 857 | H | H | H | H | H | 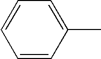 | 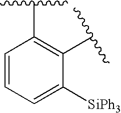 | 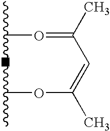 | 2 |
| 858 | H | H | H | H | H | 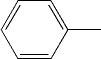 | 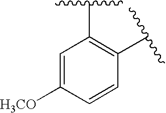 | 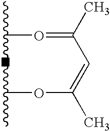 | 2 |
| 859 | H | H | H | H | H | 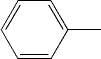 | 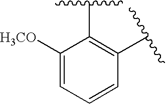 | 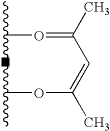 | 2 |
| 860 | H | H | H | H | H | 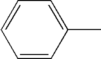 | 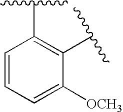 | 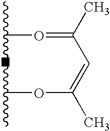 | 2 |
| 861 | H | H | H | H | H | 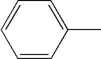 | 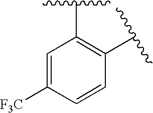 | 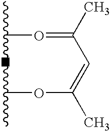 | 2 |
| 862 | H | H | H | H | H | 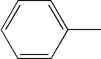 | 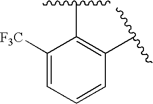 | 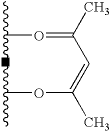 | 2 |
| 863 | H | H | H | H | H | 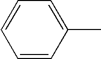 | 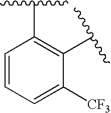 | 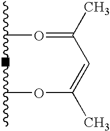 | 2 |
| 864 | H | H | H | H | H | 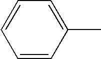 | 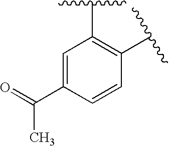 | 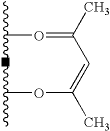 | 2 |
| 865 | H | H | H | H | H | 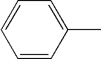 | 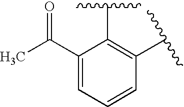 | 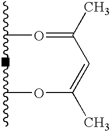 | 2 |
| 866 | H | H | H | H | H | 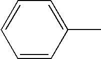 | 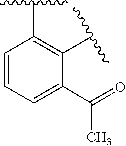 | 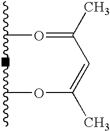 | 2 |
| 867 | H | H | H | H | H | 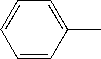 | 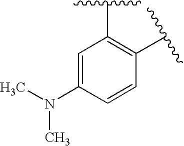 | 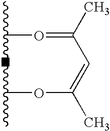 | 2 |
| 868 | H | H | H | H | H | 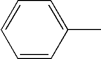 | 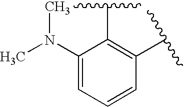 | 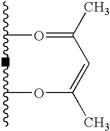 | 2 |
| 869 | H | H | H | H | H | 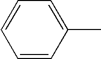 | 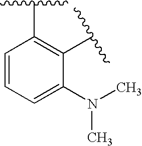 | 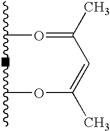 | 2 |
| 870 | H | H | H | H | H | 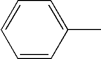 | 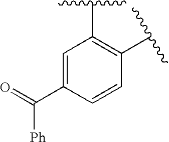 | 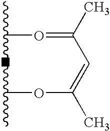 | 2 |
| 871 | H | H | H | H | H | 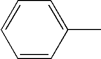 | 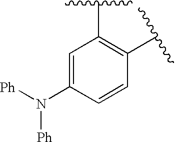 | 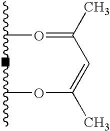 | 2 |
| 872 | H | H | H | H | H | 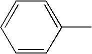 | 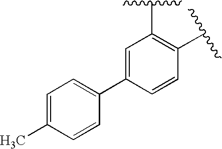 | 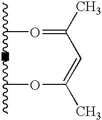 | 2 |
| 873 | H | H | H | H | H | 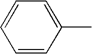 | 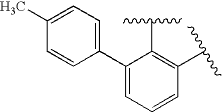 | 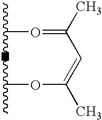 | 2 |
| 874 | H | H | H | H | H | 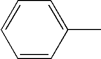 | 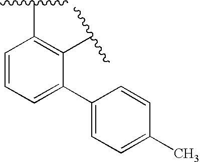 | 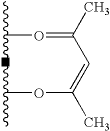 | 2 |
| 875 | H | H | H | H | H | 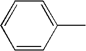 | 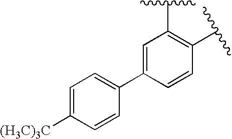 | 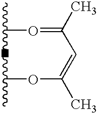 | 2 |
| 876 | H | H | H | H | H | 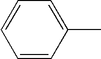 | 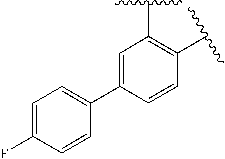 | 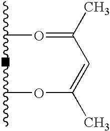 | 2 |
| 877 | H | H | H | H | H | 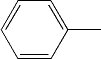 | 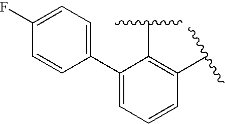 | 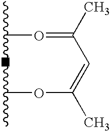 | 2 |
| 878 | H | H | H | H | H | 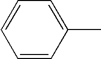 | 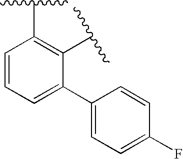 | 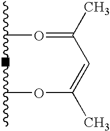 | 2 |
| 879 | H | H | H | H | H | 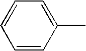 | 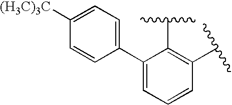 | 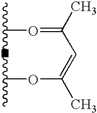 | 2 |
| 880 | H | H | H | H | H | 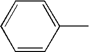 | 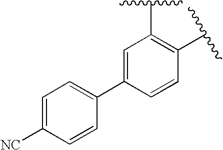 | 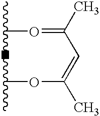 | 2 |
| 881 | H | H | H | H | H | 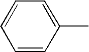 | 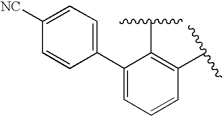 | 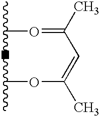 | 2 |
| 882 | H | H | H | H | H | 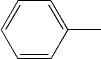 | 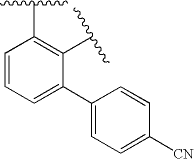 | 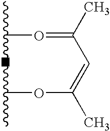 | 2 |
| 883 | H | H | H | H | H | 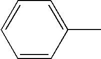 | 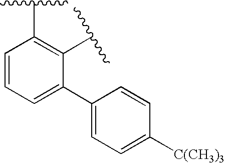 | 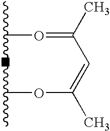 | 2 |
| 884 | H | H | H | H | H | 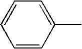 | 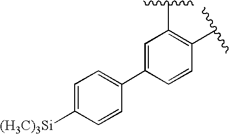 | 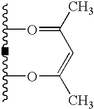 | 2 |
| 885 | H | H | H | H | H | 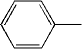 | 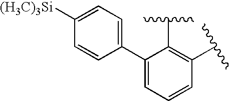 | 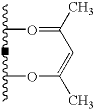 | 2 |
| 886 | H | H | H | H | H | 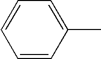 | 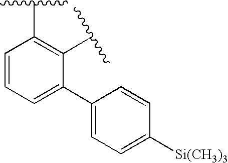 | 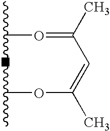 | 2 |
| 887 | H | H | H | H | H | 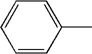 | 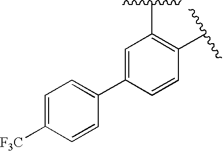 | 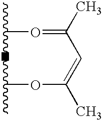 | 2 |
| 888 | H | H | H | H | H | 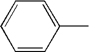 | 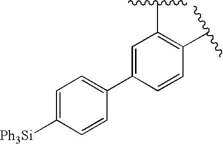 | 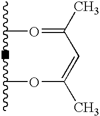 | 2 |
| 889 | H | H | H | H | H | 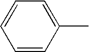 | 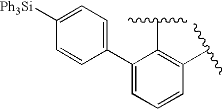 | 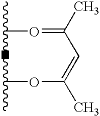 | 2 |
| 890 | H | H | H | H | H | 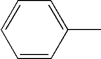 | 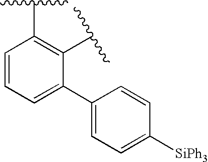 | 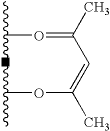 | 2 |
| 891 | H | H | H | H | H | 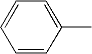 | 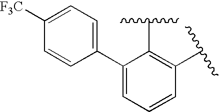 | 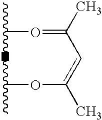 | 2 |
| 892 | H | H | H | H | H | 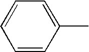 | 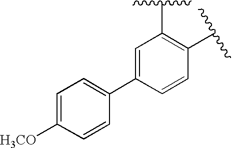 | 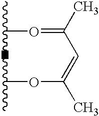 | 2 |
| 893 | H | H | H | H | H | 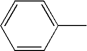 | 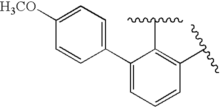 | 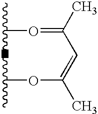 | 2 |
| 894 | H | H | H | H | H | 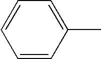 | 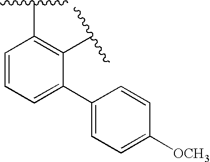 | 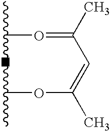 | 2 |
| 895 | H | H | H | H | H | 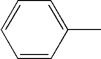 | 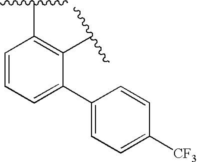 | 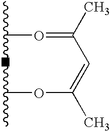 | 2 |
| 896 | H | H | H | H | H | 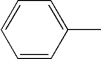 | 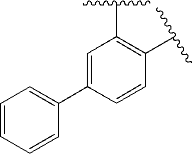 | 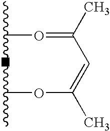 | 2 |
| 897 | H | H | H | H | H | 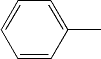 | 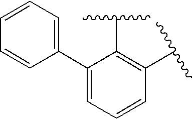 | 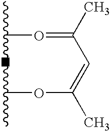 | 2 |
| 898 | H | H | H | H | H | 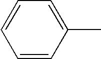 | 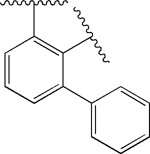 | 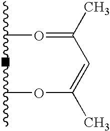 | 2 |
| 899 | H | H | H | H | H | 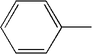 | 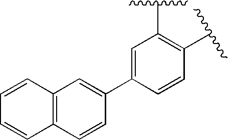 | 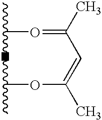 | 2 |
| 900 | H | H | H | H | H | 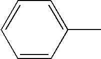 | 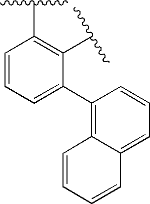 | 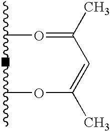 | 2 |
| 901 | H | H | H | H | H | 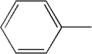 | 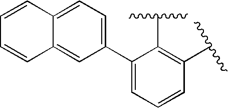 | 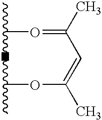 | 2 |
| 902 | H | H | H | H | H | 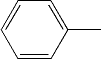 | 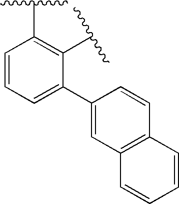 | 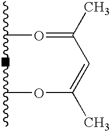 | 2 |
| 903 | H | H | H | H | H | 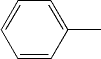 | 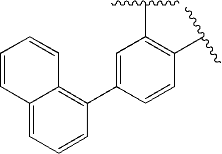 | 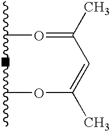 | 2 |
| 904 | H | H | H | H | H | 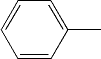 | 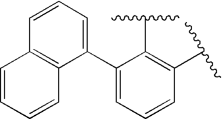 | 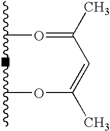 | 2 |
| 905 | H | H | H | H | H | 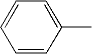 | 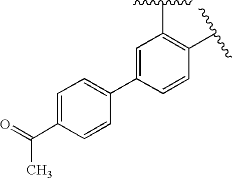 | 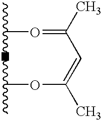 | 2 |
| 906 | H | H | H | H | H | 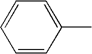 | 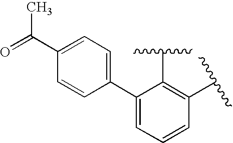 | 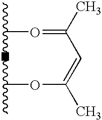 | 2 |
| 907 | H | H | H | H | H | 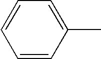 | 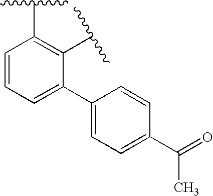 | 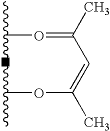 | 2 |
| 908 | H | H | H | H | H | 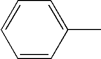 | 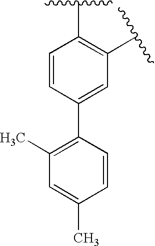 | 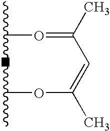 | 2 |
| 909 | H | H | H | H | H | 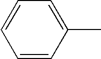 | 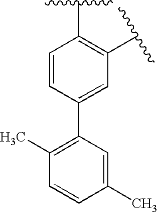 | 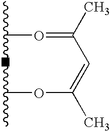 | 2 |
| 910 | H | H | H | H | H | 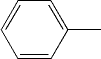 | 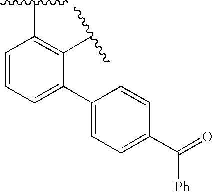 | 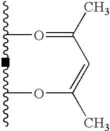 | 2 |
| 911 | H | H | H | H | H | 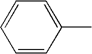 | 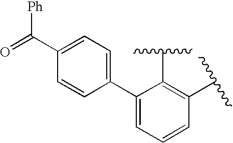 | 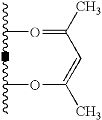 | 2 |
| 912 | H | H | H | H | H | 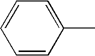 | 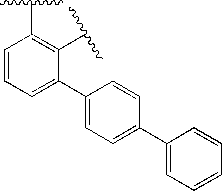 | 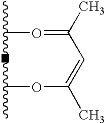 | 2 |
| 913 | H | H | H | H | H | 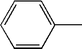 | 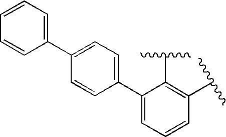 | 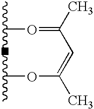 | 2 |
| 914 | H | H | H | H | H | 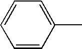 | 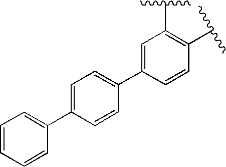 | 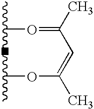 | 2 |
| 915 | H | H | H | H | H | 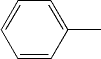 | 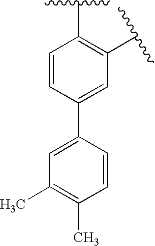 | 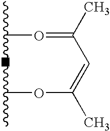 | 2 |
| 916 | H | H | H | H | H | 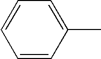 | 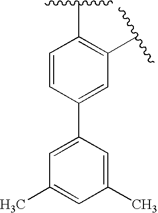 | 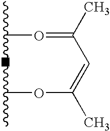 | 2 |
| 917 | H | H | H | H | H | 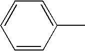 | 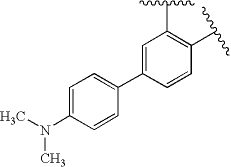 | 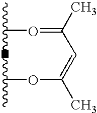 | 2 |
| 918 | H | H | H | H | H | 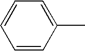 | 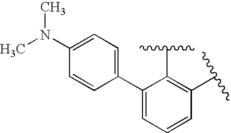 | 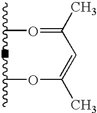 | 2 |
| 919 | H | H | H | H | H | 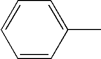 | 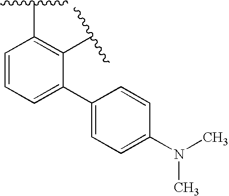 | 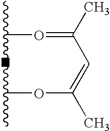 | 2 |
| 920 | H | H | H | H | H | 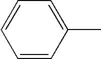 | 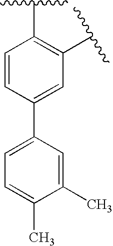 | 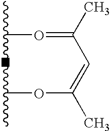 | 2 |
| 921 | H | H | H | H | H | 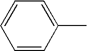 | 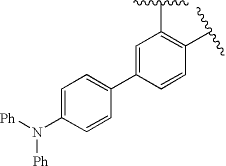 | 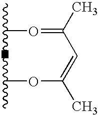 | 2 |
| 922 | H | H | H | H | H | 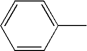 | 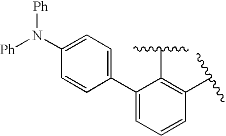 | 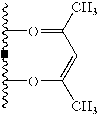 | 2 |
| 923 | H | H | H | H | H | 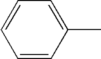 | 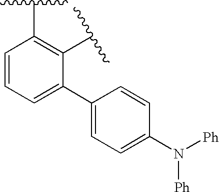 | 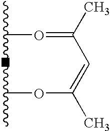 | 2 |
| 924 | H | H | H | H | H | 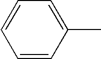 | 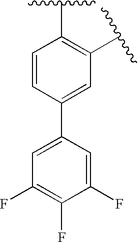 | 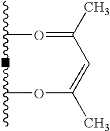 | 2 |
| 925 | H | H | H | H | H | 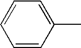 | 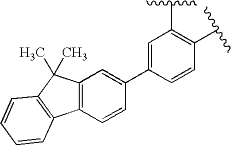 | 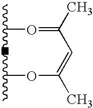 | 2 |
| 926 | H | H | H | H | H | 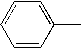 | 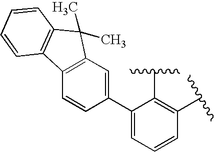 | 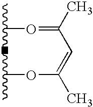 | 2 |
| 927 | H | H | H | H | H | 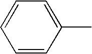 | 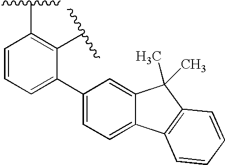 | 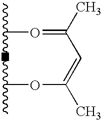 | 2 |
| 928 | H | H | H | H | H | 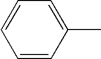 | 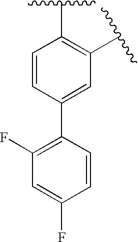 | 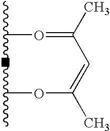 | 2 |
| 929 | H | H | H | H | H | 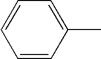 | 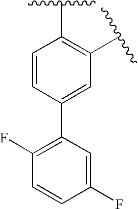 | 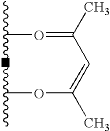 | 2 |
| 930 | H | H | H | H | H | 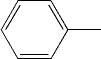 | 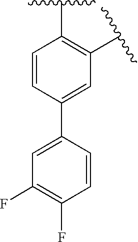 | 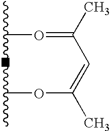 | 2 |
| 931 | H | H | H | H | H | 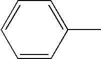 | 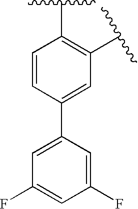 | 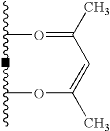 | 2 |
| 932 | H | H | H | H | H | 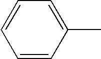 | 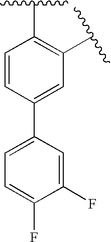 | 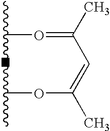 | 2 |
| 933 | H | H | H | H | H | 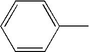 | 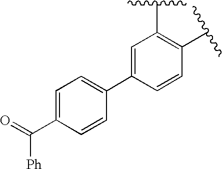 | 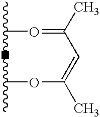 | 2 |
| 934 | H | H | H | H | H | 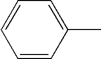 | 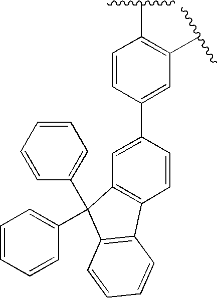 | 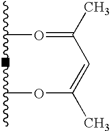 | 2 |
| 935 | H | H | H | H | H | 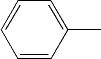 | 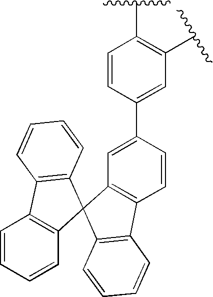 | 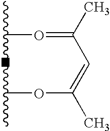 | 2 |
| 936 | H | H | H | H | H | 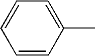 | 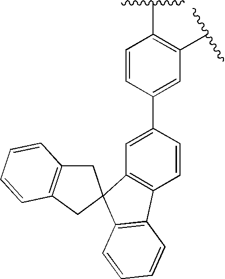 | 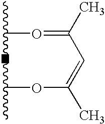 | 2 |
| 937 | H | H | H | H | H | 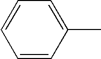 | 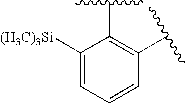 | 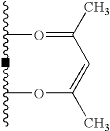 | 2 |
| 938 | H | H | H | H | H | 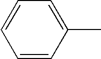 | 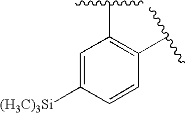 | 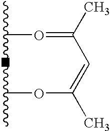 | 2 |
| 939 | H | H | H | H | H | 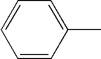 | 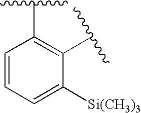 | 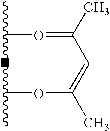 | 2 |
| 940 | H | H | H | H | H | 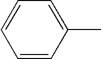 | 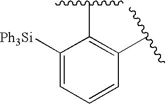 | 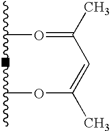 | 2 |
| 941 | H | H | H | H | H | 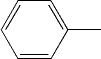 | 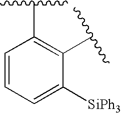 | 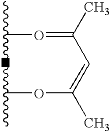 | 2 |
| 942 | H | H | H | H | H | 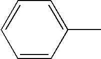 | 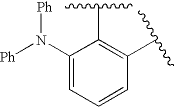 | 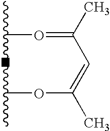 | 2 |
| 943 | H | H | H | H | H | 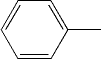 | 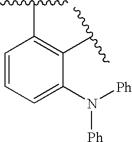 | 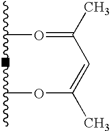 | 2 |
| 944 | H | H | H | H | H | 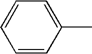 | 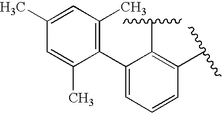 | 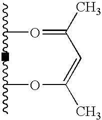 | 2 |
| 945 | H | H | H | H | H | 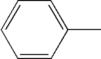 | 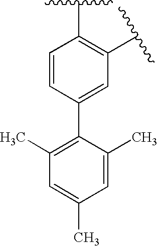 | 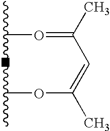 | 2 |
| 946 | H | H | H | H | H | 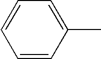 | 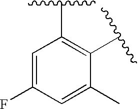 | 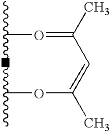 | 2 |
| 947 | H | H | H | H | H | 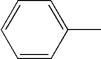 | 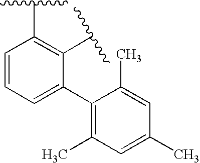 | 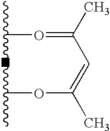 | 2 |
| 948 | H | H | H | H | H | 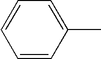 | 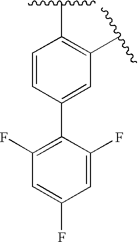 | 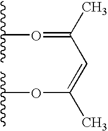 | 2 |
| 949 | H | H | H | H | H | 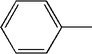 | 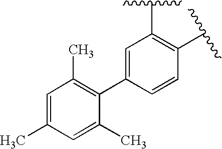 | 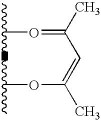 | 2 |
| 950 | H | H | H | H | H | 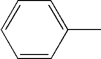 | 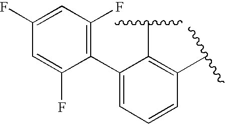 | 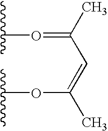 | 2 |
| 951 | H | H | H | H | H | 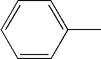 | 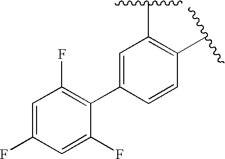 | 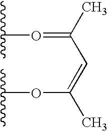 | 2 |
| 952 | H | H | H | H | H | 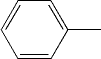 | 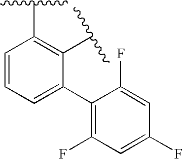 | 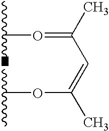 | 2 |
| 953 | H | H | H | H | H | 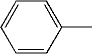 | 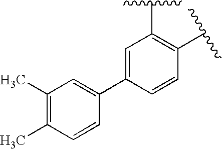 | 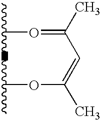 | 2 |
| 954 | H | H | H | H | H | 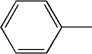 | 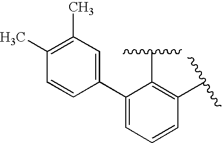 | 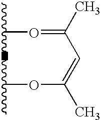 | 2 |
| 955 | H | H | H | H | H | 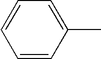 | 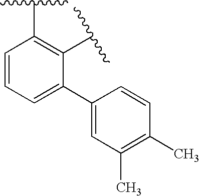 | 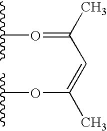 | 2 |
| 956 | H | H | H | H | H | 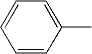 | 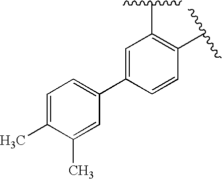 | 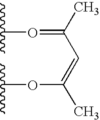 | 2 |
| 957 | H | H | H | H | H | 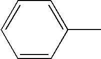 | 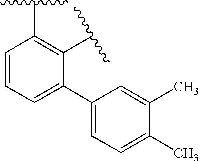 | 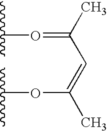 | 2 |
| 958 | H | H | H | H | H | 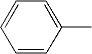 | 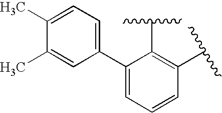 | 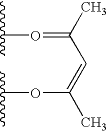 | 2 |
| 959 | H | H | H | H | H | 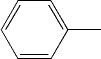 | 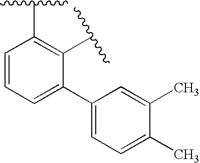 | 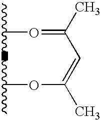 | 2 |
| 960 | H | H | H | H | H | 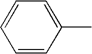 | 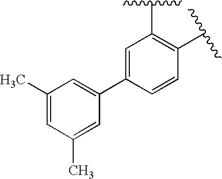 | 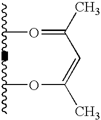 | 2 |
| 961 | H | H | H | H | H | 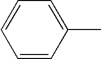 | 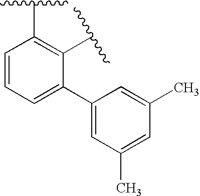 | 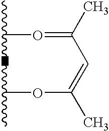 | 2 |
| 962 | H | H | H | H | H | 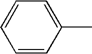 | 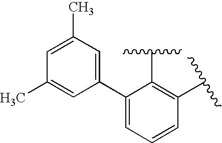 | 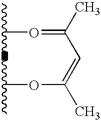 | 2 |
| 963 | H | H | H | H | H | 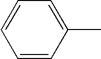 | 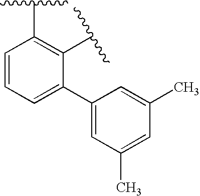 | 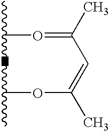 | 2 |
| 964 | H | H | H | H | H | 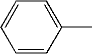 | 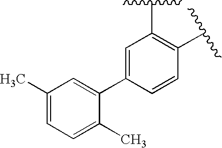 | 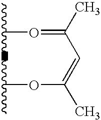 | 2 |
| 965 | H | H | H | H | H | 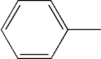 | 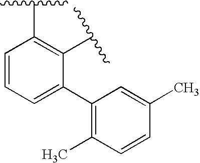 | 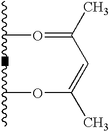 | 2 |
| 966 | H | H | H | H | H | 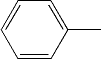 | 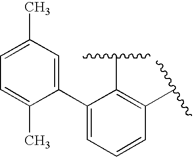 | 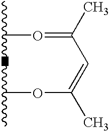 | 2 |
| 967 | H | H | H | H | H | 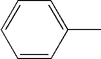 | 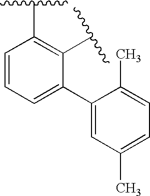 | 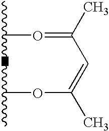 | 2 |
| 968 | H | H | H | H | H | 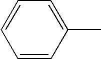 | 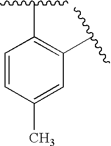 | 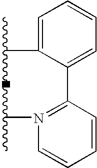 | 2 |
| 969 | H | H | H | H | H | 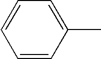 | 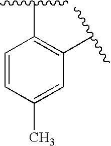 | 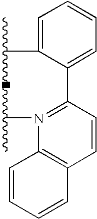 | 2 |
| 970 | H | H | H | H | H | 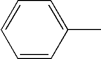 | 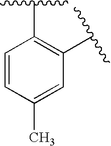 | 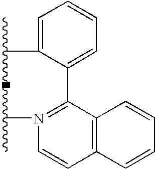 | 2 |
| 971 | H | H | H | H | H | 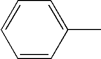 | 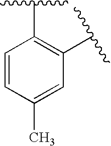 | 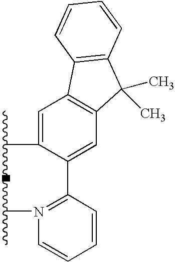 | 2 |
| 972 | H | H | H | H | H | 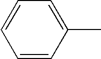 | 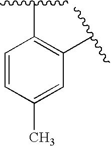 | 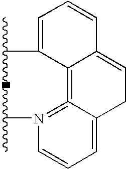 | 2 |
| 973 | H | H | H | H | H | 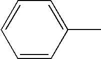 | 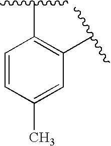 | 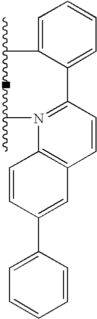 | 2 |
| 974 | H | H | H | H | H | 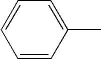 | 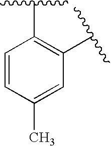 | 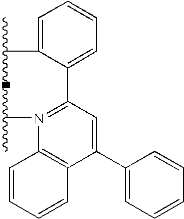 | 2 |
| 975 | H | H | H | H | H | 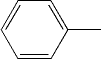 | 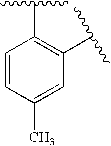 | 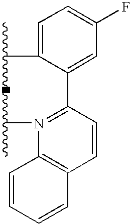 | 2 |
| 976 | H | H | H | H | H | 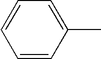 | 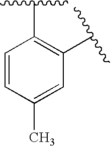 | 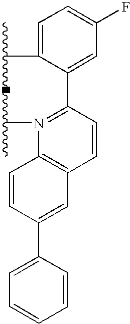 | 2 |
| 977 | H | H | H | H | H | 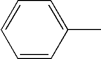 | 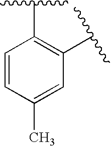 | 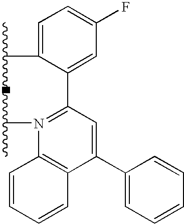 | 2 |
| 978 | H | H | H | H | H | 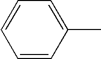 | 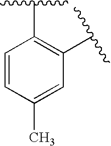 | 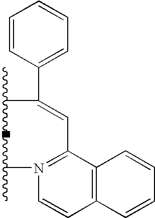 | 2 |
| 979 | H | H | H | H | H | 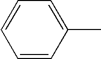 | 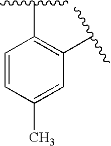 | 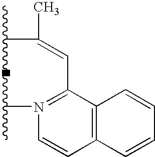 | 2 |
| 980 | H | H | H | H | H | 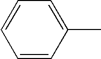 | 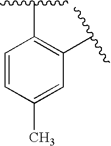 | 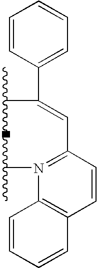 | 2 |
| 981 | H | H | H | H | H | 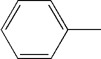 | 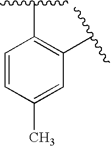 | 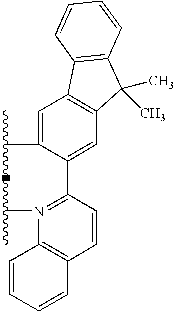 | 2 |
| 982 | H | H | H | H | H | 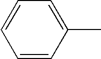 | 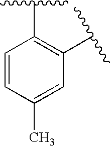 | 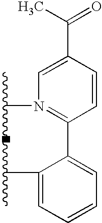 | 2 |
| 983 | H | H | H | H | H | 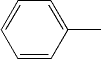 | 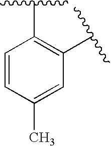 | 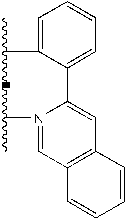 | 2 |
| 984 | H | H | H | H | H | 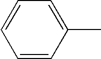 | 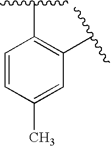 | 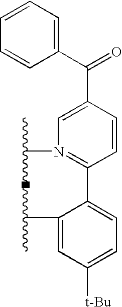 | 2 |
| 985 | H | H | H | H | H | 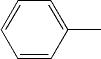 | 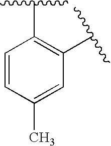 | 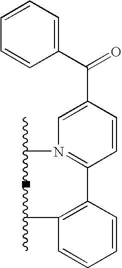 | 2 |
| 986 | H | H | H | H | H | 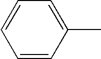 | 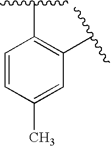 | 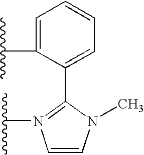 | 2 |
| 987 | H | H | H | H | H | 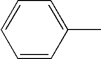 | 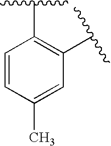 | 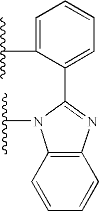 | 2 |
| 988 | H | H | H | H | H | 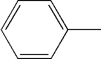 | 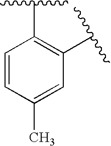 | 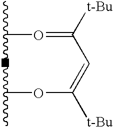 | 2 |
| 989 | H | H | H | H | H | 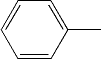 | 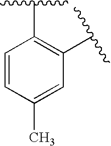 | 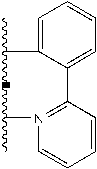 | 2 |
| 990 | H | H | H | H | H | 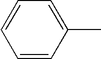 | 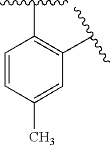 | — | 3 |
| 991 | H | H | H | H | H | H | 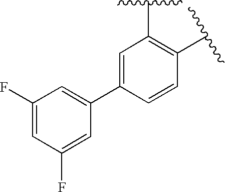 | 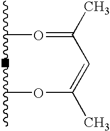 | 2 |
| 992 | H | H | H | H | H | H | 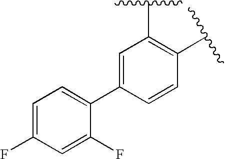 | 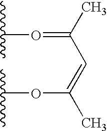 | 2 |
| 993 | H | H | H | H | H | H | 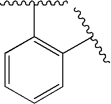 | 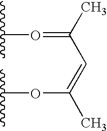 | 2 |
| 994 | H | H | H | H | H | F | 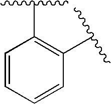 | 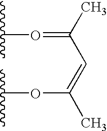 | 2 |
| 995 | H | H | H | H | H | —CH₃ | 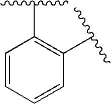 | 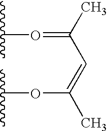 | 2 |
| 996 | H | H | H | H | H | —C(CH₃)₃ | 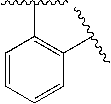 | 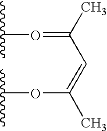 | 2 |
| 997 | H | H | H | H | H | 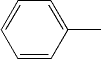 | 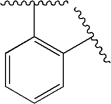 | 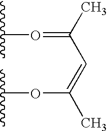 | 2 |
| 998 | H | H | H | H | H | H | 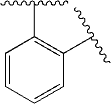 | 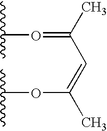 | 2 |
| 999 | —CH₃ | H | H | H | H | H | 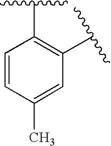 | 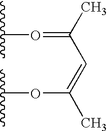 | 2 |
| 1000 | H | —CH₃ | H | H | H | H | 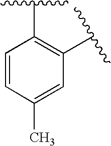 | 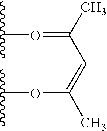 | 2 |
| 1001 | H | H | —CH₃ | H | H | H | 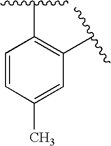 | 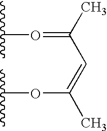 | 2 |
| 1002 | H | H | H | —CH₃ | H | H | 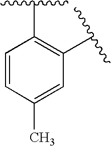 | 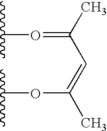 | 2 |
| 1003 | H | H | H | H | —CH₃ | H | 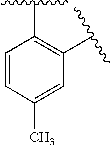 | 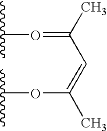 | 2 |
| 1004 | —CH₃ | H | H | H | H | F | 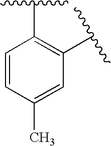 | 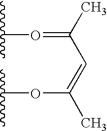 | 2 |
| 1005 | H | —CH₃ | H | H | H | F | 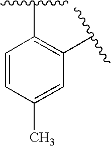 | 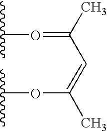 | 2 |
| 1006 | H | H | —CH₃ | H | H | F | 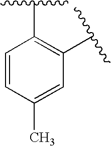 | 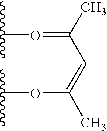 | 2 |
| 1007 | H | H | H | —CH₃ | H | F | 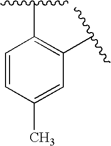 | 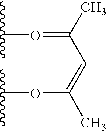 | 2 |
| 1008 | H | H | H | H | —CH₃ | F | 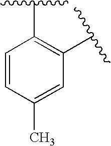 | 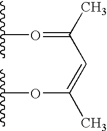 | 2 |
| 1009 | —CH₃ | H | H | H | H | —CH₃ | 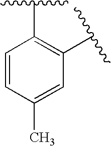 | 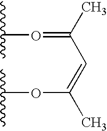 | 2 |
| 1010 | H | —CH₃ | H | H | H | —CH₃ | 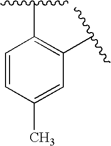 | 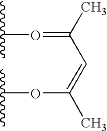 | 2 |
| 1011 | H | H | —CH₃ | H | H | —CH₃ | 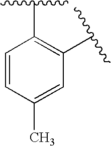 | 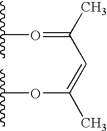 | 2 |
| 1012 | H | H | H | —CH₃ | H | —CH₃ | 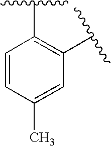 | 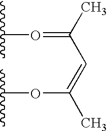 | 2 |
| 1013 | H | H | H | H | —CH₃ | —CH₃ | 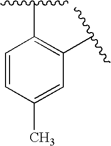 | 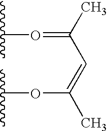 | 2 |
| 1014 | —CH₃ | H | H | H | H | 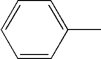 | 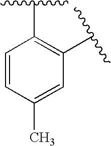 | 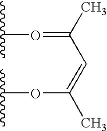 | 2 |
| 1015 | H | —CH₃ | H | H | H | 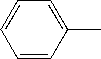 | 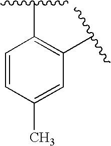 | 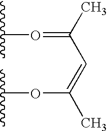 | 2 |
| 1016 | H | H | —CH₃ | H | H | 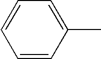 | 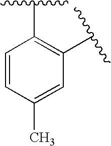 | 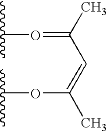 | 2 |
| 1017 | H | H | H | —CH₃ | H | 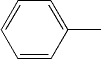 | 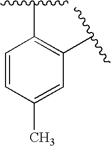 | 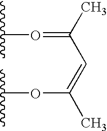 | 2 |
| 1018 | H | H | H | H | —CH₃ | 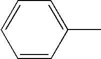 | 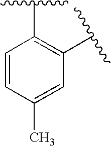 | 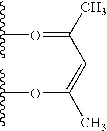 | 2 |
| 1019 | —CH₃ | H | H | H | H | —CH₃ | 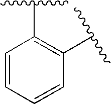 | 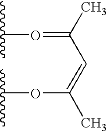 | 2 |
| 1020 | H | —CH₃ | H | H | H | —CH₃ | 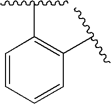 | 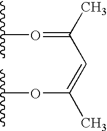 | 2 |
| 1021 | H | H | —CH₃ | H | H | —CH₃ | 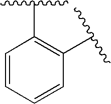 | 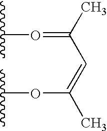 | 2 |
| 1022 | H | H | H | —CH₃ | H | —CH₃ | 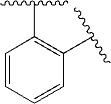 | 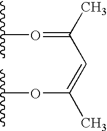 | 2 |
| 1023 | H | H | H | H | —CH₃ | —CH₃ | 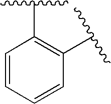 | 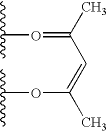 | 2 |

TABLE 2

| compound | | MS/FAB | |
|---|---|---|---|
| No. | ¹H NMR(CDCl₃, 200 MHz) | found | calculated |
| 11 | δ = 8.6 (d, 2H), 8.1 (d, 2H), 7.9-7.7 (m, 14H), 7.5-7.3 (m, | 623 | 624.15 |
| | 14H), 1.71 (s, 3H), 1.31 (s, 3H) | | |
| 12 | δ = 8.3 (s, 2H), 8.1 (d, 2H), 7.9-7.7 (m, 14H), 7.5-7.3 (m, 14H), | 689 | 690.20 |
| | 1.71 (s, 3H), 1.67 (s, 6H), 1.31 (s, 3H) | | |
| 84 | δ = 8.2 (s, 2H), 8.1 (d, 2H), 7.9 (m, 2H), 7.8-7.7 (m, 8H), | 667 | 668.16 |
| | 7.5-7.3 (m, 20H), 1.71 (s, 3H), 1.33 (s, 9H), 1.31 (s, 3H) | | |
| 104 | δ = 8.2 (s, 2H), 8.1 (d, 2H), 7.9 (m, 2H), 7.8-7.7 (m, 12H), | 649 | 650.17 |
| | 7.5-7.4 (m, 18H), 1.71 (s, 3H), 1.31 (s, 3H) | | |
| 302 | δ = 8.2 (s, 2H), 8.1 (d, 2H), 7.9-7.7 (m, 10H), 7.5-7.3 (m, 16H), | 667 | 668.16 |
| | 7.1 (d, 4H), 1.71 (s, 3H), 1.31 (s, 3H) | | |
| 698 | δ = 8.2 (s, 2H), 8.1 (d, 2H), 7.9-7.7 (m, 10H), 7.5-7.3 (m, 20H), | 705 | 706.23 |
| | 1.71 (s, 3H), 1.33 (s, 9H), 1.31 (s, 3H) | | |
| 896 | δ = 8.2 (s, 2H), 8.1 (d, 2H), 7.9-7.7 (m, 16H), 7.5-7.3 (m, 18H), | 725 | 726.20 |
| | 7.2 (s, 8H), 1.71 (s, 3H), 1.31 (s, 3H) | | |

### Example 1

### Manufacture of an OLED (1)

An OLED device was manufactured by using a red phosphorescent compound according to the invention.

First, a transparent electrode ITO thin film (15Ω/□) (2) prepared from a glass for OLED (produced by Samsung Corning) (1) was subjected to ultrasonic washing with trichloroethylene, acetone, ethanol and distilled water, sequentially, and stored in isopronanol before use.

Then, an ITO substrate was equipped in a substrate folder of a vacuum vapor-deposit device, and 4,4′,4″-tris(N,N-(2-naphthyl)-phenylamino)triphenylamine (2-TNATA) was placed in a cell of the vacuum vapor-deposit device, which was then ventilated up to 10⁻⁶ torr of vacuum in the chamber. Electric current was applied to the cell to evaporate 2-TNATA, thereby providing vapor-deposit of a hole injection layer (3) having 60 nm of thickness on the ITO substrate.

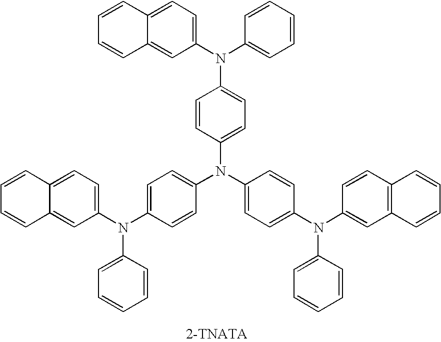

Then, to another cell of the vacuum vapor-deposit device, charged was N,N′-bis(α-naphthyl)-N,N′-diphenyl-4,4′-diamine (NPB), and electric current was applied to the cell to evaporate NPB, thereby providing vapor-deposit of a hole transportation layer (4) of 20 nm of thickness on the hole injection layer.

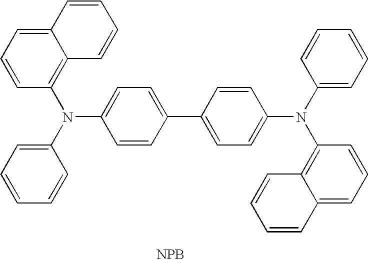

In another cell of said vacuum vapor-deposit device, charged was 4,4′-N,N′-dicarbazole-biphenyl (CBP) as an electroluminescent host material, and a red phosphorescent compound (Compound 1) according to the present invention was charged to still another cell. The two materials were evaporated at different rates to carry out doping to vapor-deposit an electroluminescent layer (5) having 30 nm of thickness on the hole transportation layer. The suitable doping concentration is 4 to 10 mol % on the basis of CBP.

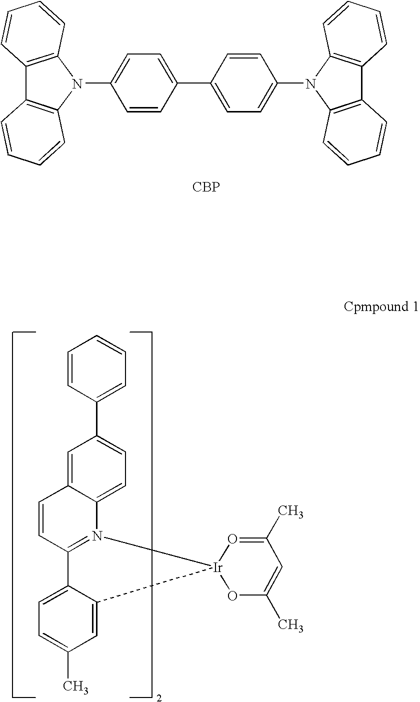

Then, on the electroluminescent layer, bis(2-methyl-8-quinolinato)(p-phenylphenolato)aluminum (III) (BAlq) was vapor-deposited as a hole blocking layer in a thickness of 10 nm in the same manner for NPB, tris(8-hydroxyquinoline)aluminum (III) (Alq) was vapor-deposited as an electron transportation layer (6) in a thickness of 20 nm, and then lithium quinolate (Liq) was vapor-deposited as an electron injection layer (7) in a thickness of 1 to 2 nm. Thereafter, an Al cathode (8) was vapor-deposited in a thickness of 150 nm by using another vacuum vapor-deposit device to manufacture an OLED.

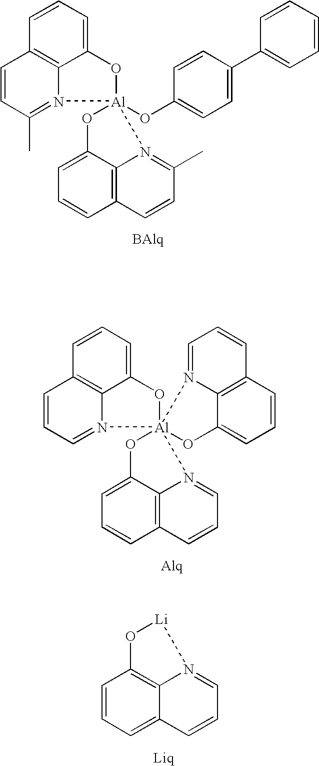

### Example 2

### Manufacture of an OLED (2)

An hole injection layer and a hole transport layer were formed according to the procedure of Example 1, and an electroluminescent layer was vapor-deposited as follows. In another cell of said vacuum vapor-deposit device, charged was H-4 as an electroluminescent host material, and a red phosphorescent compound (Compound 12) according to the present invention was charged to still another cell. The two materials were evaporated at different rates to carry out doping to vapor-deposit an electroluminescent layer (5) having 30 nm of thickness on the hole transportation layer. The suitable doping concentration is 4 to 10 mol % on the basis of the host. Then, a hole blocking layer, an electron transport layer and an electron injection layer were vapor-deposited according to the same procedure as in Example 1, and then Al cathode (8) was vapor-deposited in a thickness of 150 nm by using another vacuum vapor-deposit device to manufacture an OLED.

### Example 3

### Manufacture of an OLED (3)

A hole injection layer, an hole transport layer and an electroluminescent layer were formed according to the same procedure as in Example 2, and then an electron transport layer and an electron injection layer were vapor-deposited. Thereafter, Al cathode was vapor-deposited in a thickness of 150 nm by using another vacuum vapor-deposit device to manufacture an OLED.

In order to confirm the performance of the OLED's prepared according to Example 1 through Example 3, the luminous efficiency of the OLED's was measured at 10 mA/cm². Various properties are shown in Tables 3.

TABLE 3

| | | | Hole | | | Max. luminous |
|---|---|---|---|---|---|---|
| | | | blocking | | Operation | efficiency |
| | Material | Host | layer | EL color | voltage | (cd/A) |
| Ex. 1 | Compund 1 | CBP | BAlq | Red | 7.9 | 8.1 |
| | Compound 12 | CBP | BAlq | Red | 7.9 | 7.4 |
| | Compound 44 | CBP | BAlq | Red | 7.8 | 8.6 |
| | Compound 53 | CBP | BAlq | Red | 8.1 | 9.7 |
| | Compound 176 | CBP | BAlq | Red | 8.3 | 10.0 |
| | Compound 181 | CBP | BAlq | Red | 8.2 | 9.9 |
| | Compound 188 | CBP | BAlq | Red | 8.0 | 11.2 |
| | Compound 215 | CBP | BAlq | Red | 8.0 | 10.4 |
| | Compound 335 | CBP | BAlq | Red | 8.1 | 10.9 |
| | Compound 574 | CBP | BAlq | Red | 8.2 | 6.8 |
| | Compound 575 | CBP | BAlq | Red | 7.9 | 8.8 |
| | Compound 787 | CBP | BAlq | Red | 8.0 | 11.2 |
| | Compound 791 | CBP | BAlq | Red | 7.9 | 9.8 |
| | Compound 835 | CBP | BAlq | Red | 7.8 | 10.7 |
| | Compound 968 | CBP | BAlq | Red | 8.0 | 10.4 |
| | Compound 974 | CBP | BAlq | Red | 8.1 | 9.9 |
| | Compound 979 | CBP | BAlq | Red | 8.2 | 10.5 |
| | Compound 993 | CBP | BAlq | Red | 8.5 | 10.6 |
| Ex. 2 | Compound 12 | H-4 | BAlq | Red | 7.4 | 7.8 |
| | Compound 53 | H-6 | BAlq | Red | 7.6 | 9.8 |
| | Compound 188 | H-39 | BAlq | Red | 7.4 | 11.1 |
| | Compound 575 | Chem. | BAlq | Red | 7.4 | 9.0 |
| | | For. VIII | | | | |
| Ex. 3 | Compound 1 | H-2 | — | Red | 6.6 | 8.3 |
| | Compound 835 | H-5 | — | Red | 6.5 | 10.7 |
| | Compound 974 | H-10 | — | Red | 6.6 | 10.0 |
| | Compound 993 | H-62 | — | Red | 6.8 | 11.1 |

Compound (176) and Compound (188), to which ppy and styrylquinoline were introduced as a subsidiary ligand, respectively, showed high luminous efficiency of 10 cd/A or more. Compound (335), to which F was applied to a ligand as an electron withdrawal, showed the effect of increased efficiency. Compound (787), which employs phenyl(6-phenylpyridin-3-yl)methanone as a subsidiary ligand, showed the highest efficiency among the compounds developed by the present invention.

With identical device structure, using the host according to the present invention instead of CBP did not provide significant change of efficiency, but the operation voltage was advance by approximately 0.5 V, and thus enhancement of power consumption could be anticipated. When the host according to the present invention is employed without using a hole blocking layer, the device exhibits comparable or higher luminous efficiency as compared to that using conventional host, and provides decreased power consumption of the OLED due to lowered operation voltage by about 1.3 V˜1.7 V. If the invention is applied to mass production of OLEDs, the time for mass production can be also reduced to give great benefit on its commercialization.

1. An organic phosphorescent compound represented by Chemical Formula (I): 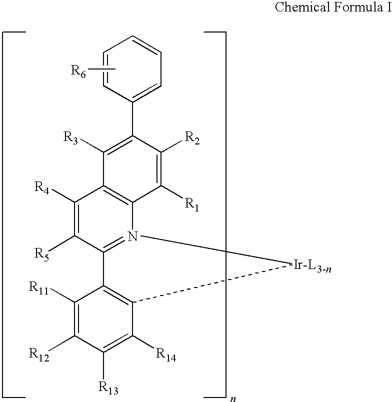
wherein, L is an organic ligand;
R₁ through R₅ independently represent hydrogen, (C₁-C₂₀) alkyl, (C₁-C₂₀) alkoxy, (C₃-C₁₂) cycloalkyl, halogen, tri(C₁-C₂₀)alkylsilyl or tri(C₆-C₂₀)arylsilyl;
R₆ represents hydrogen, (C₁-C₂₀)alkyl, halogen or (C₆-C₂₀) aryl;
R₁₁ through R₁₄ independently represent hydrogen, (C₁-C₂₀) alkyl, halogen, cyano, tri(C₁-C₂₀) alkylsilyl, tri(C₆-C₂₀) arylsilyl, (C₁-C₂₀) alkoxy, (C₁-C₂₀) alkylcarbonyl, (C₆-C₂₀) arylcarbonyl, di(C₁-C₂₀) alkylamino, di(C₆-C₂₀) arylamino, phenyl, naphthyl, anthryl, fluorenyl, spirobifluorenyl or 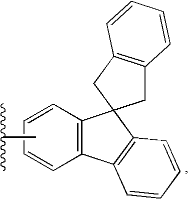
or each of R₁₁ through R₁₄ may be linked to another adjacent group from R₁₁ through R₁₄ via (C₃-C₁₂)alkylene or (C₃-C₁₂)alkenylene with or without a fused ring to form an alicyclic ring, or a monocyclic or polycyclic aromatic ring;
the alkyl, phenyl, naphthyl, anthryl, fluorenyl of R₁₁ through R₁₄, and the alicyclic ring, or the monocyclic or polycyclic aromatic ring formed therefrom by linkage via (C₃-C₁₂)alkylene or (C₃-C₁₂)alkenylene with or without a fused ring may be further substituted by one or more substituent(s) selected from (C₁-C₂₀)alkyl with or without halogen substituent(s), (C₁-C₂₀)alkoxy, halogen, tri(C₁-C₂₀)alkylsilyl, tri(C₆-C₂₀) arylsilyl, (C₁-C₂₀) alkylcarbonyl, (C₆-C₂₀) arylcarbonyl, di(C₁-C₂₀) alkylamino, di(C₆-C₂₀) arylamino and (C₆-C₂₀) aryl; and
n is an integer from 1 to 3.

2. The organic phosphorescent compound according to claim 1, wherein R₁₁ through R₁₄ independently represent hydrogen, methyl, ethyl, n-propyl, i-propyl, n-butyl, i-butyl, t-butyl, n-pentyl, i-pentyl, n-hexyl, n-heptyl, n-octyl, 2-ethylhexyl, n-nonyl, trifluoromethyl, fluoro, cyano, trimethylsilyl, tripropylsilyl, tri(t-butyl)silyl, t-butyldimethylsilyl, triphenylsilyl, methoxy, ethoxy, butoxy, methylcarbonyl, ethylcarbonyl, t-butylcarbonyl, phenylcarbonyl, dimethylamino, diphenylamino, phenyl, naphthyl, anthryl, fluorenyl or 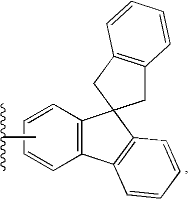
and the fluorenyl may be further substituted by methyl, ethyl, n-propyl, i-propyl, n-butyl, i-butyl, t-butyl, n-pentyl, i-pentyl, n-hexyl, n-heptyl, n-octyl, 2-ethylhexyl, n-nonyl, phenyl, naphthyl, anthryl, trimethylsilyl, tripropylsilyl, tri(t-butyl)silyl, t-butyldimethylsilyl or triphenylsilyl.

3. The organic phosphorescent compound according to claim 1, which is selected from the compounds represented by one of Chemical Formulas (II) to (VI): 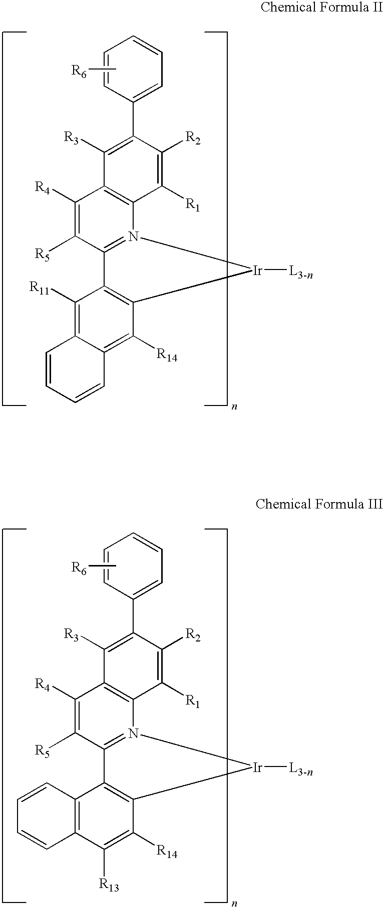 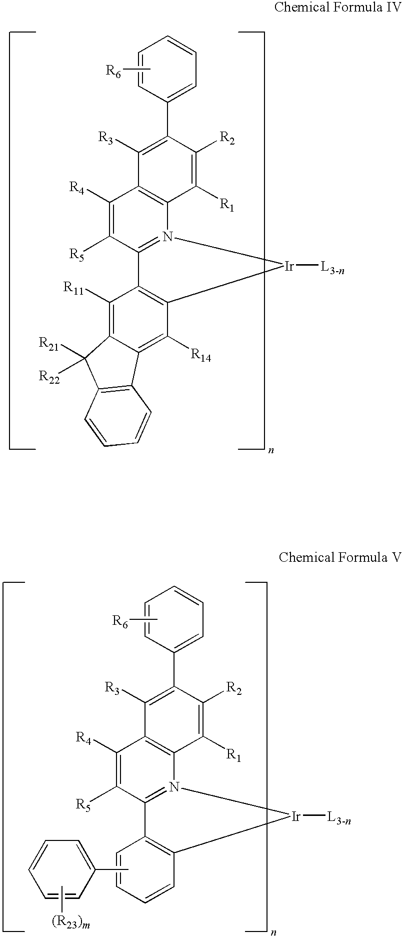 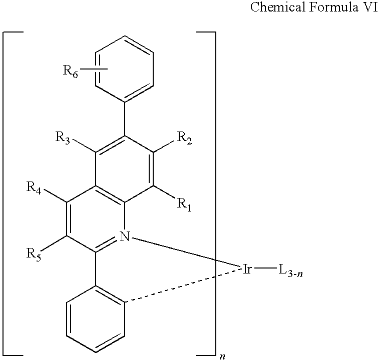
wherein, L, R₁, R₂, R₃, R₄, R₅, R₆, R₁₁, R₁₃, R₁₄ and n are defined as in Chemical Formula (I) of claim 1;
R₂₁ and R₂₂ independently represent hydrogen, (C₁-C₂₀)alkyl, (C₆-C₂₀)aryl, or R₂₁ and R₂₂ may be linked via (C₃-C₁₂)alkylene or (C₃-C₁₂)alkenylene with or without a fused ring to form an alicyclic ring, or a monocyclic or polycyclic aromatic ring;
R₂₃ represents (C₁-C₂₀) alkyl, halogen, cyano, tri(C₁-C₂₀) alkylsilyl, tri(C₆-C₂₀) arylsilyl, (C₁-C₂₀) alkoxy, (C₁-C₂₀)alkylcarbonyl, (C₆-C₂₀)arylcarbonyl, phenyl, di(C₁-C₂₀) alkylamino, di(C₆-C₂₀) arylamino, naphthyl, 9,9-di(C₁-C₂₀) alkylfluorenyl or 9,9-di(C₆-C₂₀) arylfluorenyl; and
m is an integer from 1 to 5.

4. The organic phosphorescent compound according to claim 1, wherein R₁ through R₅ independently represent hydrogen, methyl, ethyl, n-propyl, i-propyl, n-butyl, i-butyl, t-butyl, n-pentyl, i-pentyl, n-hexyl, n-heptyl, n-octyl, ethylhexyl, methoxy, ethoxy, butoxy, cyclopropyl, cyclohexyl, cycloheptyl, fluoro, trimethylsilyl, tripropylsilyl, tri(t-butyl)silyl, t-butyldimethylsilyl or triphenylsilyl; and R₆ represents hydrogen, methyl, ethyl, n-propyl, i-propyl, n-butyl, i-butyl, t-butyl, n-pentyl, i-pentyl, n-hexyl, n-heptyl, n-octyl, ethylhexyl, fluoro, phenyl, naphthyl, anthryl, fluorenyl or spirobifluorenyl.

5. The organic phosphorescent compound according to claim 2, which is selected from the compounds represented by one of the following chemical formulas: 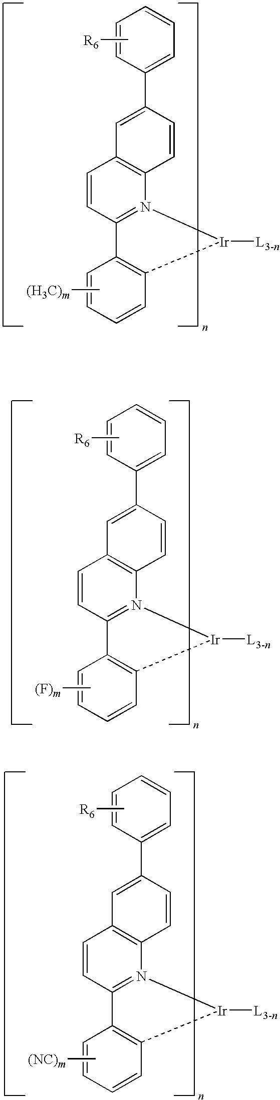 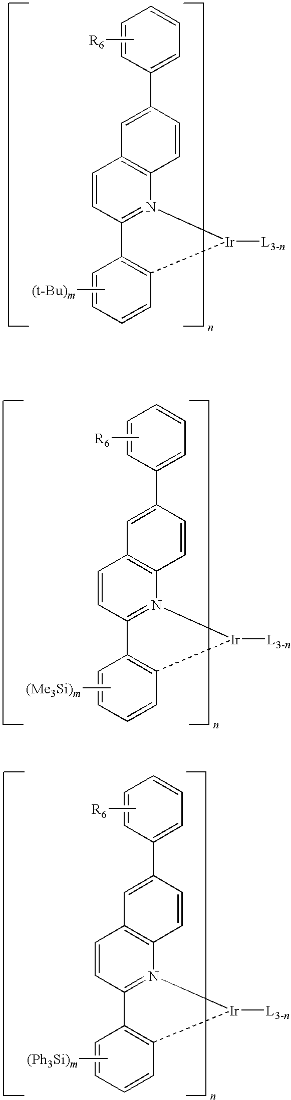 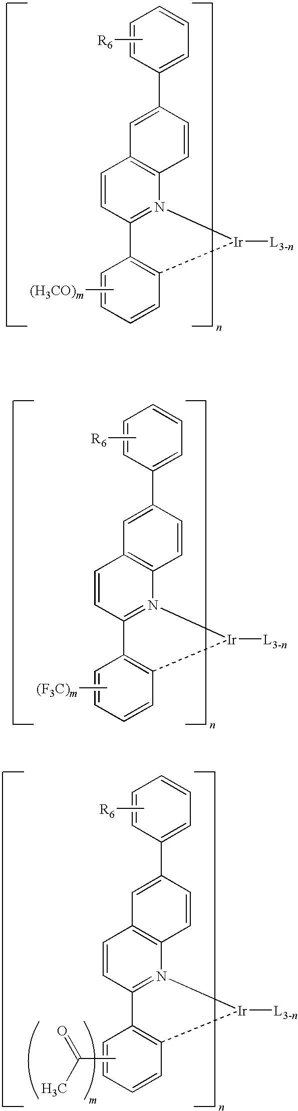 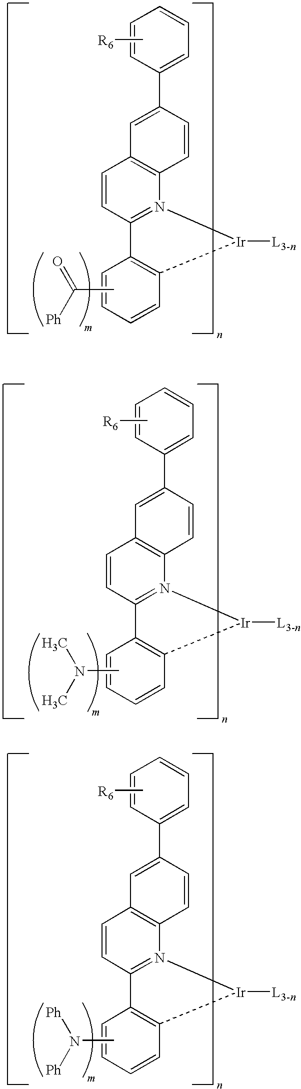 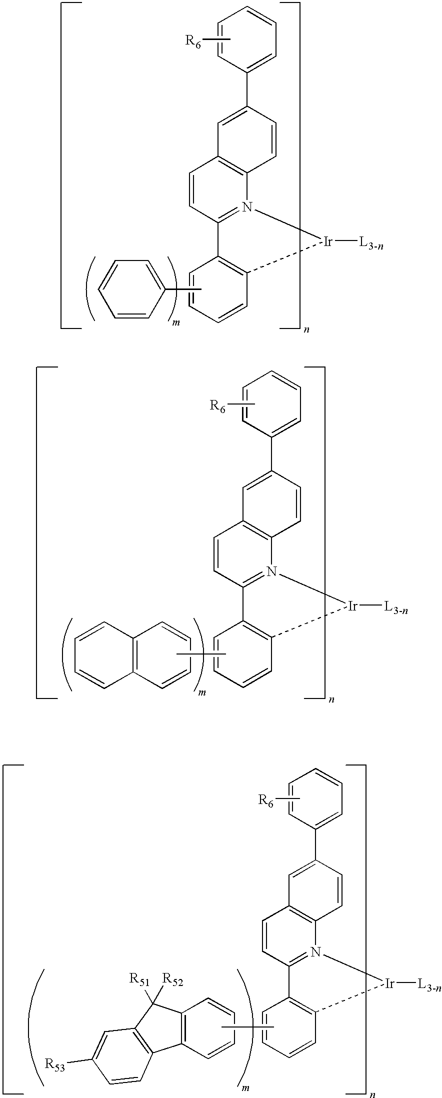 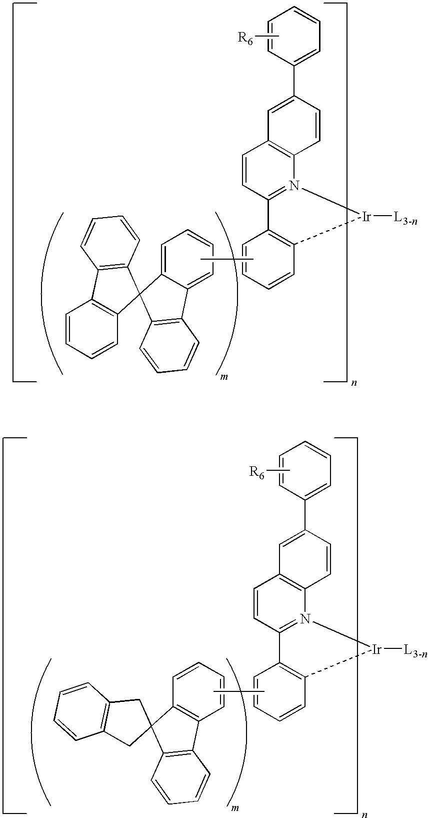
wherein, L and n are defined as in Chemical Formula (I) of claim 1;
R₆ represents hydrogen, methyl, ethyl, n-propyl, i-propyl, n-butyl, i-butyl, t-butyl, n-pentyl, i-pentyl, n-hexyl, n-heptyl, n-octyl, ethylhexyl, fluoro, phenyl or naphthyl;
R₅₁ and R₅₂ independently represent methyl, ethyl, n-propyl, i-propyl, n-butyl, i-butyl, t-butyl, n-pentyl, i-pentyl, n-hexyl, n-heptyl, n-octyl, ethylhexyl, phenyl or naphthyl, or R₅₁ and R₅₂ may be linked each other via (C₃-C₁₂)alkylene or (C₃-C₁₂)alkenylene with or without a fused ring to form an alicyclic ring, or a monocyclic or polycyclic aromatic ring;
R₅₃ represents hydrogen, methyl, ethyl, n-propyl, i-propyl, n-butyl, i-butyl, t-butyl, n-pentyl, i-pentyl, n-hexyl, n-heptyl, n-octyl, ethylhexyl, trimethylsilyl, tripropylsilyl, tri(t-butyl)silyl, t-butyldimethylsilyl or triphenylsilyl; and
m is an integer from 1 to 3.

6. The organic phosphorescent compound according to claim 3, which is selected from the following compounds: 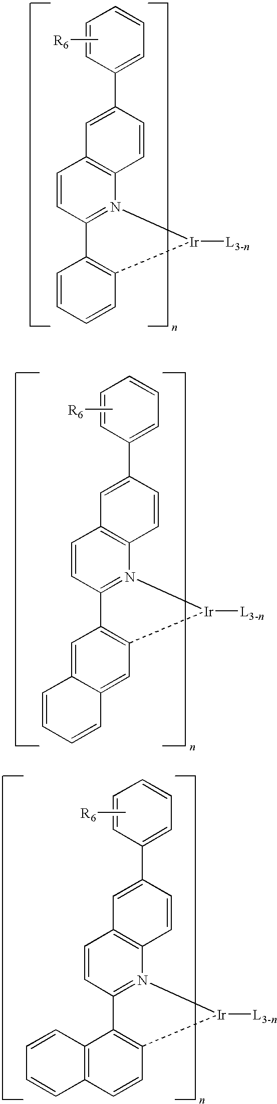 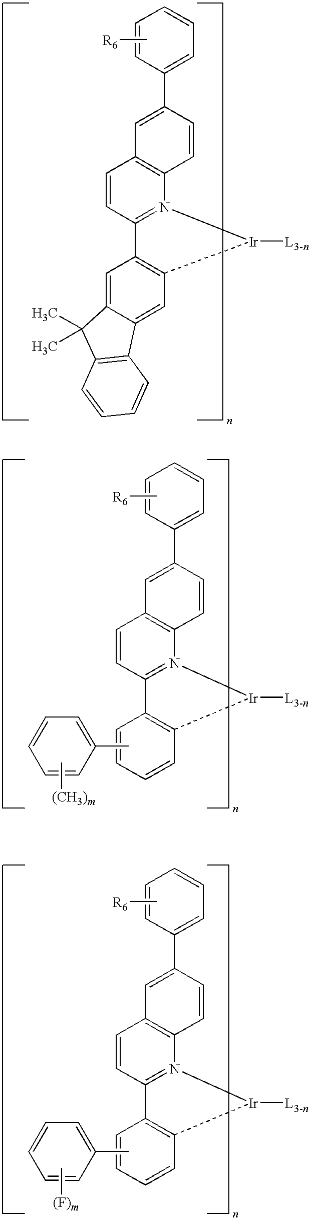 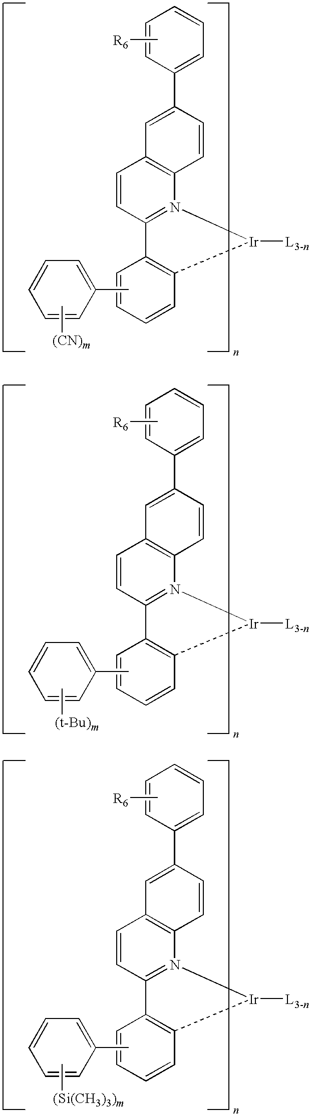 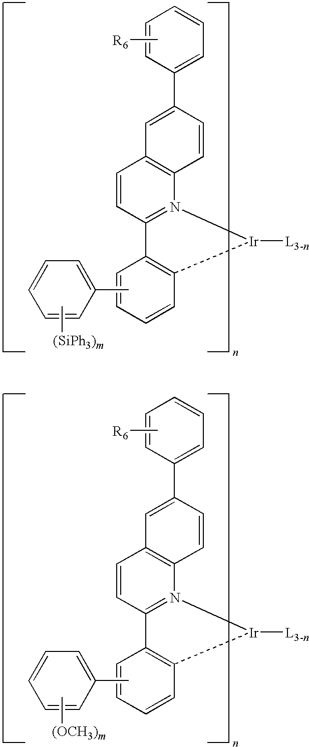 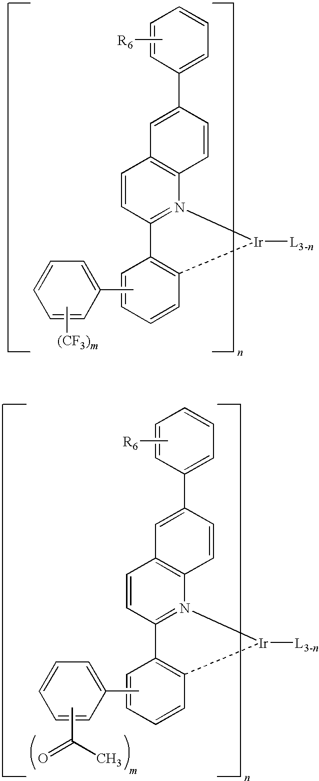 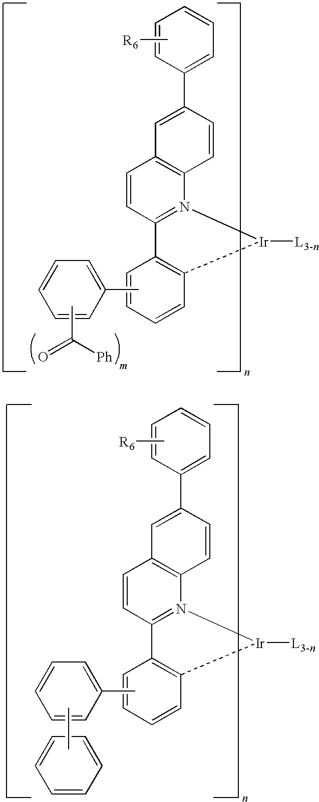 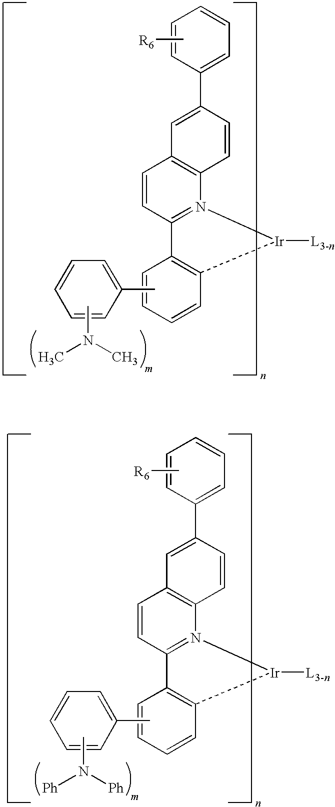 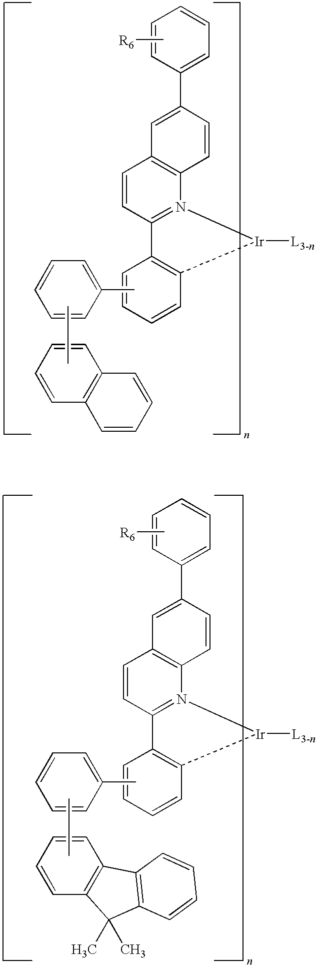
wherein, L and n are defined as in Chemical Formula (I) of claim 1;
R₆ represents hydrogen, methyl, ethyl, n-propyl, i-propyl, n-butyl, i-butyl, t-butyl, n-pentyl, i-pentyl, n-hexyl, n-heptyl, n-octyl, ethylhexyl, fluoro, phenyl or naphthyl; and
m is an integer from 1 to 3.

7. The organic phosphorescent compound according to claim 1, wherein the ligand (L) has a structure represented by one of the following chemical formulas: 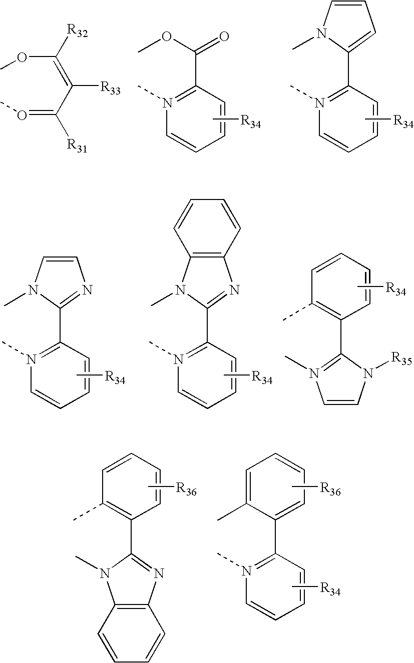 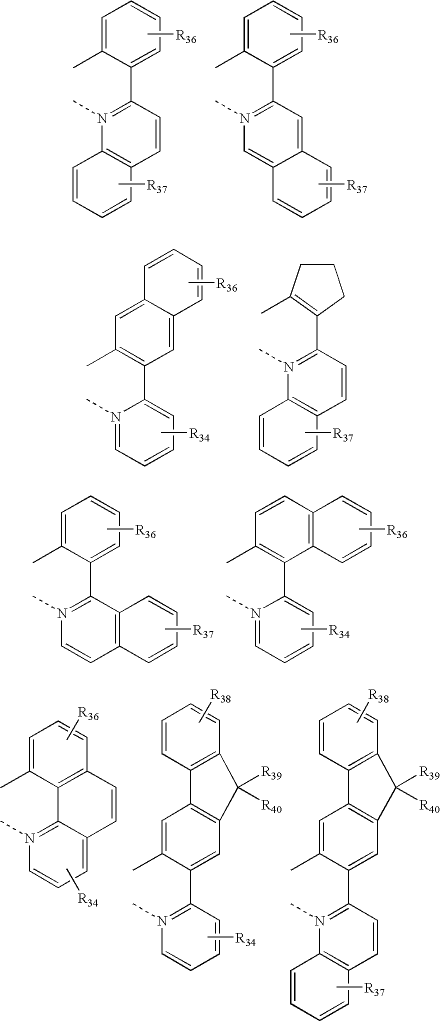 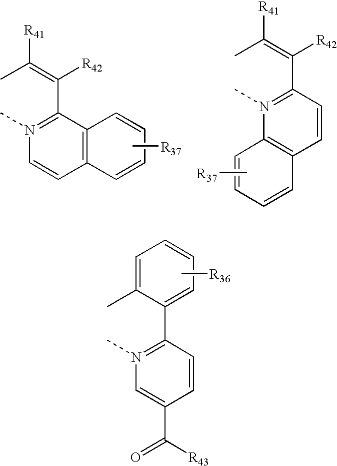
wherein, R₃₁ and R₃₂ independently represent hydrogen, (C₁-C₂₀)alkyl with or without halogen substituent(s), phenyl with or without (C₁-C₂₀)alkyl substituent(s), or halogen;
R₃₃ through R₃₈ independently represent hydrogen, (C₁-C₂₀) alkyl, phenyl with or without (C₁-C₂₀) alkyl substituent (s), tri(C₁-C₂₀)alkylsilyl or halogen;
R₃₉ through R₄₂ independently represent hydrogen, (C₁-C₂₀) alkyl or, phenyl with or without (C₁-C₂₀) alkyl substituent(s); and
R₄₃ represents (C₁-C₂₀)alkyl, phenyl with or without (C₁-C₂₀)alkyl, or halogen.

8. The organic phosphorescent compound according to claim 7, wherein the ligand (L) has a structure represented by one of the following chemical formulas.

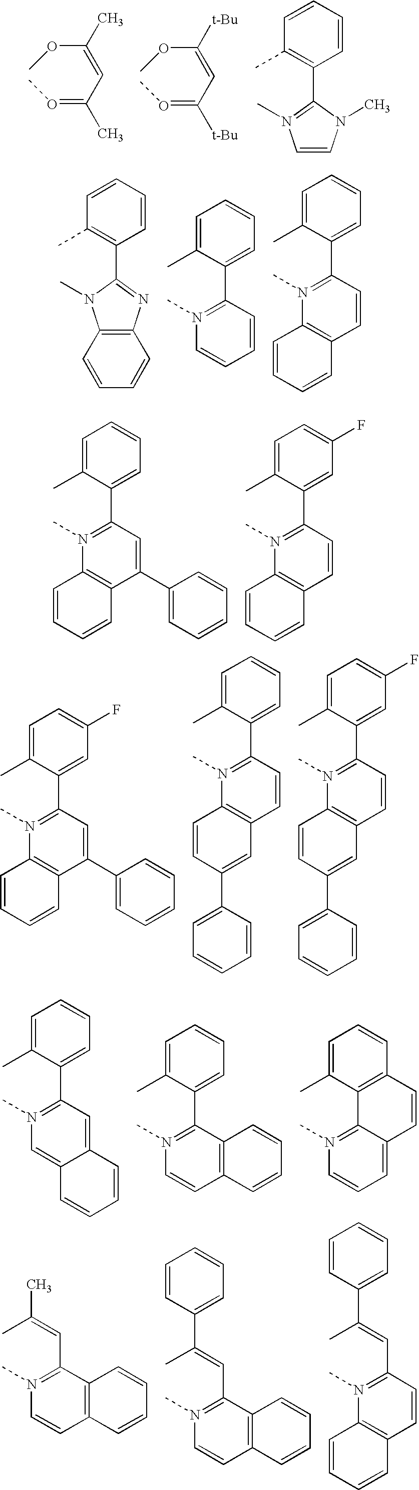

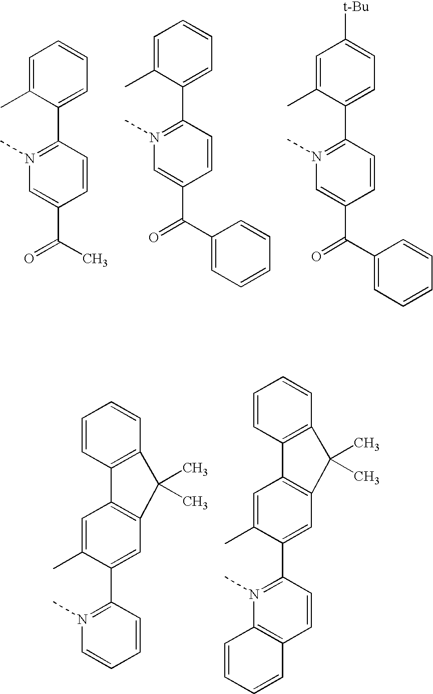

9. An organic electroluminescent device which is comprised of
a first electrode;
a second electrode; and
at least one organic layer(s) interposed between the first electrode and the second electrode;
wherein the organic layer comprises one or more compound(s) represented by Chemical Formula (I): 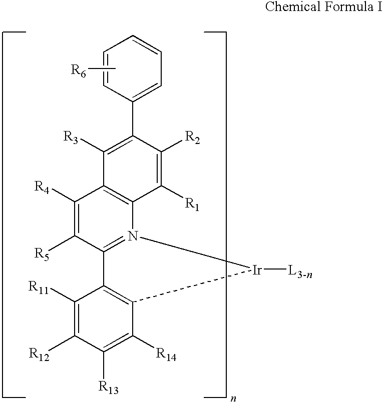
wherein, L is an organic ligand;
R₁ through R₅ independently represent hydrogen, (C₁-C₂₀) alkyl, (C₁-C₂₀) alkoxy, (C₃-C₁₂) cycloalkyl, halogen, tri(C₁-C₂₀)alkylsilyl or tri(C₆-C₂₀)arylsilyl;
R₆ represents hydrogen, (C₁-C₂₀)alkyl, halogen or (C₆-C₂₀) aryl;
R₁₁ through R₁₄ independently represent hydrogen, (C₁-C₂₀)alkyl, halogen, cyano, tri(C₁-C₂₀)alkylsilyl, tri(C₆-C₂₀) arylsilyl, (C₁-C₂₀) alkoxy, (C₁-C₂₀) alkylcarbonyl, (C₆-C₂₀) arylcarbonyl, di(C₁-C₂₀) alkylamino, di(C₆-C₂₀) arylamino, phenyl, naphthyl, anthryl, fluorenyl, spirobifluorenyl or 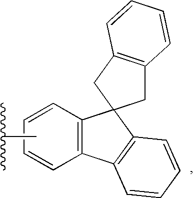
or each of R₁₁ through R₁₄ may be linked to another adjacent group from R₁₁ through R₁₄ via (C₃-C₁₂)alkylene or (C₃-C₁₂)alkenylene with or without a fused ring to form an alicyclic ring, or a monocyclic or polycyclic aromatic ring;
the alkyl, phenyl, naphthyl, anthryl, fluorenyl of R₁₁ through R₁₄, and the alicyclic ring, or the monocyclic or polycyclic aromatic ring formed therefrom by linkage via (C₃-C₁₂)alkylene or (C₃-C₁₂)alkenylene with or without a fused ring may be further substituted by one or more substituent(s) selected from (C₁-C₂₀)alkyl with or without halogen substituent(s), (C₁-C₂₀)alkoxy, halogen, tri(C₁-C₂₀)alkylsilyl, tri(C₆-C₂₀) arylsilyl, (C₁-C₂₀) alkylcarbonyl, (C₆-C₂₀) arylcarbonyl, di(C₁-C₂₀) alkylamino, di(C₆-C₂₀) arylamino and (C₆-C₂₀) aryl; and
n is an integer from 1 to 3.

10. The organic electroluminescent device according to claim 11, wherein the organic layer comprises an electroluminescent region which comprises one or more compound(s) represented by Chemical Formula (I) and one or more host(s).

11. The organic electroluminescent device according to claim 10, wherein the host is selected from the compounds represented by one of Chemical Formulas (VII) to (IX): 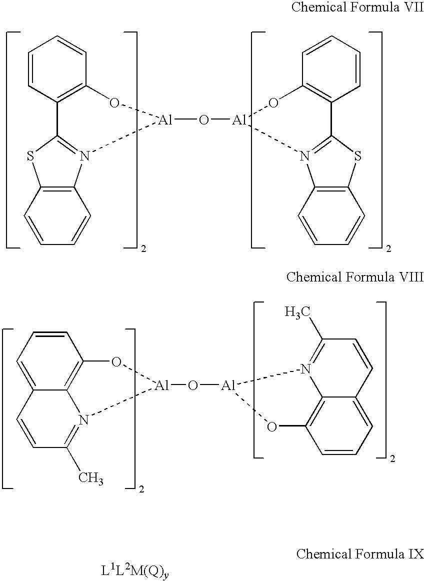
wherein, the ligands, L¹ and L² independently represent one of the following structures: 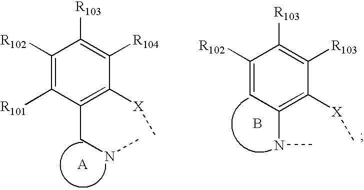
M is a bivalent or trivalent metal;
y is 0 when M is a bivalent metal, while y is 1 when M is a trivalent metal;
Q represents (C₆-C₂₀)aryloxy or tri(C₆-C₂₀)arylsilyl, and the aryloxy and triarylsilyl of Q may be further substituted by (C₁-C₅)alkyl or (C₆-C₂₀)aryl;
X represents O, S or Se;
ring A represents oxazole, thiazole, imidazole, oxadiazole, thiadiazole, benzoxazole, benzothiazole, benzimidazole, pyridine or quinoline;
ring B represents pyridine or quinoline, and ring B may be further substituted by (C₁-C₅)alkyl, or substituted or unsubstituted phenyl or naphthyl;
R₁₀₁ through R₁₀₄ independently represent hydrogen, (C₁-C₅)alkyl, halogen, tri(C₁-C₅)alkylsilyl, tri(C₆-C₂₀)arylsilyl or (C₆-C₂₀)aryl, or each of them may be linked to an adjacent substituent via alkylene or alkenylene to form a fused ring, and the pyridine or quinoline may form a chemical bond together with R₁₀₁ to form a fused ring; and
the ring A or aryl group of R₁₀₁ through R₁₀₄ may be further substituted by (C₁-C₅)alkyl, halogen, (C₁-C₅)alkyl with halogen substituent(s), phenyl, naphthyl, tri(C₁-C₅)alkylsilyl, tri(C₆-C₂₀)arylsilyl or amino group.

12. An organic electroluminescent device according to claim 11, wherein the ligands, L¹ and L² are independently selected from the following structures: 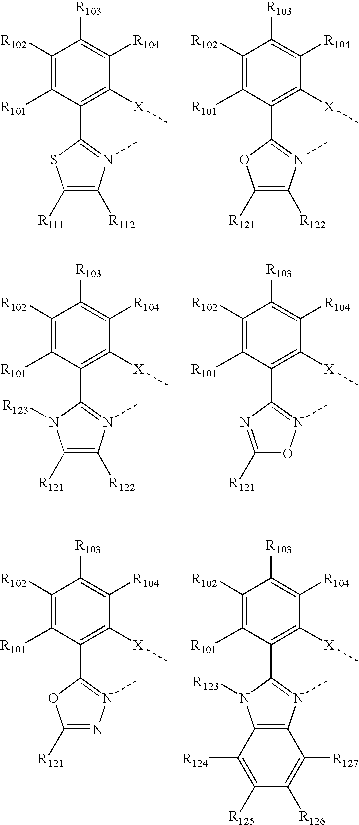 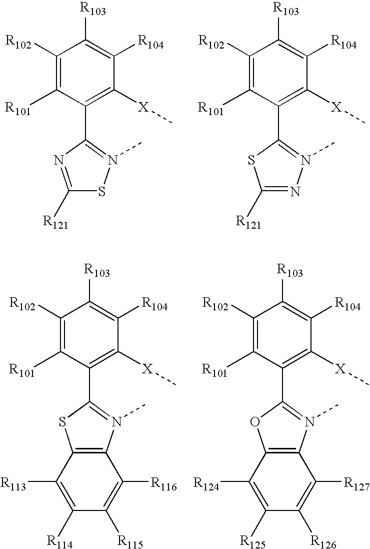 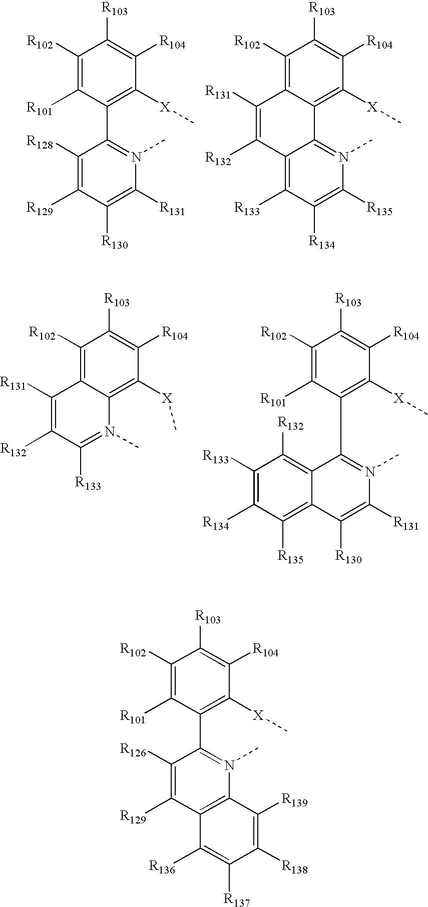
wherein, X represents O, S or Se; R₁₀₁ through R₁₀₄ independently represent hydrogen, (C₁-C₅)alkyl with or without halogen substituent(s), halogen, (C₆-C₂₀)aryl, (C₄-C₂₀) heteroaryl, tri(C₁-C₅) alkylsilyl, tri(C₆-C₂₀) arylsilyl, di(C₁-C₅)alkylamino, di(C₆-C₂₀)arylamino, thiophenyl or furanyl, or each of them may be linked to an adjacent substituent via alkylene or alkenylene to form a fused ring;
R₁₁₁ through R₁₁₆, R₁₂₁ and R₁₂₂ independently represent hydrogen, (C₁-C₅)alkyl, halogen, (C₁-C₅)alkyl with or without halogen substituent(s), phenyl, naphthyl, biphenyl, fluorenyl, tri(C₁-C₅)alkylsilyl, tri(C₆-C₂₀)arylsilyl, di(C₁-C₅)alkylamino, di(C₆-C₂₀)arylamino, thiophenyl or furanyl;
R₁₂₃ represents (C₁-C₂₀)alkyl, phenyl or naphthyl;
R₁₂₄ through R₁₃₉ independently represent hydrogen, (C₁-C₅)alkyl, halogen, (C₁-C₅)alkyl with halogen substituent(s), phenyl, naphthyl, biphenyl, fluorenyl, tri(C₁-C₅) alkylsilyl, tri(C₆-C₂₀) arylsilyl, di(C₁-C₅) alkylamino, di(C₆-C₂₀) arylamino, thiophenyl or furanyl; and
the phenyl, naphthyl, biphenyl, fluorenyl, thiophenyl or furanyl of R₁₁₁ through R₁₁₆ and R₁₂₁ through R₁₃₉ may be further substituted by one or more substituent(s) selected from (C₁-C₅)alkyl, halogen, naphthyl, fluorenyl, tri(C₁-C₅)alkylsilyl, tri(C₆-C₂₀)arylsilyl, di(C₁-C₅)alkylamino and di(C₆-C₂₀)arylamino.

13. An organic electroluminescent device according to claim 11, wherein M is a bivalent metal selected from Be, Zn, Mg, Cu and Ni, or a trivalent metal selected from Al, Ga, In and B.

14. An organic electroluminescent device according to claim 11, wherein Q is selected from the following structures.

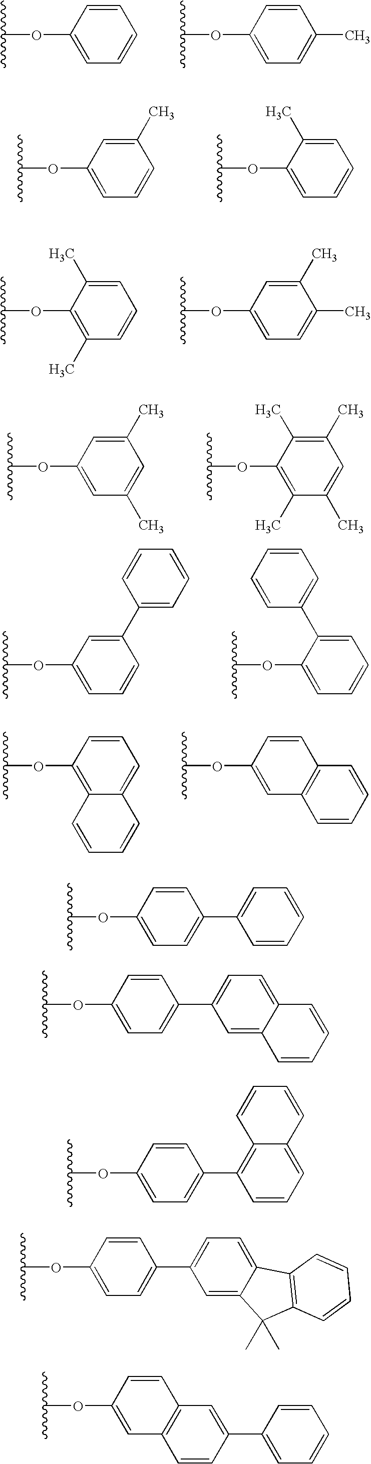

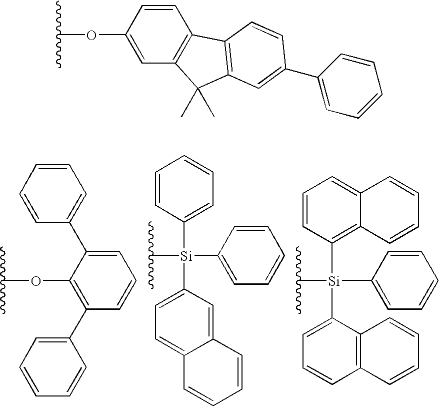

15. An organic electroluminescent device according to claim 11, wherein the host is selected from the compounds represented by the following structures. 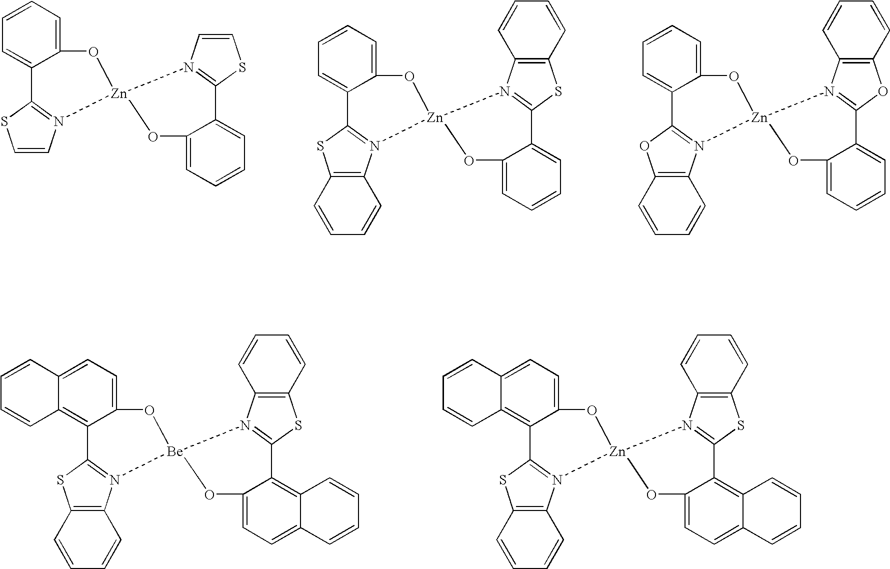 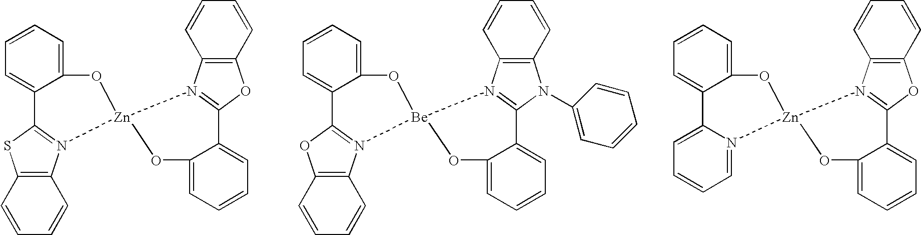 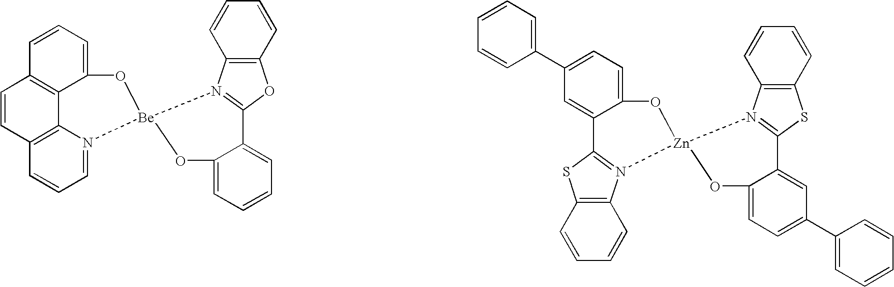 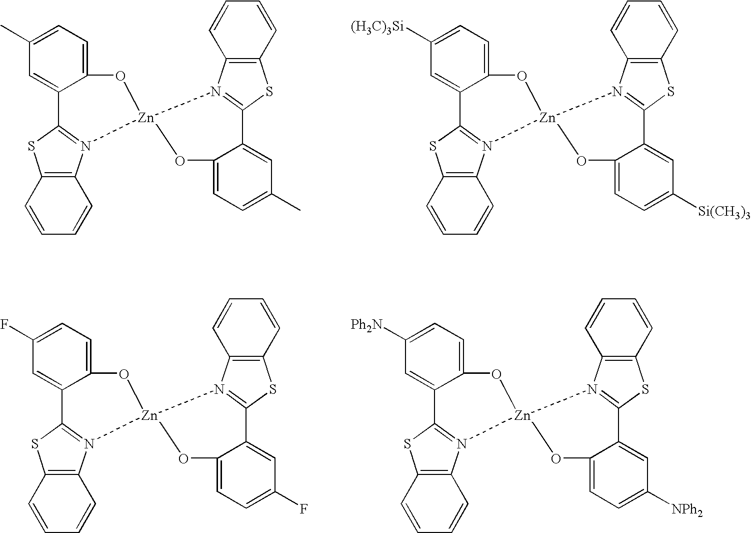 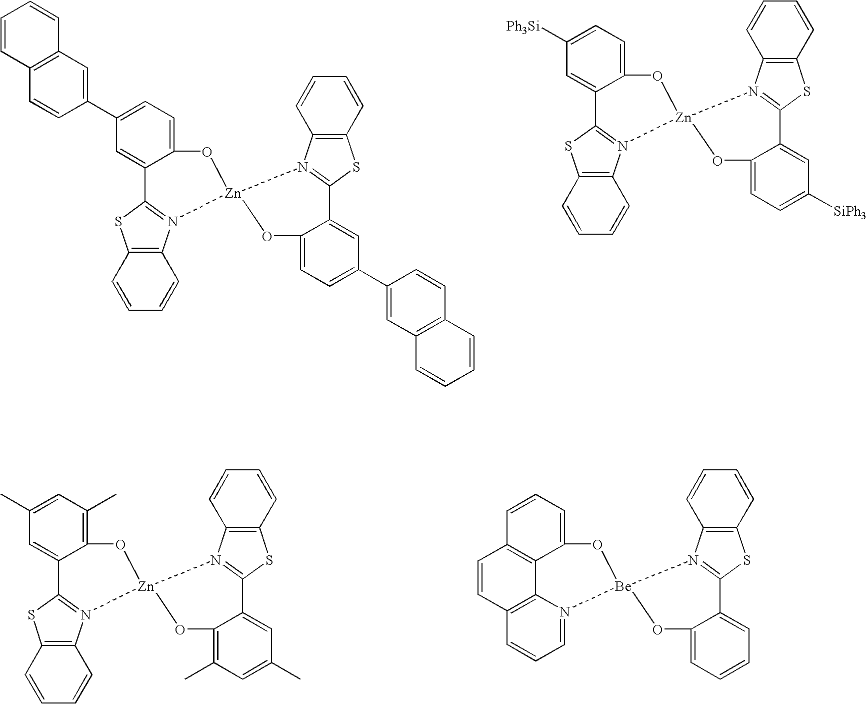 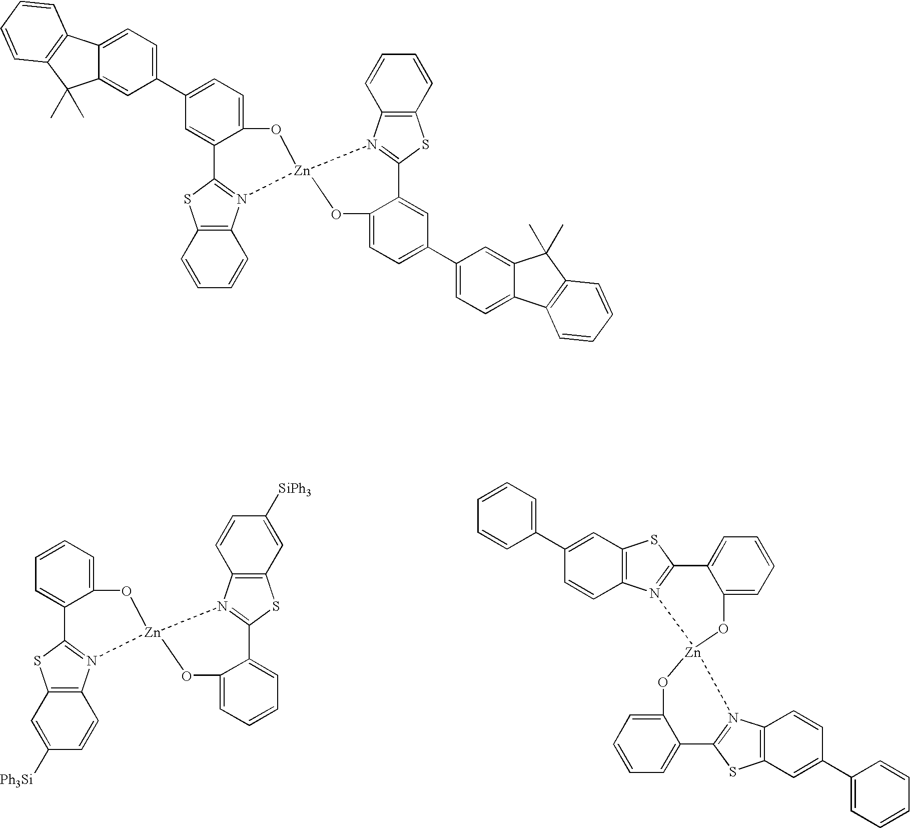 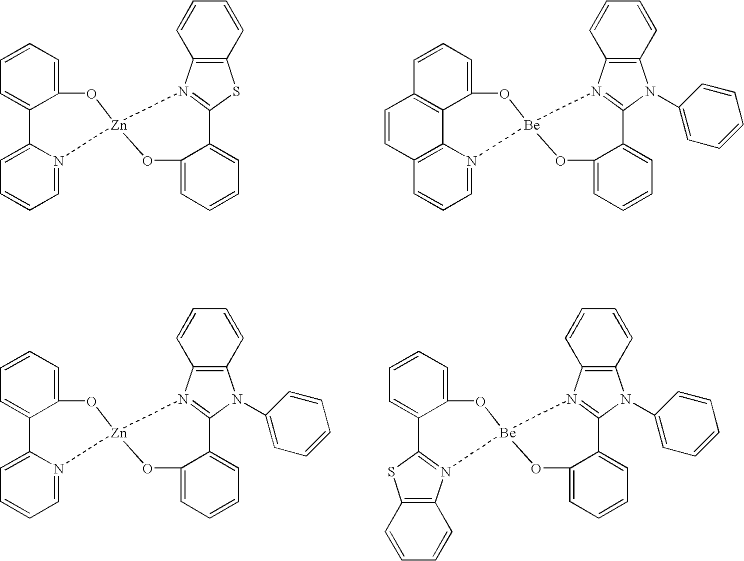 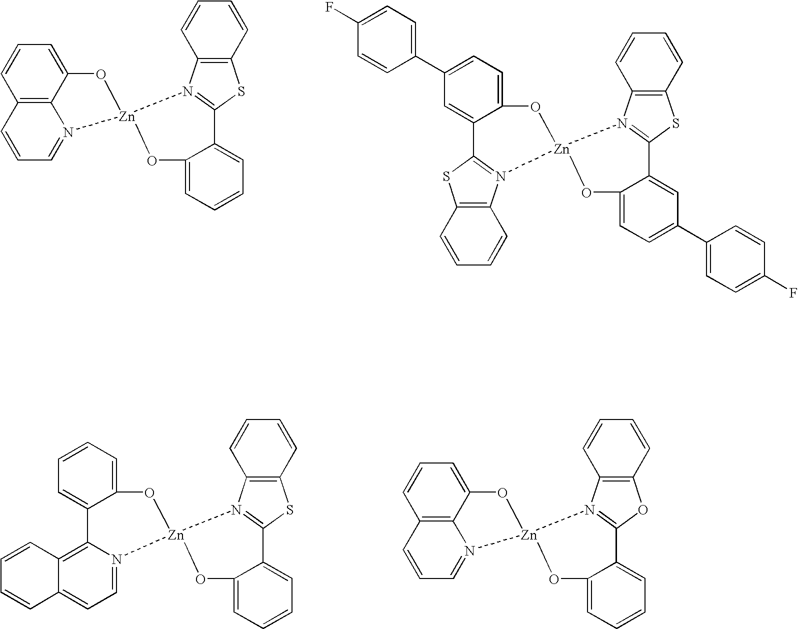 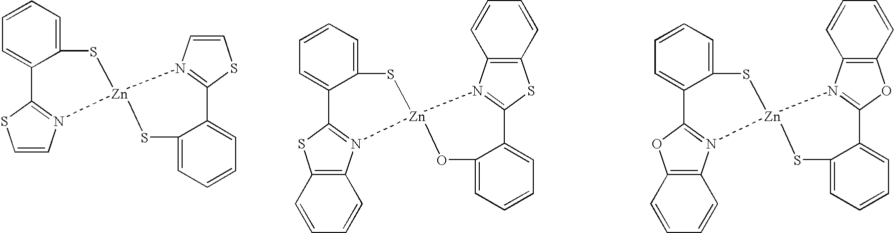 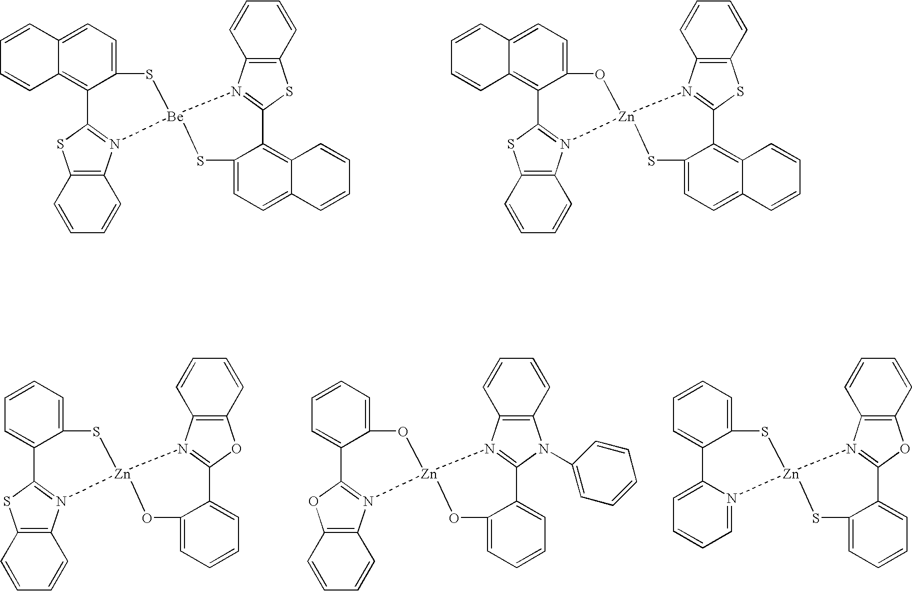 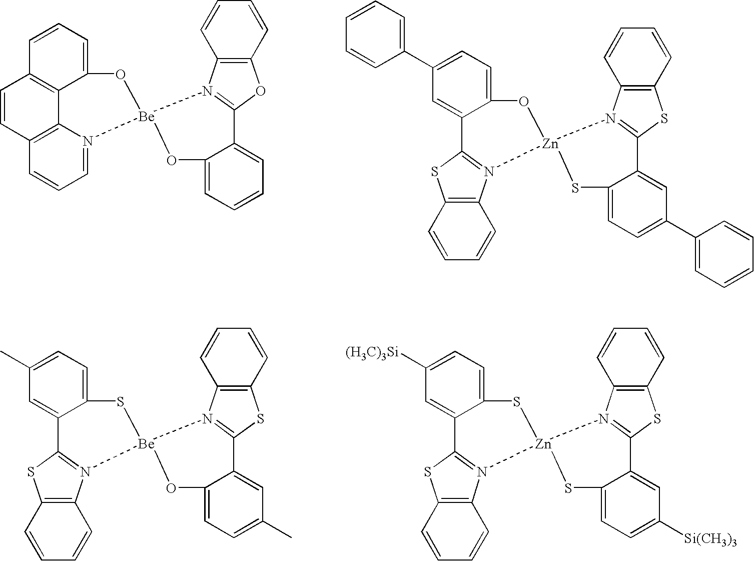 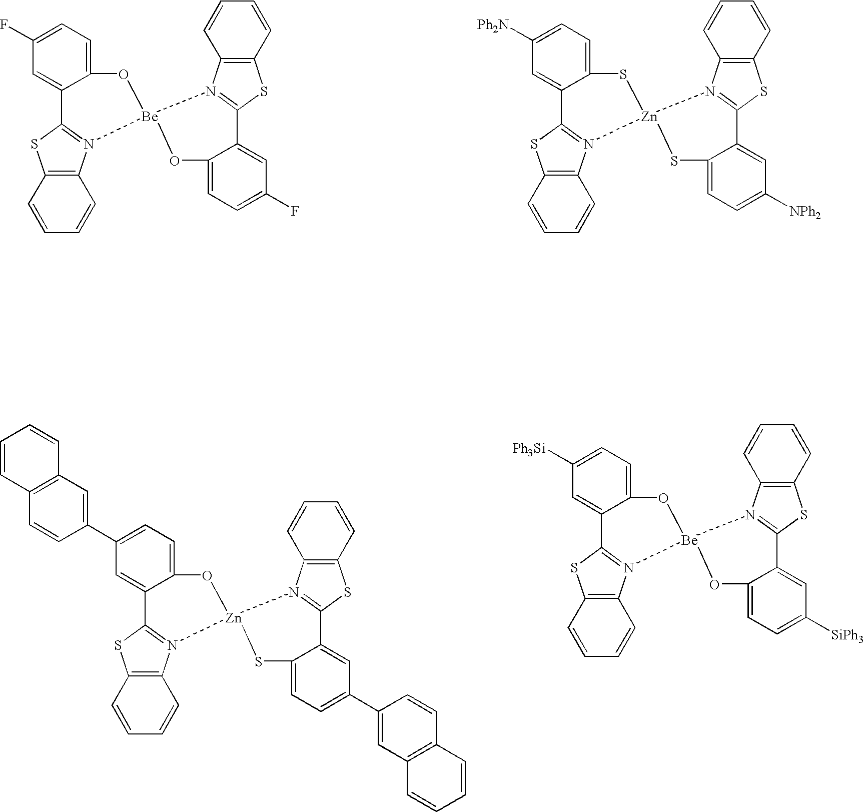 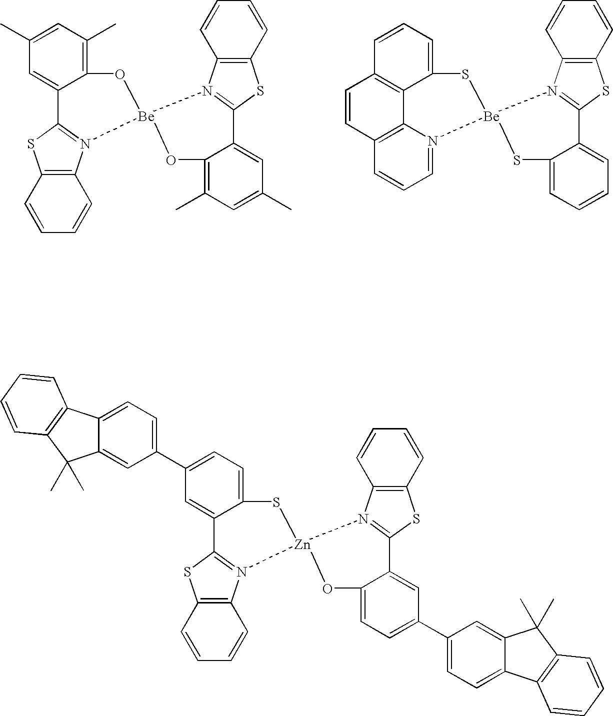 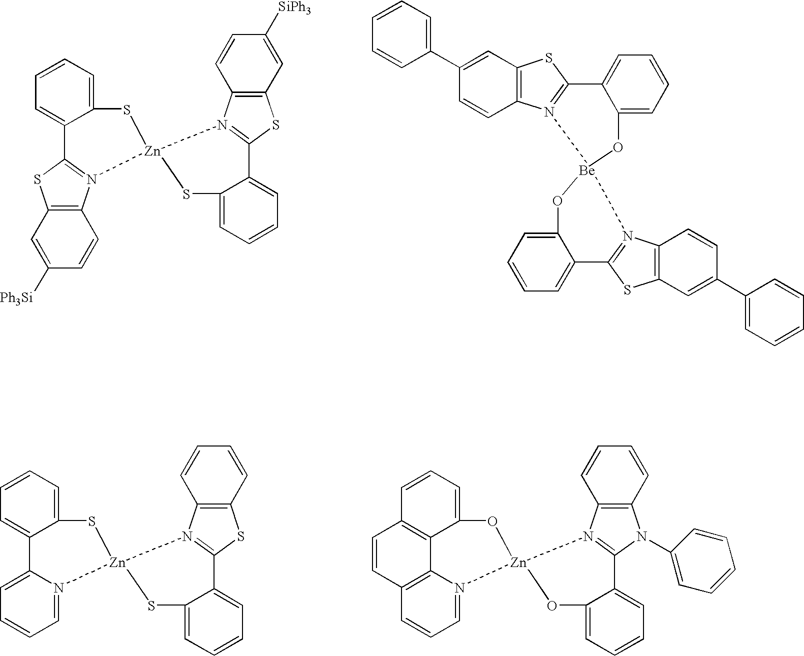 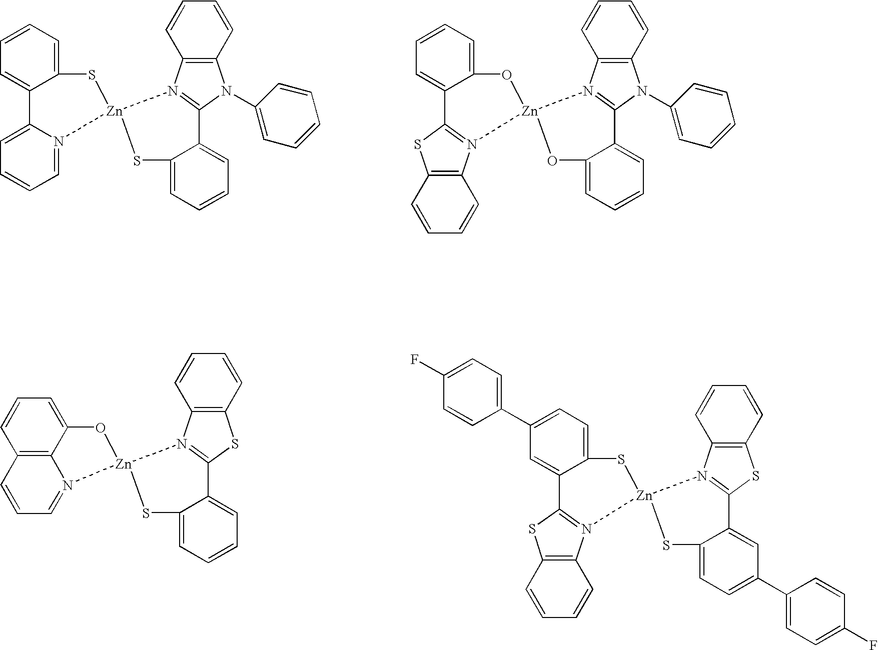 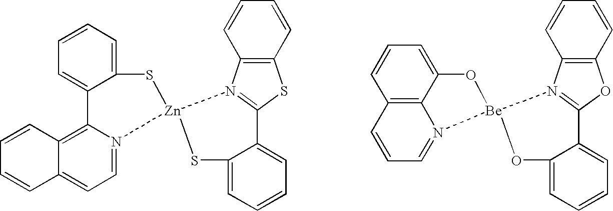 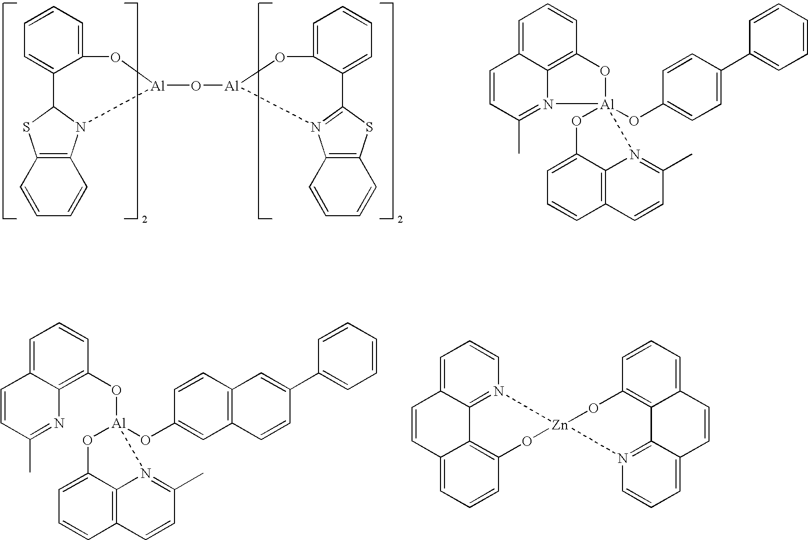 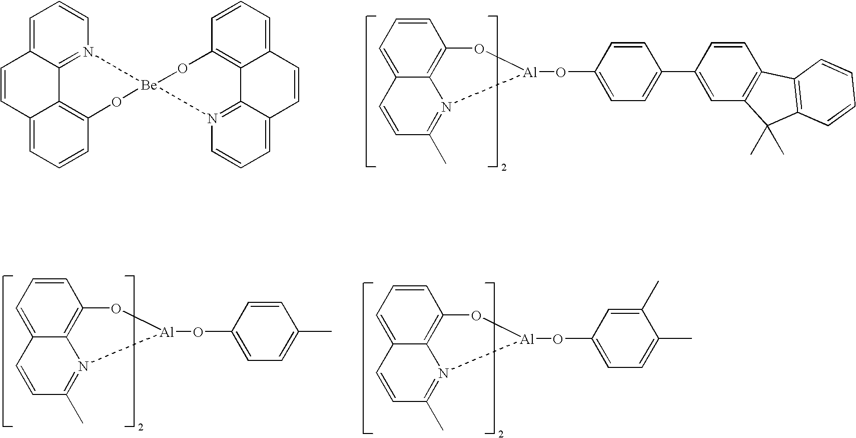 [chemical structure]
